(19) United States
(12) Patent Application Publication
(10) Pub. No.: US 2024/0283284 A1
(43) Pub. Date: Aug. 22, 2024

(54) CHANGEOVER SWITCH BUILT-IN BOARD

(71) Applicant: Tempearl Industrial Co., Ltd., Hiroshima-shi, Hiroshima (JP)

(72) Inventors: Yuta Matsumoto, Hiroshima-shi (JP); Tsubasa Hamada, Hiroshima-shi (JP); Makoto Imagawa, Hiroshima-shi (JP); Kazuma Matsumoto, Hiroshima-shi (JP); Shusaku Kajiya, Hiroshima-shi (JP); Takashi Baba, Hiroshima-shi (JP); Ryo Kikkawa, Hiroshima-shi (JP); Yuma Okutani, Hiroshima-shi (JP)

(73) Assignee: Tempearl Industrial Co., Ltd., Hiroshima-shi, Hiroshima (JP)

(21) Appl. No.: 18/568,158

(22) PCT Filed: Jun. 9, 2022
(86) PCT No.: PCT/JP2022/023288

§ 371 Date: Dec. 7, 2023

(30) Foreign Application Priority Data
Jun. 11, 2021 (JP) 2021-097872
Jun. 11, 2021 (JP) 2021-097873
Jun. 11, 2021 (JP) 2021-097874
Jun. 11, 2021 (JP) 2021-097875
Jun. 11, 2021 (JP) 2021-097876
Jun. 11, 2021 (JP) 2021-097877
Jun. 11, 2021 (JP) 2021-097878
Jun. 11, 2021 (JP) 2021-097879
Jun. 11, 2021 (JP) 2021-097880
Jun. 11, 2021 (JP) 2021-097881

(51) Int. Cl. H02J 9/04

(52) U.S. Cl. CPC H02J 9/04

(57) ABSTRACT

A changeover switch for changing over a power source for supplying power to a load system includes a load between a 1st power supply system and a 2nd power supply system. The changeover switch includes: a 1st side terminal to which power from the 1st power supply system is input; a 2nd side terminal to which power from the 2nd power supply system is input; and a load side terminal for outputting to a load system power from the 1st power supply system that is input to the 1st side terminal, or power from the 2nd power supply system that is input to the 2nd side terminal, in which areas in which the 1st side terminal, the 2nd side terminal, and the load side terminal are respectively disposed are set at different locations from each other in a front view.

### CROSS-REFERENCE TO RELATED APPLICATION

This application claims priority to Japanese Patent Application Nos. 2021-097872, 2021-097873, 2021-097874, 2021-097875, 2021-097876, 2021-097877, 2021-097878, 2021-097879, 2021-097880, and 2021-097881, the disclosures of which are incorporated herein by reference in its entirety.

### FIELD

The present invention relates to a changeover switch built-in board for switching the connection state between a plurality of power supply systems and a load.

### BACKGROUND

Conventionally, as disclosed in, for example, Patent Document 1, known is a distribution board with capacity for all loads that can switch the connection state between a commercial power supply system or an emergency power system and a load.

The distribution board with capacity for all loads includes a one-pole double-throw type automatic changeover switch electrically connected to a general distribution board to which a residential load is connected, a main breaker connected to the commercial power supply system and the automatic changeover switch (one fixed contact out of two fixed contacts), a power storage unit breaker connected to the commercial power supply system and a storage battery, and an operation mode switching breaker connected to a power conditioner and the automatic changeover switch (the other fixed contact out of the two fixed contacts).

The distribution board with capacity for all loads is configured to perform switching between a state in which at least one of the commercial power supply system and the storage battery is electrically connected to the load by the automatic changeover switch, and a state in which the power conditioner is electrically connected to the load, so that power can be supplied from the power conditioner to the load when an abnormality occurs in the commercial power supply system or the storage battery.

Incidentally, the distribution board with capacity for all loads is required to have a space for wiring the automatic changeover switch, the main breaker, the power storage unit breaker, the operation mode switching breaker, which are vertically and horizontally arranged side by side, (e.g., a space for bending wiring members to change their directions according to the arrangement of the automatic changeable switch and the breakers). However, when the distribution board is designed to secure this space, there is a likelihood that the size of the distribution board is increased.

Such a problem is not limited to the distribution board with capacity for all loads, and similarly occurs in a changeover switch built-in board configured to switch the connection state between a plurality of power supply systems and a load in general.

### CITATION LIST

### Patent Literature

Patent Literature 1: JP 2019-198203 A

### SUMMARY

### Technical Problem

In view of the above circumstance, it is an object of the present invention is to provide a changeover switch built-in board that enables downsizing.

### Solution to Problem

A changeover switch built-in board including: a changeover switch configured to switch an electric power supply source, which supplies electricity to a load, to a 1st electric power source system or a 2nd electric power source system; a 1st circuit part electrically connected to the 1st electric power supply system and the changeover switch; a relay circuit part electrically connected to the 1st circuit part and an external equipment; and a housing for housing the 1st circuit part, the relay circuit part, and the changeover switch; in which one of the changeover switch and the relay circuit part is arranged to be aligned with the 1st circuit part in a 1st direction orthogonal to a front-back direction of the housing, and the remaining one of them is arranged to be aligned with the 1st circuit part in a 2nd direction orthogonal to the front-back direction and the 1st direction; the 1st circuit part including: a 1st electric device to which the 1st power supply system is connected; and a 1st conductive connection part to be connected to the 1st electric device so as to be conductive with the 1st electric power supply system, and the 1st conductive connection part including: a connection fixing part fixed to the 1st electric device and to which the 1st electric power supply system is connected; a 1st conductive part extending in the 1st direction relative to the connection fixing part; a 2nd conductive part extending in the 2nd direction relative to the connection fixing part, in which one of the changeover switch and the relay circuit part is arranged to be opposed to a distal end of the 1st conductive part in the 1st direction, and includes a terminal to which the distal end of the 1st conductive part can be fixed, and the remaining one of the changeover switch and the relay circuit part is arranged to be opposed to a distal end of the 2nd conductive part in the 2nd direction, and includes a terminal to which the distal end of the 2nd conductive part can be fixed.

The changeover switch built-in board may be configured such that the 1st conductive connection part of the 1st circuit part includes a plurality of 1st conductive connection parts; the arrangement position in the front-back direction on the side of a proximal end of the 2nd conductive part of at least one of the plurality of 1st conductive connection parts is positioned on a front side in the front-back direction of the connection fixing part and the distal end of the at least one 2nd conductive part itself, and the 1st conductive part is branched from the side of the proximal end of the 2nd conductive part in the 1st direction.

The changeover switch built-in board may be configured such that the 1st conductive connection part of the 1st circuit part includes a plurality of 1st conductive connection parts, the 1st conductive part of each of the plurality of 1st conductive connection pats includes a proximal-side conductive part that leads to the proximal end of the 2nd conductive part, and that is arranged between the 1st electric device and one of the changeover switch and the relay circuit part which is aligned in the 2nd direction with the 1st circuit part, and the plurality of proximal-side conductive parts of the 1st conductive connection parts are lined up in a row at intervals in the front-back direction.

In this case, it may be configured such that the 2nd conductive parts of the plurality of 1st conductive connection parts are lined up in a row in the 1st direction, the proximal-side conductive parts respectively extend from the 2nd conductive parts in the 1st direction, and the proximal-side conductive parts of the 2nd conductive parts are arranged to be aligned with each other from the front side to the back side in the front-back direction in the order from that extending from the 2nd conductive part arranged at the position farthest in the 1st direction with respect to one of the changeover switch and the relay circuit part which is aligned with the 1st circuit part in the 1st direction.

Further, the changeover switch built-in board may be configured such that the 1st conductive parts respectively comprise distal-side conductive parts that extend from the proximal-side conductive parts to the distal ends of the 1st conductive parts themselves, and that are each arranged between the 1st electric device and the one of the changeover switch and the relay circuit part which is aligned with the 1st circuit part in the 1st direction, the arrangement positions in the 2nd direction of the distal ends of the distal-side conductive parts of the 1st conductive parts are different from each other, and the distal ends are arranged to be aligned with each other from the back side to the front side in the front-back direction in the order from that arranged at a position farthest from the proximal-side conductive part in the 2nd direction, and an identification display for displaying the type of the 1st conductive connection part is disposed on a forward side of the distal-side conductive parts arranged toward the front side.

The changeover switch built-in board may be configured such that the 1st conductive connection parts are formed of a plate material having conductivity.

The changeover switch built-in board may further includes a 1st cover part for covering the 1st conductive connection part from the front side in the front-back direction, in which the 1st cover part includes: a 1st protection part for covering the connection fixing part from the front side, and a 2nd protection part for covering the 1st conductive part and the 2nd conductive part from the front side, in which the 1st protection part and the 2nd protection part are configured such that in a state where the 2nd protection part covers the 1st conductive part and the 2nd conductive part, the 1st protection part can be switched between a closed state where the 1st protection part covers the connection fixing part from the front side and an open state where the 1st protection part opens the front of the connection fixing part of the 2nd conductive part.

### BRIEF DESCRIPTION OF DRAWINGS

FIG. 1 is a schematic view of a changeover system of a power supply system including a changeover switch built-in board according to one embodiment of the present invention.

FIG. 2 is an external view of the changeover switch built-in board according to the one embodiment.

FIG. 3 is a front view of the inside of the changeover switch built-in board according to the one embodiment.

FIG. 4 is an exploded perspective view of a 1st circuit part of the changeover switch built-in board according to the one embodiment.

FIG. 5 is an enlarged perspective view of the 1st circuit part of the changeover switch built-in board according to the one embodiment.

FIG. 6 is an enlarged perspective view of the 1st circuit part of the changeover switch built-in board according to the one embodiment with a 1st conductive connection part of a 1st phase removed therefrom.

FIG. 7 is an explanatory view of a housing of a casing of the changeover switch built-in board according to the one embodiment.

FIG. 8 is an explanatory view of a cover structure of the changeover switch built-in board according to the one embodiment.

FIG. 9 is an explanatory view of a 1st cover and a 2nd cover of the changeover switch built-in board according to the one embodiment in the state where both the 1st cover and the 2nd cover are mounted in the board.

FIG. 10 is an explanatory view of the 1st cover and the 2nd cover of the changeover switch built-in board according to the one embodiment in the state where only the 1st cover is removed from the board.

FIG. 11 is an explanatory view showing a state where a 3rd cover is mounted in the changeover switch built-in board according to the one embodiment.

FIG. 12 is an explanatory view of the operation of the changeover switch built-in board according to the one embodiment in the state where a 1st power supply system and a load are connected to each other.

FIG. 13 is an explanatory view of the operation of the changeover switch built-in board according to the one embodiment in the state where a 2nd power supply system and a load are connected to each other.

FIG. 14 is an explanatory view of a 1st circuit part of a changeover switch built-in board according to an other embodiment.

FIG. 15 is a perspective view of a 1st electric device of the changeover switch built-in board according to the other embodiment.

FIG. 16 is a schematic view of a power supply system including the changeover switch built-in board according to one embodiment of the present invention.

FIG. 17 is an external view of the changeover switch built-in board according to the one embodiment.

FIG. 18 is a front view of the inside of the changeover switch built-in board according to the one embodiment.

FIG. 19 is an exploded perspective view of a 1st circuit part of the changeover switch built-in board according to the one embodiment.

FIG. 20 is an enlarged perspective view of the 1st circuit part of the changeover switch built-in board according to the one embodiment.

FIG. 21 is an enlarged perspective view of the 1st circuit part of the changeover switch built-in board according to the one embodiment, in which a 1st conductive connection part of a 1st phase is removed.

FIG. 22 is an explanatory view of a housing of a casing of the changeover switch built-in board according to the one embodiment.

FIG. 23 is an explanatory view of a cover structure of the changeover switch built-in board according to the one embodiment.

FIG. 24 is an explanatory view of a 1st cover and a 2nd cover of the changeover switch built-in board according to the one embodiment, in which both the 1st cover and the 2nd cover are mounted in the board.

FIG. 25 is an explanatory view of the 1st cover and the 2nd cover of the changeover switch built-in board according to the one embodiment, in which only the 1st cover is removed from the board.

FIG. 26 is an explanatory view showing a state, in which a 3rd cover is mounted in the changeover switch built-in board according to the one embodiment.

FIG. 27 is an explanatory view of the operation of the changeover switch built-in board according to the one embodiment, in which a 1st power supply system and a load are connected to each other.

FIG. 28 is an explanatory view of the operation of the changeover switch built-in board according to the one embodiment, in which a 2nd power supply system and a load are connected to each other.

FIG. 29 is an explanatory view of a 1st circuit part of a changeover switch built-in board according to another embodiment of the present invention.

FIG. 30 is a perspective view of a 1st electric device of the changeover switch built-in board according to the other embodiment.

FIG. 31 is a schematic view of a changeover system of a power supply system including a changeover switch built-in board according to one embodiment of the present invention.

FIG. 32 is an external view of the changeover switch built-in board according to the one embodiment.

FIG. 33 is a front view of the inside of the changeover switch built-in board according to the one embodiment.

FIG. 34 is an exploded perspective view of a 1st circuit part of the changeover switch built-in board according to the one embodiment.

FIG. 35 is an enlarged perspective view of the 1st circuit part of the changeover switch built-in board according to the one embodiment.

FIG. 36 is an enlarged perspective view of the 1st circuit part of the changeover switch built-in board according to the one embodiment, in which a 1st conductive connection part of a 1st phase is removed.

FIG. 37 is an explanatory view of a housing of a casing of the changeover switch built-in board according to the one embodiment.

FIG. 38 is an explanatory view of a cover structure of the changeover switch built-in board according to the one embodiment.

FIG. 39 is an explanatory view of a 1st cover and a 2nd cover of the changeover switch built-in board according to the one embodiment, in which both the 1st cover and the 2nd cover are mounted in the board.

FIG. 40 is an explanatory view of the 1st cover and the 2nd cover of the changeover switch built-in board according to the one embodiment, in which only the 1st cover is removed from the board.

FIG. 41 is an explanatory view for a state, in which a 3rd cover is mounted in the changeover switch built-in board according to the one embodiment.

FIG. 42 is an explanatory view of the operation of the changeover switch built-in board according to the one embodiment, in which a 1st power supply system and a load are connected to each other.

FIG. 43 is an explanatory view of the operation of the changeover switch built-in board according to the one embodiment, in which a 2nd power supply system and a load are connected to each other.

FIG. 44 is an explanatory view of a 1st circuit part of a changeover switch built-in board according to another embodiment of the present invention.

FIG. 45 is a perspective view of a 1st electric device of the changeover switch built-in board according to the other embodiment.

FIG. 46 is a schematic view of a power supply system including the changeover switch built-in board according to one embodiment of the present invention.

FIG. 47 is an external view of the changeover switch built-in board according to the one embodiment.

FIG. 48 is a front view of the inside of the changeover switch built-in board according to the one embodiment.

FIG. 49 is an exploded perspective view of a 1st circuit part of the changeover switch built-in board according to the one embodiment.

FIG. 50 is an enlarged perspective view of the 1st circuit part of the changeover switch built-in board according to the one embodiment.

FIG. 51 is an enlarged perspective view of the 1st circuit part of the changeover switch built-in board according to the one embodiment, in which a 1st conductive connection part of a 1st phase is removed from the board.

FIG. 52 is an explanatory view of a housing of a casing of the changeover switch built-in board according to the one embodiment.

FIG. 53 is an explanatory view of a cover structure of the changeover switch built-in board according to the one embodiment.

FIG. 54 is an explanatory view of a 1st cover and a 2nd cover of the changeover switch built-in board according to the one embodiment, in which both the 1st cover and the 2nd cover are mounted in the board.

FIG. 55 is an explanatory view of the 1st cover and the 2nd cover of the changeover switch built-in board according to the one embodiment, in which only the 1st cover is removed from the board.

FIG. 56 is an explanatory view for a state, in which a 3rd cover is mounted in the changeover switch built-in board according to the one embodiment

FIG. 57 is an explanatory view of the operation of the changeover switch built-in board according to the one embodiment, in which a 1st power supply system and a load are connected to each other.

FIG. 58 is an explanatory view of the operation of the changeover switch built-in board according to the one embodiment, in which a 2nd power supply system and a load are connected to each other.

FIG. 59 is a schematic view of a changeover system of a power supply system including a changeover switch built-in board according to another embodiment of the present invention.

FIG. 60 is a front view of the inside of the changeover switch built-in board according to the other embodiment.

FIG. 61 is an explanatory view of a 1st circuit part of a changeover switch built-in board according to another embodiment of the present invention.

FIG. 62 is a perspective view of a 1st electric device of the changeover switch built-in board according to the other embodiment.

FIG. 63 is a schematic view of a changeover system of a power supply system including a changeover switch built-in board according to a first embodiment of the present invention.

FIG. 64 is a front view of the inside of the changeover switch built-in board according to the embodiment.

FIG. 65 is an exploded perspective view of a 1st circuit part of the changeover switch built-in board according to the embodiment.

FIG. 66 is an enlarged perspective view of the 1st circuit part of the changeover switch built-in board according to the embodiment.

FIG. 67 is an enlarged perspective view of the 1st circuit part of the changeover switch built-in board according to the embodiment, in which a 1st conductive connection part of a 1st phase is removed.

FIG. 68 is an explanatory view of a housing of a casing of the changeover switch built-in board according to the embodiment.

FIG. 69 is a schematic view of a changeover system of a power supply system including a changeover switch built-in board according to a second embodiment of the present invention.

FIG. 70 is a front view of the inside of the changeover switch built-in board according to the embodiment.

FIG. 71 is an exploded perspective view of a 1st circuit part of the changeover switch built-in board according to the embodiment.

FIG. 72 is a schematic view of a changeover system of a power supply system including the changeover switch built-in board according to a first embodiment of the present invention.

FIG. 73 is an external view of the changeover switch built-in board according to the embodiment.

FIG. 74 is a front view of the inside of the changeover switch built-in board according to the embodiment.

FIG. 75 is an exploded perspective view of a 1st circuit part of the changeover switch built-in board according to the embodiment.

FIG. 76 is an enlarged perspective view of the 1st circuit part of the changeover switch built-in board according to the embodiment.

FIG. 77 is an enlarged perspective view of the 1st circuit part of the changeover switch built-in board according to the embodiment, in which a 1st conductive connection part of a 1st phase is removed from the board.

FIG. 78 is an explanatory view of a housing of a casing of the changeover switch built-in board according to the embodiment.

FIG. 79 is an explanatory view of a cover structure of the changeover switch built-in board according to the embodiment.

FIG. 80 is an explanatory view of a 1st cover and a 2nd cover of the changeover switch built-in board according to the embodiment, in which both the 1st cover and the 2nd cover are mounted in the board.

FIG. 81 is an explanatory view of the 1st cover and the 2nd cover of the changeover switch built-in board according to the embodiment, in which only the 1st cover is removed from the board.

FIG. 82 is an explanatory view for a state, in which a 3rd cover is mounted in the changeover switch built-in board according to the embodiment.

FIG. 83 is an explanatory view of the operation of the changeover switch built-in board according to the embodiment, in which a 1st power supply system and a load are connected to each other.

FIG. 84 is an explanatory view of the operation of the changeover switch built-in board according to the embodiment, in which a 2nd power supply system and a load are connected to each other.

FIG. 85 is a schematic view of a changeover system of a power supply system including a changeover switch built-in board according to a second embodiment of the present invention.

FIG. 86 is a front view of the inside of the changeover switch built-in board according to the embodiment.

FIG. 87 is an explanatory view of a housing of a casing of the changeover switch built-in board according to the embodiment.

FIG. 88 is a front view of the inside of the changeover switch built-in board according to a 3rd embodiment of the present invention.

FIG. 89 is an exploded perspective view of a 1st circuit part of the changeover switch built-in board according to the embodiment.

FIG. 90 is an explanatory view of a 1st circuit part of a changeover switch built-in board according to an embodiment other than the above embodiments of the present invention.

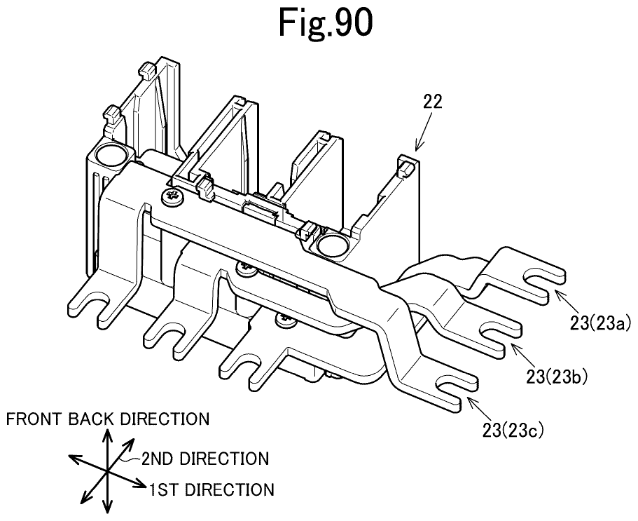

FIG. 91 is a perspective view of a 1st electric device of the changeover switch built-in board according to the embodiment.

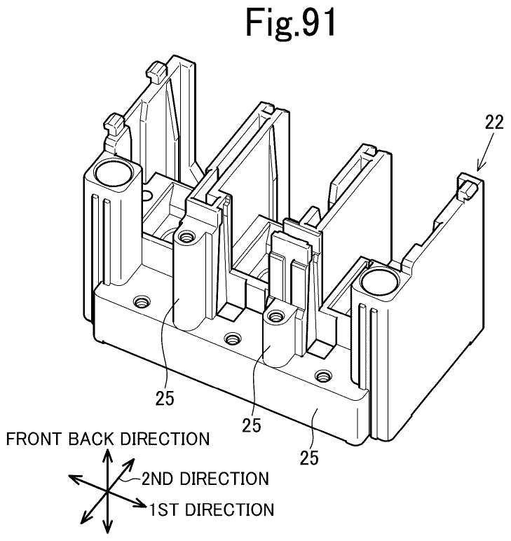

FIG. 92 is a schematic view of a changeover system of a power supply system including a changeover switch built-in board according to a first embodiment of the present invention.

FIG. 93 is an external view of the changeover switch built-in board according to the embodiment.

FIG. 94 is a front view of the inside of the changeover switch built-in board according to the embodiment.

FIG. 95 is an exploded perspective view of a 1st circuit part of the changeover switch built-in board according to the embodiment.

FIG. 96 is an enlarged perspective view of the 1st circuit part of the changeover switch built-in board according to the embodiment.

FIG. 97 is an enlarged perspective view of the 1st circuit part of the changeover switch built-in board according to the embodiment, in which a 1st conductive connection part of a 1st phase is removed from the board.

FIG. 98 is an explanatory view of a housing of a casing of the changeover switch built-in board according to the embodiment.

FIG. 99 is an explanatory view of a cover structure of the changeover switch built-in board according to the embodiment.

FIG. 100 is an explanatory view of a 1st cover and a 2nd cover of the changeover switch built-in board according to the embodiment, in which both the 1st cover and the 2nd cover are mounted in the board.

FIG. 101 is an explanatory view of the 1st cover and the 2nd cover of the changeover switch built-in board according to the embodiment, in which only the 1st cover is removed from the board.

FIG. 102 is an explanatory view for a state, in which a 3rd cover is mounted in the changeover switch built-in board according to the embodiment.

FIG. 103 is an explanatory view of the operation of the changeover switch built-in board according to the embodiment, in which a 1st power supply system and a load are connected to each other.

FIG. 104 is an explanatory view of the operation of the changeover switch built-in board according to the embodiment, in which a 2nd power supply system and a load are connected to each other.

FIG. 105 is a schematic view of a changeover system of a power supply system including a changeover switch built-in board according to a second embodiment of the present invention.

FIG. 106 is a front view of the inside of the changeover switch built-in board according to the embodiment.

FIG. 107 is an explanatory view of a housing of a casing of the changeover switch built-in board according to the embodiment.

FIG. 108 is a front view of the inside of a changeover switch built-in board according to a third embodiment of the present invention.

FIG. 109 is an exploded perspective view of a 1st circuit part of the changeover switch built-in board according to the embodiment.

FIG. 110 is an explanatory view of a 1st circuit part of a changeover switch built-in board according to an embodiment other than the above embodiments of the present invention.

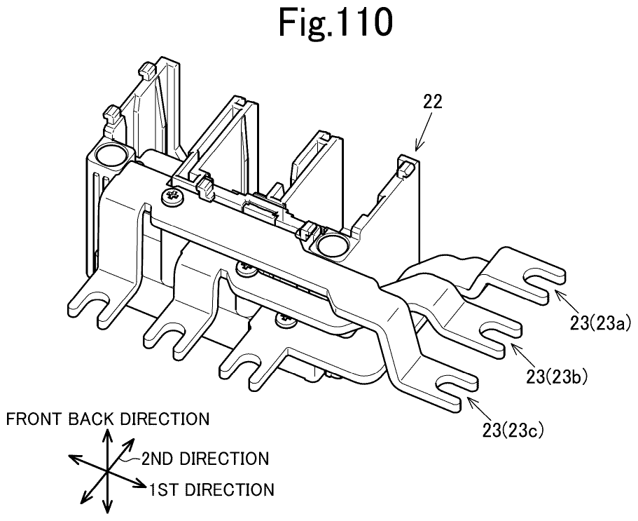

FIG. 111 is a perspective view of a 1st electric device of the changeover switch built-in board according to the embodiment.

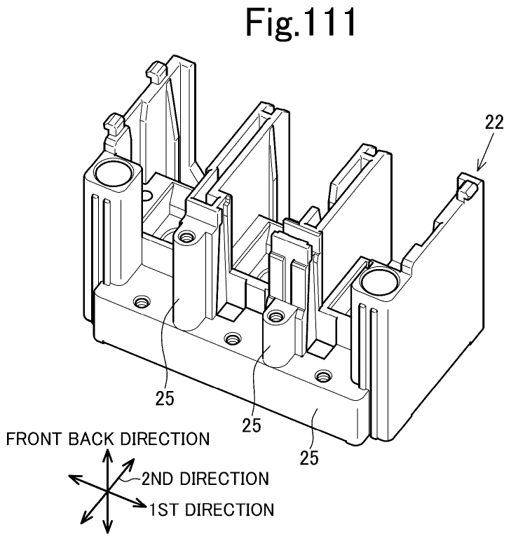

FIG. 112 is a schematic view of a changeover system of a power supply system including a changeover switch built-in board according to a first embodiment of the present invention.

FIG. 113 is an external view of the changeover switch built-in board according to the embodiment.

FIG. 114 is a front view of the inside of the changeover switch built-in board according to the embodiment.

FIG. 115 is an exploded perspective view of a 1st circuit part of the changeover switch built-in board according to the embodiment.

FIG. 116 is an enlarged perspective view of the 1st circuit part of the changeover switch built-in board according to the embodiment.

FIG. 117 is an enlarged perspective view of the 1st circuit part of the changeover switch built-in board according to the embodiment, in which a 1st conductive connection part of a 1st phase is removed from the board.

FIG. 118 is an explanatory view of a housing of a casing of the changeover switch built-in board according to the embodiment.

FIG. 119 is an explanatory view of a cover structure of the changeover switch built-in board according to the embodiment.

FIG. 120 is an explanatory view of a 1st cover and a 2nd cover of the changeover switch built-in board according to the embodiment, in which both the 1st cover and the 2nd cover are mounted in the board.

FIG. 121 is an explanatory view of the 1st cover and the 2nd cover of the changeover switch built-in board according to the embodiment, in which only the 1st cover is removed from the board.

FIG. 122 is an explanatory view for a state, in which a 3rd cover is mounted in the changeover switch built-in board according to the embodiment.

FIG. 123 is an explanatory view of the operation of the changeover switch built-in board according to the embodiment, in which a 1st power supply system and a load are connected to each other.

FIG. 124 is an explanatory view of the operation of the changeover switch built-in board according to the embodiment, in which a 2nd power supply system and a load are connected to each other.

FIG. 125 is a schematic view of a changeover system of a power supply system including a changeover switch built-in board according to a second embodiment of the present invention.

FIG. 126 is a front view of the inside of the changeover switch built-in board according to the embodiment.

FIG. 127 is an explanatory view of a housing of a casing of the changeover switch built-in board according to the embodiment.

FIG. 128 is a front view of the inside of a changeover switch built-in board according to a third embodiment of the present invention.

FIG. 129 is an exploded perspective view of a 1st circuit part of the changeover switch built-in board according to the embodiment.

FIG. 130 is an explanatory view of a 1st circuit part of a changeover switch built-in board according to an embodiment other than above embodiments of the present invention.

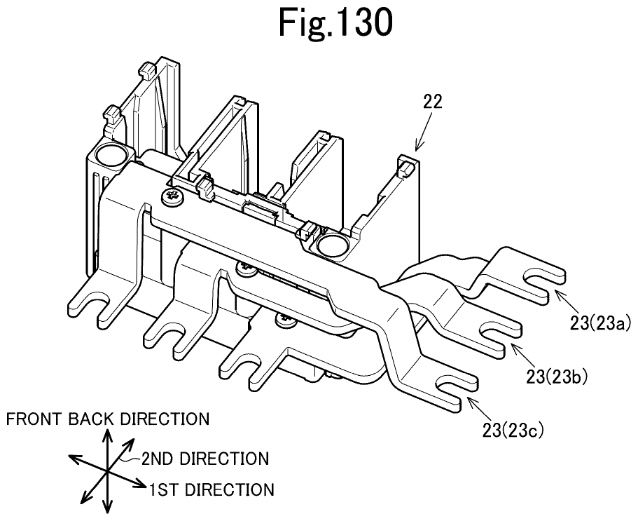

FIG. 131 is a perspective view of a 1st electric device of the changeover switch built-in board according to the embodiment.

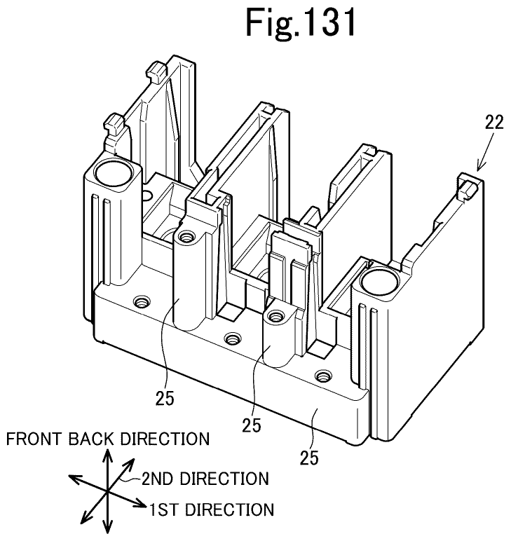

FIG. 132 is a perspective view of a changeover switch according to an embodiment of the present invention.

FIG. 133 is a front view of the changeover switch according to the embodiment.

FIG. 134 is a partially enlarged view of the changeover switch according to the embodiment, specifically a partially enlarged view of an area including a 1st side terminal.

FIG. 135 is a partially enlarged view of the changeover switch according to the embodiment, specifically a partially enlarged view of an area including a 2nd side terminal.

FIG. 136 is a partially enlarged view of the changeover switch according to the embodiment, specifically a partially enlarged view of an area including a load side terminal.

FIG. 137 is a partially cross sectional view of the changeover switch according to the embodiment, specifically a partially enlarged view of a wiring cover.

FIG. 138 is a partially cross sectional view taken along a line VII-VII in FIG. 137 with an external member for mechanism eliminated.

FIG. 139 is an explanatory view of the operation of the changeover switch built-in board according to the embodiment, specifically an explanatory view for a state, in which a 1st power supply system and a load are connected to each other.

FIG. 140 is an explanatory view of the operation of the changeover switch built-in board according to the embodiment, specifically an explanatory view for a state, in which a 2nd power supply system and a load system are connected to each other.

FIG. 141 is an explanatory view of the changeover switch built-in board with a changeover switch according to the embodiment built in.

FIG. 142 is a block diagram showing an outline of a configuration of the changeover switch including a contact device according to one embodiment of the present invention.

FIG. 143 is a front view of the changeover switch according to the embodiment.

FIG. 144 is a perspective view of the contact device according to the embodiment.

FIG. 145 is an explanatory view of the inside of the contact device according to the embodiment.

FIG. 146 is an enlarged view of an area including a passive member of the contact device according to the embodiment.

FIG. 147 shows a conductive plate of the contact device according to the embodiment as viewed from a front side.

FIG. 148 is an explanatory view of the contact device according to the embodiment, specifically the positional relationship among a point of support, a point of application, and a point of action.

FIG. 149 is an explanatory view for a state, in which the contact device according to the embodiment has been switched into a 1st state.

FIG. 150 is an explanatory view for a state, in which the contact device according to the embodiment has bee switched to a 2nd state.

### DESCRIPTION OF EMBODIMENTS

Hereinafter, the changeover switch built-in board according to an embodiment of the present invention will be described with reference to the accompanied drawings.
the changeover switch built-in board is installed between a plurality of power supply systems and a load, and is configured to switch a connection state between the plurality of power supply systems and the load.

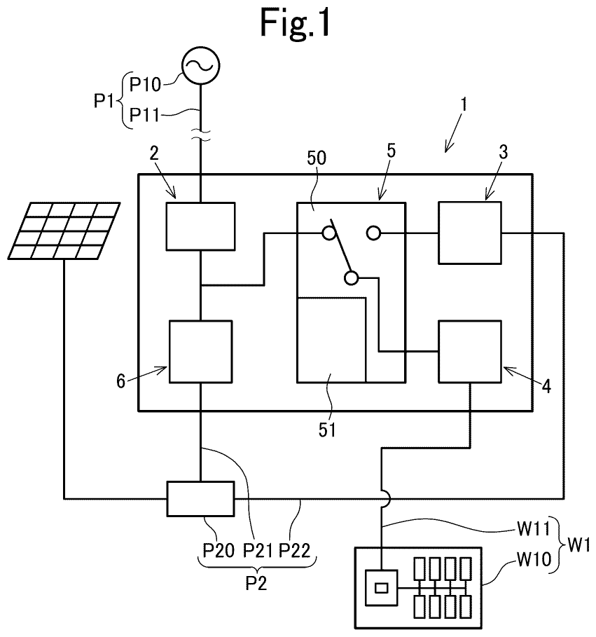

For example, as shown in FIG. 1, when the switching switch built-in board is installed in a house, the first power supply system P1 through which the commercial power flows, the second power supply system P2 including the distributed power supply, and the load system W1 including the load W10 are electrically connected to the changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

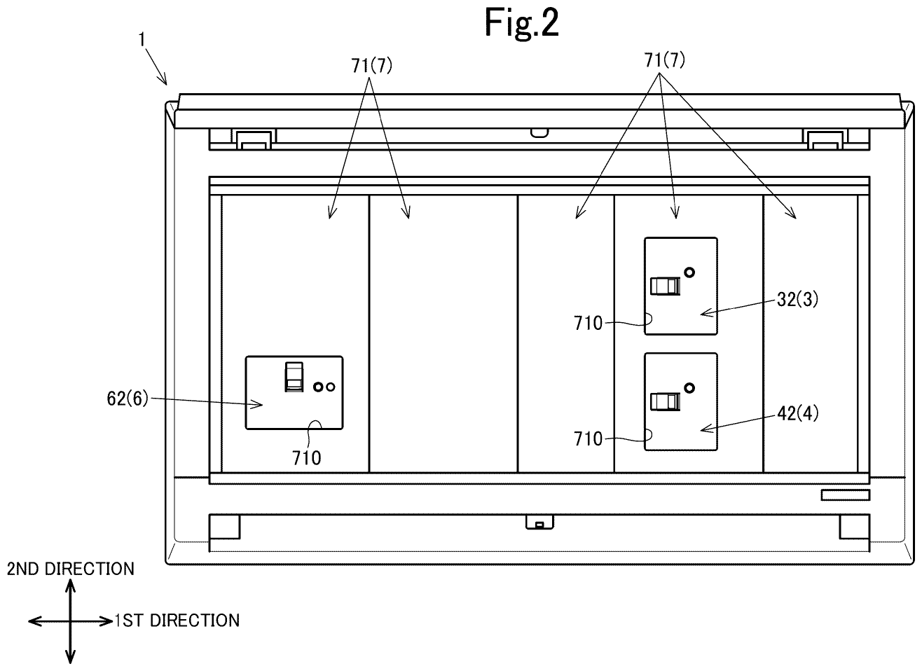

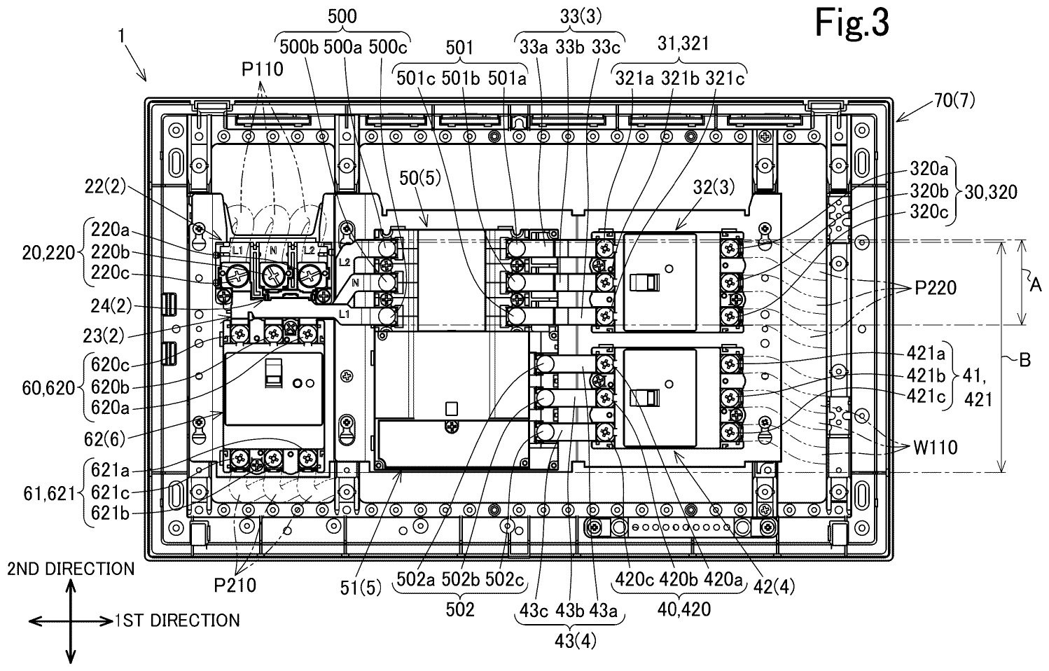

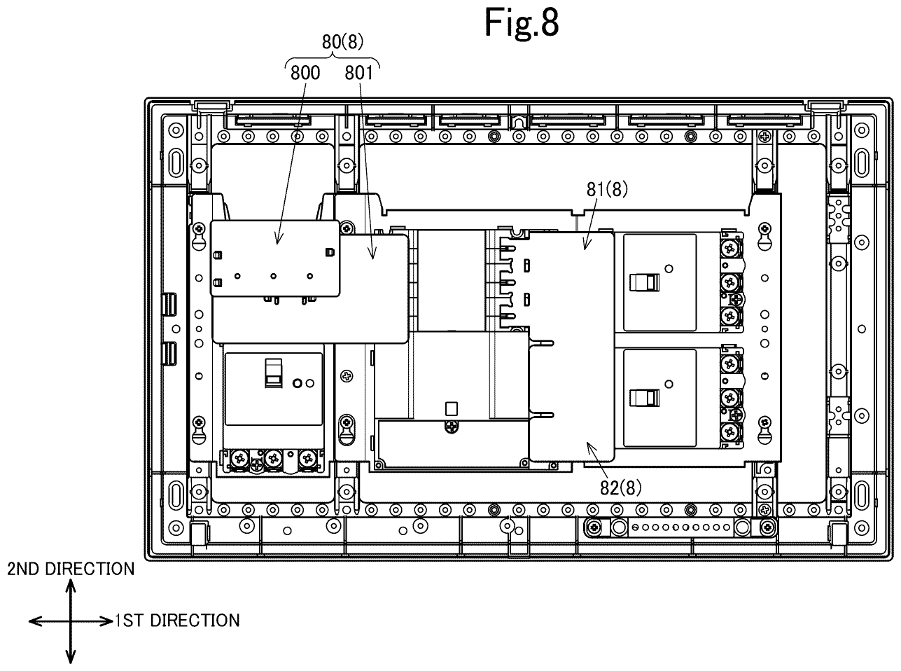

Changeover switch built-in board 1, as shown in FIG. 3, a first circuit part 2 which is electrically connected to the first power supply system P1, a second circuit part 3 which is electrically connected to the second power supply system P2, a load circuit part 4 which is electrically connected to the load system W1, switching switch 5 for switching the power supplied to the load system P2 to the first power supply system P1 or the second power supply system P2, electrically to the first circuit part 2 and the second power supply system W1A relay circuit part 6 to be connected, the first circuit part 2, the second circuit part 3, the relay circuit part 6, the changeover switch 5, a housing 7 for accommodating the load circuit part 4 (see FIG. 2), and a cover structure 8 for covering the charging part in the housing 7 (see FIG. 8).

In the present embodiment, a direction in which the front surface and the back surface of the changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction of a surface formed by the first direction and the second direction is referred to as a board surface direction.

In the present embodiment, the first direction is a direction corresponding to the left-right direction in a state in which the changeover switch built-in board 1 in the installed state is viewed from the front, and the one side in the first direction is a left side and the other side in the first direction is a right side.

Further, the second direction is a direction corresponding to the vertical direction in a state in which the changeover switch built-in board 1 in the installed state is viewed from the front, one side in the second direction is an upper side, the other side in the second direction is a lower side.

The first circuit part 2 is electrically connected to the first power supply system P1 and the changeover switch 5. The first circuit part 2 is disposed on one side of the changeover switch 5 in the first direction.

The first circuit part 2 of the present embodiment includes a first primary terminal part 20 electrically connected to the first power supply system P1, and a first secondary terminal part (not numbered) electrically connected to the changeover switch 5 (the first side terminal part 500 described later) and the relay circuit part 6. In the first circuit part 2 of the present embodiment, the first primary terminal part 20 also serves as the first and second terminal parts.

In the first primary terminal part 2, the first terminal part 20 is disposed toward one side in the second direction, and the first conductive P110 connected to the first power supply P10 (the first distribution path P11 in the present embodiment) and the first primary terminal part 20 can be connected to the first primary terminal part 20 in a direction extending from the first primary terminal part 20 to one side in the second direction.

The first circuit part 2 includes a first electric device 22, a first conductive connection part 23 fixed to the first electric device 22 so as to be electrically connected to the first conductive P110, and a partition member 24 for preventing a short circuit of the first conductive connection part 23.

The first electrical device 22 is a terminal block. Further, the first electric device 22 is a terminal block including a first primary terminal part 20 electrically connected to the first power supply system P1, and a first power distribution path P1 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 includes a device primary terminal part 220 capable of fixing the first conductive P110, and a device secondary terminal part (not numbered) capable of fixing the first conductive connection part 23. In the first electric device 22, the device primary terminal part 220 also serves as a device secondary terminal part.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and the first conductive connection part 23 are fixed to the device primary terminal part 220, the first conductor P110 and the first conductive connection part 23 are electrically connected to each other. The device primary terminal part 220 of the present embodiment is configured such that the first conductive P110 and the first conductive connection part 23 can be fixed by screws.

The equipment primary terminal part 220 may be configured to conduct each other by directly contacting the first conductive P110 and the first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

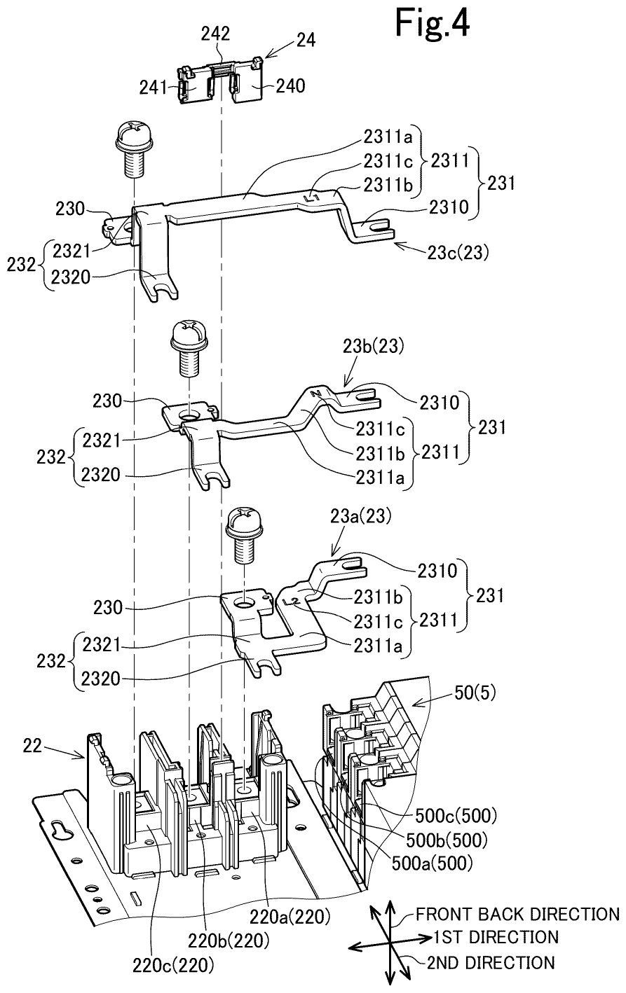

As shown in FIG. 4, the first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the first conductive connection part 23 has a shape in which the distal end side in the case where the connection fixing part 230 is a proximal end is branched into the other side in the second direction and the other side in the first direction. The first conductive connection part 23 of the present embodiment is formed of a plate material having conductivity.

The first conductive part 231 includes a distal end part 2310 fixed to a first-side terminal part 500 (described later) of changeover switch 5, and an intermediate part 2311 that is continuous with the distal end part 2310 and the second conductive part 232 (an intermediate part 2321 (described later) of the second conductive part 232).

The intermediate part 2311 of the first conductive part 231 is a part interposed between the second conductive part 232 and the distal end part 2310 of the first conductive part 231. The intermediate part 2311 of the first conductive part 231 of the present embodiment includes a base-end-side conductive part 2311a disposed between the first electric device 22 and the relay circuit part 6 (the other side in the second direction than the first electric device 22), a distal-side conductive part 2311b disposed between the first electric device 22 and changeover switch 5 (the other side in the first direction than the first electric device 22), and an identification-display 2311c attached to a front surface (one surface disposed toward the front side in the front-rear direction) of the distal-side conductive part 2311b. The identification-display 2311c may be formed by digging in the intermediate part 2311 of the first conductive part 231 by direct marking, or may be formed by printing on the intermediate part with a laser or the like.

The identification 2311c indicates the type of the first conductive connection part 23. The identification-display 2311c of the present embodiment is constituted by characters of “L1” indicating L1 phase, “N” indicating the N phase, and “L2” indicating L2 phase.

The second conductive part 232 includes a distal end part 2320 that is fixed to a relay primary terminal part (a relay device primary terminal part) of the relay circuit part 6, which will be described later, and an intermediate part 2321 that is connected to the distal end part 2320 and the connection fixing part 230.

Here, the first circuit part 2 has three first conductive connectors 23 corresponding to the numbers of the device primary terminal part 220. The three first conductive connection parts 23 are a first conductive connection part 23 for the first phase (first phase conductive connection part 23a), a first conductive connection part 23 for the second phase (second phase conductive connection part 23b), and a first conductive connection part 23 for the third phase (third phase conductive connection part 23c), respectively.

The three first conductive connection part 23 are arranged such that the respective second conductive part 232 are aligned in the first direction in the front view.

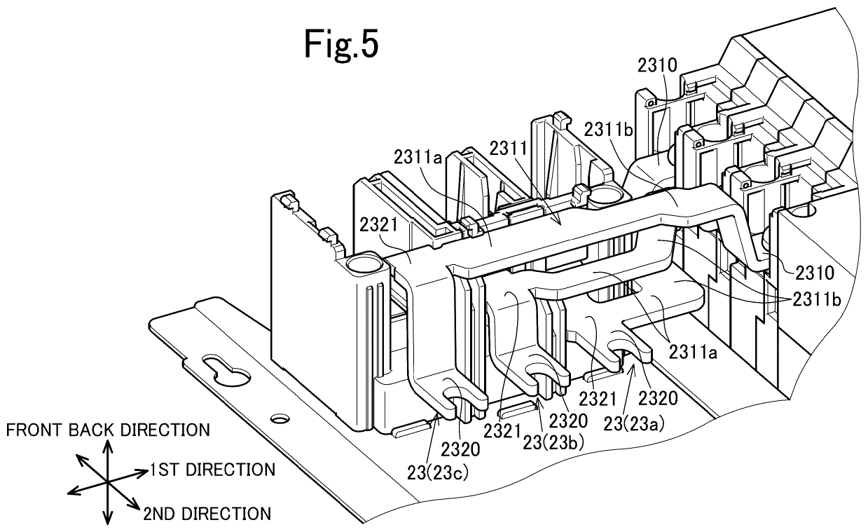

As shown in FIG. 5, intermediate part 2321 of each second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second conductive part 232 for the first phase, which is disposed on the most other side in the first direction, is disposed on the most rear side in the front-rear direction.

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the three-phase conductive part 23c (conductive connection part 23 for the third phase (L1 phase)) is disposed on the most forward side in the longitudinal direction, the distal end side conductive part 2311b included in the second-phase conductive connecting part 23b (second phase (N-phase) conductive connection part 23) is disposed on one side in the front-rear direction and the second direction with respect to the distal end side conductive part 2311b included in the third-phase conductive connecting part 23c, the distal end side conductive part 2311b included in the first-phase conductive connecting part 23a (conductive connection part 23 for the first phase (L2 phase)) is disposed on one side in the front-rear direction and in the second direction with respect to the distal end side conductive part 2311b included in the second-phase conductive connecting part 23b.

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the first phase conductive connection part 23b is also arranged so as to cross the region on the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

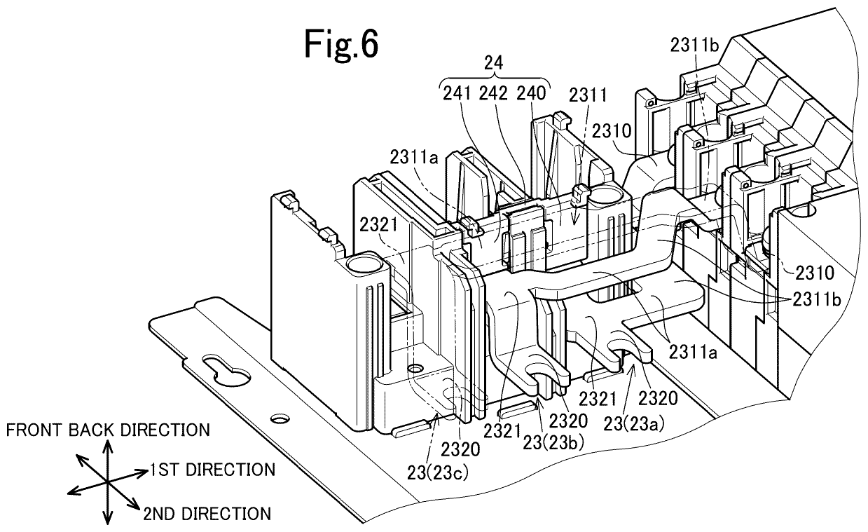

More specifically, as shown in FIG. 6, the partition member 24 has a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 3, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the first direction, and is connectable to second primary terminal part 30 in a direction extending from second primary terminal part 30 to the other side in the first direction with the second power supply P20 (the second power distribution path P22 in the present embodiment) and the second conductor P220 connected to second primary terminal part 30.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The equipment primary terminal part 320 and the equipment secondary terminal part 321 are arranged side by side in a first direction, and the arrangement position of the equipment primary terminal part 320 in the second direction and the arrangement position of the equipment secondary terminal part 321 in the second direction are the same. Further, in the present embodiment, the second electric device 32 is arranged such that the device primary terminal part 320 faces the other side of the first direction and the device secondary terminal part 321 faces the one side of the first direction.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductor P220 of the second distribution path P22 is fixed to the equipment primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductor P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the second direction, and the first phase terminal part 321a of the device secondary terminal part 321, the second phase terminal part 321b, and the third phase terminal part 321c are also arranged to align with each other in the second direction.

The second conductive connection part 33 is formed so as to extend along the first direction (i.e., formed in a straight line shape). One longitudinal end of the second conductive connection part 33 is fixed to the device secondary terminal part 321.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, since the first phase terminal part 321a, the second phase terminal part 321b, and the third phase terminal part 321c of the device secondary terminal part 321 are arranged so as to be aligned along the second direction, the three second conductive connection part 33 are also arranged along the second direction while being fixed to the first phase terminal part 321a, the second phase terminal part 321b, and the third phase terminal part 321c, respectively.

The second electric apparatus of the present embodiment is a circuit breaker. Therefore, in a state in which the second conductive terminal part 320 is fixed with the second conductor P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading equipment 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

The load device primary terminal part 420 and the load device secondary terminal part 421 are arranged side by side in the first direction, the load device primary terminal part 420 is provided at one end of the load device 42 in the first direction, and the load device secondary terminal part 421 is provided at the other end of the load device 42 in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical device 42 is arranged side by side in the second direction with respect to the second circuit part 3, and the load device primary terminal part 420 of the load electrical device 42 and the device secondary terminal part 321 of the second electrical device 32 are arranged in the second direction, and the load device secondary terminal part 421 of the load electrical device 42 and the device primary terminal part 320 of the second electrical device 32 are arranged in the second direction. In the present embodiment, the load electrical device 42 is disposed at a position spaced apart from the second electrical device 32 in the second direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged so as to be aligned in the second direction, and the first phase terminal part 421a, the second phase terminal part 421b, and the third phase terminal part 421c of the load device secondary terminal part 421 are also arranged so as to be aligned in the second direction.

The load conductive connection part 43 is formed so as to extend along the first direction (i.e., is straight), and one end part in the longitudinal direction is fixed to the load primary terminal part 40.

The load circuit part 4 has three load conductive connection part 43 corresponding to the numbers of the first phase terminal part 420a, the second phase terminal part 420b, and the third phase terminal part 420c. The three load conductive connection part 43 are also a load conductive connection part 43 for the first phase (first phase conductive connection 43a), a load conductive connection part 43 for the second phase (second phase conductive connection 43b), and a load conductive connection part 43 for the third phase (third phase conductive connection 43c), respectively.

As described above, since the first phase terminal part 420a, the second phase terminal part 420b, and the third phase terminal part 420c of the load device primary terminal part 420 are arranged to be aligned along the second direction, the three load conductive connection part 43 are arranged to be aligned along the second direction in a state where they are fixed to the first phase terminal part 420a, the second phase terminal part 420b, and the third phase terminal part 420c, respectively.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching body part 50 that switches between the first circuit part 2 and the second circuit part 3 and the load circuit part 4, and a switching control part 51 that operates the switching body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500, the second side terminal part 501, and the load-side terminal part 502 are provided at separate ends in the first direction of changeover switch 5. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction.

Further, the second side terminal part 501 and the load side terminal part 502 are arranged side by side in the second direction in the same direction in the first direction, the second side terminal part 501 and second secondary terminal part 31 face each other in the first direction, and the load side terminal part 502 and the load primary terminal part 40 face each other in the first direction.

In the present embodiment, the second side terminal part 501 is disposed on one side in the second direction, and the load-side terminal part 502 is disposed on the other side in the second direction. Furthermore, the arrangement position of the second side terminal part 501 of the present embodiment in the first direction and the arrangement position of the load-side terminal part 502 in the first direction are different from each other. More specifically, the second side terminal part 501 is arranged to be located on one side of the load-side terminal part 502 in the first direction.

The first phase terminal part 500, the first phase terminal part 500a, the second phase terminal part 500b, and the third phase terminal part 500c are arranged in order in the second direction, and the first phase terminal part 501a of the second side terminal part 501, the second phase terminal part 501b, and the third phase terminal part 501c are arranged in order in the second direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b, 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

In addition to the second-side terminal part 501, in each of the device secondary terminal part 321, the load-side terminal part 502, and the load-device primary terminal part 420 of the load electrical device 42 of the second electrical device 32, the first-phase terminal part 321a, 502a, 420a, the second-phase terminal part 321b, 502b, 420b, and the third-phase terminal part 321c, 502c, 420c are arranged so as to be aligned in the second direction.

Further, the second-side terminal part 501 and the device secondary terminal part 321 of the second electric device 32 are configured such that the first phase terminal part 501a, 321a of each other oppose each other in the first direction, the second phase terminal part 501b, 321b of each other oppose each other in the first direction, and the third phase terminal part 501c, 321c of each other oppose each other in the first direction.

Note that the second-side terminal part 501 and the device secondary terminal part 321 of the second electric device 32 may be opposed to each other in a positional relationship, or may be substantially opposed to each other without being perfectly opposed to each other.

For example, the first phase terminal part 501 first phase terminal part 501a of the second electrical equipment 32 and the first phase terminal part 321 of the second electrical equipment 32 terminal part 321a is arranged so that at least a part is opposed in the first direction, the second phase terminal part 501 second phase terminal part 501b of the second electrical equipment 32 second phase terminal part 321 terminal part 321b, the third phase terminal part 501c of the second side terminal part 501 and the second device of the second electrical equipment 32 the third phase terminal part 321c 321 also, at least a part is opposed in the first direction, the second side terminal part 501 and the device secondary terminal part 321 of the second electrical equipment 32 may be arranged.

Further, for example, if the first phase terminal part 501a of the second side terminal part 501 and the first phase terminal part 321 of the second electric device 32 are arranged so that at least a part of the first phase terminal part 321a of the second electric device 32 is opposed to each other in the first direction, the direction of the second side terminal part 501 of the first phase terminal part 501a of the second electric device 32 and the direction of the first phase terminal part of the second electric device 32 terminal part 321a of the second electric device 32 may intersect, and the direction of the second phase terminal part 501b of the second side terminal part 501 and the direction of the second phase terminal part 321b of the second electric device 32, the direction of the third phase terminal part 501c of the second side terminal part 501 and the direction of the third phase terminal part 321c of the device secondary terminal part 321 of the second electric device 32 may also intersect.

The load-side terminal part 502 and the load device primary terminal part 420 of the load electric device 42 are configured such that the first phase terminal part 502a, 420a of each other oppose each other in the first direction, the second phase terminal part 502b, 420b of each other oppose each other in the first direction, and the third phase terminal part 502c, 420c of each other oppose each other in the first direction.

Note that the load-side terminal part 502 and the load device primary terminal part 420 of the load electric device 42 may be opposed to each other in a positional relationship, or may be substantially opposed to each other without being perfectly opposed to each other.

For example, the first phase terminal part 502 terminal part 502a and the first phase terminal part 420 of the load electrical device 42 may be arranged so that at least some of the first phase terminal part 420a are facing in one direction, the second phase terminal part 502b of the load terminal part 502 and the second phase terminal part 420b of the load electrical device 42 primary phase terminal part 420, the third phase terminal part 502c of the load side terminal part 502 and the third phase terminal part 420c 420 of the load electrical device 42 may also be arranged so that at least some of the third phase 420b in one direction are facing each other, and the load side terminal part 502 and the load electrical device primary terminal part 420 of the load electrical device 42.

Further, for example, if the first phase terminal part 502 and terminal part 502a of the load electrical device 42 and the first phase terminal part 420 of the load electrical device terminal part 420a 420 are arranged so as to be at least partially opposed to each other in the first direction, the direction of the load side terminal part 502 first phase terminal part 502a and the direction of the load electrical device 42 first phase terminal part of the load electrical device 42 first phase terminal part 420a of the load electrical device terminal part 420c 420 may cross, and the direction of the second phase terminal part 502b of the load side terminal part 502 and the direction of the load device primary phase terminal part 420b of the load electrical device 420, the direction of the third phase terminal part 502c of the load side terminal part 502 and the direction of the load device primary terminal part 420 of the load electrical device 42 may also cross.

In addition, in the second direction, in the band-like area A that extends in a first direction from the first phase terminal part 500a of the first side terminal part 500 and the first phase terminal part 501a of the second side terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side than terminal part 500, and second secondary terminal part 31 is arranged in the second direction on the other side of the first side than terminal part 501.

Therefore, changeover switch 5 of the present embodiment is disposed between the first circuit part 2 and the second circuit part 3 in the first direction. Specifically, as shown in FIG. 3, changeover switch 5 is disposed between the first circuit part 2 and the second circuit part 3 which are disposed at the same position in the second direction by being disposed in the band-shaped area A extending in the first direction.

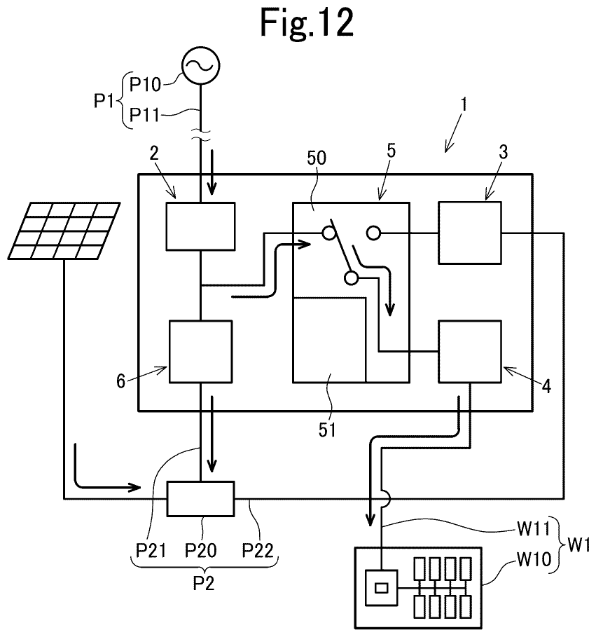

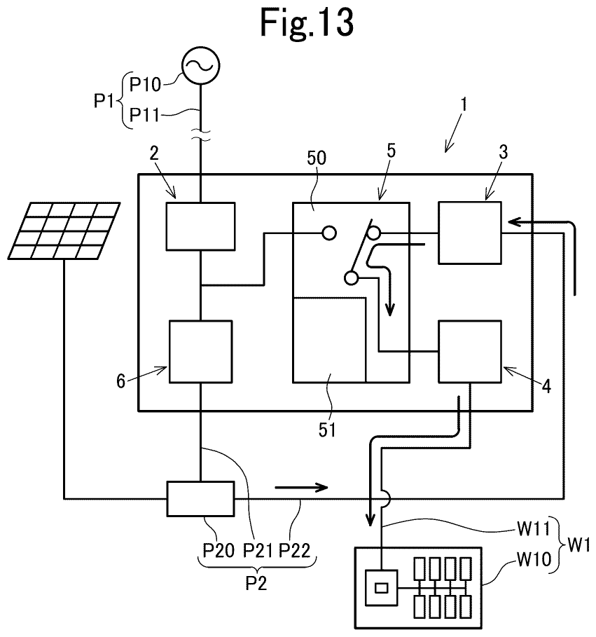

As shown in FIG. 12, the switching body 50 is switchable between a state in which the first side terminal part 500 and the load side terminal part 502 are electrically connected to each other and the second side terminal part 501 and the load side terminal part 502 are electrically disconnected from each other (first power supply state), and a state in which the first side terminal part 500 and the load side terminal part 502 are electrically disconnected from each other and the second side terminal part 501 and the load side terminal part 502 are electrically connected to each other (second power supply state) as shown in FIG. 13, and the switching control part 51 is configured to switch the first power supply state and the second power supply state by operating the switching body 50.

The switching control part 51 may be configured to automatically switch the first power supply state and the second power supply state of the switching body 50 according to the respective power supply states, but may be configured to manually switch between the first power supply state and the second power supply state, or may be configured to switch between the first power supply state and the second power supply state by remote control from the outside.

Further, for example, the switching control part 51 may be configured to switch the switching body part 50 from the first power supply state to the second power supply state when it is detected that the power supply from the first power supply system P1 is interrupted, and to switch the switching body part 50 from the second power supply state to the first power supply state when it is detected that the power supply from the first power supply system P1 is restored.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 321 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

In the relay electric device 62, the first phase terminal part 620a, the second phase terminal part 620b, and the third phase terminal part 620c are arranged in the first direction (so as to be aligned), and the first phase terminal part 621a, the second phase terminal part 621b, and the third phase terminal part 621c are also arranged in the first direction (so as to be aligned).

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 621 of the relay electrical device 62) in the second direction, and to be within the band-shaped area B extending in the first direction.

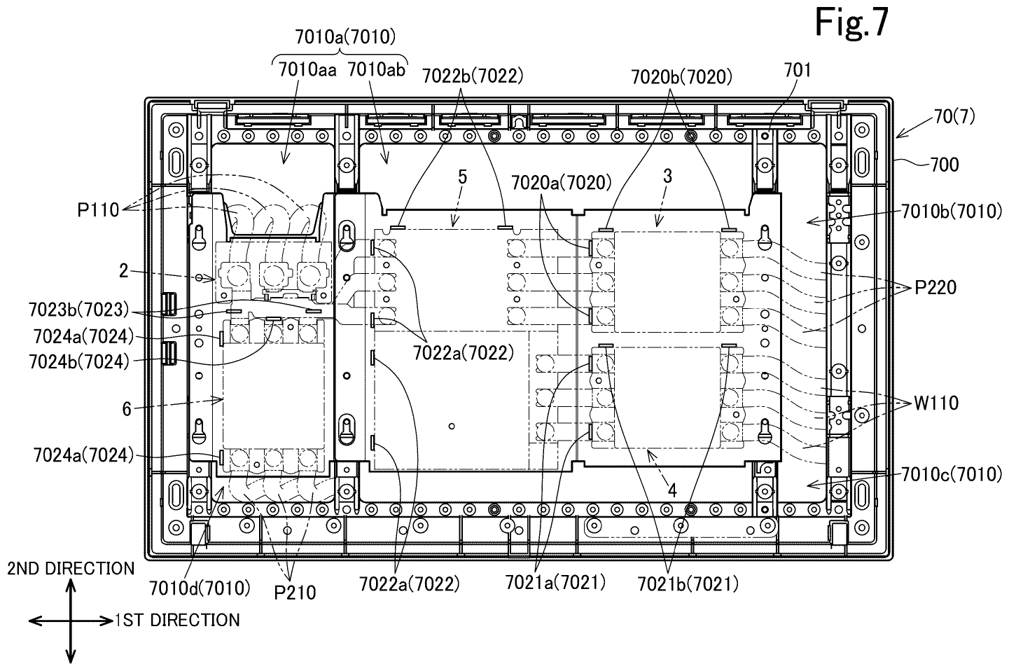

As shown in FIG. 7, the housing 7 includes a housing part 70 capable of housing the first circuit part 2, the second circuit part 3, the loading circuit part 4, changeover switch 5, and the relay circuit part 6 therein, and an inner lid part 71 (see FIG. 2) attached to the front surface of the housing part 70. Although not illustrated in FIG. 7, the housing 7 includes an outer lid part that covers the inner lid part 71 attached to the front surface of the housing part 70.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of the first electric device 22 in the second direction relative to first primary terminal part 20 or changeover switch 5 (in the present embodiment, on one side of the first electric device 22 in the second direction). Therefore, the first conductor insertion part 7010a allows the first conductor P110 to be inserted into and out of the housing 7 on one side of first primary terminal part 20 or changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric equipment 22, and the switching-side first conductor insertion part 7010ab is disposed directly above changeover switch 5 and the second electric device 32. In the present embodiment, as shown in FIG. 3, the first conductor P110 is inserted inside the housing 7 via the first-side first conductor insertion part 7010aa.

The second conductive insertion part 7010b is provided on the other side in the first direction than the device primary terminal part 320 of the second electric device 32. Therefore, the second conductor insertion part 7010b allows the second conductor P220 to be inserted into and out of the housing 7 on the other side in the first direction than the device primary terminal part 320 of the second electric device 32.

Further, the second conductor insertion part 7010b is disposed on the other side of the second electric device 32 in the first direction in the band-shaped area A. and the arrangement position in the second direction is the same position as the arrangement position in the second direction of the second conductor insertion part 7010b.

The load conductor insertion part 7010c is provided on the other side of the load device secondary terminal part 421 of the load electric device 42 in the first direction. Therefore, the load conductor insertion part 7010c allows the load conductor W110 to be inserted into and out of the housing 7 on the other side of the load device secondary terminal part 421 of the load electric device 42 in the first direction.

Further, the load-conductor insertion part 7010c and the second conductor insertion part 7010b are formed at positions aligned in the second direction, and are formed so as to be continuous with each other.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction.

The positioning structure 702 includes a second circuit part positioning part 7020 for positioning the second circuit part 3 with respect to the back surface part 701, a load circuit part positioning part 7021 for positioning the load circuit part 4 with respect to the back surface part 701, a changeover switch positioning part 7022 for positioning changeover switch 5 with respect to the back surface part 701, a first circuit part positioning part 7023 for positioning the first circuit part 2 with respect to the back surface part 701, and a relay circuit part positioning part 7024 for positioning the relay circuit part 6 with respect to the back surface part 701.

The second circuit part positioning part 7020 of the present embodiment is configured to position the second electrical device 32.

Further, the second circuit part positioning part 7020 is configured to abut on two intersecting side surfaces of the second electrical device 32. More specifically, the second circuit part positioning part 7020 has a first contact part 7020a that protrudes from the back surface part 701 toward the front side in the front-rear direction and abuts on the side surface of the second electric device 32 on the one side in the first direction, and a second contact part 7020b that protrudes from the back surface part 701 toward the front side in the front-rear direction and abuts on the side surface of the second electric device 32 on the one side in the second direction.

Load circuit part positioning part 7021 is configured to position the load electric device 42.

In addition, the load circuit part positioning part 7021 is configured to abut on two intersecting side surfaces of the load electric device 42. More specifically, the load circuit part positioning part 7021 includes a first contact part 7021a that protrudes from the back surface part 701 toward the front side in the front-rear direction and abuts on a side surface of the load electrical device 42 on one side in the first direction, and a second contact part 7021b that protrudes from the back surface part 701 toward the front side in the front-rear direction and abuts on a side surface of the load electrical device 42 on one side in the second direction.

The changeover switch positioning part 7022 is configured to abut two intersecting sides of changeover switch 5. More specifically, the changeover switch positioning part 7022 has a first contact part 7022a that protrudes from the back surface part 701 toward the front side in the front-rear direction and abuts on the side surface on one side in the first direction of changeover switch 5, and a second contact part 7022b that protrudes from the back surface part 701 toward the front side in the front-rear direction and abuts on the side surface on one side in the second direction of changeover switch 5.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The inner lid part 71 is attached to the housing part 70 and is configured to cover the front surfaces of the first circuit part 2, the second circuit part 3, the loading circuit part 4, changeover switch 5, and the relay circuit part 6. Further, in the middle cover part 71 of the present embodiment, the windows 710 are formed in accordance with the positions of the non-charging part of the second circuit part 3 (specifically, the operation part of the second electric device 32), the non-charging part of the load circuit part 4 (specifically, the operation part of the load electric device 42), and the non-charging part of the relay circuit part 6 (specifically, the operation part of the relay electric device 62).

The second electric device 32 and the load electric device 42 are arranged in a state in which the operation direction of the operation part is aligned with the first direction, and the relay electric device 62 is arranged in a state in which the operation direction of the operation part is aligned with the second direction. As described above, the second electric appliance 32 and the load electric appliance 42 arranged at the positions close to each other are arranged so that the operation direction of the operation part is the same, and the relay electric appliance 62 arranged at the position away from the second electric appliance 32 and the load electric appliance 42 is arranged so that the operation direction of the operation part is different from the operation direction of the operation part of the second electric appliance 32 and the load electric appliance 42.

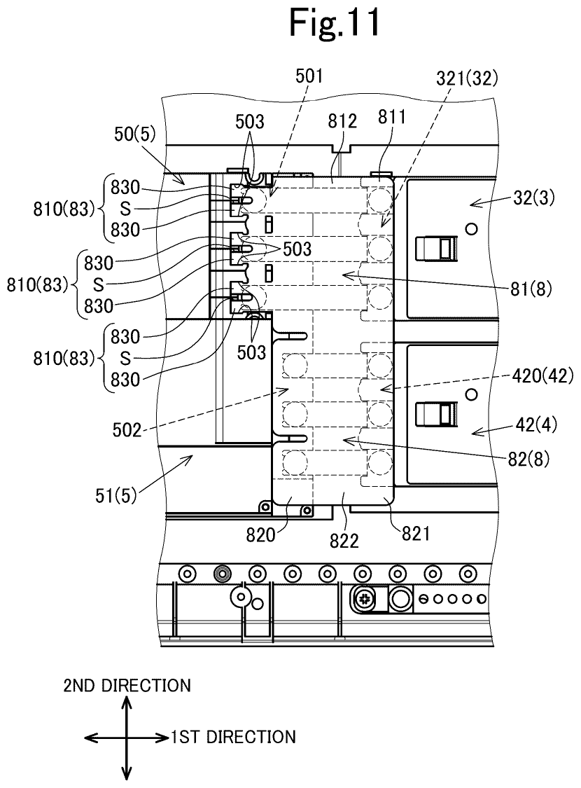

As shown in FIG. 8, the cover structure 8 includes a first cover part 80 that covers first conductive connection part 23, a second cover part 81 that covers the second conductive connection part 33, and a third cover part 82 that covers the loaded conductive connection part 43. Although the second cover part 81 and the third cover part 82 of the present embodiment are integrally formed, the second cover part 81 and the third cover part 82 may be separate members (see FIG. 11).

The first cover part 80 includes a first protection part 800 that covers the proximal end part of the first conductive part 231, and a second protection part 801 that covers the distal end part of the first conductive part 231 and the second conductive part 232.

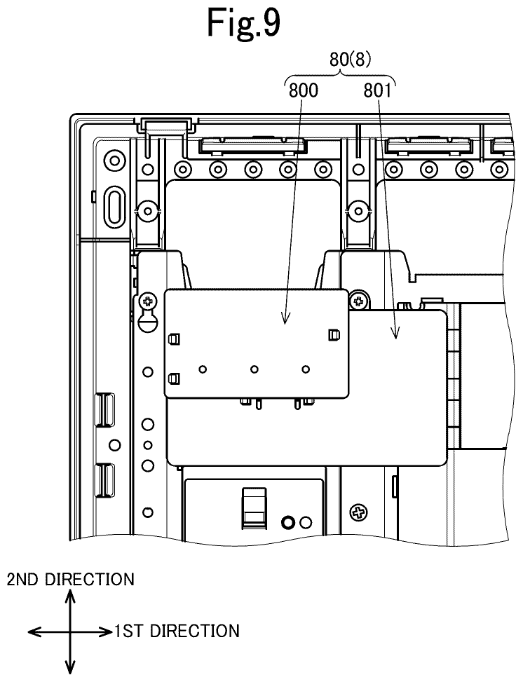

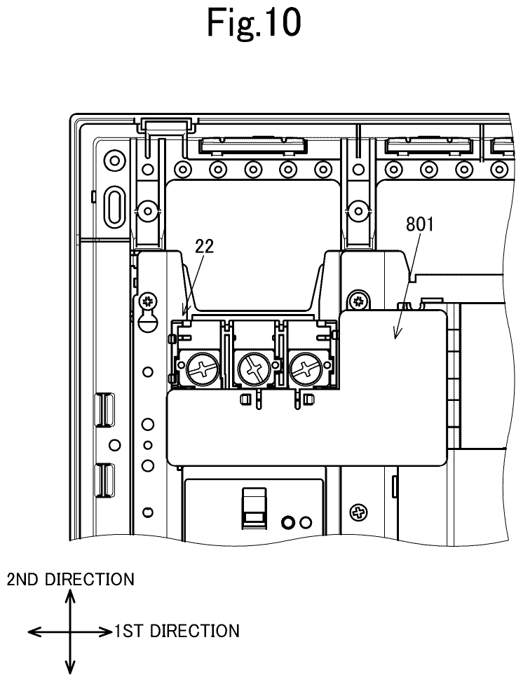

The first protection part 800 and the second protection part 801 are detachable from each other, and in a state in which the second protection part 801 covers the distal end side and the second conductive part 232 from the front side relative to the proximal end part of the first conductive part 231, the first protection part 800 is configured to be switchable between a closed state in which the proximal end part of the first conductive part 231 is covered from the front side and an open state in which the first protection part 800 opens the front of the proximal end part of the first conductive part 231 (see FIGS. 9 and 10).

Further, in a state in which both the first protection part 800 and the second protection part 801 are installed, the first protection part 800 is disposed on the front side in the front-rear direction relative to the second protection part 801, and the outer peripheral edge part of the first protection part and the outer peripheral edge part of the second protection part 801 are in a state of part overlapping with each other.

As shown in FIG. 11, the second cover part 81 includes a first protection part 810 that covers the front of the second side terminal part 501, a second side protection part 811 that covers the front of the device secondary terminal part 321 of the second electric device 32, and an intermediate protection part 812 that covers the front of the area between the second side terminal part 501 and the device secondary terminal part 321 of the second electric device 32.

The third cover part 82 has a first protection part 820 covering the front of the load side terminal part 502, a second side protection part 821 covering the front of the load device primary terminal part 420 of the load electrical device 42, and an intermediate protection part 822 covering the front of the area between the load side terminal part 502 and the load device primary terminal part 420 of the load electrical device 42.

The second cover part 81 and the third cover part 82 are configured to be externally attachable to changeover switch 5, and the cover structure 8 of the present embodiment has a cover-side engagement part 83 that secures the second cover part 81 and the third cover part 82 to the switching body part 50 while engaging with the switching body part 50 in order to securely attach and fix the second cover part 81 and the third cover part 82 to changeover switch 5 (to reliably prevent the second cover part and the third cover part from being detached from changeover switch 5).

In the cover structure 8 of the present embodiment, the second cover part 81 and the third cover part 82 are integrally formed, and the cover-side engagement part 83 is provided in the second cover part 81.

The cover-side engaging part 83 is configured to be erected at a position adjacent to terminal part of the second side terminal part 501 in the second direction and to be engaged between a pair of insulating walled parts 503 opposed to each other in the second direction.

The cover-side engaging part 83 of the present embodiment has a pair of flexible engaging parts 830 which are flexible and arranged in a direction in which the pair of insulating wall parts 503 are arranged (second direction in the present embodiment).

The cover-side engagement part 83 of the present embodiment is constituted by the first protection part 810 of the second cover part 81. In the second cover part 81, the first protection part 810 is formed so as to extend outward from the intermediate protection part 812, and the first protection part 810 is formed with a slit S extending from the distal end toward the proximal end side.

Therefore, in the second cover part 81, part on one side (one side in the second direction) of the first protection part 810 relative to the slit S constitutes one flexible engagement part 830, and part on the other side (the other side in the second direction) of the first protection part 810 relative to the slit S constitutes the other flexible engagement part 830. That is, the pair of flexible engagement parts 830 are arranged in the second direction via the slit S.

Note that, as described above, since the second-side terminal part 501 of changeover switch 5 includes the second-side terminal part 501 (first phase terminal part 501a) for the first phase, the second-side terminal part 501 (second phase terminal part 501b) for the second phase, and the second-side terminal part 501 (third phase terminal part 501c) for the third phase, the cover construction 8 is configured to have three cover-side engagement parts 83.

As described above, in the cover configuration 8, the cover-side engagement part 83 engages with the switching body part 50 (the pair of opposing insulating wall parts 503 for the second-side terminal part 501 in the present embodiment), so that the second cover part 81 and the third cover part 82 can be maintained attached to the switching body part 50.

In addition, if the slit S is formed between the pair of flexible engagement parts 830 as in the cover-side engagement part 83 of the present embodiment, the pair of flexible engagement parts 830 can easily be disposed between the insulating wall parts 503 that are allowed to move.

In the present embodiment, the cover-side engaging part 83 is formed only in the second cover part 81 of the second cover part 81 and the third cover part 82, the cover-side engaging part 83 may be formed in the second cover part 81 and the third cover part 82, and in the case where the second cover part 81 and the third cover part 82 are integrally formed, the cover-side engaging part 83 may be formed only in the third cover part 82.

As described above, according to changeover switch built-in board 1 of the present embodiment, the first changeover switch 5 and the relay circuit part 6, which are arranged in the first direction with respect to the first circuit part 2 (in the present embodiment, changeover switch 5), can connect the first conductive part 231 to the first side terminal part 500 along the first direction because the first conductive part 231 extending in the first direction has terminal part (the first side terminal part 500) facing end part 2310 in the first direction.

Of changeover switch 5 and the relay circuit part 6, those aligned in the second direction with respect to the first circuit part 2 (the relay circuit part 6 in the present embodiment) have the relay primary terminal part 60 facing end part 2320 of the second conductive part 232 extending in the second direction in the second direction, so that the second conductive part 232 can be connected to the relay primary terminal part 60 along the second direction.

As described above, since the first conductive part 231 and the second conductive part 232 can be connected along the first direction or the second direction in which changeover switch 5 or the relay circuit part 6 is aligned with the first circuit part 2, it is possible to reduce the size of changeover switch built-in board 1.

In first conductive connection part 23 of the present embodiment, since the first conductive part 231 is formed so that the proximal conductive part 2311a extends straight from the second conductive part 232 toward the connection target (the first side terminal part 500), the first conductive part 231 may not be oriented with respect to the direction in which the second conductive part 232 extends from the connection fixing part 230. Therefore, in the present embodiment, the space between the first electrical device 22 and the relay electrical device 62 is reduced.

In addition, in changeover switch built-in board 1 of the present embodiment, since first conductive connection part 23 is formed of a plate material having conductivity, first conductive connection part 23 can be formed in a configuration along the wire path, and the space required for changing the direction of first conductive connection part 23 can be reduced.

Further, in changeover switch built-in board 1 of the present embodiment, the base end part side (intermediate part 2321) of the second conductive part 232 is formed so as to be located on the front side in the front-rear direction of the connecting fixing part 230 and conductive part 232 in end part 2320, and the space on the rear side of the first conductive part 231 can be used as a space for, for example, a wire or the like because the first conductive part 231 branches from intermediate part 2321 of the second conductive part 232 toward the first direction.

Further, the plurality of first conductive connection part 23 can be prevented from spreading in the second direction because the proximal conductive part 2311a of the respective first conductive connection part 23 are arranged in a row in the front-rear direction.

In particular, the three proximal conductive part 2311a can be arranged closer to each other in the front-rear direction and the plurality of second conductive part 232 can be arranged closer to each other in the first direction because they are arranged side by side from the front side to the rear side in the front-rear direction in order from the one extending from the second conductive part 232 which is arranged at the one-most position in the first direction (the position farthest from changeover switch 5 in the first direction). As a result, it is possible to suppress the extension of the space in which the plurality of first conductive connection part 23 are arranged in the first direction.

Further, in changeover switch built-in board 1 of the present embodiment, since the identification display 2311c attached to the front surface of each of the front-end-side conductive part 2311b is configured to be exposed to the front side, the identification display 2311c attached to each of the plurality of first conductive connection part 23 becomes easy to see, and the type of each of first conductive connection part 23 becomes easy to distinguish.

The cover structure 8 of the board 1 with a changeover switch of this embodiment is provided with the first cover part 80 which has the first protection part 800 which covers the connection fixing part 230 from a front side, and the second protection part 801 which covers the first conductive part 231 and the second conductive part 232 from a front side, and the second protection part 801 covers the first conductive part 231 and the second conductive part 232 from a front side, Since the first protection part 800 is configured to be switchable between a closed state in which the first protection part 800 covers the connection fixing part 230 from the front side and an open state in which the front of the connection fixing part 230 of the 2 conductive part 232 is opened, only the first protection part 800 is opened to the terminal block Since only the front of the connection fixing part 230 to which the fixed first power supply system P1 is connected is opened, the operation of the connection fixing part 230 can be safely performed while the other part of the first conductive connection part 23 is covered with the second protective part 801.

Further, in changeover switch built-in board 1 of the present embodiment, the first side terminal part 500 can be electrically connected to the first circuit part 2 on one side in the first direction, the second side terminal part 501 can be electrically connected to the second circuit part 3 on the other side in the first direction, and the second side terminal part 501 and second secondary terminal part 31 are arranged so as to face each other in the first direction, so that the second side terminal part 500 and second secondary terminal part 31 can be electrically connected to each other by arranging the second conductive connection part 33 in a straight line in the first direction when the second side terminal part 501 and OOH 31 are electrically connected using the second conductive connection part 33.

Specifically, the first phase terminal part 501a, the second phase terminal part 501b, and the third phase terminal part 501c of the second side terminal part 501 are arranged linearly in the first direction so as to face the first phase terminal part 321a, the second phase terminal part 321b, and the third phase terminal part 321c of the device secondary terminal part 321, respectively, so that the second side terminal part 501 and second secondary terminal part 31 can be electrically connected with the first phase conductive connection part 33a, the second phase conductive connection part 33b, and the third phase conductive connection part 33c arranged in the second direction.

In addition, in changeover switch built-in board 1 of the present embodiment, the second conductor P220 is inserted from the outside to the inside of the housing 7 via the second conductor insertion part 7010b, and is connected to the device primary terminal part 220 in the first direction, and the device secondary terminal part and the second-side terminal part 220 can be connected via the second conductive connection part 33 which is linear in the first direction, so that the wiring operation is facilitated and the wiring path is also simplified.

Further, in the present embodiment, since the second conductor insertion part 7010b is provided on the other side in the first direction than the second electric device 32 in the band-shaped area A, the second conductor P220 is introduced into the housing 7 from the opposite side in the second conductor insertion part 7010b, and the second conductor P220 can be connected to the device primary terminal part 320 from the other side in the first direction. Therefore, in the present embodiment, without significantly changing the direction of the second conductor P220, since it is possible to perform the operation of connecting the second conductor P220 to the device primary terminal part 320 from the operation of introducing the second conductor P220 into the housing 7, the second conductor P220 can be connected easily and smoothly to the second electric device 32, thereby, it is possible to easily perform the wiring operation.

Further, first primary terminal part 20 is disposed toward one side in the second direction perpendicular to the first direction and the front-rear direction, the first electric device 22 or changeover switch 5 is a terminal block on one side in the second direction, since the first conductor insertion part 7010a is provided, the first conductor insertion part from 7010a of the first conductor insertion part without significantly changing the direction of the first conductor P110 to introduce the first conductor P110 to the inside of the housing 7, the first conductor P110 can be connected to first primary terminal part 20, the first conductor P110 can be easily and smoothly connected to the first electric device 22, thereby, it is possible to easily perform the wiring operation.

Further, in the present embodiment, first primary terminal part 20 is disposed toward one side in the second direction, the first-side first conductor insertion part 7010aa is disposed on one side (directly above) in the second direction of the terminal block as the first electric device 22, and the switching-side first conductor insertion part 7010ab is disposed on one side (directly above) in the second direction of changeover switch 5 and the second electric device 32. The first conductor P110 introduced into the inside of the housing 7 is connected to first primary terminal part 20 via the first-side first conductor insertion part 7010aa. Therefore, the first conductive P110 and first primary terminal part 20 can be easily connected in the second direction.

Therefore, since the second-side terminal part 501 and second secondary terminal part 31 are arranged so as to face each other in one direction, the interconnection path can be simplified when changeover switch 5 and the second circuit part 3 are electrically connected to each other.

In addition, since the second-side terminal part 501 and the load-side terminal part 502 are arranged so as to be aligned in the first direction while facing the other side in the first direction in the second direction, the second-side terminal part 501 and the load-side terminal part 502 can be separated in the second direction, so that the second-side terminal part 501 and the load-side terminal part 502 can be electrically connected to each other (that is, an insulating distance can be secured). Further, in the first direction, the second side terminal part 501 and second secondary terminal part 31 can be electrically connected, the load side terminal part 502 and the load primary terminal part 40 can be electrically connected, and the second side terminal part 501 and second secondary terminal part 31 can be arranged so as to face each other in the first direction, and the electrical connection between the second side terminal part 501 and second secondary terminal part 31 and the electrical connection between the load side terminal part 502 and the load primary terminal part 40 can be separated from each other because the load side terminal part 502 and the load primary terminal part 40 are arranged so as to face each other in the first direction.

In the present embodiment, the second side terminal part 501 is disposed on one side in the second direction, and the load-side terminal part 502 is disposed on the other side in the second direction. In the second direction, the second electric device 32 and the load electric device 42 are separated from each other in a state in which the second electric device 32 is disposed on one side and the load electric device 42 is disposed on the other side. Thus, the connection between the second side terminal part 501 and second secondary terminal part 31 via the second conductive connection part 33 and the connection between the load side terminal part 502 and the load primary terminal part 40 via the load conductive connection part 43 can be separated in the second direction. Therefore, it is possible to contribute to securing the insulation distance in the second direction.

Since the terminal part of each phase of the second side terminal part 501 and the terminal part of each phase of the load side terminal part 502 can be separated in the second direction, and the terminal part of each phase of the device secondary terminal part 321 and the terminal part of each phase of the load device primary terminal part 420 can be separated in the second direction, interphase short circuit between the terminal portions can be suppressed, and the second side terminal part 501 and the device secondary terminal part 321 have first phase terminal part 501a, 321a facing each other in a first direction, second phase terminal part 501b, 321b facing each other in a first direction, and third phase terminal part 501c, 321c facing each other in a first direction, and the load side terminal part 502 and the load device primary terminal part 420 have first phase terminal part 502a, 420a facing each other in first direction, second phase terminal part 502b, 420b facing each other in a first direction and third phase terminal part 502c, 420c facing each other in a first direction, so that the electric connectivity can be simplified and interphase short circuit can be suppressed.

In the present embodiment, the second side terminal part 501 is disposed on one side and the load-side terminal part 502 is disposed on the other side in the second direction. As shown in FIG. 3, the first phase terminal part 501a, the second phase terminal part 501b, and the third phase terminal part 501c of the second-side terminal part 501 are arranged in the second direction, and the first phase terminal part 502a, the second phase terminal part 502b, and the third phase terminal part 502c of the load-side terminal part 502 are arranged in the second direction. Further, as shown in FIG. 3, in a second orientation, the equipment secondary terminal part 321 is located on one side and the loading equipment primary terminal part 420 is located on the other side. Then, as shown in FIG. 3, the first phase terminal part 321a, the second phase terminal part 321b, and the third phase terminal part 321c of the device secondary terminal part 321 are arranged in the second direction, and the first phase terminal part 420a, the second phase terminal part 420b, and the third phase terminal part 420c of the loading device primary terminal part 420 are arranged in the second direction. In addition, the second-side terminal part 501 and the secondary terminal part, each other of the first phase terminal part 501a, 220a facing each other in the first direction, each other of the second phase terminal part 501b, 220b facing each other in the first direction, each other of the third phase terminal part 501c, 220c facing each other in the first direction, the load-side terminal part 502 and the load device primary terminal part 420, each other of the first phase terminal part 502a, 420a facing each other in the first direction, each other of the second phase terminal part 502b, 420b facing each other in the first direction, each other of the third phase terminal part 502c, 420c facing each other in the first direction. Therefore, between the second-side terminal part 501 and the device secondary terminal part 321, and between the load-side terminal part 502 and the load-device primary terminal part 420, the first phase terminal part 502a, 321a, the second phase terminal part 502b, 321b, and the third phase terminal part 502c, 321c are arranged in this order from one side to the other side in the second direction. Therefore, the arrangement of terminal part of each phase in the second direction is easy to understand.

The second-side terminal part 501 and the load-side terminal part 502 are arranged side by side in the second direction so as to face the other side in the first direction, and the second-side terminal part 501 and the first-side terminal part 500 are arranged side by side in the first direction toward the other side in the first direction, so that the first circuit part 2 and the second circuit part 3 are arranged on the one side in the first direction and the other side in changeover switch 5 in the housing 7, respectively, so that the first-side terminal part 500 and the second-side terminal part 501 can be wired in the first direction, so that the space-efficiency and the wiring-efficiency in the housing 7 can be improved while securing the insulating distance between terminal part.

In the present embodiment, the first side terminal part 500 and the second side terminal part 501 are disposed on one side in the second direction, and the load-side terminal part 502 is disposed on the other side in the second direction. Therefore, electricity is supplied to changeover switch 5 on one side in the second direction, and electricity is supplied from changeover switch 5 on the other side in the second direction.

Therefore, the second side terminal part 501 and the load side terminal part 502 can be separated from each other in the second direction, and the electrical connection between the second side terminal part 501 and second secondary terminal part 31 and the electrical connection between the load side terminal part 502 and the load primary terminal part 40 can be separated from each other.

Since first secondary terminal part and second secondary terminal part 31 in the strip area A including the first side terminal part 500 and the second side terminal part 501 are arranged on one side and the other side of the first direction, the first side of changeover switch 5 connected by first conductive connection part 23 to each other terminal part 500 and first secondary terminal part of the first circuit part 2 in the vicinity it is possible to place second secondary terminal part 31 of the second side 501 and the second circuit part 3 of changeover switch 5 in the vicinity, it is possible to simplify the first circuit part 2 and changeover switch 5 and the second circuit part 3 interconnection path.

In this embodiment, the first phase, terminal part 220a, second phase, terminal part 220b, and third phase terminal part 220c of the device primary terminal part 220 as a first secondary terminal part can be placed in the cingulate area A. In addition, the first phase, terminal part 321a, second phase terminal part 321b, and third phase terminal part 321c of the device secondary terminal part 321 as a second secondary terminal part 31 can be placed in the cingulate area A. Therefore, when the first circuit part 2, changeover switch 5, and the second circuit part 3 are electrically connected to each other, the interconnection path can be simplified because terminal part required for the electrical connection between the first circuit part 2, changeover switch 5, and the second circuit part 3 can be arranged in the belt-like area A.

Therefore, the first side terminal part 500 of changeover switch 5 connected by first conductive connection part 23 and first secondary terminal part of the first circuit part 2 can be arranged in the vicinity, the second side terminal part 501 of changeover switch 5 and second secondary terminal part 31 of the second circuit part 3 since it is possible to place in the vicinity, it is possible to simplify the first circuit part 2 and changeover switch 5 and the second circuit part 3 routing path.

Note that changeover switch built-in board 1 of the present disclosure is not limited to the above-described embodiment, and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply.

For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the device primary terminal part 420 and the device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the device primary terminal part 220 of the first electric device 22 is configured to have the first phase terminal part 220a, the second phase terminal part 220b, and the third phase terminal part 220c, but is not limited to this configuration. For example, in the case of having only the first phase terminal part 220a, in addition to the case of having the first phase terminal part 220a and the second phase terminal part 220b, in the case of having the first phase terminal part 220a, the second phase terminal part 220b, and the third phase terminal part 220c, it may also be a case of having the fourth phase terminal part. That is, the device primary terminal part 220 may include at least a first phase terminal part 220a.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

Also in this case, the second conductive part 232 may be integrally formed with the first conductive part 231 as in the above-described embodiment, or may be separately attached to the first conductive part 231.

In the above embodiment, the first circuit part 2 is configured to have three first conductive connection part 23, but is not limited to this configuration, for example, the first circuit part 2 may be configured to have one first conductive connection part 23, or may be configured to have two or four or more first conductive connection part 23. That is, the first circuit part 2 may be configured to have at least one first conductive connection part 23.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2.

As a result, the load circuit part 4 can be electrically disconnected from the first power supply system P1 and the second power supply system P2, and can further improve electric safety such as when inspecting load devices connected to the load circuit part 4.

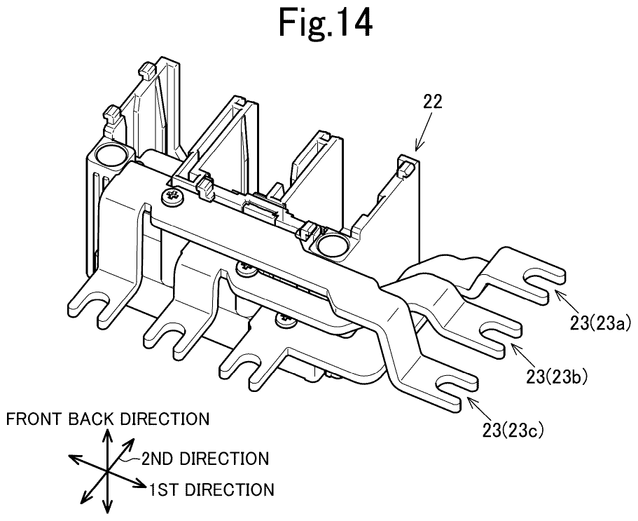

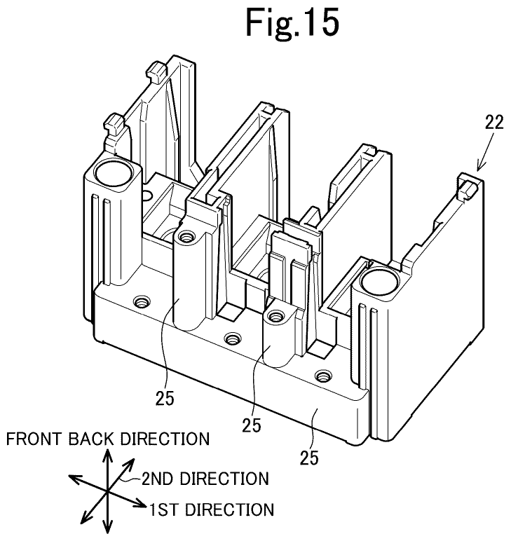

Although not specifically mentioned in the above embodiment, first conductive connection part 23 may be configured so that the second conductive part 232 is also screwed to the first electric device 22. In this case, for example, as shown in FIGS. 14 and 15, the first electrical device 22 may be provided with a fixing base part 25 having a screw hole formed therein.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 extends to the other side in the second direction with respect to the connecting fixing part 230, but is not limited to this configuration. The second conductive part 232 may extend, for example, to one side in the second orientation relative to the connecting fixing part 230. Again, the first conductive part 231 may be configured to extend to the other side of the first direction relative to the connection fixing part 230, and the first conductive part 231 may be configured to extend to the one side of the first direction relative to the connection fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

Further, in the above embodiment, the first side terminal part 500 and the second side terminal part 501 are arranged in a straight line in the first direction and the arrangement positions in the second direction are the same position, but the present invention is not limited thereto, and for example, the arrangement positions of the first side terminal part 500 and the second side terminal part 501 in the second direction may be different from each other.

In the above embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the above embodiment, the second side terminal part 501 and the load side terminal part 502 are arranged in the second direction, and the second side terminal part 501 is arranged on one side in the second direction, and the load side terminal part 502 is arranged on the other side in the second direction, but the present invention is not limited thereto, and for example, the second side terminal part 501 may be arranged on the other side in the second direction and the load side terminal part 502 may be arranged on one side in the second direction. In this case, it is conceivable that the second circuit part 3 is arranged on the other side in the second direction and the loading circuit part 4 is arranged on the one side in the second direction.

In addition, in this case, in the second direction, the load side terminal part 502 may be disposed at the same position as the first side terminal part 500 or the second side terminal part 501, or the load side terminal part 502 may be disposed before and after the first side terminal part 500 or the second side terminal part 501.

In the description of the strip-shaped area A of the above embodiment, the arrangement position of the first side terminal part 500 and the arrangement position of the second side terminal part 501 in the second direction has been given an example of the same, for example, the arrangement position of the first side terminal part 500 in the second direction and the arrangement position of the second side terminal part 501 are different from each other even in the second direction, the first phase terminal part 500a and the second side terminal part 501 of the first side terminal part 500 in the second direction it may be a strip-shaped area A area extending in a range including up to the third phase terminal part 501c of the third phase terminal part 500c and the second side terminal part 500 of the first side terminal part 501a.

In the above embodiment, changeover switch built-in board 1 includes the load circuit part 4, but the present invention is not limited thereto, and for example, changeover switch built-in board 1 may not include the load circuit part 4. A load conductor W110 may be connected to the load-side terminal part 502 of changeover switch 5.

In the load electric device 42 of the above embodiment, the load device primary terminal part 420 is provided at one end of the first direction, and the load device secondary terminal part 421 is provided at the other end of the first direction. However, the present invention is not limited thereto, and for example, in the load electric device 42, the load device primary terminal part 420 may be provided at the other end part in the first direction, and the load device secondary terminal part 421 may be provided at the one end part in the first direction.

In the load electric device 42 of the above embodiment, the load device primary terminal part 420 is oriented in one side of the first direction, and the load device secondary terminal part 421 is oriented in the other side of the first direction, that is, the load electric device 42 is arranged in a lateral direction along the first direction. However, for example, the load appliance 42 may be vertically oriented such that the load appliance primary terminal part 420 and the load appliance secondary terminal part 421 are aligned in the second direction, i.e., along the second direction. In this case, one of the load device primary terminal part 420 and the load device secondary terminal part 421 may be disposed on one side in the second direction and the other may be disposed on the other side in the second direction.

In the above embodiment, changeover switch 5 includes the second-side terminal part 501 and the load-side terminal part 502 at the other end in the first direction. However, the present invention is not limited thereto, and for example, changeover switch 5 may include the second-side terminal part 501 and the load-side terminal part 502 at one end in the second direction.

In addition, changeover switch 5 may include a first side terminal part 500 and a load-side terminal part 502 at one end in the first direction. Here, the first side terminal part 500 and the load side terminal part 502 may be arranged so as to be oriented in the same direction in the first direction and aligned in the second direction. In addition, the loading circuit part 4 may be disposed on one side of changeover switch 5 in the first direction.

In the above-described embodiment, the second conductive insertion part 7010b is disposed on the other side of second primary terminal part 30 in the first direction. However, the present invention is not limited thereto, and for example, the second conductive insertion part 7010b may be disposed on one side of second primary terminal part 30 in the first direction.

In the above embodiment, the arrangement positions of the device primary terminal part 320 and the device secondary terminal part 321 of the second electric device 32 in the second orientation are the same. However, the present invention is not limited thereto, and for example, the arrangement positions of the device primary terminal part 320 and the device secondary terminal part 321 of the second electric device 32 in the second direction may differ from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, the first conductive insertion part 7010a is provided on one side of first primary terminal part 20 or changeover switch 5 in the second direction. However, the present invention is not limited thereto, and for example, the first conductive insertion part 7010a may be disposed on one side of first primary terminal part 20 in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

The first conductor-insertion part 7010a may be provided in the second direction just above one side of first primary terminal part 20 or just above one side of changeover switch 5.

In the above-described embodiment, as shown in FIG. 3, the positions of the second-side terminal part 501 and the load-side terminal part 502 in the first direction differ from each other. However, for example, the second-side terminal part 501 and the load-side terminal part 502 may be arranged such that their positions in the first direction are the same (that is, they are arranged along an imaginary straight line extending in the second direction).

In the second circuit part 3 of the above-described embodiment, second primary terminal part 30 is disposed on the other side in the first direction, but the present invention is not limited thereto, and for example, second primary terminal part 30 may be disposed on the one side in the second direction. Second primary terminal part 30 may be configured to be connectable in a direction in which the second conductor P220 extends from second primary terminal part 30 to one side in the second direction.

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the above embodiment, the arrangement positions of the device primary terminal part 320 and the device secondary terminal part 321 are the same in the second orientation. However, the present invention is not limited thereto, and for example, the device primary terminal part 320 and the device secondary terminal part 321 of the second electric device 32 may be arranged at different positions in the second direction.

In the above embodiment, the load circuit part 4 includes the load electric device 42 as a circuit breaker, but the present invention is not limited thereto, and the load circuit part 4 may be configured to include the power distribution circuit part. Specifically, the load circuit part 4 may be configured to include a main switch connected to the load side terminal part 502 of changeover switch 5, and a plurality of branch switches connected to the secondary side of the main switch via a bus. The housing 7 is sized to accommodate the power distribution circuit part as well.

Next, a changeover switch built-in board according to another embodiment will be described. Changeover switch built-in board according to the present disclosure incorporates a changeover switch.

As a distribution board which is a conventional changeover switch built-in board, for example, there is a distribution board described in Japanese Patent No. 6351333. The distribution board includes a commercial power supply circuit part and a distributed power supply circuit part. The commercial power supply circuit part comprises a main switch and a number of branch switches plugged into its secondary bus bar. In the distributed power supply circuit part, a switch for a distributed power supply and a changeover switch with a vibration-sensitive relay are arranged. Changeover switch with vibration-sensitive relays has two input-terminals and one output-terminal. The distributed power supply is connected to the primary side of the switch for the distributed power supply, and is further connected from the secondary side of the switch for the distributed power supply to one of the input terminals of changeover switch with vibration-sensitive relays. The other terminal of changeover switch with the vibration-sensitive relay is connected to one branch switch of the commercial power supply circuit part. Furthermore, an emergency circuit is connected as a load to the output terminal of changeover switch with vibration-sensitive relay, and is formed so that the supply from the commercial power supply or the distributed power supply can be switched by changeover switch with vibration-sensitive relay.

However, in the distribution board described in Japanese Patent No. 6351333, changeover switch with vibration-sensitive relay and the switchgear for the distributed power supply are arranged side by side in the left-right direction, and one input terminal of changeover switch with vibration-sensitive relay is arranged downward at the lower end part, whereas the secondary side of the switchgear for the distributed power supply is arranged upward at the upper end part. Therefore, in order to electrically connect one of the input terminals of changeover switch with the vibration-sensitive relay and the secondary side of the switch for the distributed power supply, the wiring needs to be circulated such that one end of the wiring faces upward and the other end faces downward. Therefore, the distribution board described in Japanese Patent No. 6351333 has a complicated wiring path. This is not limited to a distribution board including a main switch and a branch switch, but also an electric board including a changeover switch capable of switching the power supply.

Therefore, an object of the present disclosure is to provide a changeover switch built-in board capable of simplifying a wire path.

The present invention comprises: Changeover switch built-in board is characterized in that includes changeover switch for switching a power supply for supplying electricity to a load to a first power supply system or a second power supply system and a first circuit part electrically connecting the first power supply system and changeover switch and a second circuit part electrically connecting the second power supply system and changeover switch and a housing for housing changeover switch, the first circuit part, and the second circuit part, and the changeover switch includes a first side terminal part electrically connected to the first circuit part and a second side terminal part electrically connected to the second circuit part, and the second circuit part includes a second secondary terminal part electrically connected to the second side terminal part and the first side terminal part and the second side terminal part are arranged in one of a first direction and a second direction perpendicular to the front-rear direction of the casing and orthogonal to each other, the first side terminal part is arranged toward one side in the one direction, and the second side terminal part is arranged toward the other side in the one direction and the second side terminal part and second secondary terminal part are arranged so as to face each other in the one direction

According to the above configuration, since the first side terminal part and the second side terminal part are arranged in one direction of the first direction and the second direction, and the first side terminal part is arranged toward one side in the one direction, and the second side terminal part is arranged toward the other side in the one direction, for example, the first side terminal part can be electrically connected to the first circuit part on one side of the first direction as the one direction, and the second side terminal part can be electrically connected to the second circuit part on the other side of the first direction, and since the second side terminal part and the second side terminal part are arranged so as to face each other in the one direction, for example, when the second side terminal part and the second terminal part are electrically connected using the conductive connection part the second terminal part and the second terminal part can be electrically connected by arranging the conductive connection part linearly in the first direction.

The second circuit part may include a second electric device having a device secondary terminal part provided at one side end part in the one direction and a device primary terminal part provided at the other side end part in the one direction, wherein the device primary terminal part is electrically connected to the second power supply system, and the device secondary terminal part is electrically connected to the second side terminal part as second secondary terminal part, and the housing may be provided with a second conductor insertion part through which a second power supply included in the second power supply system and a second conductor for electrically connecting the device primary terminal part are inserted from the outside to the inside of the housing on the other side in the one direction than the device primary terminal part.

According to the above configuration, the second conductor is inserted from the outer side to the inner side of the housing through the second conductor insertion part, and is connected to the device primary terminal part in the one direction, and the device secondary terminal part and the second-side terminal part can be connected to each other through the conductive connection part which is linear in the one direction.

The first circuit part may include a terminal block including a first primary terminal part electrically connected to the first power supply system, and first primary terminal part may be disposed toward one side of the other direction perpendicular to the front-rear direction and the one direction, and may be configured such that a first power supply included in the first power supply system and a first conductor connecting the first terminal part are connectable to first primary terminal part in a direction extending from the first terminal part to one side of the other direction, and a first conductor insertion part for inserting the first conductor from the outside to the inside of the housing may be provided on one side of the terminal block or the other direction of changeover switch.

According to the above configuration, first primary terminal part is disposed toward one side of the other direction perpendicular to the one direction and the front-rear direction, and the first conductor insertion part is provided on one side of the terminal block or changeover switch in the other direction, so that it is possible to easily perform an operation of introducing the first conductor from the first conductor insertion part to the inside of the housing and connecting the first conductor to first primary terminal part.

As described above, according to the present disclosure, since the secondary-side terminal part and second secondary terminal part are arranged so as to face each other in the one direction, the interconnection path can be simplified when changeover switch and the second circuit part are electrically connected.

Hereinafter, a changeover switch built-in board according to an embodiment of the present disclosure will be described referring to the accompanying drawings. Note that the reference numerals used in the description of the present embodiment and the reference numerals used in the description of the above-described embodiment are not related to each other.

Changeover switch built-in board is installed between a plurality of power supply systems and a load, and is configured to switch between a plurality of power supply systems and a load.

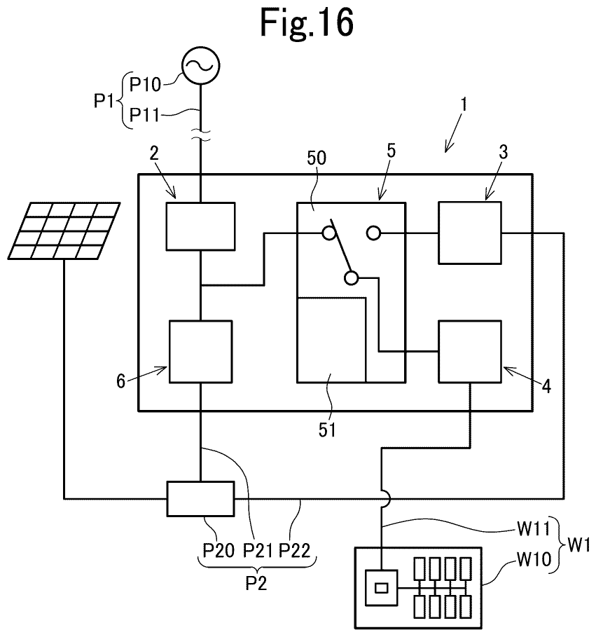

For example, as shown in FIG. 16, when changeover switch built-in board is installed in a house, a first power supply system P1 through which commercial power flows, a second power supply system P2 including a distributed power supply, and a load system W10 including a load W1 are electrically connected to changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

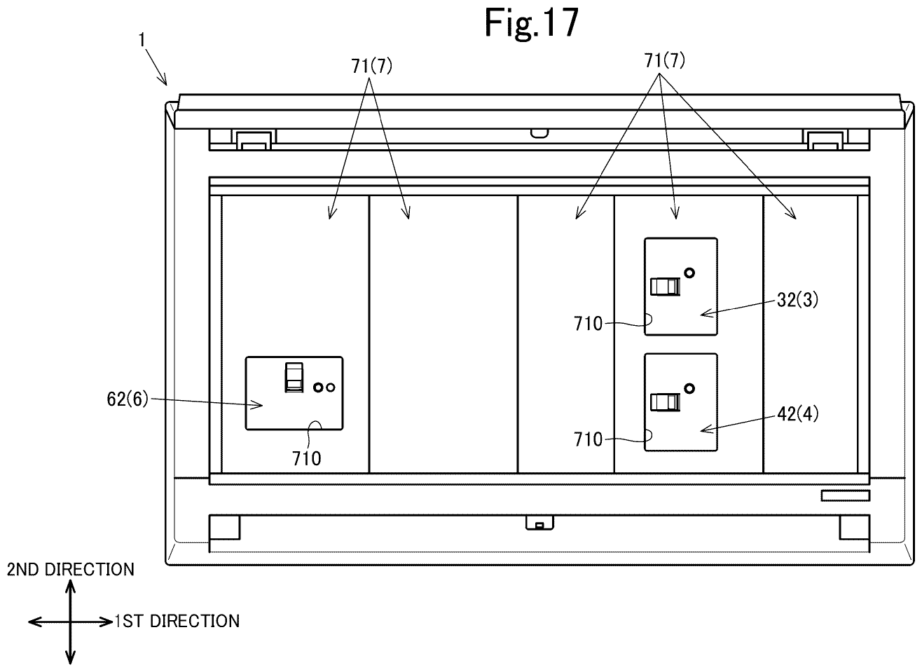

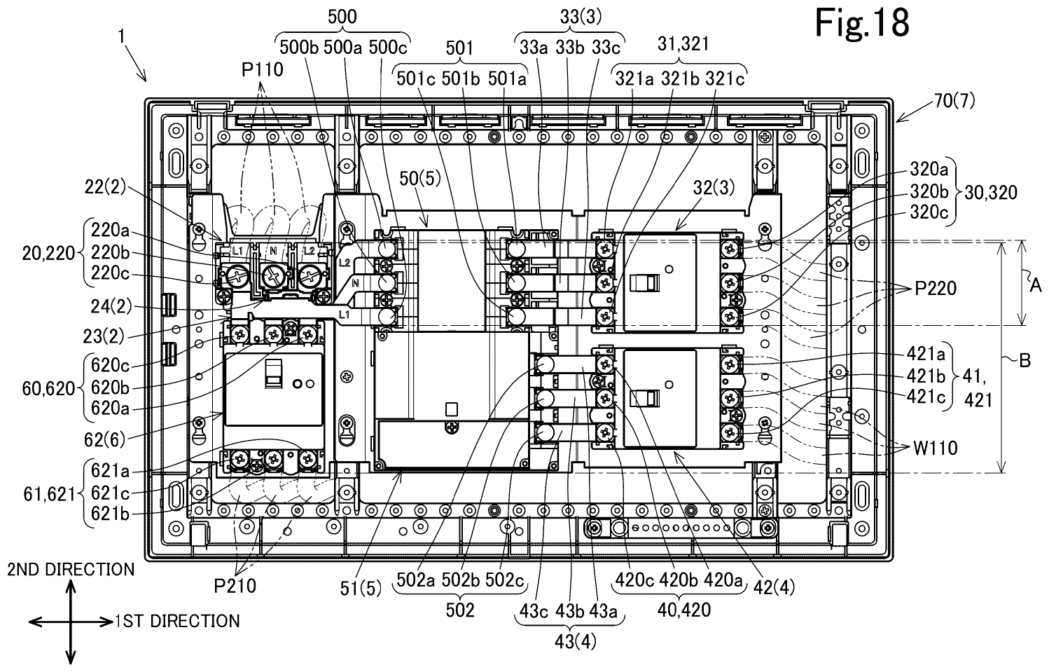

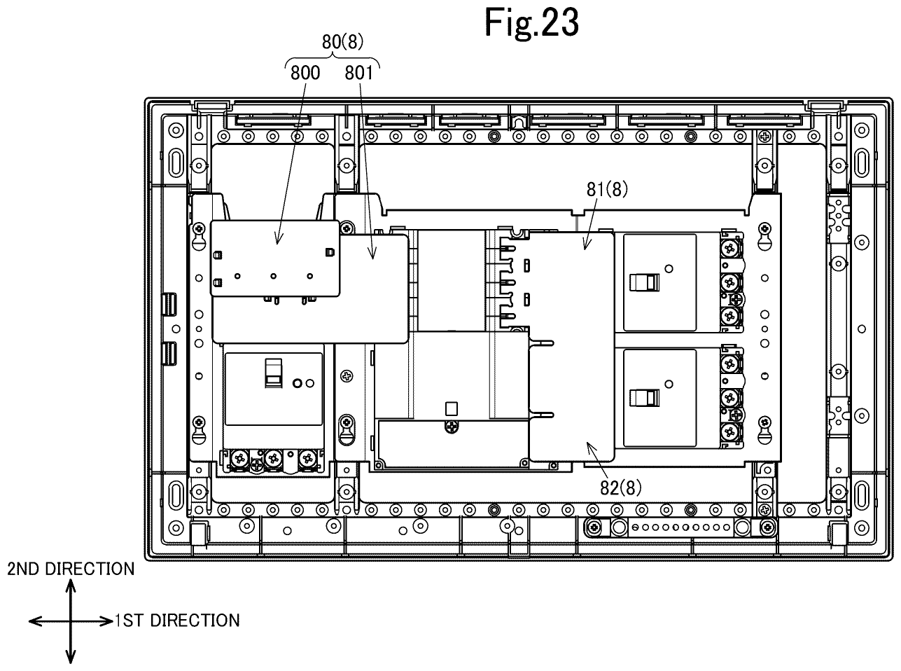

As shown in FIG. 18, changeover switch built-in board 1 is electrically connected to the first power supply system P1, the first circuit part 2 electrically connected to the second power supply system P2, the load circuit part 3 to which the load system W1 is connected, and changeover switch 5 for switching the power supply which supplies electricity to the load system W1 to the first power supply system P1 or the second power supply system P2A housing 7 (see FIG. 17) for housing the relay circuit part 6 to be connected, the first circuit part 2, the second circuit part 3, the relay circuit part 6, changeover switch 5, and the load P2 4, and a cover-structure 8 (see FIG. 23) for covering the charging part in the housing 7 are provided.

In the present embodiment, a direction in which the front surface and the back surface of changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction of a surface formed by the first direction and the second direction is referred to as a board surface direction.

In the present embodiment, the first direction is a direction corresponding to the left-right direction in a state where changeover switch built-in board 1 in the installed state is viewed from the front, and the one side in the first direction is a left side and the other side in the first direction is a right side.

In addition, the second direction is a direction corresponding to the up-down direction in a state where changeover switch built-in board 1 in the installed state is viewed from the front, the one side in the second direction is the upper side, and the other side in the second direction is the lower side.

The first circuit part 2 is electrically connected to the first power supply system P1 and changeover switch 5. The first circuit part 2 is disposed on one side of changeover switch 5 in the first direction.

The first circuit part 2 of the present embodiment has a first power supply system P1 electrically connected to a first primary terminal part 20, and a changeover switch 5 (a first-side terminal part 500 to be described later) and a relay circuit part 6 electrically connected to a first secondary terminal part (not numbered). In the first circuit part 2 of the present embodiment, first primary terminal part 20 also serves as a first secondary terminal part.

In the first circuit part 2, first primary terminal part 20 is disposed toward one side in the second direction, and is connectable to first primary terminal part 20 in a direction extending from first primary terminal part 20 to one side in the second direction with the first power supply P10 (in the present embodiment, the first power distribution path P11) and the first conductive P110 connected to first primary terminal part 20.

The first circuit part 2 includes a first electric device 22, a first conductive connection part 23 fixed to the first electric device 22 so as to be electrically connected to the first conductive P110, and a partition member 24 for preventing a short circuit of first conductive connection part 23.

The first electrical device 22 is a terminal block. Further, the first electric device 22 is a terminal block including a first primary terminal part 20 electrically connected to the first power supply system P1, and a first power distribution path P11 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 includes a device primary terminal part 220 capable of fixing the first conductive P110, and a device secondary terminal part (not numbered) capable of fixing first conductive connection part 23. In the first electric device 22, the device primary terminal part 220 also serves as a device secondary terminal part.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and first conductive connection part 23 are fixed to the device primary terminal part 220, the first conductor P110 and first conductive connection part 23 are electrically connected to each other. The device primary terminal part 220 of the present embodiment is configured such that the first conductive P110 and first conductive connection part 23 can be fixed by screws.

In addition, the equipment primary terminal part 220 may be configured to conduct each other by directly contacting the first conductive P110 and first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

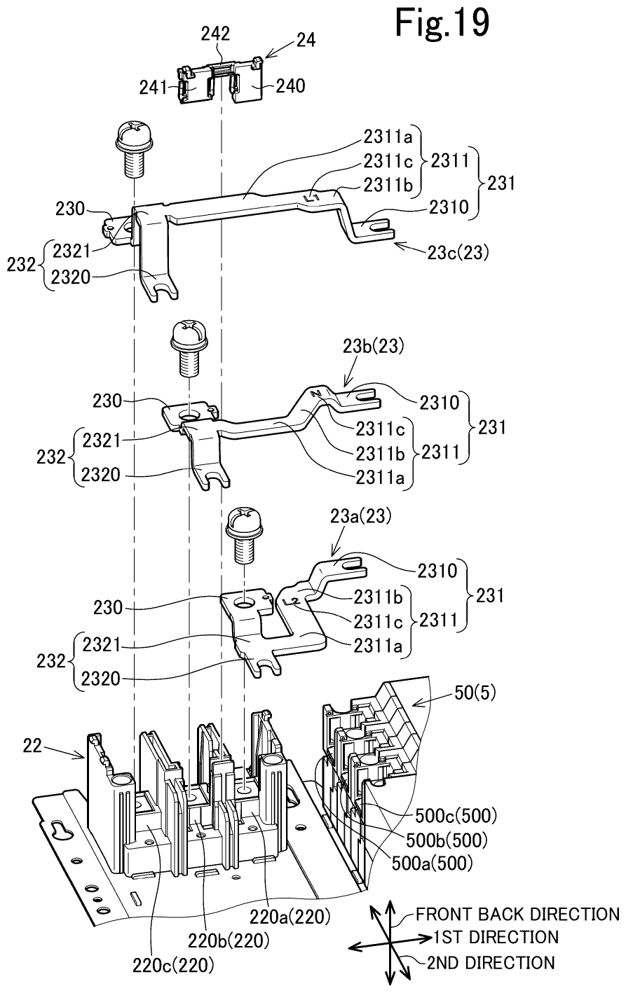

As shown in FIG. 19, first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the distal end side of the connection fixing part 230 is branched into the other side in the second direction and the other side in the first direction in first conductive connection part 23. First conductive connection part 23 of the present embodiment is made of a conductive plate material.

The first conductive part 231 includes a end part 2310 fixed to a first-side terminal part 500 of changeover switch 5, which will be described later, and a intermediate part 2311 that is contiguous with end part 2310 and the second conductive part 232 (a intermediate part 2321 of the second conductive part 232, which will be described later).

The first conductive part 231 intermediate part 2311 is a part interposed between the second conductive part 232 and end part 2310 of the first conductive part 231. Intermediate part 2311 of the first conductive part 231 of the present embodiment includes a proximal end side conductive part 2311a disposed between the first electric device 22 and the relay circuit part 6 (the other side in the second direction than the first electric device 22), a distal end side conductive part 2311b disposed between the first electric device 22 and changeover switch 5 (the other side in the first direction than the first electric device 22), and an identification 2311c attached to a front surface (one surface disposed toward the front side in the front-rear direction) of the distal end side conductive part 2311b. The identification 2311c may be formed by digging in intermediate part 2311 of the first conductive part 231 by direct marking, or may be formed by printing with a laser or the like.

The identification-display 2311c indicates the type of first conductive connection part 23. The identification-display 2311c of the present embodiment is constituted by characters of “L1” indicating L1 phase, “N” indicating the N phase, and “L2” indicating L2 phase.

The second conductive part 232 includes a end part 2320 fixed to a relay primary terminal part (relay device primary terminal part) of the relay circuit part 6, which will be described later, and a intermediate part 2321 connected to end part 2320 and the connecting fixing part 230.

Here, the first circuit part 2 has three first conductive connection part 23 corresponding to the numbers of the device primary terminal part 220. The three first conductive connection part 23, respectively, first conductive connection part 23 for the first phase (first phase conductive connection 23a), first conductive connection part 23 for the second phase (second phase conductive connection 23b), first conductive connection part 23 for the third phase (third phase conductive connection 23c).

The three first conductive connection part 23 are arranged such that the respective second conductive part 232 are aligned in the first direction in the front view.

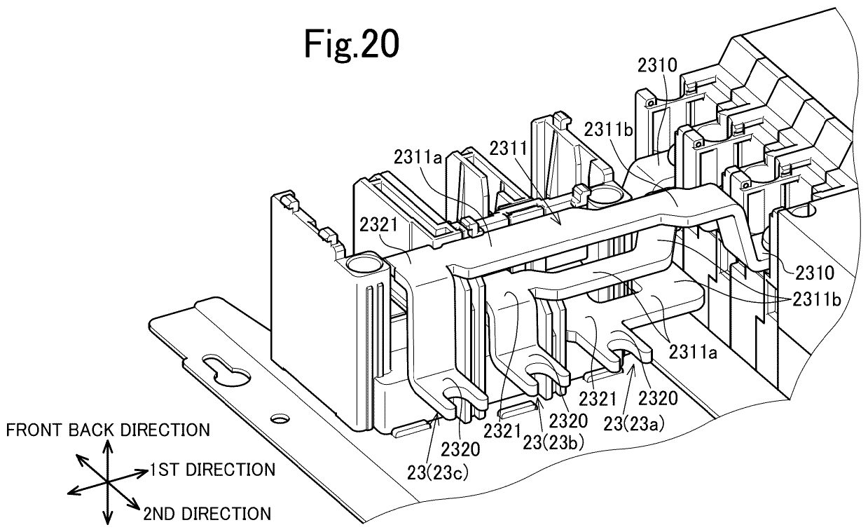

As shown in FIG. 20, intermediate part 2321 of each second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second 232 for the first phase, which is disposed on the most other side in the first direction, is disposed on the most rear side in the front-rear direction.

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the third phase conductive connection part 23c (conductive connection part 23 for the third phase (L1 phase)) is disposed on the most front side in the front-rear direction, and the distal end side conductive part 2311b included in the first phase conductive connection part 23c (conductive connection part 23 for the first phase (L1 phase)) is disposed on one side in the front-rear direction with respect to the distal end side conductive part 2311b included in the second phase conductive connection part 23b (conductive connection part 23 for the second phase (N-phase)) is disposed on one side in the front-rear direction and in the second direction with respect to the distal end side conductive part 2311b included in the third phase conductive connection part 23c, and the distal end side conductive part 2311b included in the first phase conductive connection part 23b and the third phase conductive connection part connection part is disposed on one side in the front-rear direction and in the second direction with respect to the distal end side conductive part 2311b included in the second phase conductive connection part connection part.

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the second phase conductive connection part 23b is also arranged so as to cross the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

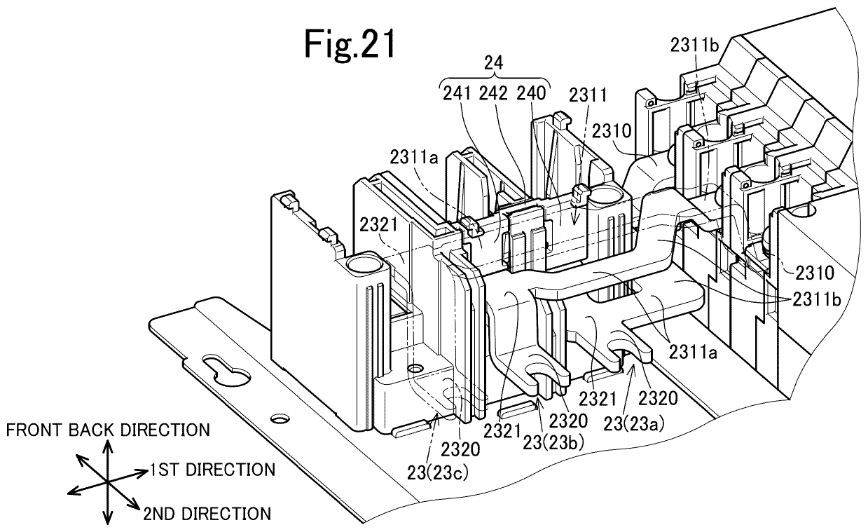

More specifically, as shown in FIG. 21, the partition member 24 has a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 18, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the first direction, and is connectable to second primary terminal part 30 in a direction extending from second primary terminal part 30 to the other side in the first direction with the second power supply P20 (the second power distribution path P22 in the present embodiment) and the second conductor P220 connected to second primary terminal part 30.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The equipment primary terminal part 320 and the equipment secondary terminal part 321 are arranged side by side in a first direction, and the arrangement position of the equipment primary terminal part 320 in the second direction and the arrangement position of the equipment secondary terminal part 321 in the second direction are the same. Further, in the present embodiment, the second electric device 32 is arranged such that the device primary terminal part 320 faces the other side of the first direction and the device secondary terminal part 321 faces the one side of the first direction.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductor P220 of the second distribution path P22 is fixed to the equipment primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductor P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the second direction, and the first phase terminal part 321a of the device secondary terminal part 321, the second phase terminal part 321b, and the third phase terminal part 321c are also arranged to align with each other in the second direction.

The second conductive connection part 33 is formed so as to extend along the first direction (i.e., formed in a straight line shape). One longitudinal end of the second conductive connection part 33 is fixed to the device secondary terminal part 321.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, since the first phase terminal part 321a, the second phase terminal part 321b, and the third phase terminal part 321c of the device secondary terminal part 321 are arranged so as to be aligned along the second direction, the three second conductive connection part 33 are also arranged along the second direction while being fixed to the first phase terminal part 321a, the second phase terminal part 321b, and the third phase terminal part 321c, respectively.

The second electric apparatus of the present embodiment is a circuit breaker. Therefore, in a state in which the second conductive terminal part 320 is fixed with the second conductor P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading equipment 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

The load device primary terminal part 420 and the load device secondary terminal part 421 are arranged side by side in the first direction, the load device primary terminal part 420 is provided at one end of the load device 42 in the first direction, and the load device secondary terminal part 421 is provided at the other end of the load device 42 in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical device 42 is arranged side by side in the second direction with respect to the second circuit part 3, and the load device primary terminal part 420 of the load electrical device 42 and the device secondary terminal part 321 of the second electrical device 32 are arranged in the second direction, and the load device secondary terminal part 421 of the load electrical device 42 and the device primary terminal part 320 of the second electrical device 32 are arranged in the second direction. In the present embodiment, the load electrical device 42 is disposed at a position spaced apart from the second electrical device 32 in the second direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged so as to be aligned in the second direction, and the first phase terminal part 421a, the second phase terminal part 421b, and the third phase terminal part 421c of the load device secondary terminal part 421 are also arranged so as to be aligned in the second direction.

The load conductive connection part 43 is formed so as to extend along the first direction (i.e., is straight), and one end part in the longitudinal direction is fixed to the load primary terminal part 40.

The load circuit part 4 has three load conductive connection part 43 corresponding to the numbers of the first phase terminal part 420a, the second phase terminal part 420b, and the third phase terminal part 420c. The three load conductive connection part 43 are also a load conductive connection part 43 for the first phase (first phase conductive connection 43a), a load conductive connection part 43 for the second phase (second phase conductive connection 43b), and a load conductive connection part 43 for the third phase (third phase conductive connection 43c), respectively.

As described above, since the first phase terminal part 420a, the second phase terminal part 420b, and the third phase terminal part 420c of the load device primary terminal part 420 are arranged to be aligned along the second direction, the three load conductive connection part 43 are arranged to be aligned along the second direction in a state where they are fixed to the first phase terminal part 420a, the second phase terminal part 420b, and the third phase terminal part 420c, respectively.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching body part 50 that switches between the first circuit part 2 and the second circuit part 3 and the load circuit part 4, and a switching control part 51 that operates the switching body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500, the second side terminal part 501, and the load-side terminal part 502 are provided at separate ends in the first direction of changeover switch 5. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction.

Further, the second side terminal part 501 and the load side terminal part 502 are arranged side by side in the second direction in the same direction in the first direction, the second side terminal part 501 and second secondary terminal part 31 face each other in the first direction, and the load side terminal part 502 and the load primary terminal part 40 face each other in the first direction.

In the present embodiment, the second side terminal part 501 is disposed on one side in the second direction, and the load-side terminal part 502 is disposed on the other side in the second direction. Furthermore, the arrangement position of the second side terminal part 501 of the present embodiment in the first direction and the arrangement position of the load-side terminal part 502 in the first direction are different from each other. More specifically, the second side terminal part 501 is arranged to be located on one side of the load-side terminal part 502 in the first direction.

The first phase terminal part 500, the first phase terminal part 500a, the second phase terminal part 500b, and the third phase terminal part 500c are arranged in order in the second direction, and the first phase terminal part 501a of the second side terminal part 501, the second phase terminal part 501b, and the third phase terminal part 501c are arranged in order in the second direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b. 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

In addition to the second-side terminal part 501, in each of the device secondary terminal part 321, the load-side terminal part 502, and the load-device primary terminal part 420 of the load electrical device 42 of the second electrical device 32, the first-phase terminal part 321a, 502a, 420a, the second-phase terminal part 321b, 502b, 420b, and the third-phase terminal part 321c, 502c, 420c are arranged so as to be aligned in the second direction.

Further, the second-side terminal part 501 and the device secondary terminal part 321 of the second electric device 32 are configured such that the first phase terminal part 501a, 321a of each other oppose each other in the first direction, the second phase terminal part 501b, 321b of each other oppose each other in the first direction, and the third phase terminal part 501c, 321c of each other oppose each other in the first direction.

Note that the second-side terminal part 501 and the device secondary terminal part 321 of the second electric device 32 may be opposed to each other in a positional relationship, or may be substantially opposed to each other without being perfectly opposed to each other.

For example, the first phase terminal part 501 first phase terminal part 501a of the second electrical equipment 32 and the first phase terminal part 321 of the second electrical equipment 32 terminal part 321a is arranged so that at least a part is opposed in the first direction, the second phase terminal part 501 second phase terminal part 501b of the second electrical equipment 32 second phase terminal part 321 terminal part 321b, the third phase terminal part 501c of the second side terminal part 501 and the second device of the second electrical equipment 32 the third phase terminal part 321c 321 also, at least a part is opposed in the first direction, the second side terminal part 501 and the device secondary terminal part 321 of the second electrical equipment 32 may be arranged.

Further, for example, if the first phase terminal part 501a of the second side terminal part 501 and the first phase terminal part 321 of the second electric device 32 are arranged so that at least a part of the first phase terminal part 321a of the second electric device 32 is opposed to each other in the first direction, the direction of the second side terminal part 501 of the first phase terminal part 501a of the second electric device 32 and the direction of the first phase terminal part of the second electric device 32 terminal part 321a of the second electric device 32 may intersect, and the direction of the second phase terminal part 501b of the second side terminal part 501 and the direction of the second phase terminal part 321b of the second electric device 32, the direction of the third phase terminal part 501c of the second side terminal part 501 and the direction of the third phase terminal part 321c of the device secondary terminal part 321 of the second electric device 32 may also intersect.

The load-side terminal part 502 and the load device primary terminal part 420 of the load electric device 42 are configured such that the first phase terminal part 502a, 420a of each other oppose each other in the first direction, the second phase terminal part 502b, 420b of each other oppose each other in the first direction, and the third phase terminal part 502c, 420c of each other oppose each other in the first direction.

Note that the load-side terminal part 502 and the load device primary terminal part 420 of the load electric device 42 may be opposed to each other in a positional relationship, or may be substantially opposed to each other without being perfectly opposed to each other.

For example, the first phase terminal part 502 terminal part 502a and the first phase terminal part 420 of the load electrical device 42 may be arranged so that at least some of the first phase terminal part 420a are facing in one direction, the second phase terminal part 502b of the load terminal part 502 and the second phase terminal part 420b of the load electrical device 42 primary phase terminal part 420, the third phase terminal part 502c of the load side terminal part 502 and the third phase terminal part 420c 420 of the load electrical device 42 may also be arranged so that at least some of the third phase 420b in one direction are facing each other, and the load side terminal part 502 and the load electrical device primary terminal part 420 of the load electrical device 42.

Further, for example, if the first phase terminal part 502 and terminal part 502a of the load electrical device 42 and the first phase terminal part 420 of the load electrical device terminal part 420a 420 are arranged so as to be at least partially opposed to each other in the first direction, the direction of the load side terminal part 502 first phase terminal part 502a and the direction of the load electrical device 42 first phase terminal part of the load electrical device 42 first phase terminal part 420a of the load electrical device terminal part 420c 420 may cross, and the direction of the second phase terminal part 502b of the load side terminal part 502 and the direction of the load device primary phase terminal part 420b of the load electrical device 420, the direction of the third phase terminal part 502c of the load side terminal part 502 and the direction of the load device primary terminal part 420 of the load electrical device 42 may also cross.

In addition, in the second direction, in the band-like area A that extends in a first direction from the first phase terminal part 500a of the first side terminal part 500 and the first phase terminal part 501a of the second side terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side than terminal part 500, and second secondary terminal part 31 is arranged in the second direction on the other side of the first side than terminal part 501.

Therefore, changeover switch 5 of the present embodiment is disposed between the first circuit part 2 and the second circuit part 3 in the first direction. Specifically, as shown in FIG. 18, changeover switch 5 is disposed between the first circuit part 2 and the second circuit part 3 which are disposed at the same position in the second direction by being disposed in the band-shaped area A extending in the first direction.

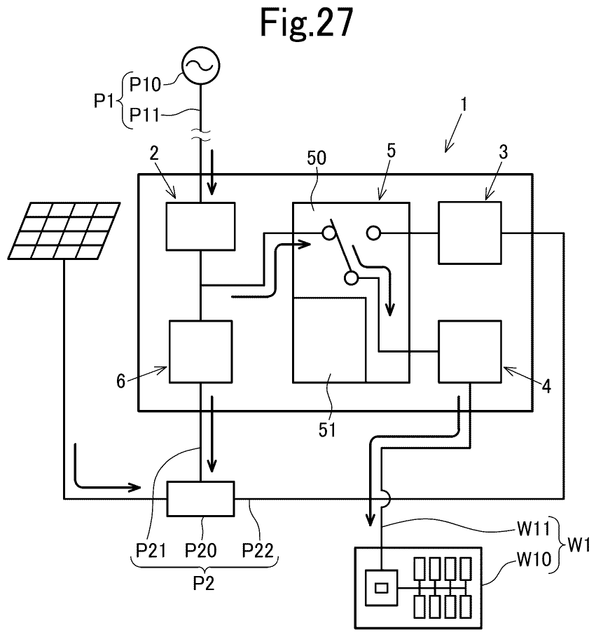

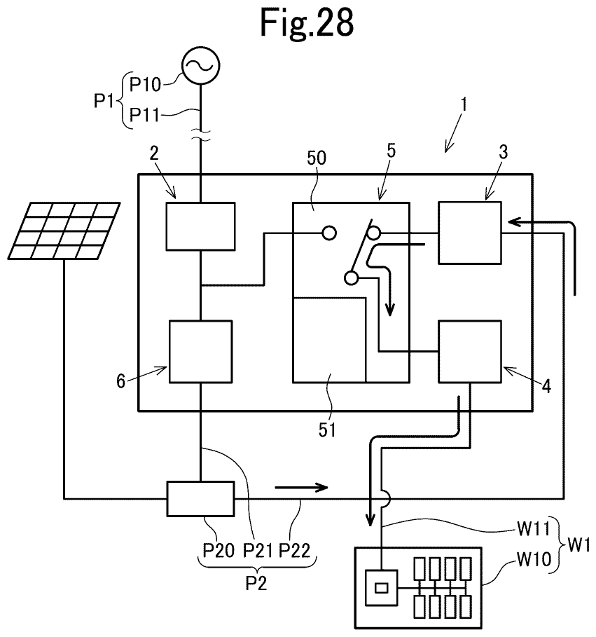

As shown in FIG. 27, the switching body 50 is switchable between a state in which the first side terminal part 500 and the load side terminal part 502 are electrically connected to each other and the second side terminal part 501 and the load side terminal part 502 are electrically disconnected from each other (first power supply state), and a state in which the first side terminal part 500 and the load side terminal part 502 are electrically disconnected from each other and the second side terminal part 501 and the load side terminal part 502 are electrically connected to each other (second power supply state) as shown in FIG. 28, and the switching control part 51 is configured to switch the first power supply state and the second power supply state by operating the switching body 50.

The switching control part 51 may be configured to automatically switch the first power supply state and the second power supply state of the switching body 50 according to the respective power supply states, but may be configured to manually switch between the first power supply state and the second power supply state, or may be configured to switch between the first power supply state and the second power supply state by remote control from the outside.

Further, for example, the switching control part 51 may be configured to switch the switching body part 50 from the first power supply state to the second power supply state when it is detected that the power supply from the first power supply system P1 is interrupted, and to switch the switching body part 50 from the second power supply state to the first power supply state when it is detected that the power supply from the first power supply system P1 is restored.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 321 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

In the relay electric device 62, the first phase terminal part 620a, the second phase terminal part 620b, and the third phase terminal part 620c are arranged in the first direction (so as to be aligned), and the first phase terminal part 621a, the second phase terminal part 621b, and the third phase terminal part 621c are also arranged in the first direction (so as to be aligned).

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 621 of the relay electrical device 62) in the second direction, and to be within the band-shaped area B extending in the first direction.

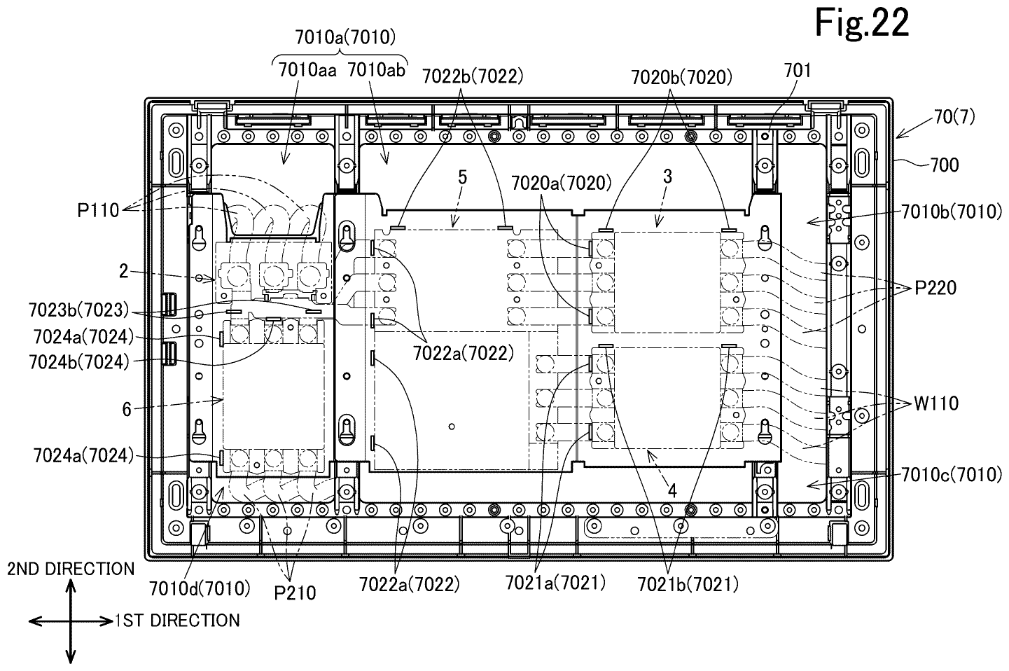

As shown in FIG. 22, the housing 7 includes a housing part 70 capable of housing the first circuit part 2, the second circuit part 3, the loading circuit part 4, changeover switch 5, and the relay circuit part 6 therein, and an inner lid part 71 (see FIG. 17) attached to the front surface of the housing part 70. Although not shown in FIG. 22, the housing 7 includes an outer lid part that covers the inner lid part 71 attached to the front surface of the housing part 70.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of the first electric device 22 in the second direction relative to first primary terminal part 20 or changeover switch 5 (in the present embodiment, on one side of the first electric device 22 in the second direction). Therefore, the first conductor insertion part 7010a allows the first conductor P110 to be inserted into and out of the housing 7 on one side of first primary terminal part 20 or changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric equipment 22, and the switching-side first conductor insertion part 7010ab is disposed directly above changeover switch 5 and the second electric device 32. In the present embodiment, as shown in FIG. 18, the first conductor P110 is inserted inside the housing 7 via the first-side first conductor insertion part 7010aa.

The second conductive insertion part 7010b is provided on the other side in the first direction than the device primary terminal part 320 of the second electric device 32. Therefore, the second conductor insertion part 7010b allows the second conductor P220 to be inserted into and out of the housing 7 on the other side in the first direction than the device primary terminal part 320 of the second electric device 32.

Further, the second conductor insertion part 7010b is disposed on the other side of the second electric device 32 in the first direction in the band-shaped area A, and the arrangement position in the second direction is the same position as the arrangement position in the second direction of the second conductor insertion part 7010b.

The load conductor insertion part 7010c is provided on the other side of the load device secondary terminal part 421 of the load electric device 42 in the first direction. Therefore, the load conductor insertion part 7010c allows the load conductor W110 to be inserted into and out of the housing 7 on the other side of the load device secondary terminal part 421 of the load electric device 42 in the first direction.

Further, the load-conductor insertion part 7010c and the second conductor insertion part 7010b are formed at positions aligned in the second direction, and are formed so as to be continuous with each other.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction.

The positioning structure 702 includes a second circuit part positioning part 7020 for positioning the second circuit part 3 with respect to the back surface part 701, a load circuit part positioning part 7021 for positioning the load circuit part 4 with respect to the back surface part 701, a changeover switch positioning part 7022 for positioning changeover switch 5 with respect to the back surface part 701, a first circuit part positioning part 7023 for positioning the first circuit part 2 with respect to the back surface part 701, and a relay circuit part positioning part 7024 for positioning the relay circuit part 6 with respect to the back surface part 701.

The second circuit part positioning part 7020 of the present embodiment is configured to position the second electrical device 32.

Further, the second circuit part positioning part 7020 is configured to abut on two intersecting side surfaces of the second electrical device 32. More specifically, the second circuit part positioning part 7020 has a first contact part 7020a that protrudes from the back surface part 701 toward the front side in the front-rear direction and abuts on the side surface of the second electric device 32 on the one side in the first direction, and a second contact part 7020b that protrudes from the back surface part 701 toward the front side in the front-rear direction and abuts on the side surface of the second electric device 32 on the one side in the second direction.

Load circuit part positioning part 7021 is configured to position the load electric device 42.

In addition, the load circuit part positioning part 7021 is configured to abut on two intersecting side surfaces of the load electric device 42. More specifically, the load circuit part positioning part 7021 includes a first contact part 7021a that protrudes from the back surface part 701 toward the front side in the front-rear direction and abuts on a side surface of the load electrical device 42 on one side in the first direction, and a second contact part 7021b that protrudes from the back surface part 701 toward the front side in the front-rear direction and abuts on a side surface of the load electrical device 42 on one side in the second direction.

The changeover switch positioning part 7022 is configured to abut two intersecting sides of changeover switch 5. More specifically, the changeover switch positioning part 7022 has a first contact part 7022a that protrudes from the back surface part 701 toward the front side in the front-rear direction and abuts on the side surface on one side in the first direction of changeover switch 5, and a second contact part 7022b that protrudes from the back surface part 701 toward the front side in the front-rear direction and abuts on the side surface on one side in the second direction of changeover switch 5.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The inner lid part 71 is attached to the housing part 70 and is configured to cover the front surfaces of the first circuit part 2, the second circuit part 3, the loading circuit part 4, changeover switch 5, and the relay circuit part 6. Further, in the middle cover part 71 of the present embodiment, the windows 710 are formed in accordance with the positions of the non-charging part of the second circuit part 3 (specifically, the operation part of the second electric device 32), the non-charging part of the load circuit part 4 (specifically, the operation part of the load electric device 42), and the non-charging part of the relay circuit part 6 (specifically, the operation part of the relay electric device 62).

The second electric device 32 and the load electric device 42 are arranged in a state in which the operation direction of the operation part is aligned with the first direction, and the relay electric device 62 is arranged in a state in which the operation direction of the operation part is aligned with the second direction. As described above, the second electric appliance 32 and the load electric appliance 42 arranged at the positions close to each other are arranged so that the operation direction of the operation part is the same, and the relay electric appliance 62 arranged at the position away from the second electric appliance 32 and the load electric appliance 42 is arranged so that the operation direction of the operation part is different from the operation direction of the operation part of the second electric appliance 32 and the load electric appliance 42.

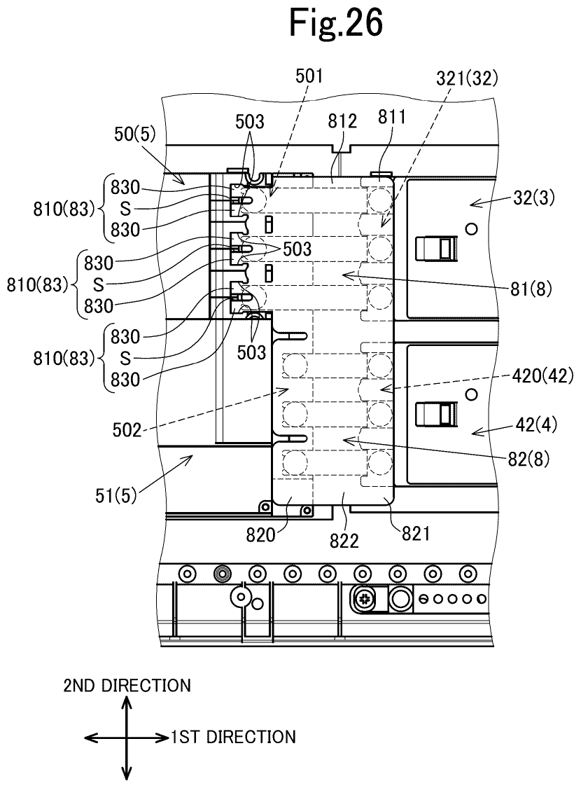

As shown in FIG. 23, the cover structure 8 includes a first cover part 80 that covers first conductive connection part 23, a second cover part 81 that covers the second conductive connection part 33, and a third cover part 82 that covers the loaded conductive connection part 43. Although the second cover part 81 and the third cover part 82 of the present embodiment are integrally formed, the second cover part 81 and the third cover part 82 may be separate members (see FIG. 26).

The first cover part 80 includes a first protection part 800 that covers the proximal end part of the first conductive part 231, and a second protection part 801 that covers the distal end part of the first conductive part 231 and the second conductive part 232.

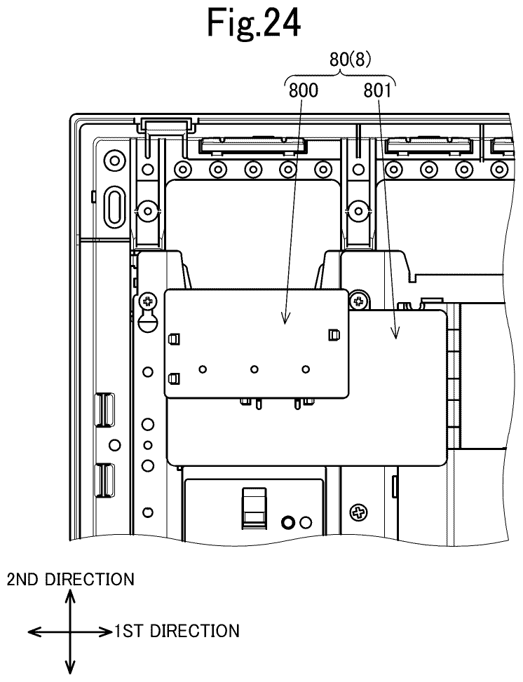

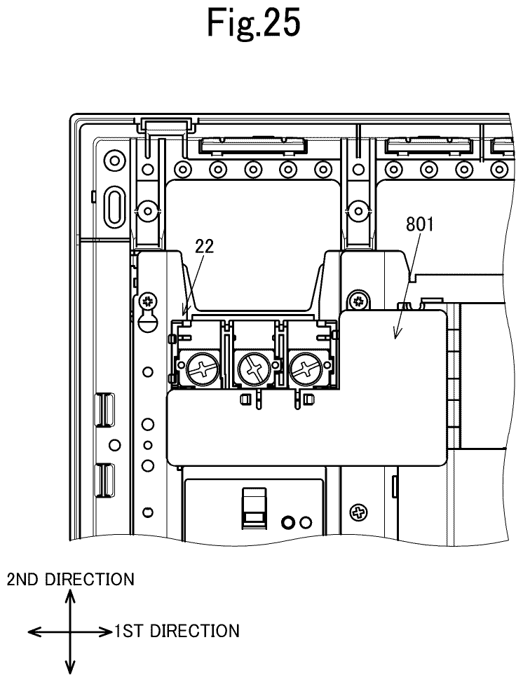

The first protective part 800 and the second protective part 801 are detachable separately, in a state where the second protective part 801 covers the distal end side and the second conductive part 232 than the proximal end part of the first conductive part 231 from the front side, the first protective part 800 covers the proximal end part of the first conductive part 231 from the front side and a closed state, the first protective part 800 is configured to be switchable to an open state of opening the front of the proximal end part of the first conductive part 231 (see FIGS. 24 and 25).

Further, in a state in which both the first protection part 800 and the second protection part 801 are installed, the first protection part 800 is disposed on the front side in the front-rear direction relative to the second protection part 801, and the outer peripheral edge part of the first protection part and the outer peripheral edge part of the second protection part 801 are in a state of part overlapping with each other.

As shown in FIG. 26, the second cover part 81 includes a first protection part 810 that covers the front of the second side terminal part 501, a second side protection part 811 that covers the front of the device secondary terminal part 321 of the second electric device 32, and an intermediate protection part 812 that covers the front of the area between the second side terminal part 501 and the device secondary terminal part 321 of the second electric device 32.

The third cover part 82 has a first protection part 820 covering the front of the load side terminal part 502, a second side protection part 821 covering the front of the load device primary terminal part 420 of the load electrical device 42, and an intermediate protection part 822 covering the front of the area between the load side terminal part 502 and the load device primary terminal part 420 of the load electrical device 42.

The second cover part 81 and the third cover part 82 are configured to be externally attachable to changeover switch 5, and the cover structure 8 of the present embodiment has a cover-side engagement part 83 that secures the second cover part 81 and the third cover part 82 to the switching body part 50 while engaging with the switching body part 50 in order to securely attach and fix the second cover part 81 and the third cover part 82 to changeover switch 5 (to reliably prevent the second cover part and the third cover part from being detached from changeover switch 5).

In the cover structure 8 of the present embodiment, the second cover part 81 and the third cover part 82 are integrally formed, and the cover-side engagement part 83 is provided in the second cover part 81.

The cover-side engaging part 83 is configured to be erected at a position adjacent to terminal part of the second side terminal part 501 in the second direction and to be engaged between a pair of insulating walled parts 503 opposed to each other in the second direction.

The cover-side engaging part 83 of the present embodiment has a pair of flexible engaging parts 830 which are flexible and arranged in a direction in which the pair of insulating wall parts 503 are arranged (second direction in the present embodiment).

The cover-side engagement part 83 of the present embodiment is constituted by the first protection part 810 of the second cover part 81. In the second cover part 81, the first protection part 810 is formed so as to extend outward from the intermediate protection part 812, and the first protection part 810 is formed with a slit S extending from the distal end toward the proximal end side.

Therefore, in the second cover part 81, part on one side (one side in the second direction) of the first protection part 810 relative to the slit S constitutes one flexible engagement part 830, and part on the other side (the other side in the second direction) of the first protection part 810 relative to the slit S constitutes the other flexible engagement part 830. That is, the pair of flexible engagement parts 830 are arranged in the second direction via the slit S.

Note that, as described above, since the second-side terminal part 501 of changeover switch 5 includes the second-side terminal part 501 (first phase terminal part 501a) for the first phase, the second-side terminal part 501 (second phase terminal part 501b) for the second phase, and the second-side terminal part 501 (third phase terminal part 501c) for the third phase, the cover construction 8 is configured to have three cover-side engagement parts 83.

As described above, in the cover configuration 8, the cover-side engagement part 83 engages with the switching body part 50 (the pair of opposing insulating wall parts 503 for the second-side terminal part 501 in the present embodiment), so that the second cover part 81 and the third cover part 82 can be maintained attached to the switching body part 50.

In addition, if the slit S is formed between the pair of flexible engagement parts 830 as in the cover-side engagement part 83 of the present embodiment, it is easy to dispose the slit S between the insulating wall parts 503 where the movement of the pair of flexible engagement parts 830 is permitted.

In the present embodiment, the cover-side engaging part 83 is formed only in the second cover part 81 of the second cover part 81 and the third cover part 82, the cover-side engaging part 83 may be formed in the second cover part 81 and the third cover part 82, and in the case where the second cover part 81 and the third cover part 82 are integrally formed, the cover-side engaging part 83 may be formed only in the third cover part 82.

As described above, according to changeover switch built-in board 1 of the present embodiment, the first changeover switch 5 and the relay circuit part 6, which are arranged in the first direction with respect to the first circuit part 2 (in the present embodiment, changeover switch 5), can connect the first conductive part 231 to the first side terminal part 500 along the first direction because the first conductive part 231 extending in the first direction has terminal part (the first side terminal part 500) facing end part 2310 in the first direction.

Of changeover switch 5 and the relay circuit part 6, those aligned in the second direction with respect to the first circuit part 2 (the relay circuit part 6 in the present embodiment) have the relay primary terminal part 60 facing end part 2320 of the second conductive part 232 extending in the second direction in the second direction, so that the second conductive part 232 can be connected to the relay primary terminal part 60 along the second direction.

As described above, since the first conductive part 231 and the second conductive part 232 can be connected along the first direction or the second direction in which changeover switch 5 or the relay circuit part 6 is aligned with the first circuit part 2, it is possible to reduce the size of changeover switch built-in board 1.

In first conductive connection part 23 of the present embodiment, since the first conductive part 231 is formed so that the proximal conductive part 2311a extends straight from the second conductive part 232 toward the connection target (the first side terminal part 500), the first conductive part 231 may not be oriented with respect to the direction in which the second conductive part 232 extends from the connection fixing part 230. Therefore, in the present embodiment, the space between the first electrical device 22 and the relay electrical device 62 is reduced.

In addition, in changeover switch built-in board 1 of the present embodiment, since first conductive connection part 23 is formed of a plate material having conductivity, first conductive connection part 23 can be formed in a configuration along the wire path, and the space required for changing the direction of first conductive connection part 23 can be reduced.

Further, in changeover switch built-in board 1 of the present embodiment, the base end part side (intermediate part 2321) of the second conductive part 232 is formed so as to be located on the front side in the front-rear direction of the connecting fixing part 230 and conductive part 232 in end part 2320, and the space on the rear side of the first conductive part 231 can be used as a space for, for example, a wire or the like because the first conductive part 231 branches from intermediate part 2321 of the second conductive part 232 toward the first direction.

Further, the plurality of first conductive connection part 23 can be prevented from spreading in the second direction because the proximal conductive part 2311a of the respective first conductive connection part 23 are arranged in a row in the front-rear direction.

In particular, the three proximal conductive part 2311a can be arranged closer to each other in the front-rear direction and the plurality of second conductive part 232 can be arranged closer to each other in the first direction because they are arranged side by side from the front side to the rear side in the front-rear direction in order from the one extending from the second conductive part 232 which is arranged at the one-most position in the first direction (the position farthest from changeover switch 5 in the first direction). As a result, it is possible to suppress the extension of the space in which the plurality of first conductive connection part 23 are arranged in the first direction.

Further, in changeover switch built-in board 1 of the present embodiment, since the identification display 2311c attached to the front surface of each of the front-end-side conductive part 2311b is configured to be exposed to the front side, the identification display 2311c attached to each of the plurality of first conductive connection part 23 becomes easy to see, and the type of each of first conductive connection part 23 becomes easy to distinguish.

The cover structure 8 of the board 1 with a changeover switch of this embodiment is provided with the first cover part 80 which has the first protection part 800 which covers the connection fixing part 230 from a front side, and the second protection part 801 which covers the first conductive part 231 and the second conductive part 232 from a front side, and the second protection part 801 covers the first conductive part 231 and the second conductive part 232 from a front side, Since the first protection part 800 is configured to be switchable between a closed state in which the first protection part 800 covers the connection fixing part 230 from the front side and an open state in which the front of the connection fixing part 230 of the 2 conductive part 232 is opened, only the first protection part 800 is opened to the terminal block Since only the front of the connection fixing part 230 to which the fixed first power supply system P1 is connected is opened, the operation of the connection fixing part 230 can be safely performed while the other part of the first conductive connection part 23 is covered with the second protective part 801.

Further, in changeover switch built-in board 1 of the present embodiment, the first side terminal part 500 can be electrically connected to the first circuit part 2 on one side in the first direction, the second side terminal part 501 can be electrically connected to the second circuit part 3 on the other side in the first direction, and the second side terminal part 501 and second secondary terminal part 31 are arranged so as to face each other in the first direction, so that the second side terminal part 501 and second secondary terminal part 31 can be electrically connected to each other by arranging the second conductive connection part 33 in a straight line in the first direction when the second side terminal part 501 and OOH 31 are electrically connected using the second conductive connection part 33.

Specifically, the first phase terminal part 501a, the second phase terminal part 501b, and the third phase terminal part 501c of the second side terminal part 501 are arranged linearly in the first direction so as to face the first phase terminal part 321a, the second phase terminal part 321b, and the third phase terminal part 321c of the device secondary terminal part 321, respectively, so that the second side terminal part 501 and second secondary terminal part 31 can be electrically connected with the first phase conductive connection part 33a, the second phase conductive connection part 33b, and the third phase conductive connection part 33c arranged in the second direction.

In addition, in changeover switch built-in board 1 of the present embodiment, the second conductor P220 is inserted from the outside to the inside of the housing 7 via the second conductor insertion part 7010b, and is connected to the device primary terminal part 220 in the first direction, and the device secondary terminal part 321 and the second-side terminal part 501 can be connected to each other via the second conductive connection part 33 that is linear in the first direction, thereby facilitating the wiring operation and simplifying the wiring path.

Further, in the present embodiment, since the second conductor insertion part 7010b is provided on the other side in the first direction than the second electric device 32 in the band-shaped area A, the second conductor P220 is introduced into the housing 7 from the opposite side in the second conductor insertion part 7010b, and the second conductor P220 can be connected to the device primary terminal part 320 from the other side in the first direction. Therefore, in the present embodiment, without significantly changing the direction of the second conductor P220, since it is possible to perform the operation of connecting the second conductor P220 to the device primary terminal part 320 from the operation of introducing the second conductor P220 into the housing 7, the second conductor P220 can be connected easily and smoothly to the second electric device 32, thereby, it is possible to easily perform the wiring operation.

Further, first primary terminal part 20 is disposed toward one side in the second direction perpendicular to the first direction and the front-rear direction, the first electric device 22 or changeover switch 5 is a terminal block on one side in the second direction, since the first conductor insertion part 7010a is provided, the first conductor insertion part from 7010a of the first conductor insertion part without significantly changing the direction of the first conductor P110 to introduce the first conductor P110 to the inside of the housing 7, the first conductor P110 can be connected to first primary terminal part 20, the first conductor P110 can be easily and smoothly connected to the first electric device 22, thereby, it is possible to easily perform the wiring operation.

Further, in the present embodiment, first primary terminal part 20 is disposed toward one side in the second direction, the first-side first conductor insertion part 7010aa is disposed on one side (directly above) in the second direction of the terminal block as the first electric device 22, and the switching-side first conductor insertion part 7010ab is disposed on one side (directly above) in the second direction of changeover switch 5 and the second electric device 32. The first conductor P110 introduced into the inside of the housing 7 is connected to first primary terminal part 20 via the first-side first conductor insertion part 7010aa. Therefore, the first conductive P110 and first primary terminal part 20 can be easily connected in the second direction.

Therefore, since the second-side terminal part 501 and second secondary terminal part 31 are arranged so as to face each other in one direction, the interconnection path can be simplified when changeover switch 5 and the second circuit part 3 are electrically connected to each other.

In addition, since the second-side terminal part 501 and the load-side terminal part 502 are arranged so as to be aligned in the first direction while facing the other side in the first direction in the second direction, the second-side terminal part 501 and the load-side terminal part 502 can be separated in the second direction, so that the second-side terminal part 501 and the load-side terminal part 502 can be electrically connected to each other (that is, an insulating distance can be secured). Further, in the first direction, the second side terminal part 501 and second secondary terminal part 31 can be electrically connected, the load side terminal part 502 and the load primary terminal part 40 can be electrically connected, and the second side terminal part 501 and second secondary terminal part 31 can be arranged so as to face each other in the first direction, and the electrical connection between the second side terminal part 501 and second secondary terminal part 31 and the electrical connection between the load side terminal part 502 and the load primary terminal part 40 can be separated from each other because the load side terminal part 502 and the load primary terminal part 40 are arranged so as to face each other in the first direction.

In the present embodiment, the second side terminal part 501 is disposed on one side in the second direction, and the load-side terminal part 502 is disposed on the other side in the second direction. In the second direction, the second electric device 32 and the load electric device 42 are separated from each other in a state in which the second electric device 32 is disposed on one side and the load electric device 42 is disposed on the other side. Thus, the connection between the second side terminal part 501 and second secondary terminal part 31 via the second conductive connection part 33 and the connection between the load side terminal part 502 and the load primary terminal part 40 via the load conductive connection part 43 can be separated in the second direction. Therefore, it is possible to contribute to securing the insulation distance in the second direction.

A terminal part of each phase of the second side terminal part 501 and a terminal part of each phase of the load side terminal part 502 can be separated in a second direction, and a terminal part of each phase of the device secondary terminal part 321 and a terminal part of each phase of the load device primary terminal part 420 can be separated in a second direction. In addition, the short circuit between the phases between the terminal parts can be suppressed, and the second side terminal part 501 and the device secondary terminal part 321, the first phase terminal parts 501a, 321a of each other face each other in the first direction, the second phase terminal parts 501b, 321b of each other face each other in the first direction, and the load side terminal part 502 and the load device primary terminal part 420 face each other in the first direction, and the second phase of each other Since the terminal parts 502b, 420b are opposed to each other in the first direction and the third phase terminal parts 502c, 420c are opposed to each other in the first direction, the terminal parts of the respective phases are opposed to each other in the first direction, so that the electric connection can be simplified and the inter-phase short circuit can be suppressed.

In the present embodiment, the second side terminal part 501 is disposed on one side and the load-side terminal part 502 is disposed on the other side in the second direction. As shown in FIG. 18, the first phase terminal part 501a, the second phase terminal part 501b, and the third phase terminal part 501c of the second-side terminal part 501 are arranged in the second direction, and the first phase terminal part 502a, the second phase terminal part 502b, and the third phase terminal part 502c of the load-side terminal part 502 are arranged in the second direction. Further, as shown in FIG. 18, in a second orientation, the equipment secondary terminal part 321 is located on one side and the loading equipment primary terminal part 420 is located on the other side. Then, as shown in FIG. 18, the first phase terminal part 321a, the second phase terminal part 32b₁, and the third phase terminal part 321c of the device secondary terminal part 321 are arranged in the second direction, and the first phase terminal part 420a, the second phase terminal part 420b, and the third phase terminal part 420c of the loading device primary terminal part 420 are arranged in the second direction. In addition, the second-side terminal part 501 and the secondary terminal part, each other of the first phase terminal part 501a, 220a facing each other in the first direction, each other of the second phase terminal part 501b, 220b facing each other in the first direction, each other of the third phase terminal part 501c, 220c facing each other in the first direction, the load-side terminal part 502 and the load device primary terminal part 420, each other of the first phase terminal part 502a, 420a facing each other in the first direction, each other of the second phase terminal part 502b, 420b facing each other in the first direction, each other of the third phase terminal part 502c, 420c facing each other in the first direction. Therefore, between the second-side terminal part 501 and the device secondary terminal part 321, and between the load-side terminal part 502 and the load-device primary terminal part 420, the first phase terminal part 502a, 321a, the second phase terminal part 502b, 321b, and the third phase terminal part 502c, 321c are arranged in this order from one side to the other side in the second direction. Therefore, the arrangement of terminal part of each phase in the second direction is easy to understand.

The second-side terminal part 501 and the load-side terminal part 502 are arranged side by side in the second direction so as to face the other side in the first direction, and the second-side terminal part 501 and the first-side terminal part 500 are arranged side by side in the first direction toward the other side in the first direction, so that the first circuit part 2 and the second circuit part 3 are arranged on the one side in the first direction and the other side in changeover switch 5 in the housing 7, respectively, so that the first-side terminal part 500 and the second-side terminal part 501 can be wired in the first direction, so that the space-efficiency and the wiring-efficiency in the housing 7 can be improved while securing the insulating distance between terminal part.

In the present embodiment, the first side terminal part 500 and the second side terminal part 501 are disposed on one side in the second direction, and the load-side terminal part 502 is disposed on the other side in the second direction. Therefore, electricity is supplied to changeover switch 5 on one side in the second direction, and electricity is supplied from changeover switch 5 on the other side in the second direction.

Therefore, the second side terminal part 501 and the load side terminal part 502 can be separated from each other in the second direction, and the electrical connection between the second side terminal part 501 and second secondary terminal part 31 and the electrical connection between the load side terminal part 502 and the load primary terminal part 40 can be separated from each other.

Since first secondary terminal part and second secondary terminal part 31 in the strip area A including the first side terminal part 500 and the second side terminal part 501 are arranged on one side and the other side of the first direction, the first side of changeover switch 5 connected by first conductive connection part 23 to each other terminal part 500 and first secondary terminal part of the first circuit part 2 in the vicinity it is possible to place second secondary terminal part 31 of the second side 501 and the second circuit part 3 of changeover switch 5 in the vicinity, it is possible to simplify the first circuit part 2 and changeover switch 5 and the second circuit part 3 interconnection path.

In this embodiment, the first phase, terminal part 220a, second phase, terminal part 220b, and third phase terminal part 220c of the device primary terminal part 220 as a first secondary terminal part can be placed in the cingulate area A. In addition, the first phase, terminal part 321a, second phase terminal part 321b, and third phase terminal part 321c of the device secondary terminal part 321 as a second secondary terminal part 31 can be placed in the cingulate area A. Therefore, when the first circuit part 2, changeover switch 5, and the second circuit part 3 are electrically connected to each other, the interconnection path can be simplified because terminal part required for the electrical connection between the first circuit part 2, changeover switch 5, and the second circuit part 3 can be arranged in the belt-like area A.

Therefore, the first side terminal part 500 of changeover switch 5 connected by first conductive connection part 23 and first secondary terminal part of the first circuit part 2 can be arranged in the vicinity, the second side terminal part 501 of changeover switch 5 and second secondary terminal part 31 of the second circuit part 3 since it is possible to place in the vicinity, it is possible to simplify the first circuit part 2 and changeover switch 5 and the second circuit part 3 routing path.

Note that changeover switch built-in board 1 of the present disclosure is not limited to the above-described embodiment, and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply.

For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the load device primary terminal part 420 and the load device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the device primary terminal part 220 of the first electric device 22 is configured to have the first phase terminal part 220a, the second phase terminal part 220b, and the third phase terminal part 220c, but is not limited to this configuration. For example, in the case of having only the first phase terminal part 220a, in addition to the case of having the first phase terminal part 220a and the second phase terminal part 220b, in the case of having the first phase terminal part 220a, the second phase terminal part 220b, and the third phase terminal part 220c, it may also be a case of having the fourth phase terminal part. That is, the device primary terminal part 220 may include at least a first phase terminal part 220a.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

Also in this case, the second conductive part 232 may be integrally formed with the first conductive part 231 as in the above-described embodiment, or may be separately attached to the first conductive part 231.

In the above embodiment, the first circuit part 2 is configured to have three first conductive connection part 23, but is not limited to this configuration, for example, the first circuit part 2 may be configured to have one first conductive connection part 23, or may be configured to have two or four or more first conductive connection part 23. That is, the first circuit part 2 may be configured to have at least one first conductive connection part 23.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2.

As a result, the load circuit part 4 can be electrically disconnected from the first power supply system P1 and the second power supply system P2, and can further improve electric safety such as when inspecting the load device or the like connected to the load circuit part 4.

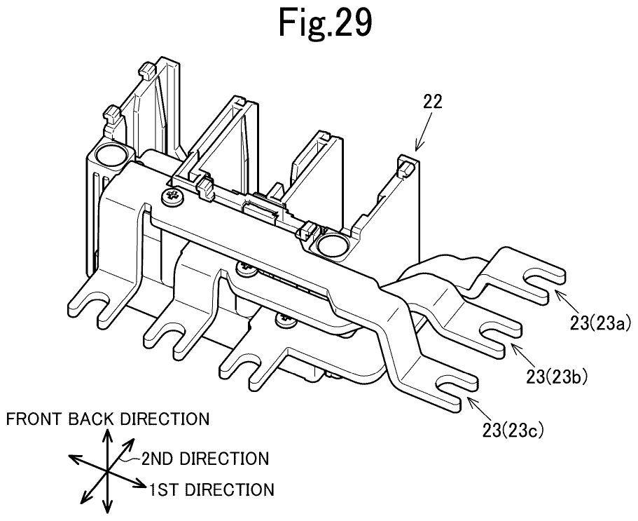

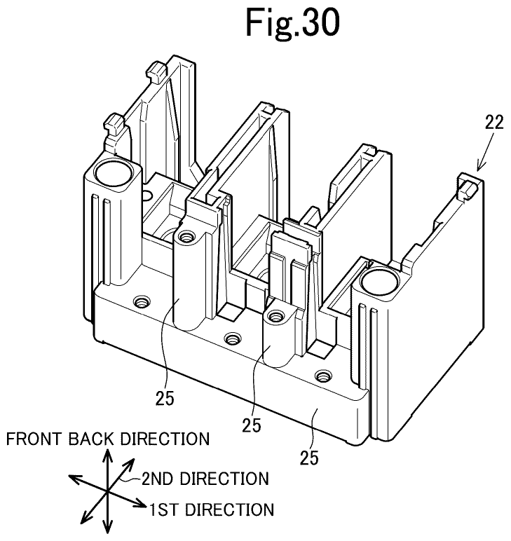

Although not specifically mentioned in the above embodiment, first conductive connection part 23 may be configured so that the second conductive part 232 is also screwed to the first electric device 22. In such a case, for example, as shown in FIGS. 29 and 30, the first electric device 22 may be provided with the fixing base part 25 having the screw hole formed therein.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 extends to the other side in the second direction with respect to the connecting fixing part 230, but is not limited to this configuration. The second conductive part 232 may extend, for example, to one side in the second orientation relative to the connecting fixing part 230. Again, the first conductive part 231 may be configured to extend to the other side of the first direction relative to the connection fixing part 230, and the first conductive part 231 may be configured to extend to the one side of the first direction relative to the connection fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

Further, in the above embodiment, the first side terminal part 500 and the second side terminal part 501 are arranged in a straight line in the first direction and the arrangement positions in the second direction are the same position, but the present invention is not limited thereto, and for example, the arrangement positions of the first side terminal part 500 and the second side terminal part 501 in the second direction may be different from each other.

In the above embodiment, the first electric device 22 is disposed on one side in the first direction with respect to changeover switch 5, and the second electric device 32 is disposed on the other side in the first direction with respect to changeover switch 5. However, the present invention is not limited thereto, and for example, the first electric device 22 may be disposed on one side of changeover switch 5 in the second direction, and the second electric device 32 may be disposed on the other side of changeover switch 5 in the second direction. In addition, it is conceivable that at least the device secondary terminal part 321 and the second-side terminal part 501 face each other in the second direction. In addition, the first phase terminal part 500a, 501a of the first side terminal part 500 and the second side terminal part 501, the second phase terminal part 500b, 501b, and the band-like area A defined by the third phase terminal part 500c, 501c may extend in the second direction.

In the above embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the above embodiment, the second side terminal part 501 and the load side terminal part 502 are arranged in the second direction, and the second side terminal part 501 is arranged on one side in the second direction, and the load side terminal part 502 is arranged on the other side in the second direction, but the present invention is not limited thereto, and for example, the second side terminal part 501 may be arranged on the other side in the second direction and the load side terminal part 502 may be arranged on one side in the second direction. Here, the second circuit part 3 is arranged on the other side in the second direction and the loading circuit part 4 is arranged on the one side in the second direction.

In addition, in this case, in the second direction, the load side terminal part 502 may be disposed at the same position as the first side terminal part 500 or the second side terminal part 501, or the load side terminal part 502 may be disposed before and after the first side terminal part 500 or the second side terminal part 501.

In the description of the strip-shaped area A of the above embodiment, the arrangement position of the first side terminal part 500 and the arrangement position of the second side terminal part 501 in the second direction has been given an example of the same, for example, the arrangement position of the first side terminal part 500 in the second direction and the arrangement position of the second side terminal part 501 are different from each other even in the second direction, the first phase terminal part 500a and the second side terminal part 501 of the first side terminal part 500 in the second direction it may be a strip-shaped area A area extending in a range including up to the third phase terminal part 501c of the third phase terminal part 500c and the second side terminal part 500 of the first side terminal part 501a.

In the above embodiment, changeover switch built-in board 1 includes the relay circuit part 6, but the present invention is not limited thereto, and for example, changeover switch built-in board 1 may not include the relay circuit part 6, and the electric wire from the direct external facility may be connected to the second conductive part 232 of first conductive connection part 23, or the relay circuit part 6 may be provided outside changeover switch built-in board 1. In addition, the first conductive insertion part 7010a may be disposed on the other side of the first circuit part 2 or changeover switch 5 in the second direction. First primary terminal part 20 may be disposed toward the other side in the second direction.

In the above embodiment, changeover switch built-in board 1 includes the load circuit part 4, but the present invention is not limited thereto, and for example, changeover switch built-in board 1 may not include the load circuit part 4. A load conductor W110 may be connected to the load-side terminal part 502 of changeover switch 5.

In the load electric device 42 of the above embodiment, the load device primary terminal part 420 is provided at one end of the first direction, and the load device secondary terminal part 421 is provided at the other end of the first direction. However, the present invention is not limited thereto, and for example, in the load electric device 42, the load device primary terminal part 420 may be provided at the other end part in the first direction, and the load device secondary terminal part 421 may be provided at the one end part in the first direction.

In the load electric device 42 of the above embodiment, the load device primary terminal part 420 is oriented in one side of the first direction, and the load device secondary terminal part 421 is oriented in the other side of the first direction, that is, the load electric device 42 is arranged in a lateral direction along the first direction. However, for example, the load appliance 42 may be vertically oriented such that the load appliance primary terminal part 420 and the load appliance secondary terminal part 421 are aligned in the second direction, i.e., along the second direction. In this case, one of the load device primary terminal part 420 and the load device secondary terminal part 421 may be disposed on one side in the second direction and the other may be disposed on the other side in the second direction.

In the above embodiment, changeover switch 5 includes the second-side terminal part 501 and the load-side terminal part 502 at the other end in the first direction. However, the present invention is not limited thereto, and for example, changeover switch 5 may include the second-side terminal part 501 and the load-side terminal part 502 at one end in the second direction.

In addition, changeover switch 5 may include a first side terminal part 500 and a load-side terminal part 502 at one end in the first direction. Here, the first side terminal part 500 and the load side terminal part 502 may be arranged so as to be oriented in the same direction in the first direction and aligned in the second direction. In addition, the loading circuit part 4 may be disposed on one side of changeover switch 5 in the first direction.

In the above-described embodiment, the second conductive insertion part 7010b is disposed on the other side of second primary terminal part 30 in the first direction. However, the present invention is not limited thereto, and for example, the second conductive insertion part 7010b may be disposed on one side of second primary terminal part 30 in the first direction.

In the above embodiment, the arrangement positions of the device primary terminal part 320 and the device secondary terminal part 321 of the second electric device 32 in the second orientation are the same. However, the present invention is not limited thereto, and for example, the arrangement positions of the device primary terminal part 320 and the device secondary terminal part 321 of the second electric device 32 in the second direction may differ from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, the first conductive insertion part 7010a is provided on one side of first primary terminal part 20 or changeover switch 5 in the second direction. However, the present invention is not limited thereto, and for example, the first conductive insertion part 7010a may be disposed on one side of first primary terminal part 20 in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

The first conductor-insertion part 7010a may be provided in the second direction just above one side of first primary terminal part 20 or just above one side of changeover switch 5.

In the above-described embodiment, as shown in FIG. 18, the positions of the second-side terminal part 501 and the load-side terminal part 502 in the first direction differ from each other. However, for example, the second-side terminal part 501 and the load-side terminal part 502 may be arranged such that their positions in the first direction are the same (that is, they are arranged along an imaginary straight line extending in the second direction).

In the second circuit part 3 of the above-described embodiment, second primary terminal part 30 is disposed on the other side in the first direction, but the present invention is not limited thereto, and for example, second primary terminal part 30 may be disposed on the one side in the second direction. Second primary terminal part 30 may be configured to be connectable in a direction in which the second conductor P220 extends from second primary terminal part 30 to one side in the second direction.

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the above embodiment, the arrangement positions of the device primary terminal part 320 and the device secondary terminal part 321 are the same in the second orientation. However, the present invention is not limited thereto, and for example, the device primary terminal part 320 and the device secondary terminal part 321 of the second electric device 32 may be arranged at different positions in the second direction.

In the above embodiment, the load circuit part 4 includes the load electric device 42 as a circuit breaker, but the present invention is not limited thereto, and the load circuit part 4 may be configured to include the power distribution circuit part. Specifically, the load circuit part 4 may be configured to include a main switch connected to the load side terminal part 502 of changeover switch 5, and a plurality of branch switches connected to the secondary side of the main switch via a bus. The housing 7 is sized to accommodate the power distribution circuit part as well.

Next, a changeover switch built-in board according to another embodiment will be described. Changeover switch built-in board of the present disclosure incorporates a changeover switch.

Conventional distribution boards include those described in Japanese Patent No. 6351333. The distribution board includes a commercial power supply circuit part and a distributed power supply circuit part. The commercial power supply circuit part comprises a main switch and a number of branch switches plugged into its secondary bus bar. In the distributed power supply circuit part, a switch for a distributed power supply and a changeover switch with a vibration-sensitive relay are arranged. Changeover switch with vibration-sensitive relays has two input-terminals and one output-terminal. The distributed power supply is connected to the primary side of the switch for the distributed power supply, and is further connected from the secondary side of the switch for the distributed power supply to one of the input terminals of changeover switch with vibration-sensitive relays. The other terminal of changeover switch with the vibration-sensitive relay is connected to one branch switch of the commercial power supply circuit part. Furthermore, an emergency circuit is connected as a load to the output terminal of changeover switch with vibration-sensitive relay, and is formed so that the supply from the commercial power supply or the distributed power supply can be switched by changeover switch with vibration-sensitive relay.

However, in the distribution board described in Japanese Patent No. 6351333, the one input terminal and the output terminal are arranged in the front-rear direction on one side in the vertical direction of changeover switch with vibration-sensitive relays. That is, the one input terminal and the output terminal are disposed on the front side and the rear side in the thickness direction of the distribution board. Therefore, the insulation distance between the one input terminal and the output terminal is not sufficiently secured, which may lead to an accident such as a phase-to-phase short circuit. This is applicable not only to a distribution board having a main switch and a branch switch, but also to an electric board having a built-in changeover switch capable of switching power.

Therefore, it is an object of the present disclosure to provide a highly safe changeover switch built-in board by securing an insulating length.

The present invention comprises: Changeover switch built-in board is characterized in that changeover switch for switching a power supply for supplying electricity to a load to a first power supply system or a second power supply system and a second circuit part electrically connecting the second power supply system and changeover switch and a load circuit part electrically connecting the load and changeover switch and a housing for housing changeover switch, the second circuit part, and the load circuit part, and changeover switch includes a second side circuit part electrically connected to the second side terminal part and a load side terminal part electrically connected to the load circuit part at an end of the housing in one direction of the first direction and the second direction orthogonal to each other and orthogonal to each other, and the second circuit part includes a second secondary terminal part electrically connected to the second side terminal part, and the load circuit part includes a load primary terminal part electrically connected to the load side terminal part, and the second side terminal part and the load side terminal part are arranged side by side in the same direction in the one direction in the other direction perpendicular to the front-rear direction and the one direction, and the second side terminal part and second secondary terminal part are arranged so as to face each other in the one direction, and the load side terminal part and the load primary terminal part are arranged so as to face each other in the one direction.

According to the above configuration, since the second side terminal part and the load side terminal part are arranged side by side in the same direction in the other direction in the other direction, the second side terminal part and the load side terminal part can be separated in the other direction, and the second side terminal part and the second side terminal part can be electrically connected in the same direction in the one direction, and the load side terminal part and the load primary terminal part can be electrically connected, and further, the second side terminal part and the second side terminal part are arranged so as to face each other in the one direction, and the load side terminal part and the load primary terminal part face each other in the one direction Since it is arranged, the electrical connection between the second side terminal part and the second terminal part and the electrical connection between the load side terminal part and the load primary terminal part can be separated from each other.

The second circuit part includes a second electric device having a second terminal part at an end part in the one direction, and the load circuit part includes a load electric device having a load device primary terminal part at an end part in the one direction, and the device secondary terminal part is configured to be electrically connected to the second side terminal part as second secondary terminal part and the load device primary terminal part is configured to be electrically connected to the load side terminal part as the load primary terminal part, and each of the second side terminal part, the second side terminal part, the load side terminal part, and the load device primary terminal part includes a first phase terminal part, a second phase terminal part, and a third phase terminal part in the other direction The second side terminal part and the device secondary terminal part, the first phase terminal part of each other is opposed to each other in the one direction, the third phase terminal part of each other is opposed in the one direction, the load side terminal part and the load device primary terminal part, The first phase terminal parts of each other may be opposed to each other in the one direction, the second phase terminal parts of each other may be opposed to each other in the one direction, and the third phase terminal parts of each other may be opposed to each other in the one direction.

To the above configuration According to the present invention, the terminal part of each phase of the second side terminal part and the terminal part of each phase of the load side terminal part can be separated from each other in the other direction, so that a short circuit between phases between the terminal parts and the terminal part of each phase of the load primary terminal part can be suppressed, and the second side terminal part and the device secondary terminal part can be opposed to each other in the one direction, and the second phase terminal parts of each other face each other in the one direction, and the load side terminal part and the load device primary terminal part face each other in the one direction Since the third phase terminal parts of each other are opposed to each other in the one direction, the terminal parts of each phase are opposed to each other in one direction, so that the electrical connection can be simplified and the inter-phase short circuit can be suppressed.

A first circuit part housed in the housing and electrically connected to the first power supply system and changeover switch may be provided, and changeover switch may include a first side terminal part electrically connected to the first circuit part at an end part in the one direction, and the first side terminal part may be arranged side by side in the first direction with respect to the second side terminal part in a direction opposite to the first direction.

According to the above configuration, in the other direction, the second side terminal part and the load side terminal part are arranged side by side so as to face the same direction in the one direction, and the second side terminal part and the first side terminal part are arranged side by side in the one direction toward the opposite side in the one direction, so that the first circuit part is arranged on one side in the one direction and the second circuit part is arranged on the other side with respect to changeover switch in the housing, so that the first side terminal part and the second side terminal part can be wired in the one direction, and the space-efficiency and the wiring-efficiency in the housing can be improved while securing the insulating distance between terminal part.

As described above, according to changeover switch built-in board of the present disclosure, the second side terminal part and the load side terminal part can be separated from each other in the other direction, and the electrical connection between the second side terminal part and second secondary terminal part and the electrical connection between the load side terminal part and the load primary terminal part can be separated from each other.

Hereinafter, a changeover switch built-in board according to an embodiment of the present disclosure will be described referring to the accompanying drawings.

Changeover switch built-in board is installed between a plurality of power supply systems and a load, and is configured to switch between a plurality of power supply systems and a load.

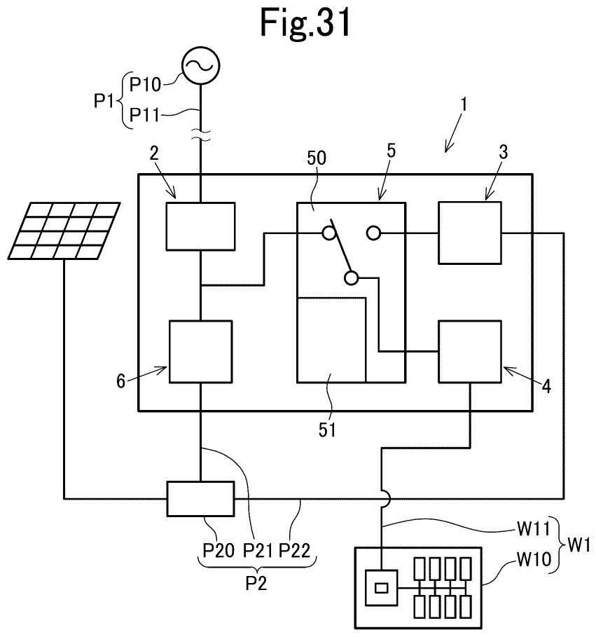

For example, as shown in FIG. 31, when changeover switch built-in board is installed in a house, a first power supply system P1 through which commercial power flows, a second power supply system P2 including a distributed power supply, and a load system W10 including a load W1 are electrically connected to changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

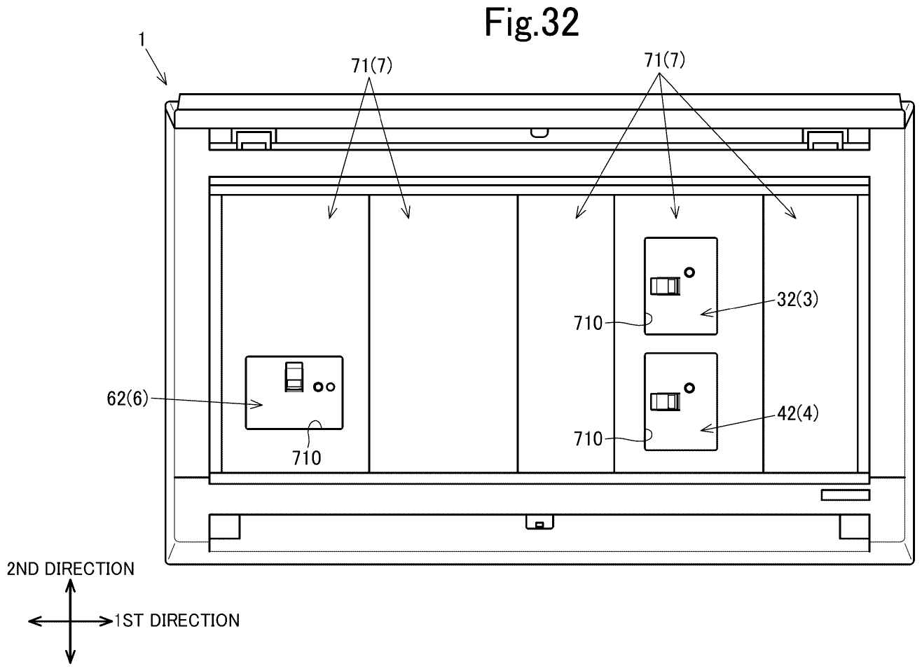

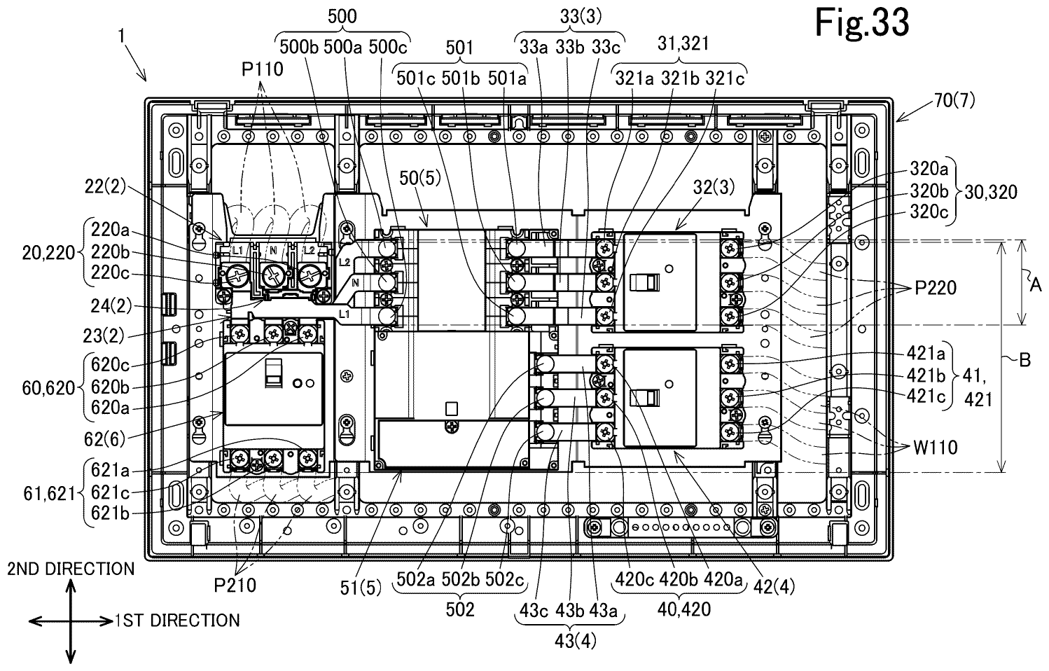

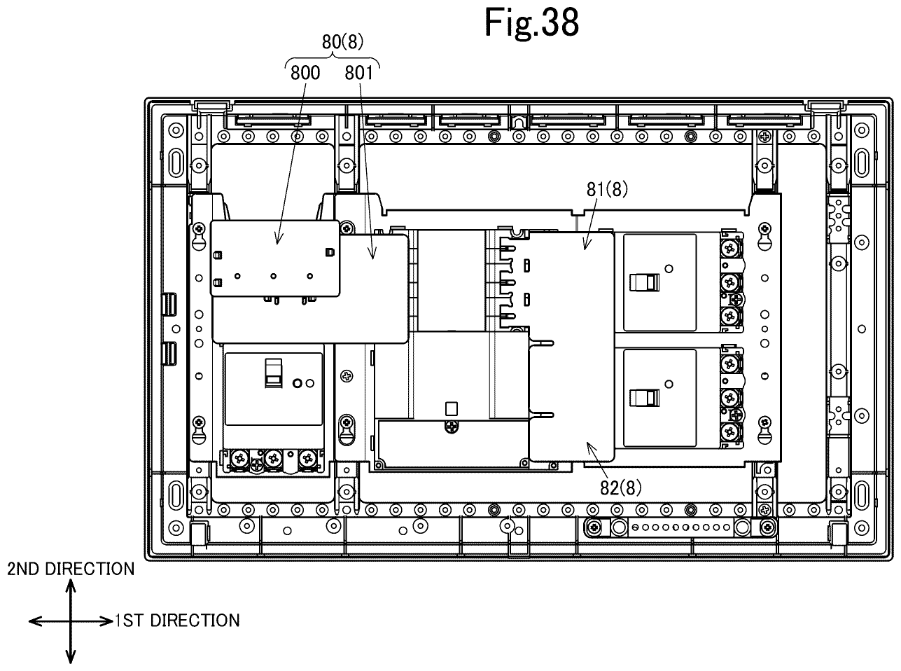

As shown in FIG. 33, changeover switch built-in board 1 is electrically connected to the first power supply system P1, the first circuit part 2 electrically connected to the second power supply system P2, the load circuit part 3 to which the load system W1 is connected, and changeover switch 5 which switches the power supply which supplies electricity to the load system W1 to the first power supply system P1 or the second power supply system P2A housing 7 (see FIG. 32) for housing the relay circuit part 6 to be connected, the first circuit part 2, the second circuit part 3, the relay circuit part 6, changeover switch 5, and the load P2 4, and a cover-structure 8 (see FIG. 38) for covering the charging part in the housing 7 are provided.

In the present embodiment, a direction in which the front surface and the back surface of changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction of a surface formed by the first direction and the second direction is referred to as a board surface direction.

In the present embodiment, the first direction is a direction corresponding to the left-right direction in a state where changeover switch built-in board 1 in the installed state is viewed from the front, and the one side in the first direction is a left side and the other side in the first direction is a right side.

In addition, the second direction is a direction corresponding to the up-down direction in a state where changeover switch built-in board 1 in the installed state is viewed from the front, the one side in the second direction is the upper side, and the other side in the second direction is the lower side.

The first circuit part 2 is electrically connected to the first power supply system P1 and changeover switch 5. The first circuit part 2 is disposed on one side of changeover switch 5 in the first direction.

It has a part 20 and a first secondary terminal part (not numbered) electrically connected to a changeover switch 5 (a first-side terminal part 500 described later) and a relay circuit part 6. In the first circuit part 2 of the present embodiment, first primary terminal part 20 also serves as a first secondary terminal part.

In the first circuit part 2, first primary terminal part 20 is disposed toward one side in the second direction, and is connectable to first primary terminal part 20 in a direction extending from first primary terminal part 20 to one side in the second direction with the first power supply P10 (in the present embodiment, the first power distribution path P11) and the first conductive P110 connected to first primary terminal part 20.

The first circuit part 2 includes a first electric device 22, a first conductive connection part 23 fixed to the first electric device 22 so as to be electrically connected to the first conductive P110, and a partition member 24 for preventing a short circuit of first conductive connection part 23.

The first electrical device 22 is a terminal block. Further, the first electric device 22 is a terminal block including a first primary terminal part 20 electrically connected to the first power supply system P1, and a first power distribution path P11 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 includes a device primary terminal part 220 capable of fixing the first conductive P110, and a device secondary terminal part (not numbered) capable of fixing first conductive connection part 23. In the first electric device 22, the device primary terminal part 220 also serves as a device secondary terminal part.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and first conductive connection part 23 are fixed to the device primary terminal part 220, the first conductor P110 and first conductive connection part 23 are electrically connected to each other. The device primary terminal part 220 of the present embodiment is configured such that the first conductive P110 and first conductive connection part 23 can be fixed by screws.

In addition, the equipment primary terminal part 220 may be configured to conduct each other by directly contacting the first conductive P110 and first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

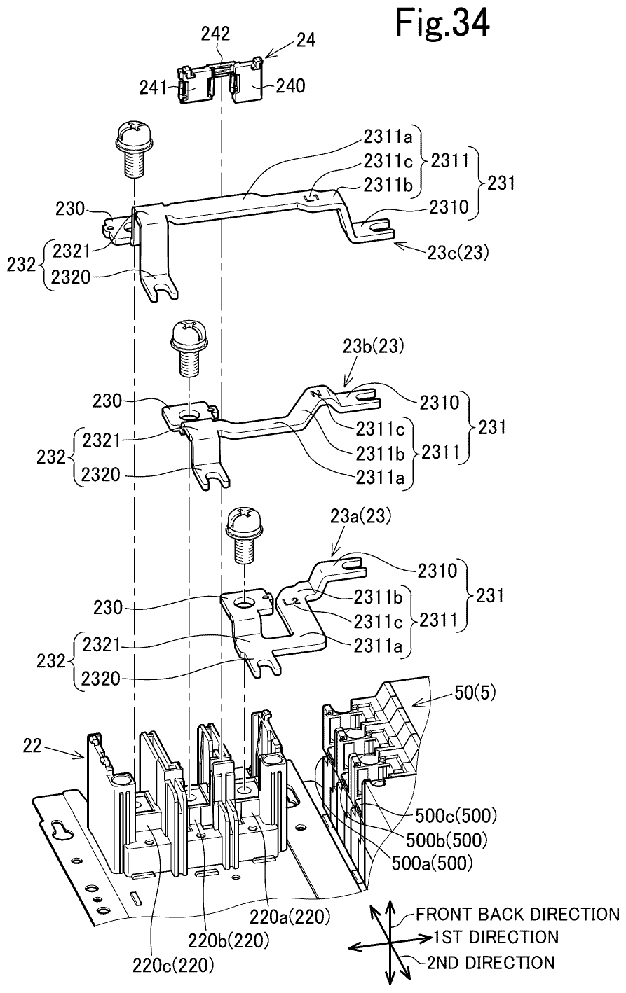

As shown in FIG. 34, first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the distal end side of the connection fixing part 230 is branched into the other side in the second direction and the other side in the first direction in first conductive connection part 23. First conductive connection part 23 of the present embodiment is made of a conductive plate material.

The first conductive part 231 includes a end part 2310 fixed to a first-side terminal part 500 of changeover switch 5, which will be described later, and a intermediate part 2311 that is contiguous with end part 2310 and the second conductive part 232 (a intermediate part 2321 of the second conductive part 232, which will be described later).

The first conductive part 231 intermediate part 2311 is a part interposed between the second conductive part 232 and end part 2310 of the first conductive part 231. Intermediate part 2311 of the first conductive part 231 of the present embodiment includes a proximal end side conductive part 2311a disposed between the first electric device 22 and the relay circuit part 6 (the other side in the second direction than the first electric device 22), a distal end side conductive part 2311b disposed between the first electric device 22 and changeover switch 5 (the other side in the first direction than the first electric device 22), and an identification 2311c attached to a front surface (one surface disposed toward the front side in the front-rear direction) of the distal end side conductive part 2311b. The identification 2311c may be formed by digging in intermediate part 2311 of the first conductive part 231 by direct marking, or may be formed by printing with a laser or the like.

The identification-display 2311c indicates the type of first conductive connection part 23. The identification-display 2311c of the present embodiment is constituted by characters of “L1” indicating L1 phase, “N” indicating the N phase, and “L2” indicating L2 phase.

The second conductive part 232 includes a end part 2320 fixed to a relay primary terminal part (relay device primary terminal part) of the relay circuit part 6, which will be described later, and a intermediate part 2321 connected to end part 2320 and the connecting fixing part 230.

Here, the first circuit part 2 has three first conductive connection part 23 corresponding to the numbers of the device primary terminal part 220. The three first conductive connection part 23, respectively, first conductive connection part 23 for the first phase (first phase conductive connection 23a), first conductive connection part 23 for the second phase (second phase conductive connection 23b), first conductive connection part 23 for the third phase (third phase conductive connection 23c).

The three first conductive connection part 23 are arranged such that the respective second conductive part 232 are aligned in the first direction in the front view.

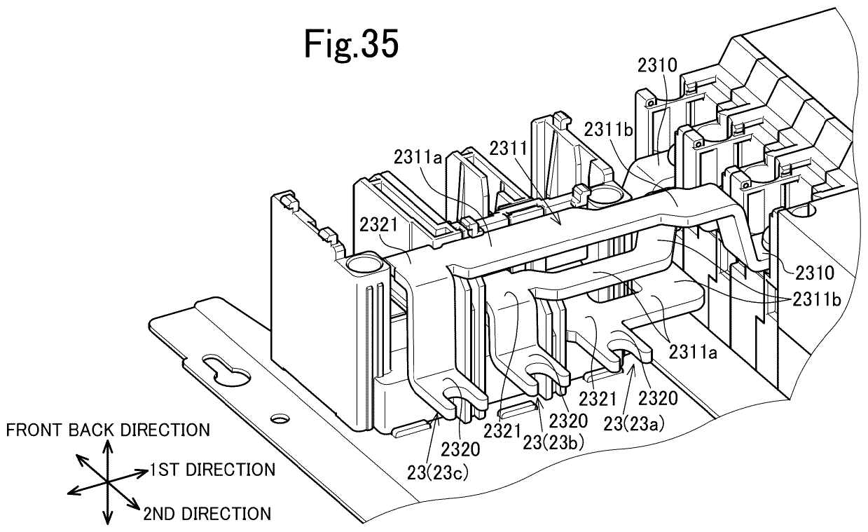

As shown in FIG. 35, intermediate part 2321 of each second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second 232 for the first phase, which is disposed on the most other side in the first direction, is disposed on the most rear side in the front-rear direction.

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the third phase conductive connection part 23c (conductive connection part 23 for the third phase (L1 phase)) is disposed on the most front side in the front-rear direction, and the distal end side conductive part 2311b included in the first phase conductive connection part 23c (conductive connection part 23 for the first phase (L1 phase)) is disposed on one side in the front-rear direction with respect to the distal end side conductive part 2311b included in the second phase conductive connection part 23b (conductive connection part 23 for the second phase (N-phase)) is disposed on one side in the front-rear direction and in the second direction with respect to the distal end side conductive part 2311b included in the third phase conductive connection part 23c, and the distal end side conductive part 2311b included in the first phase conductive connection part 23b and the third phase conductive connection part connection part is disposed on one side in the front-rear direction and in the second direction with respect to the distal end side conductive part 2311b included in the second phase conductive connection part connection part.

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the second phase conductive connection part 23b is also arranged so as to cross the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

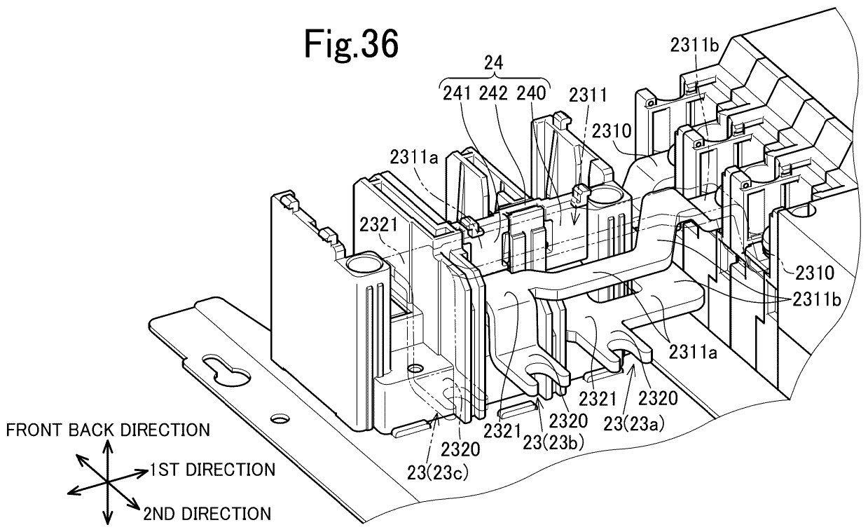

More specifically, as shown in FIG. 36, the partition member 24 has a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 33, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the first direction, and is connectable to second primary terminal part 30 in a direction extending from second primary terminal part 30 to the other side in the first direction with the second power supply P20 (the second power distribution path P22 in the present embodiment) and the second conductor P220 connected to second primary terminal part 30.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The equipment primary terminal part 320 and the equipment secondary terminal part 321 are arranged side by side in a first direction, and the arrangement position of the equipment primary terminal part 320 in the second direction and the arrangement position of the equipment secondary terminal part 321 in the second direction are the same. Further, in the present embodiment, the second electric device 32 is arranged such that the device primary terminal part 320 faces the other side of the first direction and the device secondary terminal part 321 faces the one side of the first direction.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductor P220 of the second distribution path P22 is fixed to the equipment primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductor P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the second direction, and the first phase terminal part 321a of the device secondary terminal part 321, the second phase terminal part 321b, and the third phase terminal part 321c are also arranged to align with each other in the second direction.

The second conductive connection part 33 is formed so as to extend along the first direction (i.e., formed in a straight line shape). One longitudinal end of the second conductive connection part 33 is fixed to the device secondary terminal part 321.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, since the first phase terminal part 321a, the second phase terminal part 321b, and the third phase terminal part 321c of the device secondary terminal part 321 are arranged so as to be aligned along the second direction, the three second conductive connection part 33 are also arranged along the second direction while being fixed to the first phase terminal part 321a, the second phase terminal part 321b, and the third phase terminal part 321c, respectively.

The second electric apparatus of the present embodiment is a circuit breaker. Therefore, in a state in which the second conductive terminal part 320 is fixed with the second conductor P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading equipment 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

The load device primary terminal part 420 and the load device secondary terminal part 421 are arranged side by side in the first direction, the load device primary terminal part 420 is provided at one end of the load device 42 in the first direction, and the load device secondary terminal part 421 is provided at the other end of the load device 42 in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical device 42 is arranged side by side in the second direction with respect to the second circuit part 3, and the load device primary terminal part 420 of the load electrical device 42 and the device secondary terminal part 321 of the second electrical device 32 are arranged in the second direction, and the load device secondary terminal part 421 of the load electrical device 42 and the device primary terminal part 320 of the second electrical device 32 are arranged in the second direction. In the present embodiment, the load electrical device 42 is disposed at a position spaced apart from the second electrical device 32 in the second direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged so as to be aligned in the second direction, and the first phase terminal part 421a, the second phase terminal part 421b, and the third phase terminal part 421c of the load device secondary terminal part 421 are also arranged so as to be aligned in the second direction.

The load conductive connection part 43 is formed so as to extend along the first direction (i.e., is straight), and one end part in the longitudinal direction is fixed to the load primary terminal part 40.

The load circuit part 4 has three load conductive connection part 43 corresponding to the numbers of the first phase terminal part 420a, the second phase terminal part 420b, and the third phase terminal part 420c. The three load conductive connection part 43 are also a load conductive connection part 43 for the first phase (first phase conductive connection 43a), a load conductive connection part 43 for the second phase (second phase conductive connection 43b), and a load conductive connection part 43 for the third phase (third phase conductive connection 43c), respectively.

As described above, since the first phase terminal part 420a, the second phase terminal part 420b, and the third phase terminal part 420c of the load device primary terminal part 420 are arranged to be aligned along the second direction, the three load conductive connection part 43 are arranged to be aligned along the second direction in a state where they are fixed to the first phase terminal part 420a, the second phase terminal part 420b, and the third phase terminal part 420c, respectively.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching body part 50 that switches between the first circuit part 2 and the second circuit part 3 and the load circuit part 4, and a switching control part 51 that operates the switching body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500, the second side terminal part 501, and the load-side terminal part 502 are provided at separate ends in the first direction of changeover switch 5. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction.

Further, the second side terminal part 501 and the load side terminal part 502 are arranged side by side in the second direction in the same direction in the first direction, the second side terminal part 501 and second secondary terminal part 31 face each other in the first direction, and the load side terminal part 502 and the load primary terminal part 40 face each other in the first direction.

In the present embodiment, the second side terminal part 501 is disposed on one side in the second direction, and the load-side terminal part 502 is disposed on the other side in the second direction. Furthermore, the arrangement position of the second side terminal part 501 of the present embodiment in the first direction and the arrangement position of the load-side terminal part 502 in the first direction are different from each other. More specifically, the second side terminal part 501 is arranged to be located on one side of the load-side terminal part 502 in the first direction.

The first phase terminal part 500, the first phase terminal part 500a, the second phase terminal part 500b, and the third phase terminal part 500c are arranged in order in the second direction, and the first phase terminal part 501a of the second side terminal part 501, the second phase terminal part 501b, and the third phase terminal part 501c are arranged in order in the second direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b, 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

In addition to the second-side terminal part 501, in each of the device secondary terminal part 321, the load-side terminal part 502, and the load-device primary terminal part 420 of the load electrical device 42 of the second electrical device 32, the first-phase terminal part 321a, 502a, 420a, the second-phase terminal part 321b, 502b, 420b, and the third-phase terminal part 321c, 502c, 420c are arranged so as to be aligned in the second direction.

Further, the second-side terminal part 501 and the device secondary terminal part 321 of the second electric device 32 are configured such that the first phase terminal part 501a, 321a of each other oppose each other in the first direction, the second phase terminal part 501b, 321b of each other oppose each other in the first direction, and the third phase terminal part 501c, 321c of each other oppose each other in the first direction.

Note that the second-side terminal part 501 and the device secondary terminal part 321 of the second electric device 32 may be opposed to each other in a positional relationship, or may be substantially opposed to each other without being perfectly opposed to each other.

For example, the first phase terminal part 501 first phase terminal part 501a of the second electrical equipment 32 and the first phase terminal part 321 of the second electrical equipment 32 terminal part 321a is arranged so that at least a part is opposed in the first direction, the second phase terminal part 501 second phase terminal part 501b of the second electrical equipment 32 second phase terminal part 321 terminal part 321b, the third phase terminal part 501c of the second side terminal part 501 and the second device of the second electrical equipment 32 the third phase terminal part 321c 321 also, at least a part is opposed in the first direction, the second side terminal part 501 and the device secondary terminal part 321 of the second electrical equipment 32 may be arranged.

Further, for example, if the first phase terminal part 501a of the second side terminal part 501 and the first phase terminal part 321 of the second electric device 32 are arranged so that at least a part of the first phase terminal part 321a of the second electric device 32 is opposed to each other in the first direction, the direction of the second side terminal part 501 of the first phase terminal part 501a of the second electric device 32 and the direction of the first phase terminal part of the second electric device 32 terminal part 321a of the second electric device 32 may intersect, and the direction of the second phase terminal part 501b of the second side terminal part 501 and the direction of the second phase terminal part 321b of the second electric device 32, the direction of the third phase terminal part 501c of the second side terminal part 501 and the direction of the third phase terminal part 321c of the device secondary terminal part 321 of the second electric device 32 may also intersect.

The load-side terminal part 502 and the load device primary terminal part 420 of the load electric device 42 are configured such that the first phase terminal part 502a. 420a of each other oppose each other in the first direction, the second phase terminal part 502b, 420b of each other oppose each other in the first direction, and the third phase terminal part 502c, 420c of each other oppose each other in the first direction. Note that the load-side terminal part 502 and the load device primary terminal part 420 of the load electric device 42 may be opposed to each other in a positional relationship, or may be substantially opposed to each other without being perfectly opposed to each other.

Note that the load-side terminal part 502 and the load device primary terminal part 420 of the load electric device 42 may be opposed to each other in a positional relationship, or may be substantially opposed to each other without being perfectly opposed to each other.

For example, the first phase terminal part 502 terminal part 502a and the first phase terminal part 420 of the load electrical device 42 may be arranged so that at least some of the first phase terminal part 420a are facing in one direction, the second phase terminal part 502b of the load terminal part 502 and the second phase terminal part 420b of the load electrical device 42 primary phase terminal part 420, the third phase terminal part 502c of the load side terminal part 502 and the third phase terminal part 420c 420 of the load electrical device 42 may also be arranged so that at least some of the third phase 420b in one direction are facing each other, and the load side terminal part 502 and the load electrical device primary terminal part 420 of the load electrical device 42.

In addition, in the second direction, in the band-like area A that extends in a first direction from the first phase terminal part 500a of the first side terminal part 500 and the first phase terminal part 501a of the second side terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side than terminal part 500, and second secondary terminal part 31 is arranged in the second direction on the other side of the first side than terminal part 501.

Therefore, changeover switch 5 of the present embodiment is disposed between the first circuit part 2 and the second circuit part 3 in the first direction. Specifically, as shown in FIG. 33, changeover switch 5 is disposed between the first circuit part 2 and the second circuit part 3 which are disposed at the same position in the second direction by being disposed in the band-shaped area A extending in the first direction.

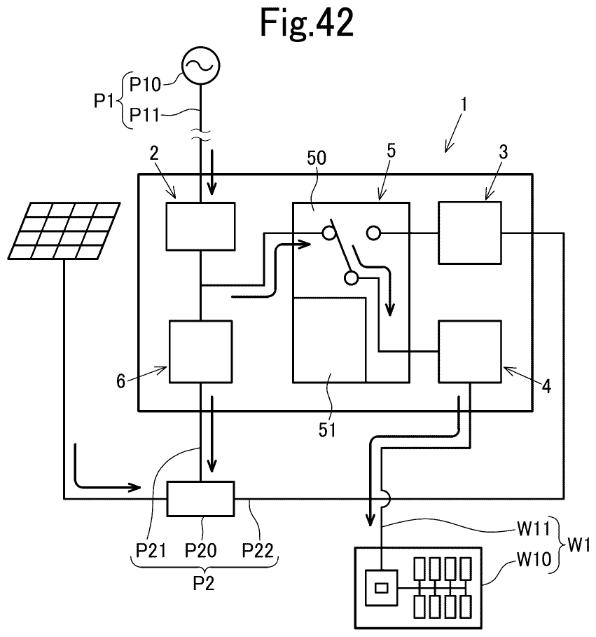

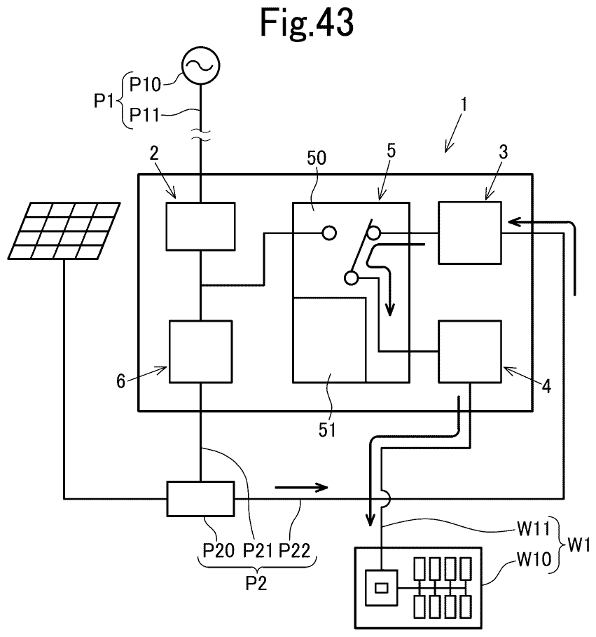

As shown in FIG. 42, the switching body 50 is switchable between a state in which the first side terminal part 500 and the load side terminal part 502 are electrically connected to each other and the second side terminal part 501 and the load side terminal part 502 are electrically disconnected from each other (first power supply state), and a state in which the first side terminal part 500 and the load side terminal part 502 are electrically disconnected from each other and the second side terminal part 501 and the load side terminal part 502 are electrically connected to each other (second power supply state) as shown in FIG. 43, and the switching control part 51 is configured to switch the first power supply state and the second power supply state by operating the switching body 50.

The switching control part 51 may be configured to automatically switch the first power supply state and the second power supply state of the switching body 50 according to the respective power supply states, but may be configured to manually switch between the first power supply state and the second power supply state, or may be configured to switch between the first power supply state and the second power supply state by remote control from the outside.

Further, for example, the switching control part 51 may be configured to switch the switching body part 50 from the first power supply state to the second power supply state when it is detected that the power supply from the first power supply system P1 is interrupted, and to switch the switching body part 50 from the second power supply state to the first power supply state when it is detected that the power supply from the first power supply system P1 is restored.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 321 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

In the relay electric device 62, the first phase terminal part 620a, the second phase terminal part 620b, and the third phase terminal part 620c are arranged in the first direction (so as to be aligned), and the first phase terminal part 621a, the second phase terminal part 621b, and the third phase terminal part 621c are also arranged in the first direction (so as to be aligned).

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 621 of the relay electrical device 62) in the second direction, and to be within the band-shaped area B extending in the first direction.

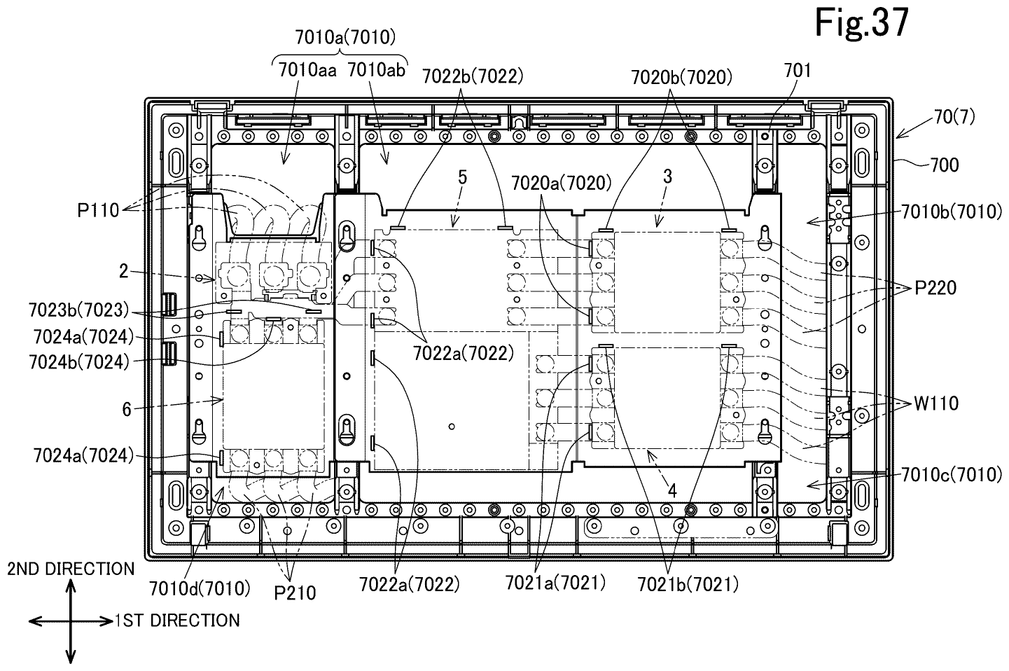

As shown in FIG. 37, the housing 7 includes a housing part 70 capable of housing the first circuit part 2, the second circuit part 3, the loading circuit part 4, changeover switch 5, and the relay circuit part 6 therein, and an inner lid part 71 (see FIG. 32) attached to the front surface of the housing part 70. Although not shown in FIG. 37, the housing 7 includes an outer lid part that covers the inner lid part 71 attached to the front surface of the housing part 70.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of the first electric device 22 in the second direction relative to first primary terminal part 20 or changeover switch 5 (in the present embodiment, on one side of the first electric device 22 in the second direction). Therefore, the first conductor insertion part 7010a allows the first conductor P110 to be inserted into and out of the housing 7 on one side of first primary terminal part 20 or changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric equipment 22, and the switching-side first conductor insertion part 7010ab is disposed directly above changeover switch 5 and the second electric device 32. In the present embodiment, as shown in FIG. 33, the first conductor P110 is inserted inside the housing 7 via the first-side first conductor insertion part 7010aa.

The second conductive insertion part 7010b is provided on the other side in the first direction than the device primary terminal part 320 of the second electric device 32. Therefore, the second conductor insertion part 7010b allows the second conductor P220 to be inserted into and out of the housing 7 on the other side in the first direction than the device primary terminal part 320 of the second electric device 32.

Further, the second conductor insertion part 7010b is disposed on the other side of the second electric device 32 in the first direction in the band-shaped area A, and the arrangement position in the second direction is the same position as the arrangement position in the second direction of the second conductor insertion part 7010b.

The load conductor insertion part 7010c is provided on the other side of the load device secondary terminal part 421 of the load electric device 42 in the first direction. Therefore, the load conductor insertion part 7010c allows the load conductor W110 to be inserted into and out of the housing 7 on the other side of the load device secondary terminal part 421 of the load electric device 42 in the first direction.

Further, the load-conductor insertion part 7010c and the second conductor insertion part 7010b are formed at positions aligned in the second direction, and are formed so as to be continuous with each other.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction.

The positioning structure 702 includes a second circuit part positioning part 7020 for positioning the second circuit part 3 with respect to the back surface part 701, a load circuit part positioning part 7021 for positioning the load circuit part 4 with respect to the back surface part 701, a changeover switch positioning part 7022 for positioning changeover switch 5 with respect to the back surface part 701, a first circuit part positioning part 7023 for positioning the first circuit part 2 with respect to the back surface part 701, and a relay circuit part positioning part 7024 for positioning the relay circuit part 6 with respect to the back surface part 701.

The second circuit part positioning part 7020 of the present embodiment is configured to position the second electrical device 32.

Further, the second circuit part positioning part 7020 is configured to abut on two intersecting side surfaces of the second electrical device 32. More specifically, the second circuit part positioning part 7020 has a first contact part 7020a that protrudes from the back surface part 701 toward the front side in the front-rear direction and abuts on the side surface of the second electric device 32 on the one side in the first direction, and a second contact part 7020b that protrudes from the back surface part 701 toward the front side in the front-rear direction and abuts on the side surface of the second electric device 32 on the one side in the second direction.

Load circuit part positioning part 7021 is configured to position the load electric device 42.

In addition, the load circuit part positioning part 7021 is configured to abut on two intersecting side surfaces of the load electric device 42. More specifically, the load circuit part positioning part 7021 includes a first contact part 7021a that protrudes from the back surface part 701 toward the front side in the front-rear direction and abuts on a side surface of the load electrical device 42 on one side in the first direction, and a second contact part 7021b that protrudes from the back surface part 701 toward the front side in the front-rear direction and abuts on a side surface of the load electrical device 42 on one side in the second direction.

The changeover switch positioning part 7022 is configured to abut two intersecting sides of changeover switch 5. More specifically, the changeover switch positioning part 7022 has a first contact part 7022a that protrudes from the back surface part 701 toward the front side in the front-rear direction and abuts on the side surface on one side in the first direction of changeover switch 5, and a second contact part 7022b that protrudes from the back surface part 701 toward the front side in the front-rear direction and abuts on the side surface on one side in the second direction of changeover switch 5.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The inner lid part 71 is attached to the housing part 70 and is configured to cover the front surfaces of the first circuit part 2, the second circuit part 3, the loading circuit part 4, changeover switch 5, and the relay circuit part 6. Further, in the middle cover part 71 of the present embodiment, the windows 710 are formed in accordance with the positions of the non-charging part of the second circuit part 3 (specifically, the operation part of the second electric device 32), the non-charging part of the load circuit part 4 (specifically, the operation part of the load electric device 42), and the non-charging part of the relay circuit part 6 (specifically, the operation part of the relay electric device 62).

The second electric device 32 and the load electric device 42 are arranged in a state in which the operation direction of the operation part is aligned with the first direction, and the relay electric device 62 is arranged in a state in which the operation direction of the operation part is aligned with the second direction. As described above, the second electric appliance 32 and the load electric appliance 42 arranged at the positions close to each other are arranged so that the operation direction of the operation part is the same, and the relay electric appliance 62 arranged at the position away from the second electric appliance 32 and the load electric appliance 42 is arranged so that the operation direction of the operation part is different from the operation direction of the operation part of the second electric appliance 32 and the load electric appliance 42.

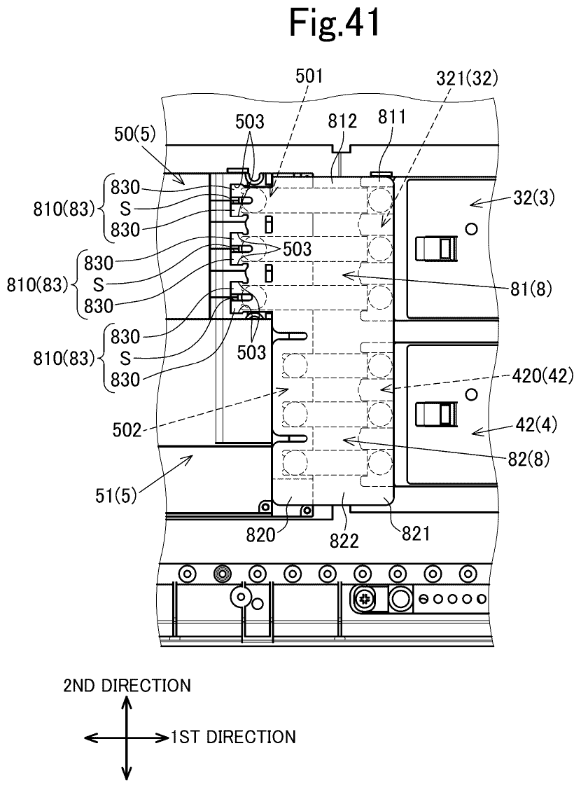

As shown in FIG. 38, the cover structure 8 includes a first cover part 80 that covers first conductive connection part 23, a second cover part 81 that covers the second conductive connection part 33, and a third cover part 82 that covers the loaded conductive connection part 43. Although the second cover part 81 and the third cover part 82 of the present embodiment are integrally formed, the second cover part 81 and the third cover part 82 may be separate members (see FIG. 41).

The first cover part 80 includes a first protection part 800 that covers the proximal end part of the first conductive part 231, and a second protection part 801 that covers the distal end part of the first conductive part 231 and the second conductive part 232.

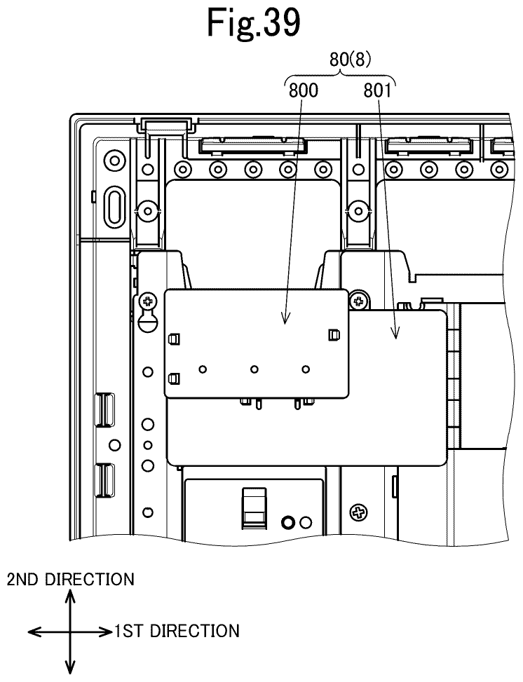

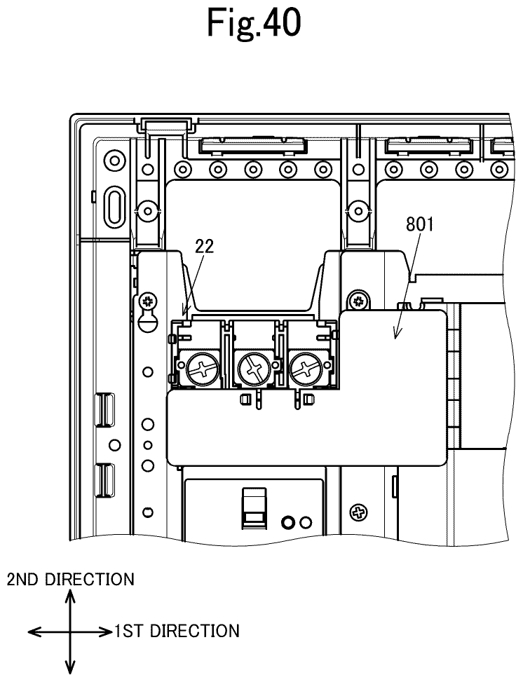

The first protective part 800 and the second protective part 801 are detachable separately, in a state where the second protective part 801 covers the distal end side and the second conductive part 232 than the proximal end part of the first conductive part 231 from the front side, the first protective part 800 covers the proximal end part of the first conductive part 231 from the front side and a closed state, the first protective part 800 is configured to be switchable to an open state of opening the front of the proximal end part of the first conductive part 231 (see FIGS. 39 and 40).

Further, in a state in which both the first protection part 800 and the second protection part 801 are installed, the first protection part 800 is disposed on the front side in the front-rear direction relative to the second protection part 801, and the outer peripheral edge part of the first protection part and the outer peripheral edge part of the second protection part 801 are in a state of part overlapping with each other.

As shown in FIG. 41, the second cover part 81 includes a first protection part 810 that covers the front of the second side terminal part 501, a second side protection part 811 that covers the front of the device secondary terminal part 321 of the second electric device 32, and an intermediate protection part 812 that covers the front of the area between the second side terminal part 501 and the device secondary terminal part 321 of the second electric device 32.

The third cover part 82 has a first protection part 820 covering the front of the load side terminal part 502, a second side protection part 821 covering the front of the load device primary terminal part 420 of the load electrical device 42, and an intermediate protection part 822 covering the front of the area between the load side terminal part 502 and the load device primary terminal part 420 of the load electrical device 42.

The second cover part 81 and the third cover part 82 are configured to be externally attachable to changeover switch 5, and the cover structure 8 of the present embodiment has a cover-side engagement part 83 that secures the second cover part 81 and the third cover part 82 to the switching body part 50 while engaging with the switching body part 50 in order to securely attach and fix the second cover part 81 and the third cover part 82 to changeover switch 5 (to reliably prevent the second cover part and the third cover part from being detached from changeover switch 5).

In the cover structure 8 of the present embodiment, the second cover part 81 and the third cover part 82 are integrally formed, and the cover-side engagement part 83 is provided in the second cover part 81.

The cover-side engaging part 83 is configured to be erected at a position adjacent to terminal part of the second side terminal part 501 in the second direction and to be engaged between a pair of insulating walled parts 503 opposed to each other in the second direction.

The cover-side engaging part 83 of the present embodiment has a pair of flexible engaging parts 830 which are flexible and arranged in a direction in which the pair of insulating wall parts 503 are arranged (second direction in the present embodiment).

The cover-side engagement part 83 of the present embodiment is constituted by the first protection part 810 of the second cover part 81. In the second cover part 81, the first protection part 810 is formed so as to extend outward from the intermediate protection part 812, and the first protection part 810 is formed with a slit S extending from the distal end toward the proximal end side.

Therefore, in the second cover part 81, part on one side (one side in the second direction) of the first protection part 810 relative to the slit S constitutes one flexible engagement part 830, and part on the other side (the other side in the second direction) of the first protection part 810 relative to the slit S constitutes the other flexible engagement part 830. That is, the pair of flexible engagement parts 830 are arranged in the second direction via the slit S.

Note that, as described above, since the second-side terminal part 501 of changeover switch 5 includes the second-side terminal part 501 (first phase terminal part 501a) for the first phase, the second-side terminal part 501 (second phase terminal part 501b) for the second phase, and the second-side terminal part 501 (third phase terminal part 501c) for the third phase, the cover construction 8 is configured to have three cover-side engagement parts 83.

As described above, in the cover configuration 8, the cover-side engagement part 83 engages with the switching body part 50 (the pair of opposing insulating wall parts 503 for the second-side terminal part 501 in the present embodiment), so that the second cover part 81 and the third cover part 82 can be maintained attached to the switching body part 50.

In addition, if the slit S is formed between the pair of flexible engagement parts 830 as in the cover-side engagement part 83 of the present embodiment, the pair of flexible engagement parts 830 can easily be disposed between the insulating wall parts 503 that are allowed to move.

In the present embodiment, the cover-side engaging part 83 is formed only in the second cover part 81 of the second cover part 81 and the third cover part 82, the cover-side engaging part 83 may be formed in the second cover part 81 and the third cover part 82, and in the case where the second cover part 81 and the third cover part 82 are integrally formed, the cover-side engaging part 83 may be formed only in the third cover part 82.

As described above, according to changeover switch built-in board 1 of the present embodiment, the first changeover switch 5 and the relay circuit part 6, which are arranged in the first direction with respect to the first circuit part 2 (in the present embodiment, changeover switch 5), can connect the first conductive part 231 to the first side terminal part 500 along the first direction because the first conductive part 231 extending in the first direction has terminal part (the first side terminal part 500) facing end part 2310 in the first direction.

Of changeover switch 5 and the relay circuit part 6, those aligned in the second direction with respect to the first circuit part 2 (the relay circuit part 6 in the present embodiment) have the relay primary terminal part 60 facing end part 2320 of the second conductive part 232 extending in the second direction in the second direction, so that the second conductive part 232 can be connected to the relay primary terminal part 60 along the second direction.

As described above, since the first conductive part 231 and the second conductive part 232 can be connected along the first direction or the second direction in which changeover switch 5 or the relay circuit part 6 is aligned with the first circuit part 2, it is possible to reduce the size of changeover switch built-in board 1.

In first conductive connection part 23 of the present embodiment, since the first conductive part 231 is formed so that the proximal conductive part 2311a extends straight from the second conductive part 232 toward the connection target (the first side terminal part 500), the first conductive part 231 may not be oriented with respect to the direction in which the second conductive part 232 extends from the connection fixing part 230. Therefore, in the present embodiment, the space between the first electrical device 22 and the relay electrical device 62 is reduced.

In addition, in changeover switch built-in board 1 of the present embodiment, since first conductive connection part 23 is formed of a plate material having conductivity, first conductive connection part 23 can be formed in a configuration along the wire path, and the space required for changing the direction of first conductive connection part 23 can be reduced.

Further, in changeover switch built-in board 1 of the present embodiment, the base end part side (intermediate part 2321) of the second conductive part 232 is formed so as to be located on the front side in the front-rear direction of the connecting fixing part 230 and conductive part 232 in end part 2320, and the space on the rear side of the first conductive part 231 can be used as a space for, for example, a wire or the like because the first conductive part 231 branches from intermediate part 2321 of the second conductive part 232 toward the first direction.

Further, the plurality of first conductive connection part 23 can be prevented from spreading in the second direction because the proximal conductive part 2311a of the respective first conductive connection part 23 are arranged in a row in the front-rear direction.

In particular, the three proximal conductive part 2311a can be arranged closer to each other in the front-rear direction and the plurality of second conductive part 232 can be arranged closer to each other in the first direction because they are arranged side by side from the front side to the rear side in the front-rear direction in order from the one extending from the second conductive part 232 which is arranged at the one-most position in the first direction (the position farthest from changeover switch 5 in the first direction). As a result, it is possible to suppress the extension of the space in which the plurality of first conductive connection part 23 are arranged in the first direction.

Further, in changeover switch built-in board 1 of the present embodiment, since the identification display 2311c attached to the front surface of each of the front-end-side conductive part 2311b is configured to be exposed to the front side, the identification display 2311c attached to each of the plurality of first conductive connection part 23 becomes easy to see, and the type of each of first conductive connection part 23 becomes easy to distinguish.

The cover structure 8 of the board 1 with a changeover switch of this embodiment is provided with the first cover part 80 which has the first protection part 800 which covers the connection fixing part 230 from a front side, and the second protection part 801 which covers the first conductive part 231 and the second conductive part 232 from a front side, and the second protection part 801 covers the first conductive part 231 and the second conductive part 232 from a front side, Since the first protection part 800 is configured to be switchable between a closed state in which the first protection part 800 covers the connection fixing part 230 from the front side and an open state in which the front of the connection fixing part 230 of the 2 conductive part 232 is opened, only the first protection part 800 is opened to the terminal block Since only the front of the connection fixing part 230 to which the fixed first power supply system P1 is connected is opened, the operation of the connection fixing part 230 can be safely performed while the other part of the first conductive connection part 23 is covered with the second protective part 801.

Further, in changeover switch built-in board 1 of the present embodiment, the first side terminal part 500 can be electrically connected to the first circuit part 2 on one side in the first direction, the second side terminal part 501 can be electrically connected to the second circuit part 3 on the other side in the first direction, and the second side terminal part 501 and second secondary terminal part 31 are arranged so as to face each other in the first direction, so that the second side terminal part 501 and second secondary terminal part 31 can be electrically connected to each other by arranging the second conductive connection part 33 in a straight line in the first direction when the second side terminal part 501 and OOH 31 are electrically connected using the second conductive connection part 33.

Specifically, the first phase terminal part 501a, the second phase terminal part 501b, and the third phase terminal part 501c of the second side terminal part 501 are arranged linearly in the first direction so as to face the first phase terminal part 321a, the second phase terminal part 321b, and the third phase terminal part 321c of the device secondary terminal part 321, respectively, so that the second side terminal part 501 and second secondary terminal part 31 can be electrically connected with the first phase conductive connection part 33a, the second phase conductive connection part 33b, and the third phase conductive connection part 33c arranged in the second direction.

In addition, in changeover switch built-in board 1 of the present embodiment, the second conductor P220 is inserted from the outside to the inside of the housing 7 via the second conductor insertion part 7010b, and is connected to the device primary terminal part 220 in the first direction, and the device secondary terminal part 321 and the second-side terminal part 501 can be connected to each other via the second conductive connection part 33 that is linear in the first direction, thereby facilitating the wiring operation and simplifying the wiring path.

Further, in the present embodiment, since the second conductor insertion part 7010b is provided on the other side in the first direction than the second electric device 32 in the band-shaped area A, the second conductor P220 is introduced into the housing 7 from the opposite side in the second conductor insertion part 7010b, and the second conductor P220 can be connected to the device primary terminal part 320 from the other side in the first direction. Therefore, in the present embodiment, without significantly changing the direction of the second conductor P220, since it is possible to perform the operation of connecting the second conductor P220 to the device primary terminal part 320 from the operation of introducing the second conductor P220 into the housing 7, the second conductor P220 can be connected easily and smoothly to the second electric device 32, thereby, it is possible to easily perform the wiring operation.

Further, first primary terminal part 20 is disposed toward one side in the second direction perpendicular to the first direction and the front-rear direction, the first electric device 22 or changeover switch 5 is a terminal block on one side in the second direction, since the first conductor insertion part 7010a is provided, the first conductor insertion part from 7010a of the first conductor insertion part without significantly changing the direction of the first conductor P110 to introduce the first conductor P110 to the inside of the housing 7, the first conductor P110 can be connected to first primary terminal part 20, the first conductor P110 can be easily and smoothly connected to the first electric device 22, thereby, it is possible to easily perform the wiring operation.

Further, in the present embodiment, first primary terminal part 20 is disposed toward one side in the second direction, the first-side first conductor insertion part 7010aa is disposed on one side (directly above) in the second direction of the terminal block as the first electric device 22, and the switching-side first conductor insertion part 7010ab is disposed on one side (directly above) in the second direction of changeover switch 5 and the second electric device 32. The first conductor P110 introduced into the inside of the housing 7 is connected to first primary terminal part 20 via the first-side first conductor insertion part 7010aa. Therefore, the first conductive P110 and first primary terminal part 20 can be easily connected in the second direction.

Therefore, since the second-side terminal part 501 and second secondary terminal part 31 are arranged so as to face each other in one direction, the interconnection path can be simplified when changeover switch 5 and the second circuit part 3 are electrically connected to each other.

In addition, since the second-side terminal part 501 and the load-side terminal part 502 are arranged so as to be aligned in the first direction while facing the other side in the first direction in the second direction, the second-side terminal part 501 and the load-side terminal part 502 can be separated in the second direction, so that the second-side terminal part 501 and the load-side terminal part 502 can be electrically connected to each other (that is, an insulating distance can be secured). Further, in the first direction, the second side terminal part 501 and second secondary terminal part 31 can be electrically connected, the load side terminal part 502 and the load primary terminal part 40 can be electrically connected, and the second side terminal part 501 and second secondary terminal part 31 can be arranged so as to face each other in the first direction, and the electrical connection between the second side terminal part 501 and second secondary terminal part 31 and the electrical connection between the load side terminal part 502 and the load primary terminal part 40 can be separated from each other because the load side terminal part 502 and the load primary terminal part 40 are arranged so as to face each other in the first direction.

In the present embodiment, the second side terminal part 501 is disposed on one side in the second direction, and the load-side terminal part 502 is disposed on the other side in the second direction. In the second direction, the second electric device 32 and the load electric device 42 are separated from each other in a state in which the second electric device 32 is disposed on one side and the load electric device 42 is disposed on the other side. Thus, the connection between the second side terminal part 501 and second secondary terminal part 31 via the second conductive connection part 33 and the connection between the load side terminal part 502 and the load primary terminal part 40 via the load conductive connection part 43 can be separated in the second direction. Therefore, it is possible to contribute to securing the insulation distance in the second direction.

Since a terminal part of each phase of the second side terminal part 501 and a terminal part of each phase of the load side terminal part 502 can be separated in the second direction, and the terminal part of each phase of the device secondary terminal part 321 and the terminal part of each phase of the load primary terminal part 40 can be separated in the second direction, the short circuit between the phases between the terminal parts can be suppressed, and the second side terminal part 501 and the device secondary terminal part 321 face each other in the first direction of the first phase terminal part 501a, 321a, the second phase terminal parts 501b, 321b of each other face each other in the first direction, the load side terminal part 502 and the load device primary terminal part 420 face each other in the first direction of the first phase terminal part 502a, 420a, and the second phase terminal parts of each other are opposed to each other in the first direction Since 502b, 420b are opposed to each other in the first direction and the third phase terminal parts 502c, 420c are opposed to each other in the first direction, the terminal parts of the respective phases are opposed to each other in the first direction, so that the electric connection can be simplified and the inter-phase short circuit can be suppressed.

In the present embodiment, the second side terminal part 501 is disposed on one side and the load-side terminal part 502 is disposed on the other side in the second direction. Then, as shown in FIG. 33, the first phase terminal part 501a, the second phase terminal part 501b, and the third phase terminal part 501c of the second-side terminal part 501 are arranged in order in the second direction, and the first phase terminal part 502a, the second phase terminal part 502b, and the third phase terminal part 502c of the load-side terminal part 502 are arranged in order in the second direction. Further, as shown in FIG. 33, in the second orientation, the equipment secondary terminal part 321 is located on one side and the loading equipment primary terminal part 420 is located on the other side. Then, as shown in FIG. 33, the first phase terminal part 321a, the second phase terminal part 321b, and the third phase terminal part 321c of the device secondary terminal part 321 are arranged in the second direction, and the first phase terminal part 420a, the second phase terminal part 420b, and the third phase terminal part 420c of the loading device primary terminal part 420 are arranged in the second direction. In addition, the second-side terminal part 501 and the secondary terminal part, each other of the first phase terminal part 501a, 220a facing each other in the first direction, each other of the second phase terminal part 501b, 220b facing each other in the first direction, each other of the third phase terminal part 501c, 220c facing each other in the first direction, the load-side terminal part 502 and the load device primary terminal part 420, each other of the first phase terminal part 502a, 420a facing each other in the first direction, each other of the second phase terminal part 502b, 420b facing each other in the first direction, each other of the third phase terminal part 502c, 420c facing each other in the first direction. Therefore, between the second-side terminal part 501 and the device secondary terminal part 321, and between the load-side terminal part 502 and the load-device primary terminal part 420, the first phase terminal part 502a, 321a, the second phase terminal part 502b, 321b, and the third phase terminal part 502c, 321c are arranged in this order from one side to the other side in the second direction. Therefore, the arrangement of terminal part of each phase in the second direction is easy to understand.

The second-side terminal part 501 and the load-side terminal part 502 are arranged side by side in the second direction so as to face the other side in the first direction, and the second-side terminal part 501 and the first-side terminal part 500 are arranged side by side in the first direction toward the other side in the first direction, so that the first circuit part 2 and the second circuit part 3 are arranged on the one side in the first direction and the other side in changeover switch 5 in the housing 7, respectively, so that the first-side terminal part 500 and the second-side terminal part 501 can be wired in the first direction, so that the space-efficiency and the wiring-efficiency in the housing 7 can be improved while securing the insulating distance between terminal part.

In the present embodiment, the first side terminal part 500 and the second side terminal part 501 are disposed on one side in the second direction, and the load-side terminal part 502 is disposed on the other side in the second direction. Therefore, electricity is supplied to changeover switch 5 on one side in the second direction, and electricity is supplied from changeover switch 5 on the other side in the second direction.

Therefore, the second side terminal part 501 and the load side terminal part 502 can be separated from each other in the second direction, and the electrical connection between the second side terminal part 501 and second secondary terminal part 31 and the electrical connection between the load side terminal part 502 and the load primary terminal part 40 can be separated from each other.

Since first secondary terminal part and second secondary terminal part 31 in the strip area A including the first side terminal part 500 and the second side terminal part 501 are arranged on one side and the other side of the first direction, the first side of changeover switch 5 connected by first conductive connection part 23 to each other terminal part 500 and first secondary terminal part of the first circuit part 2 in the vicinity it is possible to place second secondary terminal part 31 of the second side 501 and the second circuit part 3 of changeover switch 5 in the vicinity, it is possible to simplify the first circuit part 2 and changeover switch 5 and the second circuit part 3 interconnection path.

In this embodiment, the first phase, terminal part 220a, second phase, terminal part 220b, and third phase terminal part 220c of the device primary terminal part 220 as a first secondary terminal part can be placed in the cingulate area A. In addition, the first phase, terminal part 321a, second phase terminal part 321b, and third phase terminal part 321c of the device secondary terminal part 321 as a second secondary terminal part 31 can be placed in the cingulate area A. Therefore, when the first circuit part 2, changeover switch 5, and the second circuit part 3 are electrically connected to each other, the interconnection path can be simplified because terminal part required for the electrical connection between the first circuit part 2, changeover switch 5, and the second circuit part 3 can be arranged in the belt-like area A.

Therefore, the first side terminal part 500 of changeover switch 5 connected by first conductive connection part 23 and first secondary terminal part of the first circuit part 2 can be arranged in the vicinity, the second side terminal part 501 of changeover switch 5 and second secondary terminal part 31 of the second circuit part 3 since it is possible to place in the vicinity, it is possible to simplify the first circuit part 2 and changeover switch 5 and the second circuit part 3 routing path.

Changeover switch built-in board of the present disclosure is not limited to the above-described embodiment, and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply.

For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the load device primary terminal part 420 and the load device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the device primary terminal part 220 of the first electric device 22 is configured to have the first phase terminal part 220a, the second phase terminal part 220b, and the third phase terminal part 220c, but is not limited to this configuration. For example, in the case of having only the first phase terminal part 220a, in addition to the case of having the first phase terminal part 220a and the second phase terminal part 220b, in the case of having the first phase terminal part 220a, the second phase terminal part 220b, and the third phase terminal part 220c, it may also be a case of having the fourth phase terminal part. That is, the device primary terminal part 220 may include at least a first phase terminal part 220a.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

Also in this case, the second conductive part 232 may be integrally formed with the first conductive part 231 as in the above-described embodiment, or may be separately attached to the first conductive part 231.

In the above embodiment, the first circuit part 2 is configured to have three first conductive connection part 23, but is not limited to this configuration, for example, the first circuit part 2 may be configured to have one first conductive connection part 23, or may be configured to have two or four or more first conductive connection part 23. That is, the first circuit part 2 may be configured to have at least one first conductive connection part 23.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2.

As a result, the load circuit part 4 can be electrically disconnected from the first power supply system P1 and the second power supply system P2, and can further improve electric safety such as when inspecting the load device or the like connected to the load circuit part 4.

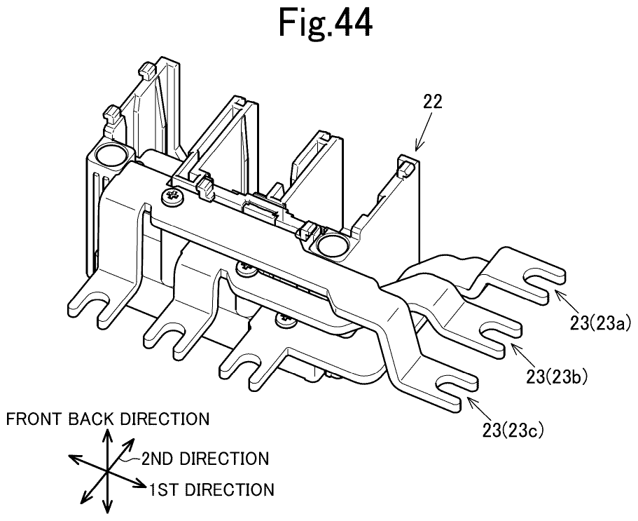

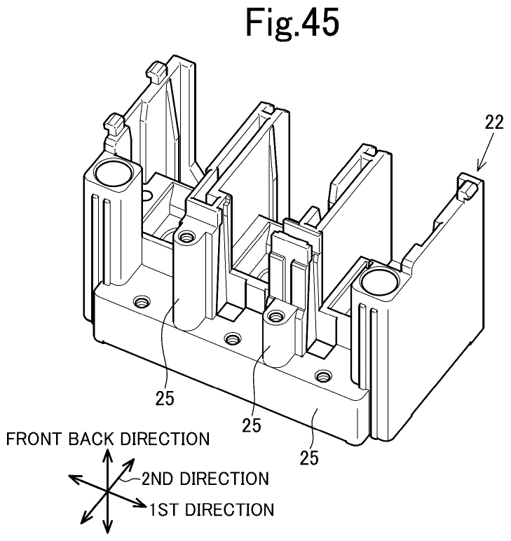

Although not specifically mentioned in the above embodiment, first conductive connection part 23 may be configured so that the second conductive part 232 is also screwed to the first electric device 22. In this case, for example, as shown in FIGS. 44 and 45, the first electrical device 22 may be provided with the fixing base part 25 having the screw hole formed therein.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 extends to the other side in the second direction with respect to the connecting fixing part 230, but is not limited to this configuration. The second conductive part 232 may extend, for example, to one side in the second orientation relative to the connecting fixing part 230. Again, the first conductive part 231 may be configured to extend to the other side of the first direction relative to the connection fixing part 230, and the first conductive part 231 may be configured to extend to the one side of the first direction relative to the connection fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

Further, in the above embodiment, the first side terminal part 500 and the second side terminal part 501 are arranged in a straight line in the first direction and the arrangement positions in the second direction are the same position, but the present invention is not limited thereto, and for example, the arrangement positions of the first side terminal part 500 and the second side terminal part 501 in the second direction may be different from each other.

In the above embodiment, the first electric device 22 is disposed on one side in the first direction with respect to changeover switch 5, and the second electric device 32 is disposed on the other side in the first direction with respect to changeover switch 5. However, the present invention is not limited thereto, and for example, the first electric device 22 may be disposed on one side of changeover switch 5 in the second direction, and the second electric device 32 may be disposed on the other side of changeover switch 5 in the second direction. In addition, it is conceivable that at least the device secondary terminal part 321 and the second-side terminal part 501 face each other in the second direction. In addition, the first phase terminal part 500a, 501a of the first side terminal part 500 and the second side terminal part 501, the second phase terminal part 500b, 501b, and the band-like area A defined by the third phase terminal part 500c, 501c may extend in the second direction.

In the above embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the above embodiment, the second side terminal part 501 and the load side terminal part 502 are arranged in the second direction, and the second side terminal part 501 is arranged on one side in the second direction, and the load side terminal part 502 is arranged on the other side in the second direction, but the present invention is not limited thereto, and for example, the second side terminal part 501 may be arranged on the other side in the second direction and the load side terminal part 502 may be arranged on one side in the second direction. Here, the second circuit part 3 is arranged on the other side in the second direction and the loading circuit part 4 is arranged on the one side in the second direction.

In the description of the strip-shaped area A of the above embodiment, the arrangement position of the first side terminal part 500 and the arrangement position of the second side terminal part 501 in the second direction has been given an example of the same, for example, the arrangement position of the first side terminal part 500 in the second direction and the arrangement position of the second side terminal part 501 are different from each other even in the second direction, the first phase terminal part 500a and the second side terminal part 501 of the first side terminal part 500 in the second direction it may be a strip-shaped area A area extending in a range including up to the third phase terminal part 501c of the third phase terminal part 500c and the second side terminal part 500 of the first side terminal part 501a.

In the above embodiment, changeover switch built-in board 1 includes the relay circuit part 6, but the present invention is not limited thereto, and for example, changeover switch built-in board 1 may not include the relay circuit part 6, and the electric wire from the direct external facility may be connected to the second conductive part 232 of first conductive connection part 23, or the relay circuit part 6 may be provided outside changeover switch built-in board 1. In addition, the first conductive insertion part 7010a may be disposed on the other side of the first circuit part 2 or changeover switch 5 in the second direction. First primary terminal part 20 may be disposed toward the other side in the second direction.

In the load electric device 42 of the above embodiment, the load device primary terminal part 420 is provided at one end of the first direction, and the load device secondary terminal part 421 is provided at the other end of the first direction. However, the present invention is not limited thereto, and for example, in the load electric device 42, the load device primary terminal part 420 may be provided at the other end part in the first direction, and the load device secondary terminal part 421 may be provided at the one end part in the first direction.

In the above embodiment, changeover switch 5 includes the second-side terminal part 501 and the load-side terminal part 502 at the other end in the first direction. However, the present invention is not limited thereto, and for example, changeover switch 5 may include the second-side terminal part 501 and the load-side terminal part 502 at one end in the second direction.

In the above-described embodiment, the second conductive insertion part 7010b is disposed on the other side of second primary terminal part 30 in the first direction. However, the present invention is not limited thereto, and for example, the second conductive insertion part 7010b may be disposed on one side of second primary terminal part 30 in the first direction.

In the above embodiment, the arrangement positions of the device primary terminal part 320 and the device secondary terminal part 321 of the second electric device 32 in the second orientation are the same. However, the present invention is not limited thereto, and for example, the arrangement positions of the device primary terminal part 320 and the device secondary terminal part 321 of the second electric device 32 in the second direction may differ from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, the first conductive insertion part 7010a is provided on one side of first primary terminal part 20 or changeover switch 5 in the second direction. However, the present invention is not limited thereto, and for example, the first conductive insertion part 7010a may be disposed on one side of first primary terminal part 20 in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

The first conductor-insertion part 7010a may be provided in the second direction just above one side of first primary terminal part 20 or just above one side of changeover switch 5.

In the above-described embodiment, as shown in FIG. 33, the positions of the second-side terminal part 501 and the load-side terminal part 502 in the first direction differ from each other. However, for example, the second-side terminal part 501 and the load-side terminal part 502 may be arranged such that their positions in the first direction are the same (that is, they are arranged along an imaginary straight line extending in the second direction).

In the above embodiment, as illustrated in FIG. 33, changeover switch built-in board 1 includes the first circuit part 2, but the present invention is not limited thereto, and for example, the first circuit part 2 may not be provided. In this case, it is conceivable that the first conductor P110 inserted into the housing 7 via the first conductor insertion part 7010a is directly connected to the first-side terminal part 500 of changeover switch 5.

In the second circuit part 3 of the above-described embodiment, second primary terminal part 30 is disposed on the other side in the first direction, but the present invention is not limited thereto, and for example, second primary terminal part 30 may be disposed on the one side in the second direction. Second primary terminal part 30 may be configured to be connectable in a direction in which the second conductor P220 extends from second primary terminal part 30 to one side in the second direction.

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the above embodiment, the arrangement positions of the device primary terminal part 320 and the device secondary terminal part 321 are the same in the second orientation. However, the present invention is not limited thereto, and for example, the device primary terminal part 320 and the device secondary terminal part 321 of the second electric device 32 may be arranged at different positions in the second direction.

In the above embodiment, the load circuit part 4 includes the load electric device 42 as a circuit breaker, but the present invention is not limited thereto, and the load circuit part 4 may be configured to include the power distribution circuit part.

Specifically, the load circuit part 4 may be configured to include a main switch connected to the load side terminal part 502 of changeover switch 5, and a plurality of branch switches connected to the secondary side of the main switch via a bus. The housing 7 is sized to accommodate the power distribution circuit part as well.

Next, a changeover switch built-in board according to another embodiment will be described. Changeover switch built-in board according to the present disclosure incorporates a changeover switch.

As a distribution board which is a conventional changeover switch built-in board, for example, there is a distribution board described in Japanese Patent No. 6351333. The distribution board includes a commercial power supply circuit part and a distributed power supply circuit part. The commercial power supply circuit part comprises a main switch and a number of branch switches plugged into its secondary bus bar. In the distributed power supply circuit part, a switch for a distributed power supply and a changeover switch with a vibration-sensitive relay are arranged. Changeover switch with vibration-sensitive relays has two input-terminals and one output-terminal. The distributed power supply is connected to the primary side of the switch for the distributed power supply, and is further connected from the secondary side of the switch for the distributed power supply to one of the input terminals of changeover switch with vibration-sensitive relays. The other terminal of changeover switch with the vibration-sensitive relay is connected to one branch switch of the commercial power supply circuit part. Furthermore, an emergency circuit is connected as a load to the output terminal of changeover switch with vibration-sensitive relay, and is formed so that the supply from the commercial power supply or the distributed power supply can be switched by changeover switch with vibration-sensitive relay.

However, in the distribution board described in Japanese Patent No. 6351333, changeover switch with vibration-sensitive relay and the switchgear for the distributed power supply are arranged side by side in the left-right direction, and one input terminal of changeover switch with vibration-sensitive relay is arranged downward at the lower end part, whereas the secondary side of the switchgear for the distributed power supply is arranged upward at the upper end part. Therefore, in order to electrically connect one of the input terminals of changeover switch with the vibration-sensitive relay and the secondary side of the switch for the distributed power supply, the wiring needs to be circulated such that one end of the wiring faces upward and the other end faces downward. Therefore, the distribution board described in Japanese Patent No. 6351333 has a complicated wiring path. This is not limited to a distribution board including a main switch and a branch switch, but also an electric board including a changeover switch capable of switching the power supply.

Therefore, an object of the present disclosure is to provide a changeover switch built-in board capable of simplifying a wire path.

The present invention comprises: Changeover switch built-in board is characterized in that includes a changeover switch for switching a power supply for supplying electricity to a load to a first power supply system or a second power supply system, and a first circuit part electrically connecting the first power supply system and the changeover switch, and a second circuit part electrically connecting to the second power supply system and the changeover switch, and a housing for housing the changeover switch and the first circuit part and the second circuit part, and the changeover switch is includes a first side terminal part arranged on one side in one direction of a first direction and a second direction orthogonal to each other and orthogonal to each other, each of the first side terminal part and the second side terminal part includes the first phase terminal part which is perpendicular to the front-rear direction and arranged in order in the other direction of the first direction and the second direction orthogonal to each other, a second phase terminal part, and a third phase terminal part, the first phase terminal part are arranged substantially linearly in the opposite direction in the one direction, the second phase terminal part are arranged substantially linearly in the opposite direction in the one direction, the third phase terminal part are arranged substantially linearly in the opposite direction in the one direction, and the first circuit part includes a first secondary terminal part electrically connected to the first side terminal part, and the second circuit part includes a second secondary terminal part electrically connected to the second side terminal part, and first secondary terminal part is disposed on one side of the first side terminal part in the one direction in a band-shaped area extending in the one direction with the first phase terminal part to the third phase terminal part in the other direction, and second secondary terminal part is disposed on the other side of the second side terminal part in the one direction in the belt-like area.

According to the above configuration, since first secondary terminal part and second secondary terminal part are disposed on one side and the other side in the one direction in the belt-like area including the first side terminal part and the second side terminal part, second secondary terminal part of the second side terminal part and the second circuit part of changeover switch can be disposed close to each other and the first side terminal part and first secondary terminal part of the first circuit part of changeover switch connected to each other by a conductive connection part can be disposed close to each other, and the interconnection path between the first circuit part, changeover switch, and the second circuit part can be simplified.

The first circuit part 2 includes a first terminal part 20 electrically connected to the first power supply system P1, and the first terminal part 20 is disposed toward one side in the other direction, and a first conductive P110 connecting the first power supply system P1 and the first terminal part 20 is configured to be connectable to the first terminal part 20 in a direction extending from the first terminal part 20 to one side in the other direction, and the second circuit part 3 is electrically connected to the second power supply system P2 The second primary terminal part 30 is disposed toward the other side in the one direction, and the second power supply P20 of the second power supply system P2 and the second conductor P220 connecting the second primary terminal part 30 are configured to be connectable to the second primary terminal part 30 in a direction extending from the second primary terminal part 30 to the other side in the one direction, or are disposed toward the other side in the other direction. The second conductor P220 is configured to be connectable to the second primary terminal part 30 in a direction extending from one side or the other side of the other direction from the second primary terminal part 30, the housing 7, the first conductor insertion part 7010 for inserting the first conductor P110 from the outside to the inside of the housing on one side of the other direction of the first terminal part 20 or the changeover switch 5 is provided, the other side of the one direction of the second primary terminal part 30 disposed toward the other side of the one direction, or the other side of the other direction of the second primary terminal part 30 disposed toward one side or the other side of the other direction, the second conductor insertion part P10 for conducting the second conductor P220 from the outside to the inside of the housing 7 may be provided.

According to the configuration, the housing, the first conductor insertion part is provided on one side of the other direction of first primary terminal part or changeover switch, the other side of the one direction of second primary terminal part which is disposed toward the other side or one side or the other side of the other direction of second primary terminal part since the second conductor insertion part is provided on one side or the other side of the other direction of second primary terminal part, the first conductor from the conductor insertion part is introduced into the inner side of the housing connecting operation, and the second conductor from the second conductor insertion part is introduced into the inside of the housing connecting operation is facilitated to OOD.

As described above, according to the present disclosure, the first connection part, changeover switch, and terminal part and circuit part, which are connected by the conductive circuit part, can be disposed close to each other, and first secondary terminal part of changeover switch can be disposed close to each other, and terminal part of the second side and second secondary terminal part of the second circuit part can be disposed close to each other, thereby simplifying the interconnection path between the first changeover switch and connection part.

Hereinafter, a changeover switch built-in board according to an embodiment of the present disclosure will be described referring to the accompanying drawings.

Changeover switch built-in board is installed between a plurality of power supply systems and a load, and is configured to switch between a plurality of power supply systems and a load.

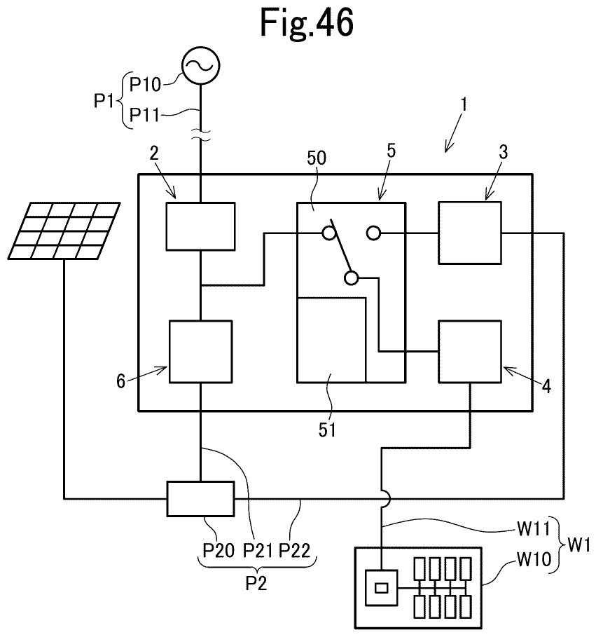

For example, as shown in FIG. 46, when changeover switch built-in board is installed in a house, a first power supply system P1 through which commercial power flows, a second power supply system P2 including a distributed power supply, and a load system W10 including a load system W1 are electrically connected to changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

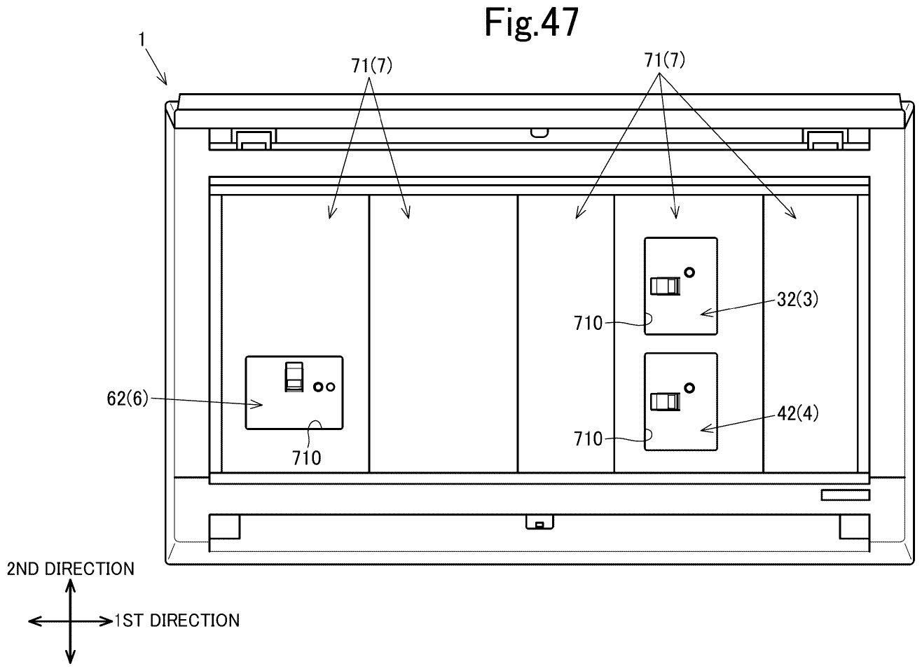

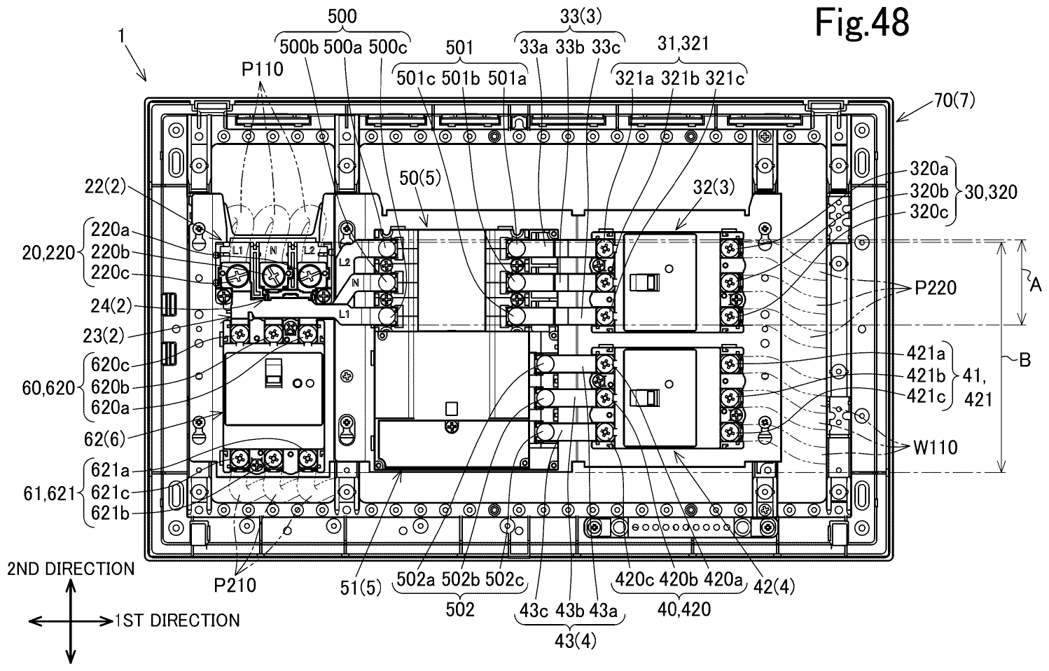

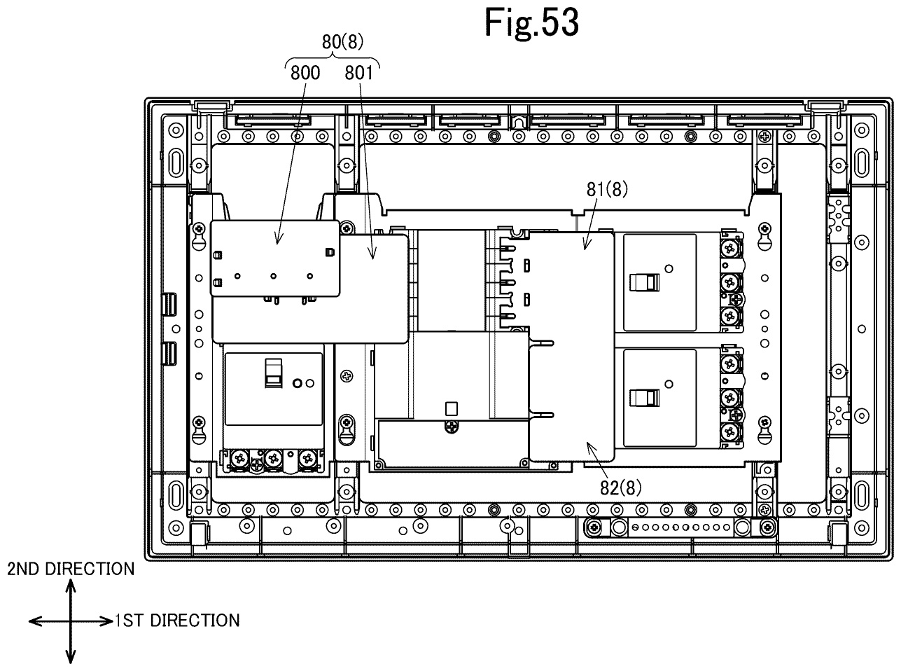

As shown in FIG. 48, changeover switch built-in board 1 is electrically connected to the first power supply system P1, the first circuit part 2 electrically connected to the second power supply system P2, the load circuit part 3 to which the load system W1 is connected, and changeover switch 5 for switching the power supply which supplies electricity to the load system W1 to the first power supply system P1 or the second power supply system P2A housing 7 (see FIG. 47) for housing the relay circuit part 6 to be connected, the first circuit part 2, the second circuit part 3, the relay circuit part 6, changeover switch 5, and the load P2 4, and a cover-structure 8 (see FIG. 53) for covering the charging part in the housing 7 are provided.

In the present embodiment, a direction in which the front surface and the back surface of changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction of a surface formed by the first direction and the second direction is referred to as a board surface direction.

In the present embodiment, the first direction is a direction corresponding to the left-right direction in a state where changeover switch built-in board 1 in the installed state is viewed from the front, and the one side in the first direction is a left side and the other side in the first direction is a right side.

In addition, the second direction is a direction corresponding to the up-down direction in a state where changeover switch built-in board 1 in the installed state is viewed from the front, the one side in the second direction is the upper side, and the other side in the second direction is the lower side.

The first circuit part 2 is electrically connected to the first power supply system P1 and changeover switch 5. The first circuit part 2 is disposed on one side of changeover switch 5 in the first direction.

The first circuit part 2 of the present embodiment has a first power supply system P1 electrically connected to a first primary terminal part 20, and a changeover switch 5 (a first-side terminal part 500 to be described later) and a relay circuit part 6 electrically connected to a first secondary terminal part (not numbered). In the first circuit part 2 of the present embodiment, first primary terminal part 20 also serves as a first secondary terminal part.

In the first circuit part 2, first primary terminal part 20 is disposed toward one side in the second direction, and is connectable to first primary terminal part 20 in a direction extending from first primary terminal part 20 to one side in the second direction with the first power supply P10 (in the present embodiment, the first power distribution path P11) and the first conductive P110 connected to first primary terminal part 20.

The first circuit part 2 includes a first electric device 22, a first conductive connection part 23 fixed to the first electric device 22 so as to be electrically connected to the first conductive P110, and a partition member 24 for preventing a short circuit of first conductive connection part 23.

The first electrical device 22 is a terminal block. Further, the first electric device 22 is a terminal block including a first primary terminal part 20 electrically connected to the first power supply system P1, and a first power distribution path P11 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 includes a device primary terminal part 220 capable of fixing the first conductive P110, and a device secondary terminal part (not numbered) capable of fixing first conductive connection part 23. In the first electric device 22, the device primary terminal part 220 also serves as a device secondary terminal part.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and first conductive connection part 23 are fixed to the device primary terminal part 220, the first conductor P110 and first conductive connection part 23 are electrically connected to each other. The device primary terminal part 220 of the present embodiment is configured such that the first conductive P110 and first conductive connection part 23 can be fixed by screws.

In addition, the equipment primary terminal part 220 may be configured to conduct each other by directly contacting the first conductive P110 and first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

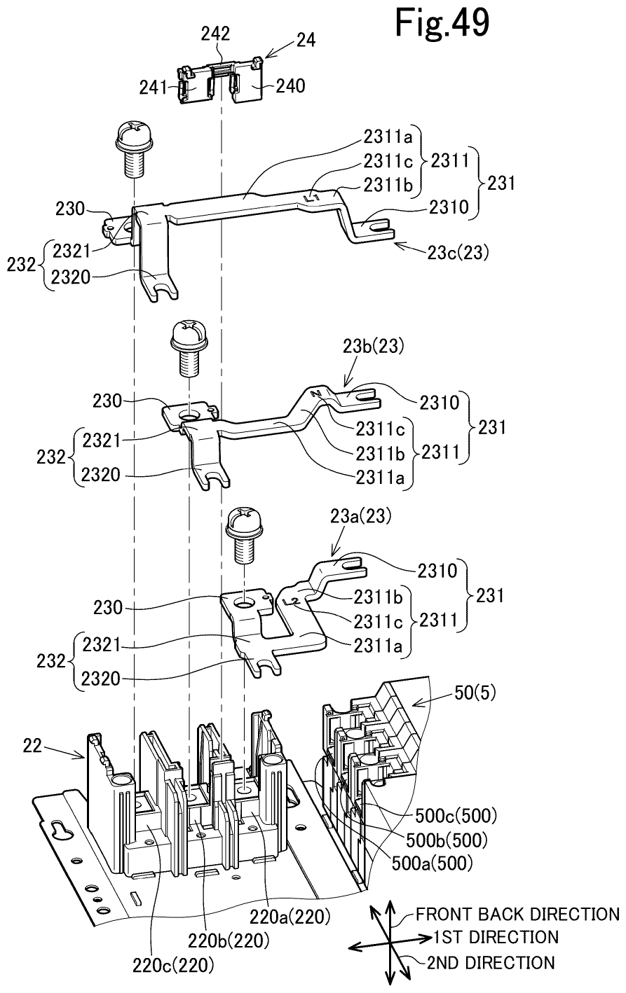

As shown in FIG. 49, first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the distal end side of the connection fixing part 230 is branched into the other side in the second direction and the other side in the first direction in first conductive connection part 23. First conductive connection part 23 of the present embodiment is made of a conductive plate material.

The first conductive part 231 includes a end part 2310 fixed to a first-side terminal part 500 of changeover switch 5, which will be described later, and a intermediate part 2311 that is contiguous with end part 2310 and the second conductive part 232 (a intermediate part 2321 of the second conductive part 232, which will be described later).

The first conductive part 231 intermediate part 2311 is a part interposed between the second conductive part 232 and end part 2310 of the first conductive part 231. Intermediate part 2311 of the first conductive part 231 of the present embodiment includes a proximal end side conductive part 2311a disposed between the first electric device 22 and the relay circuit part 6 (the other side in the second direction than the first electric device 22), a distal end side conductive part 2311b disposed between the first electric device 22 and changeover switch 5 (the other side in the first direction than the first electric device 22), and an identification 2311c attached to a front surface (one surface disposed toward the front side in the front-rear direction) of the distal end side conductive part 2311b. The identification 2311c may be formed by digging in intermediate part 2311 of the first conductive part 231 by direct marking, or may be formed by printing with a laser or the like.

The identification-display 2311c indicates the type of first conductive connection part 23. The identification-display 2311c of the present embodiment is constituted by characters of “L1” indicating L1 phase, “N” indicating the N phase, and “L2” indicating L2 phase.

The second conductive part 232 includes a end part 2320 fixed to a relay primary terminal part (relay device primary terminal part) of the relay circuit part 6, which will be described later, and a intermediate part 2321 connected to end part 2320 and the connecting fixing part 230.

Here, the first circuit part 2 has three first conductive connection part 23 corresponding to the numbers of the device primary terminal part 220. The three first conductive connection part 23, respectively, first conductive connection part 23 for the first phase (first phase conductive connection 23a), first conductive connection part 23 for the second phase (second phase conductive connection 23b), first conductive connection part 23 for the third phase (third phase conductive connection 23c).

The three first conductive connection part 23 are arranged such that the respective second conductive part 232 are aligned in the first direction in the front view.

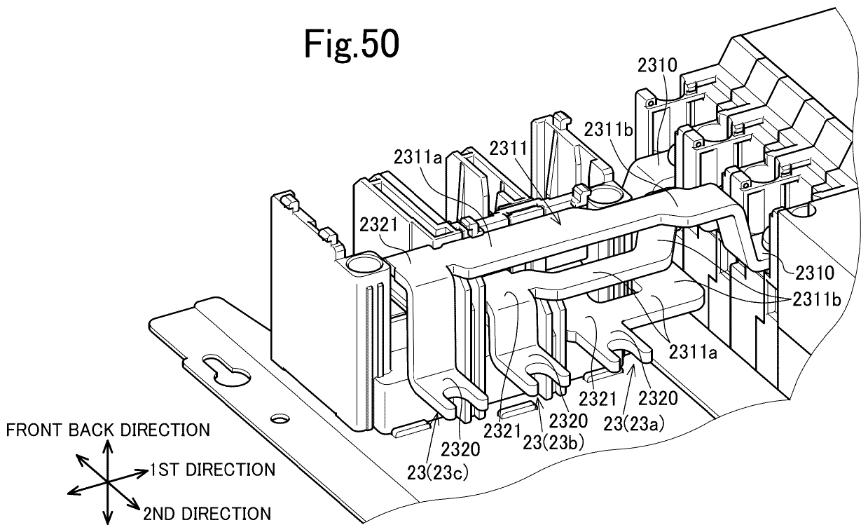

As shown in FIG. 50, intermediate part 2321 of each second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second 232 for the first phase, which is disposed on the most other side in the first direction, is disposed on the most rear side in the front-rear direction.

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the third phase conductive connection part 23c (conductive connection part 23 for the third phase (L1 phase)) is disposed on the most front side in the front-rear direction, and the distal end side conductive part 2311b included in the first phase conductive connection part 23c (conductive connection part 23 for the first phase (L1 phase)) is disposed on one side in the front-rear direction with respect to the distal end side conductive part 2311b included in the second phase conductive connection part 23b (conductive connection part 23 for the second phase (N-phase)) is disposed on one side in the front-rear direction and in the second direction with respect to the distal end side conductive part 2311b included in the third phase conductive connection part 23c, and the distal end side conductive part 2311b included in the first phase conductive connection part 23b and the third phase conductive connection part connection part is disposed on one side in the front-rear direction and in the second direction with respect to the distal end side conductive part 2311b included in the second phase conductive connection part connection part.

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the second phase conductive connection part 23b is also arranged so as to cross the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

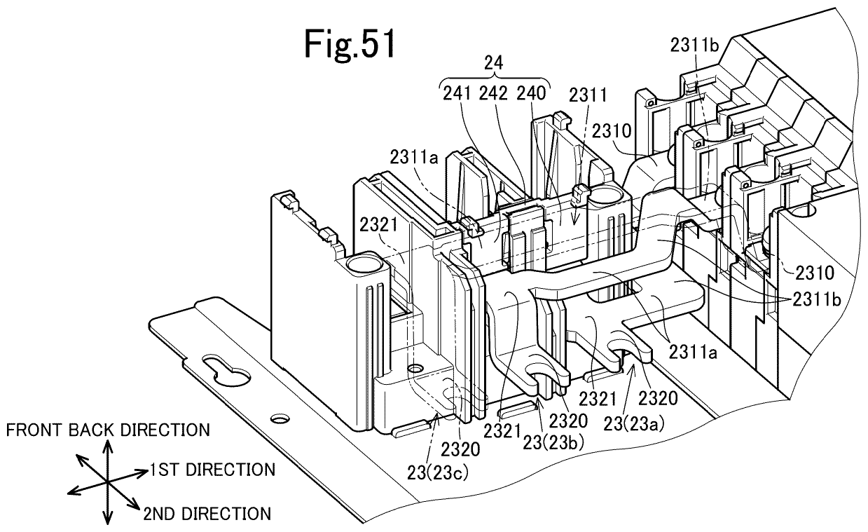

More specifically, as shown in FIG. 51, the partition member 24 has a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 48, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the first direction, and is connectable to second primary terminal part 30 in a direction extending from second primary terminal part 30 to the other side in the first direction with the second power supply P20 (the second power distribution path P22 in the present embodiment) and the second conductor P220 connected to second primary terminal part 30.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The equipment primary terminal part 320 and the equipment secondary terminal part 321 are arranged side by side in a first direction, and the arrangement position of the equipment primary terminal part 320 in the second direction and the arrangement position of the equipment secondary terminal part 321 in the second direction are the same. Further, in the present embodiment, the second electric device 32 is arranged such that the device primary terminal part 320 faces the other side of the first direction and the device secondary terminal part 321 faces the one side of the first direction.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductor P220 of the second distribution path P22 is fixed to the equipment primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductor P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the second direction, and the first phase terminal part 321a of the device secondary terminal part 321, the second phase terminal part 321b, and the third phase terminal part 321c are also arranged to align with each other in the second direction.

The second conductive connection part 33 is formed so as to extend along the first direction (i.e., formed in a straight line shape). One longitudinal end of the second conductive connection part 33 is fixed to the device secondary terminal part 321.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, since the first phase terminal part 321a, the second phase terminal part 321b, and the third phase terminal part 321c of the device secondary terminal part 321 are arranged so as to be aligned along the second direction, the three second conductive connection part 33 are also arranged along the second direction while being fixed to the first phase terminal part 321a, the second phase terminal part 321b, and the third phase terminal part 321c, respectively.

The second electric apparatus of the present embodiment is a circuit breaker. Therefore, in a state in which the second conductive terminal part 320 is fixed with the second conductor P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading equipment 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

The load device primary terminal part 420 and the load device secondary terminal part 421 are arranged side by side in the first direction, the load device primary terminal part 420 is provided at one end of the load device 42 in the first direction, and the load device secondary terminal part 421 is provided at the other end of the load device 42 in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical device 42 is arranged side by side in the second direction with respect to the second circuit part 3, and the load device primary terminal part 420 of the load electrical device 42 and the device secondary terminal part 321 of the second electrical device 32 are arranged in the second direction, and the load device secondary terminal part 421 of the load electrical device 42 and the device primary terminal part 320 of the second electrical device 32 are arranged in the second direction. In the present embodiment, the load electrical device 42 is disposed at a position spaced apart from the second electrical device 32 in the second direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged so as to be aligned in the second direction, and the first phase terminal part 421a, the second phase terminal part 421b, and the third phase terminal part 421c of the load device secondary terminal part 421 are also arranged so as to be aligned in the second direction.

The load conductive connection part 43 is formed so as to extend along the first direction (i.e., is straight), and one end part in the longitudinal direction is fixed to the load primary terminal part 40.

The load circuit part 4 has three load conductive connection part 43 corresponding to the numbers of the first phase terminal part 420a, the second phase terminal part 420b, and the third phase terminal part 420c. The three load conductive connection part 43 are also a load conductive connection part 43 for the first phase (first phase conductive connection 43a), a load conductive connection part 43 for the second phase (second phase conductive connection 43b), and a load conductive connection part 43 for the third phase (third phase conductive connection 43c), respectively.

As described above, since the first phase terminal part 420a, the second phase terminal part 420b, and the third phase terminal part 420c of the load device primary terminal part 420 are arranged to be aligned along the second direction, the three load conductive connection part 43 are arranged to be aligned along the second direction in a state where they are fixed to the first phase terminal part 420a, the second phase terminal part 420b, and the third phase terminal part 420c, respectively.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching body part 50 that switches between the first circuit part 2 and the second circuit part 3 and the load circuit part 4, and a switching control part 51 that operates the switching body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500, the second side terminal part 501, and the load-side terminal part 502 are provided at separate ends in the first direction of changeover switch 5. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction.

Further, the second side terminal part 501 and the load side terminal part 502 are arranged side by side in the second direction in the same direction in the first direction, the second side terminal part 501 and second secondary terminal part 31 face each other in the first direction, and the load side terminal part 502 and the load primary terminal part 40 face each other in the first direction.

In the present embodiment, the second side terminal part 501 is disposed on one side in the second direction, and the load-side terminal part 502 is disposed on the other side in the second direction. Furthermore, the arrangement position of the second side terminal part 501 of the present embodiment in the first direction and the arrangement position of the load-side terminal part 502 in the first direction are different from each other. More specifically, the second side terminal part 501 is arranged to be located on one side of the load-side terminal part 502 in the first direction.

The first phase terminal part 500, the first phase terminal part 500a, the second phase terminal part 500b, and the third phase terminal part 500c are arranged in order in the second direction, and the first phase terminal part 501a of the second side terminal part 501, the second phase terminal part 501b, and the third phase terminal part 501c are arranged in order in the second direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b, 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

In addition to the second-side terminal part 501, in each of the device secondary terminal part 321, the load-side terminal part 502, and the load-device primary terminal part 420 of the load electrical device 42 of the second electrical device 32, the first-phase terminal part 321a, 502a, 420a, the second-phase terminal part 321b, 502b. 420b, and the third-phase terminal part 321c, 502c, 420c are arranged so as to be aligned in the second direction.

Further, the second-side terminal part 501 and the device secondary terminal part 321 of the second electric device 32 are configured such that the first phase terminal part 501a, 321a of each other oppose each other in the first direction, the second phase terminal part 501b, 321b of each other oppose each other in the first direction, and the third phase terminal part 501c, 321c of each other oppose each other in the first direction.

Note that the second-side terminal part 501 and the device secondary terminal part 321 of the second electric device 32 may be opposed to each other in a positional relationship, or may be substantially opposed to each other without being perfectly opposed to each other.

For example, the first phase terminal part 501 first phase terminal part 501a of the second electrical equipment 32 and the first phase terminal part 321 of the second electrical equipment 32 terminal part 321a is arranged so that at least a part is opposed in the first direction, the second phase terminal part 501 second phase terminal part 501b of the second electrical equipment 32 second phase terminal part 321 terminal part 321b, the third phase terminal part 501c of the second side terminal part 501 and the second device of the second electrical equipment 32 the third phase terminal part 321c 321 also, at least a part is opposed in the first direction, the second side terminal part 501 and the device secondary terminal part 321 of the second electrical equipment 32 may be arranged.

Further, for example, if the first phase terminal part 501a of the second side terminal part 501 and the first phase terminal part 321 of the second electric device 32 are arranged so that at least a part of the first phase terminal part 321a of the second electric device 32 is opposed to each other in the first direction, the direction of the second side terminal part 501 of the first phase terminal part 501a of the second electric device 32 and the direction of the first phase terminal part of the second electric device 32 terminal part 321a of the second electric device 32 may intersect, and the direction of the second phase terminal part 501b of the second side terminal part 501 and the direction of the second phase terminal part 321b of the second electric device 32, the direction of the third phase terminal part 501c of the second side terminal part 501 and the direction of the third phase terminal part 321c of the device secondary terminal part 321 of the second electric device 32 may also intersect.

The load-side terminal part 502 and the load device primary terminal part 420 of the load electric device 42 are configured such that the first phase terminal part 502a, 420a of each other oppose each other in the first direction, the second phase terminal part 502b, 420b of each other oppose each other in the first direction, and the third phase terminal part 502c, 420c of each other oppose each other in the first direction. Note that the second-side terminal part 501 and the device secondary terminal part 321 of the second electric device 32 may be opposed to each other in a positional relationship, or may be substantially opposed to each other without being perfectly opposed to each other.

Note that the load-side terminal part 502 and the load device primary terminal part 420 of the load electric device 42 may be opposed to each other in a positional relationship, or may be substantially opposed to each other without being perfectly opposed to each other.

For example, the first phase terminal part 502 terminal part 502a and the first phase terminal part 420 of the load electrical device 42 may be arranged so that at least some of the first phase terminal part 420a are facing in one direction, the second phase terminal part 502b of the load terminal part 502 and the second phase terminal part 420b of the load electrical device 42 primary phase terminal part 420, the third phase terminal part 502c of the load side terminal part 502 and the third phase terminal part 420c 420 of the load electrical device 42 may also be arranged so that at least some of the third phase 420b in one direction are facing each other, and the load side terminal part 502 and the load electrical device primary terminal part 420 of the load electrical device 42.

Further, for example, if the first phase terminal part 502 and terminal part 502a of the load electrical device 42 and the first phase terminal part 420 of the load electrical device terminal part 420a 420 are arranged so as to be at least partially opposed to each other in the first direction, the direction of the load side terminal part 502 first phase terminal part 502a and the direction of the load electrical device 42 first phase terminal part of the load electrical device 42 first phase terminal part 420a of the load electrical device terminal part 420c 420 may cross, and the direction of the second phase terminal part 502b of the load side terminal part 502 and the direction of the load device primary phase terminal part 420b of the load electrical device 420, the direction of the third phase terminal part 502c of the load side terminal part 502 and the direction of the load device primary terminal part 420 of the load electrical device 42 may also cross.

In addition, in the second direction, in the band-like area A that extends in a first direction from the first phase terminal part 500a of the first side terminal part 500 and the first phase terminal part 501a of the second side terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side than terminal part 500, and second secondary terminal part 31 is arranged in the second direction on the other side of the first side than terminal part 501.

Therefore, changeover switch 5 of the present embodiment is disposed between the first circuit part 2 and the second circuit part 3 in the first direction. Specifically, as shown in FIG. 48, changeover switch 5 is disposed between the first circuit part 2 and the second circuit part 3 which are disposed at the same position in the second direction by being disposed in the band-shaped area A extending in the first direction.

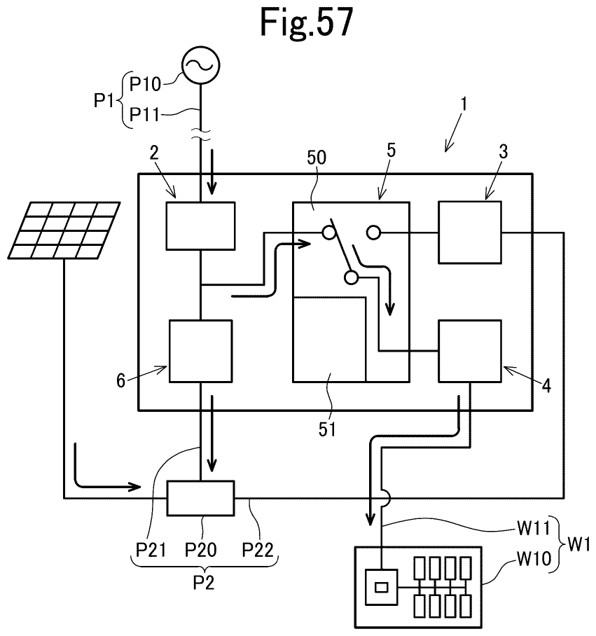

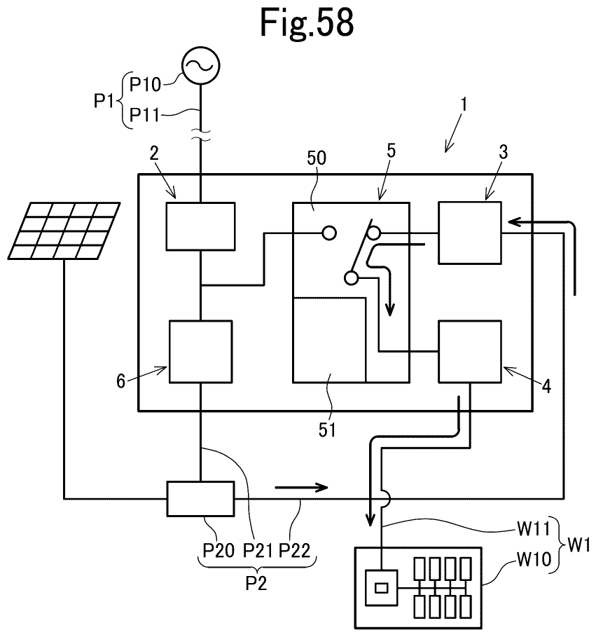

As shown in FIG. 57, the switching body 50 is switchable between a state in which the first side terminal part 500 and the load side terminal part 502 are electrically connected to each other and the second side terminal part 501 and the load side terminal part 502 are electrically disconnected from each other (first power supply state), and a state in which the first side terminal part 500 and the load side terminal part 502 are electrically disconnected from each other and the second side terminal part 501 and the load side terminal part 502 are electrically connected to each other (second power supply state) as shown in FIG. 58, and the switching control part 51 is configured to switch the first power supply state and the second power supply state by operating the switching body 50.

The switching control part 51 may be configured to automatically switch the first power supply state and the second power supply state of the switching body 50 according to the respective power supply states, but may be configured to manually switch between the first power supply state and the second power supply state, or may be configured to switch between the first power supply state and the second power supply state by remote control from the outside.

Further, for example, the switching control part 51 may be configured to switch the switching body part 50 from the first power supply state to the second power supply state when it is detected that the power supply from the first power supply system P1 is interrupted, and to switch the switching body part 50 from the second power supply state to the first power supply state when it is detected that the power supply from the first power supply system P1 is restored.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 321 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

In the relay electric device 62, the first phase terminal part 620a, the second phase terminal part 620b, and the third phase terminal part 620c are arranged in the first direction (so as to be aligned), and the first phase terminal part 621a, the second phase terminal part 621b, and the third phase terminal part 621c are also arranged in the first direction (so as to be aligned).

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 621 of the relay electrical device 62) in the second direction, and to be within the band-shaped area B extending in the first direction.

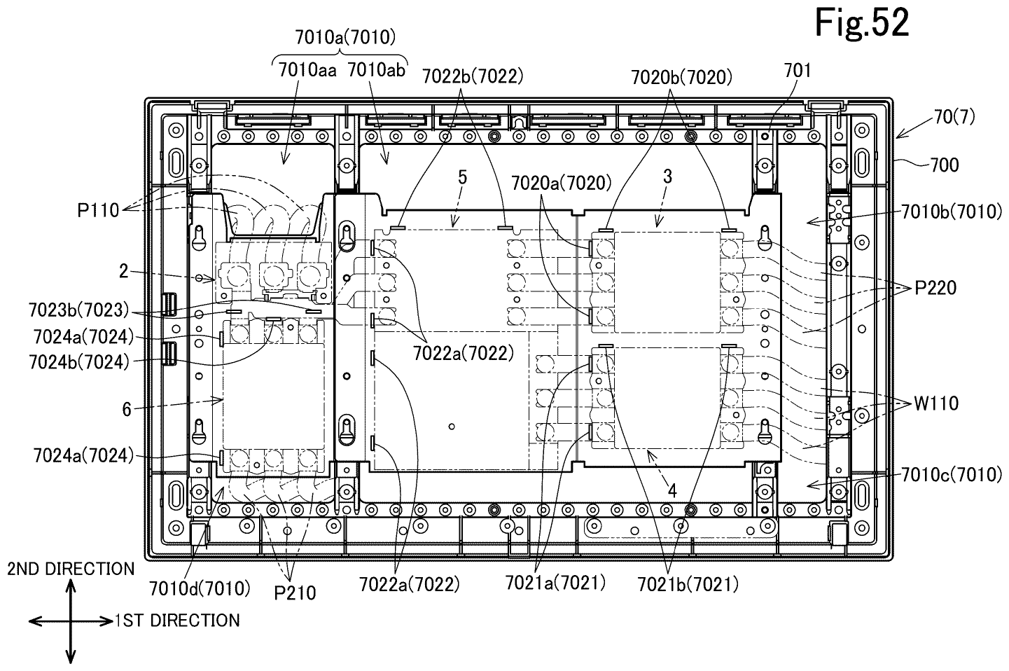

As shown in FIG. 52, the housing 7 includes a housing part 70 capable of housing the first circuit part 2, the second circuit part 3, the loading circuit part 4, changeover switch 5, and the relay circuit part 6 therein, and an inner lid part 71 (see FIG. 47) attached to the front surface of the housing part 70. Although not illustrated in FIG. 52, the housing 7 includes an outer lid part that covers the inner lid part 71 attached to the front surface of the housing part 70.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of the first electric device 22 in the second direction relative to first primary terminal part 20 or changeover switch 5 (in the present embodiment, on one side of the first electric device 22 in the second direction). Therefore, the first conductor insertion part 7010a allows the first conductor P110 to be inserted into and out of the housing 7 on one side of first primary terminal part 20 or changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric equipment 22, and the switching-side first conductor insertion part 7010ab is disposed directly above changeover switch 5 and the second electric device 32. In the present embodiment, as shown in FIG. 48, the first conductor P110 is inserted inside the housing 7 via the first-side first conductor insertion part 7010aa.

The second conductive insertion part 7010b is provided on the other side in the first direction than the device primary terminal part 320 of the second electric device 32. Therefore, the second conductor insertion part 7010b allows the second conductor P220 to be inserted into and out of the housing 7 on the other side in the first direction than the device primary terminal part 320 of the second electric device 32.

Further, the second conductor insertion part 7010b is disposed on the other side of the second electric device 32 in the first direction in the band-shaped area A. and the arrangement position in the second direction is the same position as the arrangement position in the second direction of the second conductor insertion part 7010b.

The load conductor insertion part 7010c is provided on the other side of the load device secondary terminal part 421 of the load electric device 42 in the first direction. Therefore, the load conductor insertion part 7010c allows the load conductor W110 to be inserted into and out of the housing 7 on the other side of the load device secondary terminal part 421 of the load electric device 42 in the first direction.

Further, the load-conductor insertion part 7010c and the second conductor insertion part 7010b are formed at positions aligned in the second direction, and are formed so as to be continuous with each other.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction.

The positioning structure 702 includes a second circuit part positioning part 7020 for positioning the second circuit part 3 with respect to the back surface part 701, a load circuit part positioning part 7021 for positioning the load circuit part 4 with respect to the back surface part 701, a changeover switch positioning part 7022 for positioning changeover switch 5 with respect to the back surface part 701, a first circuit part positioning part 7023 for positioning the first circuit part 2 with respect to the back surface part 701, and a relay circuit part positioning part 7024 for positioning the relay circuit part 6 with respect to the back surface part 701.

The second circuit part positioning part 7020 of the present embodiment is configured to position the second electrical device 32.

Further, the second circuit part positioning part 7020 is configured to abut on two intersecting side surfaces of the second electrical device 32. More specifically, the second circuit part positioning part 7020 has a first contact part 7020a that protrudes from the back surface part 701 toward the front side in the front-rear direction and abuts on the side surface of the second electric device 32 on the one side in the first direction, and a second contact part 7020b that protrudes from the back surface part 701 toward the front side in the front-rear direction and abuts on the side surface of the second electric device 32 on the one side in the second direction.

Load circuit part positioning part 7021 is configured to position the load electric device 42.

In addition, the load circuit part positioning part 7021 is configured to abut on two intersecting side surfaces of the load electric device 42. More specifically, the load circuit part positioning part 7021 includes a first contact part 7021a that protrudes from the back surface part 701 toward the front side in the front-rear direction and abuts on a side surface of the load electrical device 42 on one side in the first direction, and a second contact part 7021b that protrudes from the back surface part 701 toward the front side in the front-rear direction and abuts on a side surface of the load electrical device 42 on one side in the second direction.

The changeover switch positioning part 7022 is configured to abut two intersecting sides of changeover switch 5. More specifically, the changeover switch positioning part 7022 has a first contact part 7022a that protrudes from the back surface part 701 toward the front side in the front-rear direction and abuts on the side surface on one side in the first direction of changeover switch 5, and a second contact part 7022b that protrudes from the back surface part 701 toward the front side in the front-rear direction and abuts on the side surface on one side in the second direction of changeover switch 5.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The inner lid part 71 is attached to the housing part 70 and is configured to cover the front surfaces of the first circuit part 2, the second circuit part 3, the loading circuit part 4, changeover switch 5, and the relay circuit part 6. Further, in the middle cover part 71 of the present embodiment, the windows 710 are formed in accordance with the positions of the non-charging part of the second circuit part 3 (specifically, the operation part of the second electric device 32), the non-charging part of the load circuit part 4 (specifically, the operation part of the load electric device 42), and the non-charging part of the relay circuit part 6 (specifically, the operation part of the relay electric device 62).

The second electric device 32 and the load electric device 42 are arranged in a state in which the operation direction of the operation part is aligned with the first direction, and the relay electric device 62 is arranged in a state in which the operation direction of the operation part is aligned with the second direction. As described above, the second electric appliance 32 and the load electric appliance 42 arranged at the positions close to each other are arranged so that the operation direction of the operation part is the same, and the relay electric appliance 62 arranged at the position away from the second electric appliance 32 and the load electric appliance 42 is arranged so that the operation direction of the operation part is different from the operation direction of the operation part of the second electric appliance 32 and the load electric appliance 42.

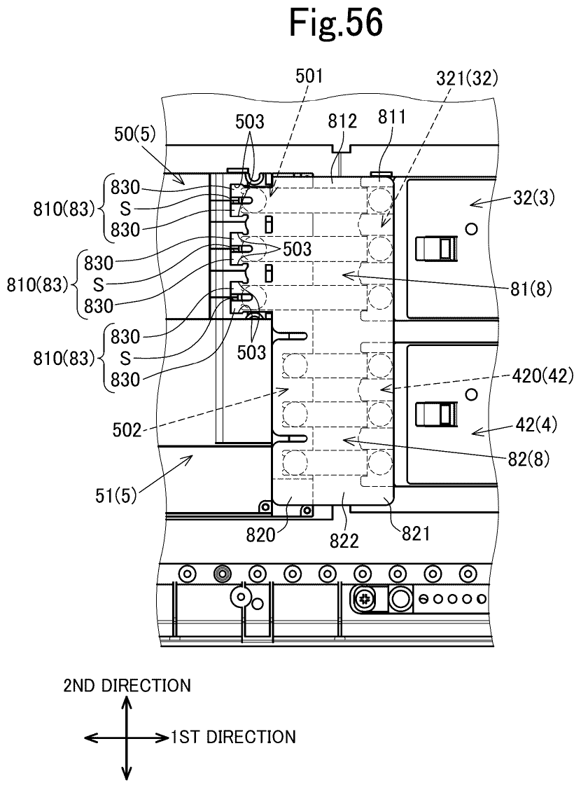

As shown in FIG. 53, the cover structure 8 includes a first cover part 80 that covers first conductive connection part 23, a second cover part 81 that covers the second conductive connection part 33, and a third cover part 82 that covers the loaded conductive connection part 43. Although the second cover part 81 and the third cover part 82 of the present embodiment are integrally formed, the second cover part 81 and the third cover part 82 may be separate members (see FIG. 56).

The first cover part 80 includes a first protection part 800 that covers the proximal end part of the first conductive part 231, and a second protection part 801 that covers the distal end part of the first conductive part 231 and the second conductive part 232.

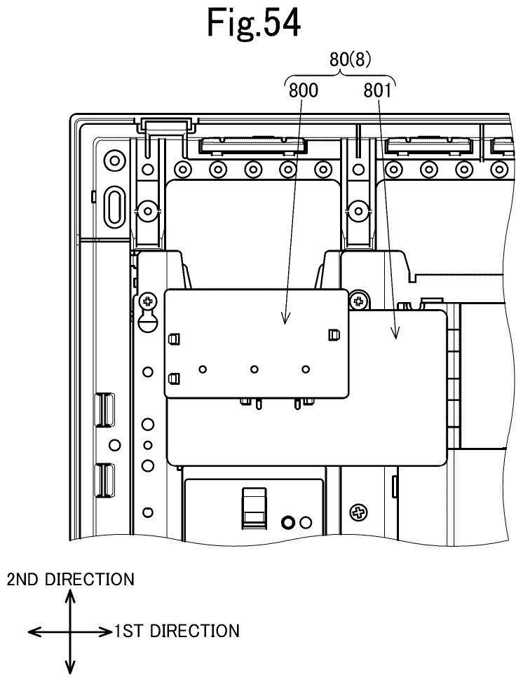

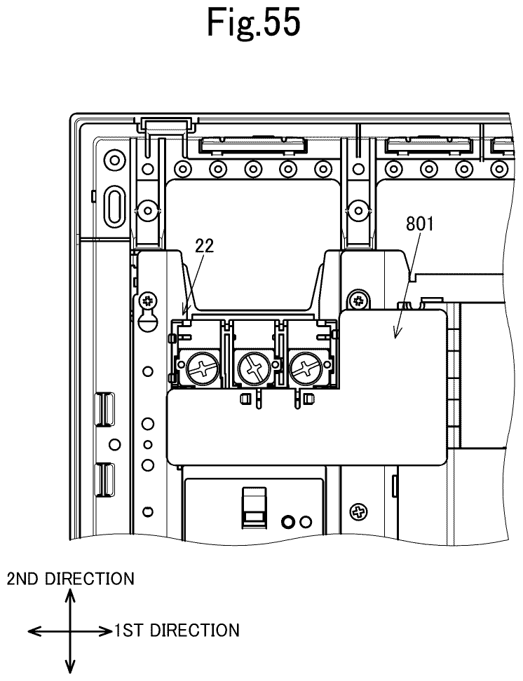

The first protective part 800 and the second protective part 801 are detachable separately, in a state where the second protective part 801 covers the distal end side and the second conductive part 232 than the proximal end part of the first conductive part 231 from the front side, the first protective part 800 covers the proximal end part of the first conductive part 231 from the front side and a closed state, the first protective part 800 is configured to be switchable to an open state of opening the front of the proximal end part of the first conductive part 231 (see FIGS. 54 and 55).

Further, in a state in which both the first protection part 800 and the second protection part 801 are installed, the first protection part 800 is disposed on the front side in the front-rear direction relative to the second protection part 801, and the outer peripheral edge part of the first protection part and the outer peripheral edge part of the second protection part 801 are in a state of part overlapping with each other.

As shown in FIG. 56, the second cover part 81 includes a first protection part 810 that covers the front of the second side terminal part 501, a second side protection part 811 that covers the front of the device secondary terminal part 321 of the second electric device 32, and an intermediate protection part 812 that covers the front of the area between the second side terminal part 501 and the device secondary terminal part 321 of the second electric device 32.

The third cover part 82 has a first protection part 820 covering the front of the load side terminal part 502, a second side protection part 821 covering the front of the load device primary terminal part 420 of the load electrical device 42, and an intermediate protection part 822 covering the front of the area between the load side terminal part 502 and the load device primary terminal part 420 of the load electrical device 42.

The second cover part 81 and the third cover part 82 are configured to be externally attachable to changeover switch 5, and the cover structure 8 of the present embodiment has a cover-side engagement part 83 that secures the second cover part 81 and the third cover part 82 to the switching body part 50 while engaging with the switching body part 50 in order to securely attach and fix the second cover part 81 and the third cover part 82 to changeover switch 5 (to reliably prevent the second cover part and the third cover part from being detached from changeover switch 5).

In the cover structure 8 of the present embodiment, the second cover part 81 and the third cover part 82 are integrally formed, and the cover-side engagement part 83 is provided in the second cover part 81.

The cover-side engaging part 83 is configured to be erected at a position adjacent to terminal part of the second side terminal part 501 in the second direction and to be engaged between a pair of insulating walled parts 503 opposed to each other in the second direction.

The cover-side engaging part 83 of the present embodiment has a pair of flexible engaging parts 830 which are flexible and arranged in a direction in which the pair of insulating wall parts 503 are arranged (second direction in the present embodiment).

The cover-side engagement part 83 of the present embodiment is constituted by the first protection part 810 of the second cover part 81. In the second cover part 81, the first protection part 810 is formed so as to extend outward from the intermediate protection part 812, and the first protection part 810 is formed with a slit S extending from the distal end toward the proximal end side.

Therefore, in the second cover part 81, part on one side (one side in the second direction) of the first protection part 810 relative to the slit S constitutes one flexible engagement part 830, and part on the other side (the other side in the second direction) of the first protection part 810 relative to the slit S constitutes the other flexible engagement part 830. That is, the pair of flexible engagement parts 830 are arranged in the second direction via the slit S.

Note that, as described above, since the second-side terminal part 501 of changeover switch 5 includes the second-side terminal part 501 (first phase terminal part 501a) for the first phase, the second-side terminal part 501 (second phase terminal part 501b) for the second phase, and the second-side terminal part 501 (third phase terminal part 501c) for the third phase, the cover construction 8 is configured to have three cover-side engagement parts 83.

As described above, in the cover configuration 8, the cover-side engagement part 83 engages with the switching body part 50 (the pair of opposing insulating wall parts 503 for the second-side terminal part 501 in the present embodiment), so that the second cover part 81 and the third cover part 82 can be maintained attached to the switching body part 50.

In addition, if the slit S is formed between the pair of flexible engagement parts 830 as in the cover-side engagement part 83 of the present embodiment, it is easy to dispose the slit S between the insulating wall parts 503 where the movement of the pair of flexible engagement parts 830 is permitted.

In the present embodiment, the cover-side engaging part 83 is formed only in the second cover part 81 of the second cover part 81 and the third cover part 82, the cover-side engaging part 83 may be formed in the second cover part 81 and the third cover part 82, and in the case where the second cover part 81 and the third cover part 82 are integrally formed, the cover-side engaging part 83 may be formed only in the third cover part 82.

The second cover part 81 and the third cover part 82 are integrally formed by one member, in order to ensure the mounting and fixing of the cover, the second side terminal part 501 for the first phase (first phase terminal part 501a), the second side terminal part 501 for the second phase (second phase terminal part 501b), the second side terminal part 501 for the third phase (third phase terminal part 501c) It is formed with an engaging part that engages the insulating wall for maintaining the insulating between the respective phases. The engagement parts are arranged side by side in the second direction so as to correspond to the second-side terminal part 501 of the respective phases, and end part is formed to extend in the first direction. In addition, end part is provided with slits that divide end part in the second direction, so that it is easy to engage with the insulating walls. Incidentally, the engaging part provided in the second cover part 81 and the third cover part 82, the load-side terminal part 502 for the first phase (first phase terminal part 502a), the load-side terminal part 502 for the second phase (second phase terminal part 502b), the load-side terminal part 502 for the third phase (third phase terminal part 502c) may be formed with an engaging part that engages with the insulating walls for maintaining the insulating between the respective phases. The second cover part 81 and the third cover part 82 are integrally formed, but the second cover part 81 and the third cover part 82 may be separate members (see FIG. 56).

As described above, according to changeover switch built-in board 1 of the present embodiment, the first changeover switch 5 and the relay circuit part 6, which are arranged in the first direction with respect to the first circuit part 2 (in the present embodiment, changeover switch 5), can connect the first conductive part 231 to the first side terminal part 500 along the first direction because the first conductive part 231 extending in the first direction has terminal part (the first side terminal part 500) facing end part 2310 in the first direction.

Of changeover switch 5 and the relay circuit part 6, those aligned in the second direction with respect to the first circuit part 2 (the relay circuit part 6 in the present embodiment) have the relay primary terminal part 60 facing end part 2320 of the second conductive part 232 extending in the second direction in the second direction, so that the second conductive part 232 can be connected to the relay primary terminal part 60 along the second direction.

As described above, since the first conductive part 231 and the second conductive part 232 can be connected along the first direction or the second direction in which changeover switch 5 or the relay circuit part 6 is aligned with the first circuit part 2, it is possible to reduce the size of changeover switch built-in board 1.

In first conductive connection part 23 of the present embodiment, since the first conductive part 231 is formed so that the proximal conductive part 2311a extends straight from the second conductive part 232 toward the connection target (the first side terminal part 500), the first conductive part 231 may not be oriented with respect to the direction in which the second conductive part 232 extends from the connection fixing part 230. Therefore, in the present embodiment, the space between the first electrical device 22 and the relay electrical device 62 is reduced.

In addition, in changeover switch built-in board 1 of the present embodiment, since first conductive connection part 23 is formed of a plate material having conductivity, first conductive connection part 23 can be formed in a configuration along the wire path, and the space required for changing the direction of first conductive connection part 23 can be reduced.

Further, in changeover switch built-in board 1 of the present embodiment, the base end part side (intermediate part 2321) of the second conductive part 232 is formed so as to be located on the front side in the front-rear direction of the connecting fixing part 230 and conductive part 232 in end part 2320, and the space on the rear side of the first conductive part 231 can be used as a space for, for example, a wire or the like because the first conductive part 231 branches from intermediate part 2321 of the second conductive part 232 toward the first direction.

Further, the plurality of first conductive connection part 23 can be prevented from spreading in the second direction because the proximal conductive part 2311a of the respective first conductive connection part 23 are arranged in a row in the front-rear direction.

In particular, the three proximal conductive part 2311a can be arranged closer to each other in the front-rear direction and the plurality of second conductive part 232 can be arranged closer to each other in the first direction because they are arranged side by side from the front side to the rear side in the front-rear direction in order from the one extending from the second conductive part 232 which is arranged at the one-most position in the first direction (the position farthest from changeover switch 5 in the first direction). As a result, it is possible to suppress the extension of the space in which the plurality of first conductive connection part 23 are arranged in the first direction.

Further, in changeover switch built-in board 1 of the present embodiment, since the identification display 2311c attached to the front surface of each of the front-end-side conductive part 2311b is configured to be exposed to the front side, the identification display 2311c attached to each of the plurality of first conductive connection part 23 becomes easy to see, and the type of each of first conductive connection part 23 becomes easy to distinguish.

The cover structure 8 of the board 1 with a changeover switch of this embodiment is provided with the first cover part 80 which has the first protection part 800 which covers the connection fixing part 230 from a front side, and the second protection part 801 which covers the first conductive part 231 and the second conductive part 232 from a front side, and the second protection part 801 covers the first conductive part 231 and the second conductive part 232 from a front side, Since the first protection part 800 is configured to be switchable between a closed state in which the first protection part 800 covers the connection fixing part 230 from the front side and an open state in which the front of the connection fixing part 230 of the 2 conductive part 232 is opened, only the first protection part 800 is opened to the terminal block Since only the front of the connection fixing part 230 to which the fixed first power supply system P1 is connected is opened, the operation of the connection fixing part 230 can be safely performed while the other part of the first conductive connection part 23 is covered with the second protective part 801.

Further, in changeover switch built-in board 1 of the present embodiment, the first side terminal part 500 can be electrically connected to the first circuit part 2 on one side in the first direction, the second side terminal part 501 can be electrically connected to the second circuit part 3 on the other side in the first direction, and the second side terminal part 501 and second secondary terminal part 31 are arranged so as to face each other in the first direction, so that the second side terminal part 501 and second secondary terminal part 31 can be electrically connected to each other by arranging the second conductive connection part 33 in a straight line in the first direction when the second side terminal part 501 and OOH 31 are electrically connected using the second conductive connection part 33.

Specifically, the first phase terminal part 501a, the second phase terminal part 501b, and the third phase terminal part 501c of the second side terminal part 501 are arranged linearly in the first direction so as to face the first phase terminal part 321a, the second phase terminal part 321b, and the third phase terminal part 321c of the device secondary terminal part 321, respectively, so that the second side terminal part 501 and second secondary terminal part 31 can be electrically connected with the first phase conductive connection part 33a, the second phase conductive connection part 33b, and the third phase conductive connection part 33c arranged in the second direction.

In addition, in changeover switch built-in board 1 of the present embodiment, the second conductor P220 is inserted from the outside to the inside of the housing 7 via the second conductor insertion part 7010b, and is connected to the device primary terminal part 220 in the first direction, and the device secondary terminal part 321 and the second-side terminal part 501 can be connected to each other via the second conductive connection part 33 that is linear in the first direction, thereby facilitating the wiring operation and simplifying the wiring path.

Further, in the present embodiment, since the second conductor insertion part 7010b is provided on the other side in the first direction than the second electric device 32 in the band-shaped area A, the second conductor P220 is introduced into the housing 7 from the opposite side in the second conductor insertion part 7010b, and the second conductor P220 can be connected to the device primary terminal part 320 from the other side in the first direction. Therefore, in the present embodiment, without significantly changing the direction of the second conductor P220, since it is possible to perform the operation of connecting the second conductor P220 to the device primary terminal part 320 from the operation of introducing the second conductor P220 into the housing 7, the second conductor P220 can be connected easily and smoothly to the second electric device 32, thereby, it is possible to easily perform the wiring operation.

Further, first primary terminal part 20 is disposed toward one side in the second direction perpendicular to the first direction and the front-rear direction, the first electric device 22 or changeover switch 5 is a terminal block on one side in the second direction, since the first conductor insertion part 7010a is provided, the first conductor insertion part from 7010a of the first conductor insertion part without significantly changing the direction of the first conductor P110 to introduce the first conductor P110 to the inside of the housing 7, the first conductor P110 can be connected to first primary terminal part 20, the first conductor P110 can be easily and smoothly connected to the first electric device 22, thereby, it is possible to easily perform the wiring operation.

Further, in the present embodiment, first primary terminal part 20 is disposed toward one side in the second direction, the first-side first conductor insertion part 7010aa is disposed on one side (directly above) in the second direction of the terminal block as the first electric device 22, and the switching-side first conductor insertion part 7010ab is disposed on one side (directly above) in the second direction of changeover switch 5 and the second electric device 32. The first conductor P110 introduced into the inside of the housing 7 is connected to first primary terminal part 20 via the first-side first conductor insertion part 7010aa. Therefore, the first conductive P110 and first primary terminal part 20 can be easily connected in the second direction.

Therefore, since the second-side terminal part 501 and second secondary terminal part 31 are arranged so as to face each other in one direction, the interconnection path can be simplified when changeover switch 5 and the second circuit part 3 are electrically connected to each other.

In addition, since the second-side terminal part 501 and the load-side terminal part 502 are arranged so as to be aligned in the first direction while facing the other side in the first direction in the second direction, the second-side terminal part 501 and the load-side terminal part 502 can be separated in the second direction, so that the second-side terminal part 501 and the load-side terminal part 502 can be electrically connected to each other (that is, an insulating distance can be secured). Further, in the first direction, the second side terminal part 501 and second secondary terminal part 31 can be electrically connected, the load side terminal part 502 and the load primary terminal part 40 can be electrically connected, and the second side terminal part 501 and second secondary terminal part 31 can be arranged so as to face each other in the first direction, and the electrical connection between the second side terminal part 501 and second secondary terminal part 31 and the electrical connection between the load side terminal part 502 and the load primary terminal part 40 can be separated from each other because the load side terminal part 502 and the load primary terminal part 40 are arranged so as to face each other in the first direction.

In the present embodiment, the second side terminal part 501 is disposed on one side in the second direction, and the load-side terminal part 502 is disposed on the other side in the second direction. In the second direction, the second electric device 32 and the load electric device 42 are separated from each other in a state in which the second electric device 32 is disposed on one side and the load electric device 42 is disposed on the other side. Thus, the connection between the second side terminal part 501 and second secondary terminal part 31 via the second conductive connection part 33 and the connection between the load side terminal part 502 and the load primary terminal part 40 via the load conductive connection part 43 can be separated in the second direction. Therefore, it is possible to contribute to securing the insulation distance in the second direction.

A terminal part of each phase of the second side terminal part 501 and a terminal part of each phase of the load side terminal part 502 can be separated in a second direction, and a terminal part of each phase of the device secondary terminal part 321 and a terminal part of each phase of the load device primary terminal part 420 can be separated in a second direction. In addition, the short circuit between the phases between the terminal parts can be suppressed, and the second side terminal part 501 and the device secondary terminal part 321, the first phase terminal parts 501a, 321a of each other face each other in the first direction, the second phase terminal parts 501b, 321b of each other face each other in the first direction, and the load side terminal part 502 and the load device primary terminal part 420 face each other in the first direction, and the second phase of each other Since the terminal parts 502b, 420b are opposed to each other in the first direction and the third phase terminal parts 502c, 420c are opposed to each other in the first direction, the terminal parts of the respective phases are opposed to each other in the first direction, so that the electric connection can be simplified and the inter-phase short circuit can be suppressed.

In the present embodiment, the second side terminal part 501 is disposed on one side and the load-side terminal part 502 is disposed on the other side in the second direction. Then, as shown in FIG. 48, the first phase terminal part 501a, the second phase terminal part 501b, and the third phase terminal part 501c of the second side terminal part 501 are arranged in order in the second direction, and the first phase terminal part 502a, the second phase terminal part 502b, and the third phase terminal part 502c of the load-side terminal part 502 are arranged in order in the second direction. Further, as shown in FIG. 48, in a second orientation, the equipment secondary terminal part 321 is located on one side and the loading equipment primary terminal part 420 is located on the other side. Then, as shown in FIG. 48, the first phase terminal part 321a, the second phase terminal part 321b, and the third phase terminal part 321c of the device secondary terminal part 321 are arranged in the second direction, and the first phase terminal part 420a, the second phase terminal part 420b, and the third phase terminal part 420c of the loading device primary terminal part 420 are arranged in the second direction. In addition, the second-side terminal part 501 and the secondary terminal part, each other of the first phase terminal part 501a, 220a facing each other in the first direction, each other of the second phase terminal part 501b, 220b facing each other in the first direction, each other of the third phase terminal part 501c, 220c facing each other in the first direction, the load-side terminal part 502 and the load device primary terminal part 420, each other of the first phase terminal part 502a, 420a facing each other in the first direction, each other of the second phase terminal part 502b, 420b facing each other in the first direction, each other of the third phase terminal part 502c, 420c facing each other in the first direction. Therefore, between the second-side terminal part 501 and the device secondary terminal part 321, and between the load-side terminal part 502 and the load-device primary terminal part 420, the first phase terminal part 502a, 321a, the second phase terminal part 502b, 321b, and the third phase terminal part 502c, 321c are arranged in this order from one side to the other side in the second direction. Therefore, the arrangement of terminal part of each phase in the second direction is easy to understand.

The second-side terminal part 501 and the load-side terminal part 502 are arranged side by side in the second direction so as to face the other side in the first direction, and the second-side terminal part 501 and the first-side terminal part 500 are arranged side by side in the first direction toward the other side in the first direction, so that the first circuit part 2 and the second circuit part 3 are arranged on the one side in the first direction and the other side in changeover switch 5 in the housing 7, respectively, so that the first-side terminal part 500 and the second-side terminal part 501 can be wired in the first direction, so that the space-efficiency and the wiring-efficiency in the housing 7 can be improved while securing the insulating distance between terminal part.

In the present embodiment, the first side terminal part 500 and the second side terminal part 501 are disposed on one side in the second direction, and the load-side terminal part 502 is disposed on the other side in the second direction. Therefore, electricity is supplied to changeover switch 5 on one side in the second direction, and electricity is supplied from changeover switch 5 on the other side in the second direction.

Therefore, the second side terminal part 501 and the load side terminal part 502 can be separated from each other in the second direction, and the electrical connection between the second side terminal part 501 and second secondary terminal part 31 and the electrical connection between the load side terminal part 502 and the load primary terminal part 40 can be separated from each other.

Since first secondary terminal part and second secondary terminal part 31 in the strip area A including the first side terminal part 500 and the second side terminal part 501 are arranged on one side and the other side of the first direction, the first side of changeover switch 5 connected by first conductive connection part 23 to each other terminal part 500 and first secondary terminal part of the first circuit part 2 in the vicinity it is possible to place second secondary terminal part 31 of the second side 501 and the second circuit part 3 of changeover switch 5 in the vicinity, it is possible to simplify the first circuit part 2 and changeover switch 5 and the second circuit part 3 interconnection path.

In this embodiment, the first phase, terminal part 220a, second phase, terminal part 220b, and third phase terminal part 220c of the device primary terminal part 220 as a first secondary terminal part can be placed in the cingulate area A. In addition, the first phase, terminal part 321a, second phase terminal part 321b, and third phase terminal part 321c of the device secondary terminal part 321 as a second secondary terminal part 31 can be placed in the cingulate area A. Therefore, when the first circuit part 2, changeover switch 5, and the second circuit part 3 are electrically connected to each other, the interconnection path can be simplified because terminal part required for the electrical connection between the first circuit part 2, changeover switch 5, and the second circuit part 3 can be arranged in the belt-like area A.

Therefore, the first side terminal part 500 of changeover switch 5 connected by first conductive connection part 23 and first secondary terminal part of the first circuit part 2 can be arranged in the vicinity, the second side terminal part 501 of changeover switch 5 and second secondary terminal part 31 of the second circuit part 3 since it is possible to place in the vicinity, it is possible to simplify the first circuit part 2 and changeover switch 5 and the second circuit part 3 routing path.

Changeover switch built-in board of the present disclosure is not limited to the above-described embodiment, and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply.

For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the load device primary terminal part 420 and the load device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

Also in this case, the second conductive part 232 may be integrally formed with the first conductive part 231 as in the above-described embodiment, or may be separately attached to the first conductive part 231.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2.

As a result, the load circuit part 4 can be electrically disconnected from the first power supply system P1 and the second power supply system P2, and can further improve electric safety such as when inspecting the load device or the like connected to the load circuit part 4.

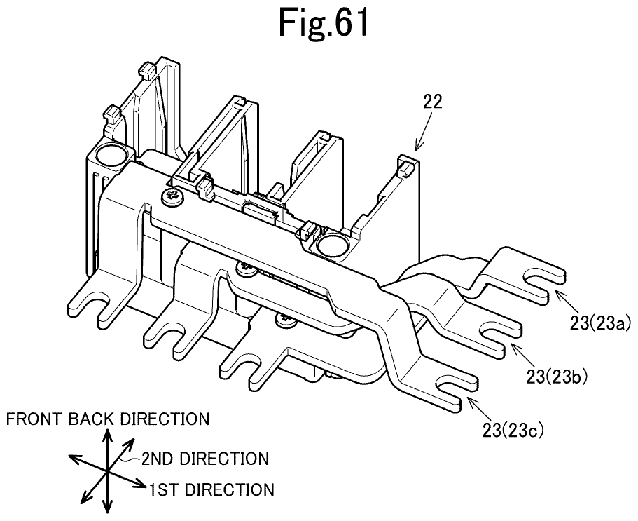

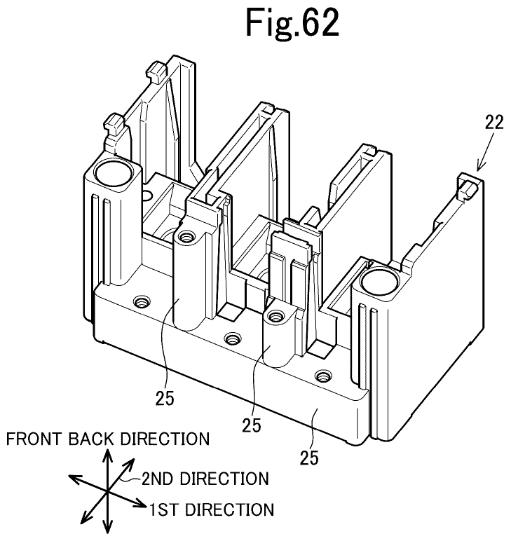

Although not specifically mentioned in the above embodiment, first conductive connection part 23 may be configured so that the second conductive part 232 is also screwed to the first electric device 22. In this case, for example, as shown in FIGS. 61 and 62, the first electrical device 22 may be provided with the fixing base part 25 having the screw hole formed therein.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 extends to the other side in the second direction with respect to the connecting fixing part 230, but is not limited to this configuration. The second conductive part 232 may extend, for example, to one side in the second orientation relative to the connecting fixing part 230. Again, the first conductive part 231 may be configured to extend to the other side of the first direction relative to the connection fixing part 230, and the first conductive part 231 may be configured to extend to the one side of the first direction relative to the connection fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

In the above embodiment, the first electric device 22 is disposed on one side in the first direction with respect to changeover switch 5, and the second electric device 32 is disposed on the other side in the first direction with respect to changeover switch 5. However, the present invention is not limited thereto, and for example, the first electric device 22 may be disposed on one side of changeover switch 5 in the second direction, and the second electric device 32 may be disposed on the other side of changeover switch 5 in the second direction. In addition, it is conceivable that at least the device secondary terminal part 321 and the second-side terminal part 501 face each other in the second direction. In addition, the first phase terminal part 500a, 501a of the first side terminal part 500 and the second side terminal part 501, the second phase terminal part 500b, 501b, and the band-like area A defined by the third phase terminal part 500c, 501c may extend in the second direction.

In the above embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the above embodiment, the second side terminal part 501 and the load side terminal part 502 are arranged in the second direction, and the second side terminal part 501 is arranged on one side in the second direction, and the load side terminal part 502 is arranged on the other side in the second direction, but the present invention is not limited thereto, and for example, the second side terminal part 501 may be arranged on the other side in the second direction and the load side terminal part 502 may be arranged on one side in the second direction. Here, the second circuit part 3 is arranged on the other side in the second direction and the loading circuit part 4 is arranged on the one side in the second direction.

In addition, in this case, in the second direction, the load side terminal part 502 may be disposed at the same position as the first side terminal part 500 or the second side terminal part 501, or the load side terminal part 502 may be disposed before and after the first side terminal part 500 or the second side terminal part 501.

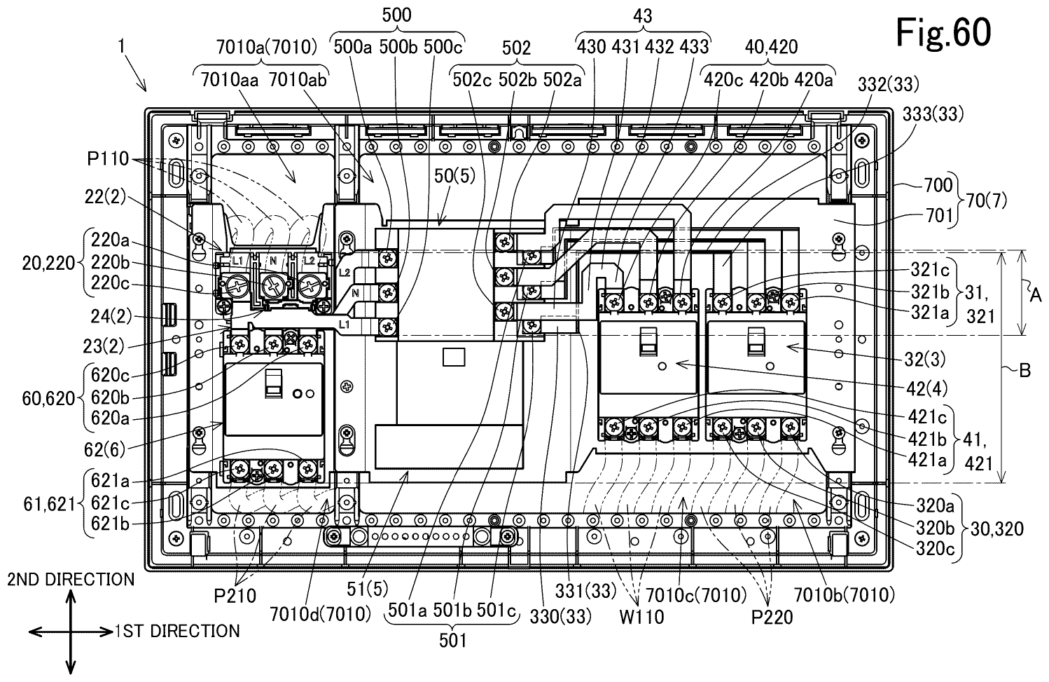

Specifically, in changeover switch 5 shown in FIG. 60, the load-side terminal part 502 is disposed on the front side of the second-side terminal part 501. The load-side terminal part 502 is disposed on one side of the second-side terminal part 501 in the first direction, and the three terminal part 502a, 502b, 502c of the load-side terminal part 502 and the three terminal part 501a, 502b, 502c of the second-side terminal part 501 are disposed at different positions in the second direction.

In the above embodiment, changeover switch built-in board 1 includes the relay circuit part 6, but the present invention is not limited thereto, and for example, changeover switch built-in board 1 may not include the relay circuit part 6, and the electric wire from the direct external facility may be connected to the second conductive part 232 of first conductive connection part 23, or the relay circuit part 6 may be provided outside changeover switch built-in board 1. In addition, the first conductive insertion part 7010a may be disposed on the other side of the first circuit part 2 or changeover switch 5 in the second direction. First primary terminal part 20 may be disposed toward the other side in the second direction.

In the above embodiment, changeover switch built-in board 1 includes the load circuit part 4, but the present invention is not limited thereto, and for example, changeover switch built-in board 1 may not include the load circuit part 4. A load conductor W110 may be connected to the load-side terminal part 502 of changeover switch 5.

In the load electric device 42 of the above embodiment, the load device primary terminal part 420 is provided at one end of the first direction, and the load device secondary terminal part 421 is provided at the other end of the first direction. However, the present invention is not limited thereto, and for example, in the load electric device 42, the load device primary terminal part 420 may be provided at the other end part in the first direction, and the load device secondary terminal part 421 may be provided at the one end part in the first direction.

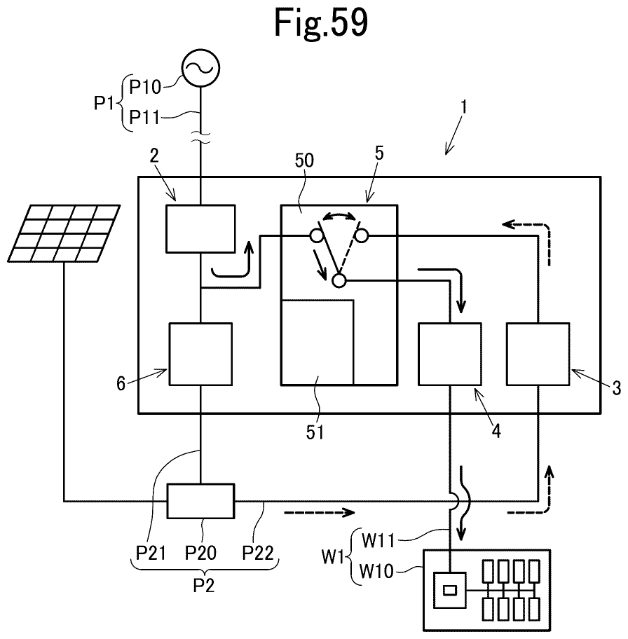

In the load electric device 42 of the above embodiment, the load device primary terminal part 420 is oriented in one side of the first direction, and the load device secondary terminal part 421 is oriented in the other side of the first direction, that is, the load electric device 42 is arranged in a lateral direction along the first direction. However, for example, the load electric appliance 42 may be vertically oriented such that the load appliance primary terminal part 420 and the load appliance secondary terminal part 421 are aligned in the second direction. i.e., along the second direction, as shown in FIGS. 59 and 60. In this case, one of the load device primary terminal part 420 and the load device secondary terminal part 421 may be disposed on one side in the second direction and the other may be disposed on the other side in the second direction.

In this case, the load conductor insertion part 7010c is provided at a position farther from the load electric device 42 than the load device secondary terminal part 421 in the direction in which the load device secondary terminal part 421 is disposed in the load electric device 42. Specifically, in FIG. 60, since the load device secondary terminal part 421 in the load electric device 42 is disposed on the other side in the second direction, the load conductor insertion part 7010c is provided on the other side (directly below) of the load device secondary terminal part 421 in the second direction. Therefore, since the load device secondary terminal part 421 is disposed toward the other side in the second direction and the load conductor insertion part 7010c is provided on the other side (directly below) in the second direction of the load electric device 42, it is possible to connect the second conductor 7010b and the device primary terminal part 320 without significantly changing the direction of the second conductor P220 introduced into the inside of the housing 7 from the second conductor insertion part 7010c.

In addition, the second electrical device 32 may be arranged in a vertical direction along the second direction. One of the device primary terminal part 320 and the device secondary terminal part 321 is disposed on one side in the second direction and the other is disposed on the other side in the second direction. Here, the second conductive insertion part 7010b is provided at a position farther from the second electric device 32 than the device primary terminal part 320 in the second electric device 32 in the direction in which the device primary terminal part 320 is disposed. Specifically, in FIG. 60, since the device primary terminal part 320 is disposed on the other side in the second direction, the second conductive insertion part 7010b is provided on the other side (directly below) of the device primary terminal part 320 in the second direction. Therefore, in FIG. 60, the device primary terminal part 320 is arranged toward the other side in the second direction, and since the second conductor insertion part 7010b is provided on the other side (directly below) in the second direction of the second electric device 32, the second conductor insertion part P220 is introduced from the second conductor insertion part 7010b to the inside of the housing 7, and the second conductor P220 can be connected to the device primary terminal part 320, so that the second conductor P220 can be easily and smoothly connected to the second electric device 32, and the wiring operation can be easily performed.

Incidentally, when the device primary terminal part 320 is disposed on one side in the second direction and the first conductor insertion part 7010a is provided on one side (directly above) in the second direction of the second electric device 32 as shown in FIG. 60, a part of the first conductor insertion part 7010a functions as the second conductor insertion part 7010b. The same applies to cases where the load device secondary terminal part 421 is disposed on one side in the second direction, and a part of the first conductor insertion part 7010a functions as the load conductor insertion part 7010c.

As shown in FIG. 60, when the second electric device 32 and the load electric device 42 are arranged in the vertical direction along the second direction, the three terminal part 320 primary device terminal part 320a, 320b, 320c and the three terminal part 421a, 421b, 421c of the load device secondary terminal part 421 may be aligned in the first direction, and the three terminal part 321a, 321b, 321c of the device secondary terminal part 321 and the three terminal part 420a, 420b, 420c of the load device primary 420 may be aligned in the first direction, or they may be arranged in different arrangement positions in the second direction.

Further, as shown in FIG. 60, when the second electric equipment 32 and the load electric device 42 are arranged in a vertical direction along the second direction, the second conductive connection part 33 and the load conductive connection part 43 may have shapes that differ from those of the above-described embodiment.

Specifically, the second conductive connection part 33 includes one end part 330 connected to the second-side terminal part 501, a conductive second part 331 extending in the second direction from the one end part 330, a conductive first part 332 extending in the first direction continuously with the conductive second part 331, and the other end part 333 connected to the device secondary terminal part 321. In FIG. 60, the conductive second part 331 extends from the one end part 330 to one side in the second direction, the conductive first part 332 extends from the conductive second part 331 to the other side in the first direction, and the other end part 333 extending from the conductive first part 332 to the other side in the second direction is connected to the device secondary terminal part 321.

The load conductive connection part 43 includes one end part 430 connected to the load-side terminal part 502, a conductive second part 431 extending in the second direction from the one end part 430, a conductive first part 432 extending in the first direction continuously with the conductive second part 431, and the other end part 433 connected to the load device primary terminal part 420. In FIG. 60, a conductive second part 431 extends from one end part 430 to one side in the second direction, a conductive first part 432 extends from the conductive second part 431 to the other side in the first direction, and the other end part 433 extending from the conductive first part 432 to the other side in the second direction is connected to the loading device primary terminal part 420.

In the above embodiment, changeover switch 5 includes the second-side terminal part 501 and the load-side terminal part 502 at the other end in the first direction. However, the present invention is not limited thereto, and for example, changeover switch 5 may include the second-side terminal part 501 and the load-side terminal part 502 at one end in the second direction.

In addition, changeover switch 5 may include a first side terminal part 500 and a load-side terminal part 502 at one end in the first direction. Here, the first side terminal part 500 and the load side terminal part 502 may be arranged so as to be oriented in the same direction in the first direction and aligned in the second direction. In addition, the loading circuit part 4 may be disposed on one side of changeover switch in the first direction.

In the above-described embodiment, the second conductive insertion part 7010b is disposed on the other side of second primary terminal part 30 in the first direction. However, the present invention is not limited thereto, and for example, the second conductive insertion part 7010b may be disposed on one side of second primary terminal part 30 in the first direction.

In the above embodiment, the arrangement positions of the device primary terminal part 320 and the device secondary terminal part 321 of the second electric device 32 in the second orientation are the same. However, the present invention is not limited thereto, and for example, the arrangement positions of the device primary terminal part 320 and the device secondary terminal part 321 of the second electric device 32 in the second direction may differ from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, the first conductive insertion part 7010a is provided on one side of first primary terminal part 20 or changeover switch 5 in the second direction. However, the present invention is not limited thereto, and for example, the first conductive insertion part 7010a may be disposed on one side of first primary terminal part 20 in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

The first conductor-insertion part 7010a may be provided in the second direction just above one side of first primary terminal part 20 or just above one side of changeover switch 5.

In the above-described embodiment, as shown in FIG. 48, the positions of the second-side terminal part 501 and the load-side terminal part 502 in the first direction differ from each other. However, for example, the second-side terminal part 501 and the load-side terminal part 502 may be arranged such that their positions in the first direction are the same (that is, they are arranged along an imaginary straight line extending in the second direction).

In the second circuit part 3 of the above-described embodiment, second primary terminal part 30 is disposed on the other side in the first direction, but the present invention is not limited thereto, and for example, second primary terminal part 30 may be disposed on the one side in the second direction. Second primary terminal part 30 may be configured to be connectable in a direction in which the second conductor P220 extends from second primary terminal part 30 to one side in the second direction.

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the above embodiment, the arrangement positions of the device primary terminal part 320 and the device secondary terminal part 321 are the same in the second orientation. However, the present invention is not limited thereto, and for example, the device primary terminal part 320 and the device secondary terminal part 321 of the second electric device 32 may be arranged at different positions in the second direction.

In the above embodiment, the load circuit part 4 includes the load electric device 42 as a circuit breaker, but the present invention is not limited thereto, and the load circuit part 4 may be configured to include the power distribution circuit part.

Specifically, the load circuit part 4 may be configured to include a main switch connected to the load side terminal part 502 of changeover switch 5, and a plurality of branch switches connected to the secondary side of the main switch via a bus. The housing 7 is sized to accommodate the power distribution circuit part as well.

Next, a changeover switch built-in board according to another embodiment will be described. Changeover switch built-in board according to the present disclosure incorporates a changeover switch.

As a distribution board which is a conventional changeover switch built-in board, for example, there is a distribution board described in Japanese Patent No. 6351333. The distribution board includes a commercial power supply circuit part and a distributed power supply circuit part. The commercial power supply circuit part comprises a main switch and a number of branch switches plugged into its secondary bus bar. In the distributed power supply circuit part, a switch for a distributed power supply and a changeover switch with a vibration-sensitive relay are arranged. Changeover switch with vibration-sensitive relays has two input-terminals and one output-terminal. The distributed power supply is connected to the primary side of the switch for the distributed power supply, and is further connected from the secondary side of the switch for the distributed power supply to one of the input terminals of changeover switch with vibration-sensitive relays. The other terminal of changeover switch with the vibration-sensitive relay is connected to one branch switch of the commercial power supply circuit part. Furthermore, an emergency circuit is connected as a load to the output terminal of changeover switch with vibration-sensitive relay, and is formed so that the supply from the commercial power supply or the distributed power supply can be switched by changeover switch with vibration-sensitive relay.

However, in the distribution board described in Japanese Patent No. 6351333, changeover switch with vibration-sensitive relay and the switchgear for the distributed power supply are arranged side by side in the left-right direction, and one input terminal of changeover switch with vibration-sensitive relay is arranged downward at the lower end part, whereas the secondary side of the switchgear for the distributed power supply is arranged upward at the upper end part. Therefore, in order to electrically connect one of the input terminals of changeover switch with the vibration-sensitive relay and the secondary side of the switch for the distributed power supply, the wiring needs to be circulated such that one end of the wiring faces upward and the other end faces downward. Therefore, the distribution board described in Japanese Patent No. 6351333 has a complicated wiring path. This is not limited to a distribution board including a main switch and a branch switch, but also an electric board including a changeover switch capable of switching the power supply.

Therefore, an object of the present disclosure is to provide a changeover switch built-in board capable of simplifying a wire path.

The present invention comprises: Changeover switch built-in board is characterized in that includes changeover switch for switching a power supply for supplying electricity to a load to a first power supply system or a second power supply system, and a first circuit part electrically connecting the first power supply system and changeover switch and a second circuit part electrically connecting the second power supply system and changeover switch and a load circuit part electrically connecting the load and changeover switch, and a housing for housing the changeover switch and the first circuit part and the second circuit part and the load circuit part, and the changeover switch includes a first side terminal part electrically connected to the first circuit part and a second side terminal part electrically connected to the second circuit part and a load side terminal part electrically connected to the load circuit part, and the load side terminal part is disposed on the front side or the rear side of the first side terminal part or the second side terminal part in the front-rear direction in the housing, the first side terminal part and the second side terminal part are arranged such that one terminal part is aligned to one side and the other terminal part is aligned to the other side in one of the first direction orthogonal to the front-rear direction and the second direction orthogonal to the first direction, the second circuit part includes a device primary terminal part which is electrically connected to the second power supply system, the second circuit part includes a second electric device including a device primary terminal part electrically connected to the second power supply system and a device secondary terminal part electrically connected to the second terminal part, and the primary terminal part and the secondary terminal part of the device of the second electric device are arranged such that one terminal part is aligned to the one side and the other terminal part is aligned to the other side in the other direction of the first direction and the second direction, and the load circuit part includes a load electric device including a load secondary terminal part electrically connected to the load and a load primary terminal part electrically connected to the load side terminal part, and the load primary terminal part and the load secondary terminal part are arranged so that one terminal part is directed to one side and the other terminal part is directed to the other side in the other direction, the second electrical device and the load electrical device are arranged in parallel with the changeover switch in one direction, and the device secondary terminal part is arranged closer to the second side terminal part in the other direction than the device primary terminal part, the load primary terminal part is arranged closer to the load side terminal part in the other direction than the load secondary terminal part.

According to the configuration, the load side terminal part is disposed on the front side or the rear side of the first side terminal part or the second side terminal part, so that the space in the front-rear direction can be effectively utilized inside the housing, and the load side terminal part and the load primary terminal part can be disposed closer to the load side terminal part in the other direction than the load primary terminal part by disposing the device secondary terminal part closer to the second side terminal part in the other direction than the device primary terminal part, so that the second side terminal part and the device secondary terminal part can be disposed closer to each other, and further, the load primary terminal part can be disposed closer to the load side terminal part in the other direction than the load secondary terminal part. Therefore, the wiring path of changeover switch and the second electric device, and the wiring path of changeover switch and the loaded electric device can be simplified.

In addition, in the present disclosure, changeover switch may include a switching body part that switches between supply of electricity from the first power supply system and supply of electricity from the second power supply system, and a switching control part that is disposed on one side or the other side in the other direction with respect to the switching body part and controls switching by the switching body part, wherein the switching body part includes the first side terminal part, the second side terminal part, and the load side terminal part, and the device primary terminal part and the load secondary terminal part may be disposed side by side in the one direction with respect to the switching control part.

According to the configuration, since the device primary terminal part and the load secondary terminal part are arranged side by side in the one direction with respect to the switching control part, the space on the one side or the space on the other side in the one direction can be effectively used more effectively than the space on the switching control part.

As described above, according to the present disclosure, since the second side terminal part and the device secondary terminal part can be arranged close to each other and the load side terminal part and the load primary terminal part can be arranged close to each other, the wiring path between changeover switch and the second electric device and the wiring path between changeover switch and the load electric device can be simplified.

Hereinafter, a changeover switch built-in board according to a first embodiment of the present disclosure will be described referring to the accompanying drawings.

Changeover switch built-in board is installed between a plurality of power supply systems and a load, and is configured to switch between a plurality of power supply systems and a connected status of the load.

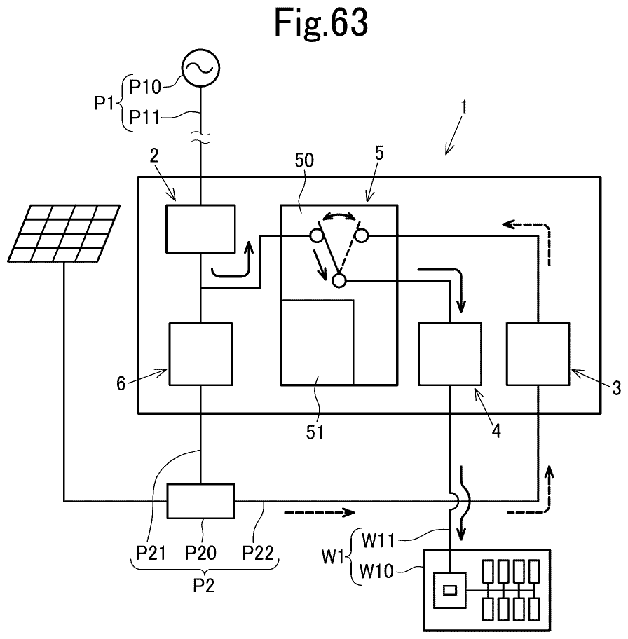

For example, as shown in FIG. 63, when changeover switch built-in board is installed in a house, a first power supply system P1 through which commercial power flows, a second power supply system P2 including a distributed power supply, and a load system W10 including a load system W1 are electrically connected to changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

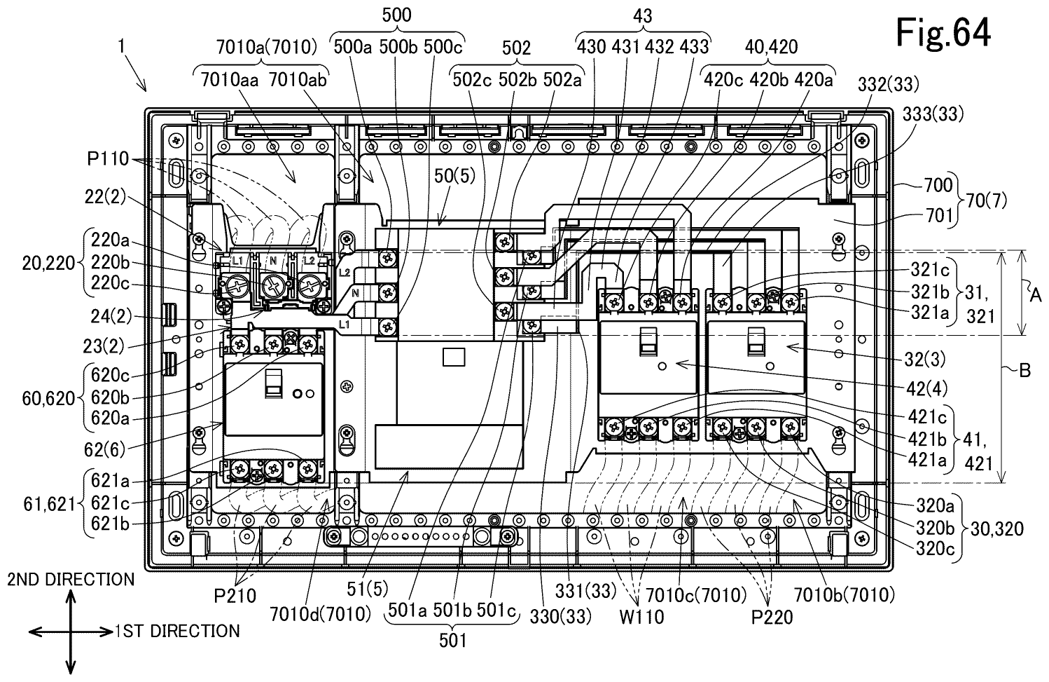

As shown in FIG. 64, changeover switch built-in board 1 includes a first P1 2 that is electrically connected to the first power supply system changeover switch, a second circuit part 3 that is electrically connected to the second power supply system P2, a load circuit part 4 that is connected to the load system W1, a changeover switch built-in board 5 that switches the power supply that supplies electricity to the load system W1 to the first power supply system P1 or the second power supply system P2, a relay circuit part 6 that is electrically connected to the first circuit part 2 and the second power supply system P2, and a housing 7 (see FIG. 64) that houses the first circuit part 2, the second circuit part 3, the relay circuit part 6, changeover switch 5, and the load circuit part 4.

In the present embodiment, a direction in which the front surface and the back surface of changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction formed by the first direction and the second direction is referred to as a board surface direction.

In the present embodiment, the first direction is a direction corresponding to the left-right direction in a state where changeover switch built-in board 1 in the installed state is viewed from the front, and the one side in the first direction is a left side and the other side in the first direction is a right side.

In addition, the second direction is a direction corresponding to the up-down direction in a state where changeover switch built-in board 1 in the installed state is viewed from the front, the one side in the second direction is the upper side, and the other side in the second direction is the lower side.

The first circuit part 2 is electrically connected to the first power supply system P1 and changeover switch 5. The first circuit part 2 is disposed on one side of changeover switch 5 in the first direction.

The first circuit part 2 of the present embodiment has a first power supply system P1 electrically connected to a first primary terminal part 20, and a changeover switch 5 (a first-side terminal part 500 to be described later) and a relay circuit part 6 electrically connected to a first secondary terminal part (not numbered). In the first circuit part 2 of the present embodiment, first primary terminal part 20 also serves as a first secondary terminal part.

In the first circuit part 2, first primary terminal part 20 is disposed toward one side in the second direction, and is connectable to first primary terminal part 20 in a direction extending from first primary terminal part 20 to one side in the second direction with the first power supply P10 (in the present embodiment, the first power distribution path P11) and the first conductive P110 connected to first primary terminal part 20.

The first circuit part 2 includes a first electric device 22, a first conductive connection part 23 fixed to the first electric device 22 so as to be electrically connected to the first conductive P110, and a partition member 24 for preventing a short circuit of first conductive connection part 23.

The first electrical device 22 is a terminal block. Further, the first electric device 22 is a terminal block including a first primary terminal part 20 electrically connected to the first power supply system P1, and a first power distribution path P1 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 of the present embodiment is disposed on one side of changeover switch 5 in the first direction. The first electric device 22 is disposed at a position spaced apart from changeover switch 5 in the first direction.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and first conductive connection part 23 are fixed to the device primary terminal part 220, the first conductor P110 and first conductive connection part 23 are electrically connected to each other. The device primary terminal part 220 of the present embodiment is configured such that the first conductive P110 and first conductive connection part 23 can be fixed by screws.

In addition, the equipment primary terminal part 220 may be configured to conduct each other by directly contacting the first conductive P110 and first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

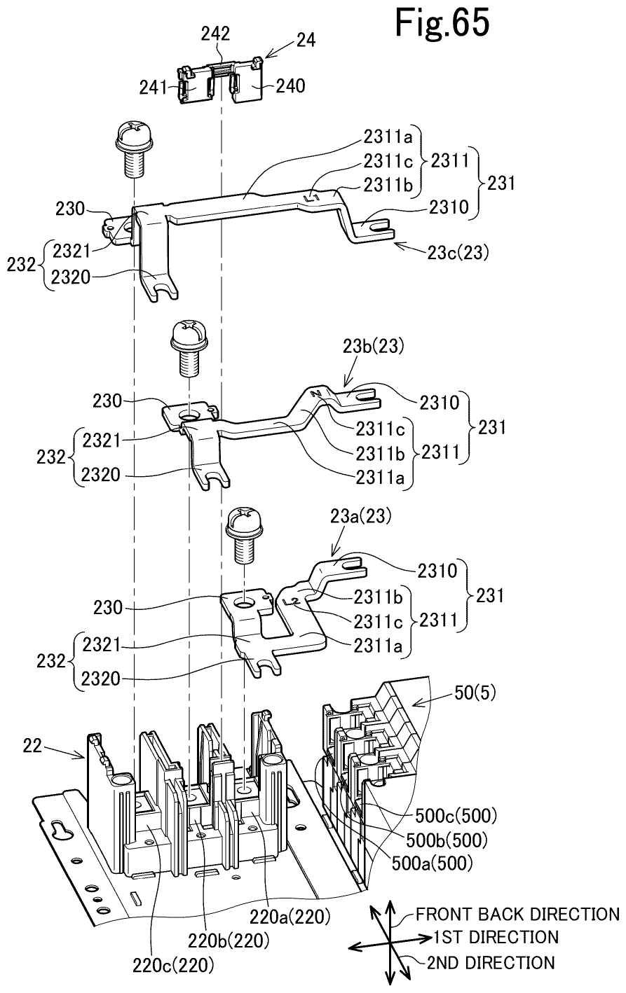

As shown in FIG. 65, first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the distal end side of the connection fixing part 230 is branched into the other side in the second direction and the other side in the first direction in first conductive connection part 23. First conductive connection part 23 of the present embodiment is made of a conductive plate material.

The first conductive part 231 includes a end part 2310 fixed to a first-side terminal part 500 of changeover switch 5, which will be described later, and a intermediate part 2311 that is contiguous with end part 2310 and the second conductive part 232 (a intermediate part 2321 of the second conductive part 232, which will be described later).

The first conductive part 231 intermediate part 2311 is a part interposed between the second conductive part 232 and end part 2310 of the first conductive part 231. Intermediate part 2311 of the first conductive part 231 of the present embodiment includes a proximal end side conductive part 2311a disposed between the first electric device 22 and the relay circuit part 6 (the other side in the second direction than the first electric device 22), a distal end side conductive part 2311b disposed between the first electric device 22 and changeover switch 5 (the other side in the first direction than the first electric device 22), and an identification 2311c attached to a front surface (one surface disposed toward the front side in the front-rear direction) of the distal end side conductive part 2311b. The identification 2311c may be formed by digging in intermediate part 2311 of the first conductive part 231 by direct marking, or may be formed by printing with a laser or the like.

The identification-display 2311c indicates the type of first conductive connection part 23. The identification-display 2311c of the present embodiment is constituted by characters of “L1” indicating L1 phase, “N” indicating the N phase, and “L2” indicating L2 phase.

The second conductive part 232 includes a end part 2320 fixed to a relay primary terminal part (relay device primary terminal part) of the relay circuit part 6, which will be described later, and a intermediate part 2321 connected to end part 2320 and the connecting fixing part 230.

Here, the first circuit part 2 has three first conductive connection part 23 corresponding to the numbers of the device primary terminal part 220. The three first conductive connection part 23, respectively, first conductive connection part 23 for the first phase (first phase conductive connection 23a), first conductive connection part 23 for the second phase (second phase conductive connection 23b), first conductive connection part 23 for the third phase (third phase conductive connection 23c).

The three first conductive connection part 23 are arranged such that the respective second conductive part 232 are aligned in the first direction in the front view.

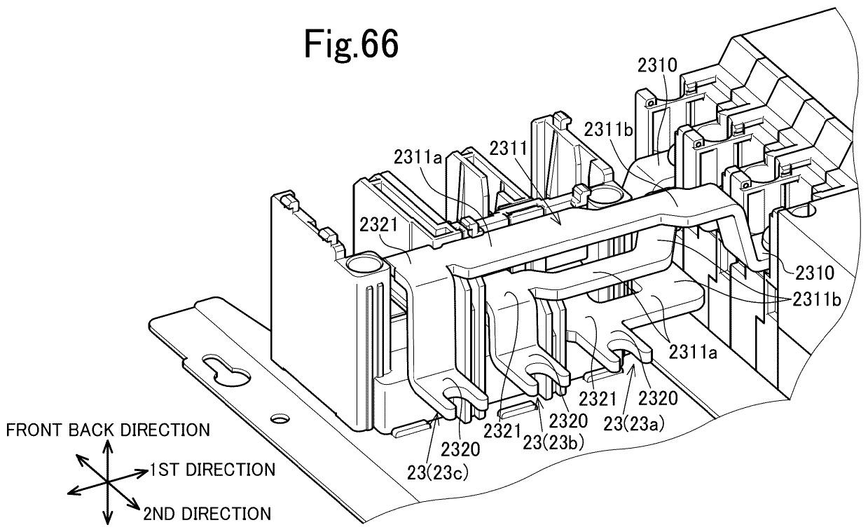

As shown in FIG. 66, intermediate part 2321 of each second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second 232 for the first phase, which is disposed on the most other side in the first direction, is disposed on the most rear side in the front-rear direction.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the conductive connection part 23) for the third phase conductive connection part 23c(L1 phase is disposed on the most front side in the front-rear direction, and the distal end side conductive part 2311b included in the second phase conductive connection part 23b and the third phase conductive connection part 23b (conductive connection part 23 for the N-phase) is disposed on one side in the front-rear direction and in the second direction with respect to the distal end side conductive part 2311b included in the second phase conductive connection part 23c is disposed on one side in the front-rear direction and in the second direction with respect to the distal end side conductive part 2311b included in the third phase conductive connection part conductive part 2311b, and is disposed on one side in the front-rear direction and in the second direction with respect to the distal end side 23a(L2 included in the first phase conductive connection part 23a(L2 23).

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the second phase conductive connection part 23b is also arranged so as to cross the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

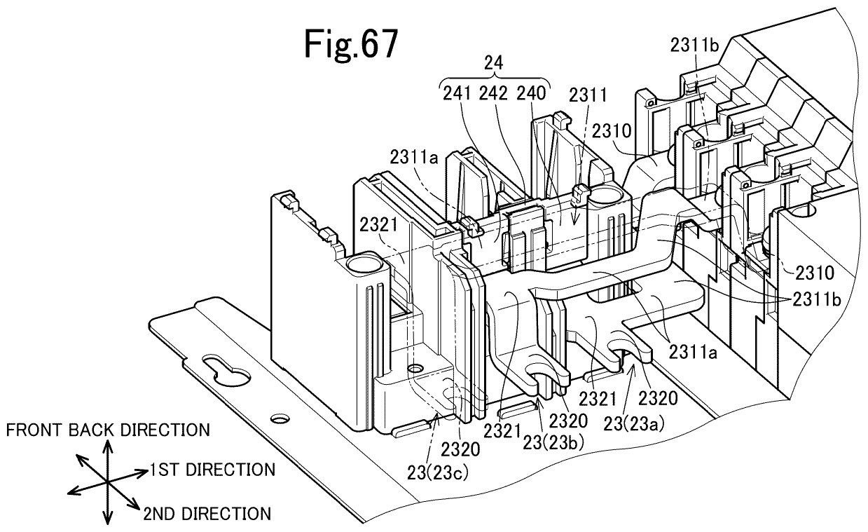

More specifically, as shown in FIG. 67, the partition member 24 has a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 64, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the second direction. The second power supply P20 (second distribution path P22 in the present embodiment), and second primary terminal part 30 in a direction in which the second conductor P220 connected to second primary terminal part 30 extends from second primary terminal part 30 to the other side of the second direction It has become connectable to.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The device primary terminal part 320 and the device secondary terminal part 321 are arranged to align in a second orientation. The location of the device primary terminal part 320 in the first direction and the location of the device secondary terminal part 321 in the first direction are the same. Further, in the present embodiment, the second electric device 32 is arranged such that the device primary terminal part 320 faces the other side in the second direction and the device secondary terminal part 321 faces the one side in the second direction. Further, the second electric device 32 of the present embodiment is disposed on the other side of the switching control part 51 in the first direction.

Therefore, in the present embodiment, the device secondary terminal part 321 of the second electric device 32 is disposed closer to the second-side terminal part 501 of changeover switch 5 than the device primary terminal part 320 in the second direction. The device secondary terminal part 321 of the second electric device 32 is disposed in a belt-like area A, which will be described later, and the device primary terminal part 320 of the second electric device 32 is disposed on the other side of the belt-like area A in the second direction and is disposed in a belt-like area B, which will be described later.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductor P220 of the second distribution path P22 is fixed to the equipment primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductor P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the first direction, and the first phase terminal part 321a of the device secondary terminal part 321, the second phase terminal part 321b, and the third phase terminal part 321c are also arranged to align with each other in the first direction.

The second conductive connection part 33 of the present embodiment includes one end part 330 connected to the second-side terminal part 501, a second conductive part 331 extending in the second direction from the one end part 330, a first conductive part 332 extending in the first direction continuously with the second conductive part 331, and the other end part 333 connected to the device secondary terminal part 321.

Specifically, as shown in FIG. 64, the second conductive part 331 extends from one end 330 extending to the other side in the first direction to one side in the second direction, the first conductive part 332 extends from the second conductive part 331 to the other side in the first direction, and the other end 333 extends from the first conductive part 332 to the other side in the second direction.

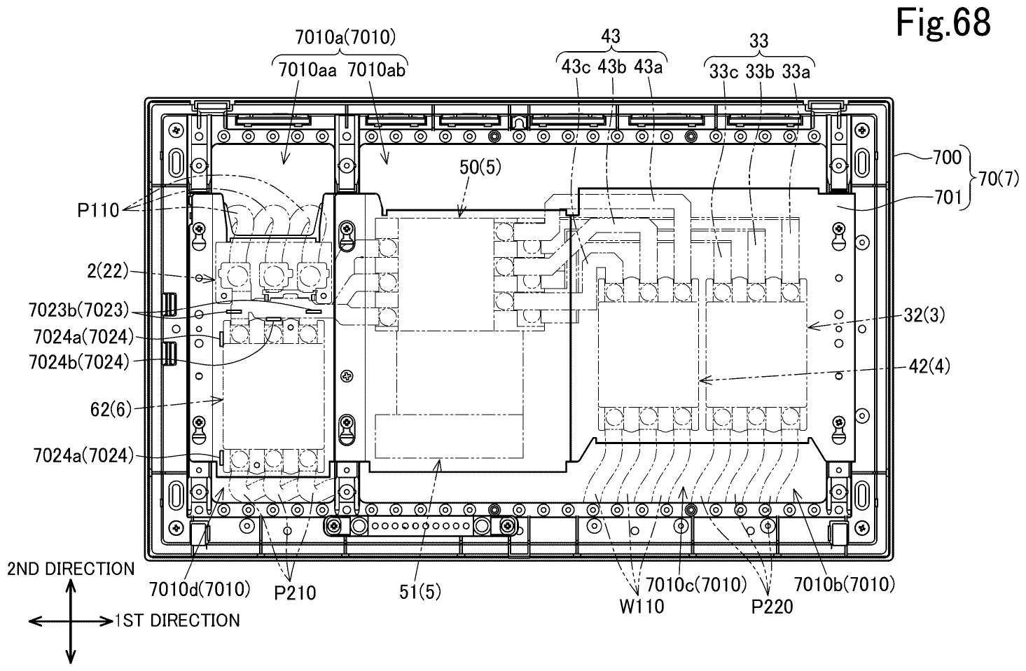

As shown in FIGS. 64 and 68, the second circuit part 3 of the present embodiment has three second conductive connection part 33 (a first phase conductive connection part 33a, a second phase conductive connection part 33b, and a third phase conductive connection part 33c). Further, in the three second conductive connection part 33, one end part 330 is aligned along the second direction, the second conductive part 331 are aligned along the first direction, the first conductive part 332 are aligned along the second direction, and the other end parts 333 are aligned along the first direction.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, the first phase terminal part 321a, the second phase terminal part 321b, and the third phase terminal part 321c of the device secondary terminal part 321 are arranged to be aligned along the first direction. The three second conductive connection part 33 are also arranged along the second direction in a state where they are fixed to the first phase terminal part 321a, the second phase terminal part 321b, and the third phase terminal part 321c. In the present embodiment, the other ends 333 of the three second conductive connection part 33 are connected to the three device primary terminal part 320 in the strip-shaped area A.

The second electric apparatus of the present embodiment is a circuit breaker. Therefore, in a state in which the second conductive terminal part 320 is fixed with the second conductor P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading equipment 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

In the load circuit part 4, the load device primary terminal part 420 and the load device secondary terminal part 421 are arranged to be aligned in the second direction, and the arrangement position of the load device primary terminal part 420 in the first direction and the arrangement position of the load device secondary terminal part 421 in the first direction are the same. In the present embodiment, the load device primary terminal part 420 is provided at one end of the load electrical device 42 in the second direction, and the load device secondary terminal part 421 is provided at the other end of the load electrical device 42 in the second direction.

Therefore, in the present embodiment, the load device primary terminal part 420 of the load electric device 42 is disposed closer to the load-side terminal part 502 of changeover switch 5 than the load device secondary terminal part 421 in the second direction. The load device primary terminal part 420 of the load electrical device 42 is disposed in a belt-like area A, which will be described later, and the load secondary terminal part 421 of the load electrical device 42 is disposed on the other side of the belt-like area A in the second direction, and is disposed in a belt-like area B, which will be described later. The load electrical device 42 of the present embodiment is disposed on the other side of the switching control part 51 in the first direction.

The load electrical device 42 of the present embodiment is arranged so as to be arranged at a position spaced apart from the second electrical device 32 in the first direction. The load-electric device 42 is disposed on the other side of changeover switch 5 in the first direction. The load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical equipment 42 is arranged side by side in the first direction with respect to the second circuit part 3, and the load equipment primary terminal part 420 of the load electrical equipment 42 and the equipment secondary terminal part 321 of the second electrical equipment 32 are arranged so as to be aligned in the first direction, and the load equipment secondary terminal part 421 of the load electrical equipment 42 and the equipment primary terminal part 320 of the second electrical equipment 32 are arranged so as to be aligned in the first direction. In the present embodiment, the load electrical equipment 42 is disposed at a position spaced apart from the second electrical device 32 in the first direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged to be aligned in the first direction, and the first phase terminal part 421a, the second phase terminal part 421b, and the third phase terminal part 421c of the load device secondary terminal part 421 are also arranged to be aligned in the first direction.

The load circuit part 4 has three load conductive connection part 43 corresponding to the numbers of the first phase terminal part 420a, the second phase terminal part 420b, and the third phase terminal part 420c. The load conductive connection part 43 includes one end 430 connected to the load-side terminal part 502, a second conductive part 431 extending in the second direction from the one end 430, a first conductive part 432 extending in the first direction from the second conductive part 431, and the other end 433 connected to the load device primary terminal part 420.

Specifically, the second conductive part 431 extends from one end 430 extending to the other side in the first direction to one side in the second direction, the first conductive part 432 extends from the second conductive part 431 to the other side in the first direction, and the other end 433 extends from the first conductive part 432 to the other side in the second direction.

As shown in FIG. 68, the load circuit part 4 of the present embodiment has three load conductive connection part 43 (a first phase conductive connection part 43a, a second phase conductive connection part 43b, and a third phase conductive connection part 43c). Further, in the three load-conducting connection part 43, one end part 430 is aligned along the second direction, the second conductive part 431 are aligned along the first direction, the first conductive part 432 are aligned along the second direction, and the other end parts 433 are aligned along the first direction.

The loaded conductive connection part 43 of the present embodiment is disposed in front of the second conductive connection part 33 in the front-rear direction in the housing 7. Therefore, the loaded conductive connection part 43 and the second conductive connection part 33 overlap each other in part or entirely in the front-rear direction while the inside of the housing 7 is viewed from the front.

As described above, since the first phase terminal part 420a, the second phase terminal part 420b, and the third phase terminal part 420c of the load device primary terminal part 420 are arranged in the first direction, the other end parts 433 of the three load conductive connection part 43 are arranged in the first direction while being fixed to the first phase terminal part 420a, the second phase terminal part 420b, and the third phase terminal part 420c, respectively. In the present embodiment, the other end 433 of the three loaded conductive connection part 43 is connected to the three device primary terminal part 321 in the strip area A.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching body part 50 that switches between the first circuit part 2 and the second circuit part 3 and the load circuit part 4, and a switching control part 51 that operates the switching body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500 and the second side terminal part 501 are provided at different ends of changeover switch 5 in the first direction. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction.

Further, the second-side terminal part 501 and the load-side terminal part 502 are arranged side by side in the front-rear direction while being oriented in the same direction in the first direction. In addition, the load-side terminal part 502 of the present embodiment is disposed at a position that differs from the second-side terminal part 501 in the second direction. Specifically, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a.

In the present embodiment, the second side terminal part 501 is disposed on the rear side in the front-rear direction, and the load-side terminal part 502 is disposed on the front side in the front-rear direction. Therefore, in the present embodiment, one end part 430 connected to the second side terminal part 501 is disposed rearward, and one end part 430 connected to the load-side terminal part 502 is disposed forward. Furthermore, the arrangement position of the second side terminal part 501 of the present embodiment in the first direction and the arrangement position of the load-side terminal part 502 in the first direction are different from each other. More specifically, the second side terminal part 501 is arranged to be located on the other side of the load-side terminal part 502 in the first direction. The load-side terminal part 502 of the present embodiment is disposed at the same position as the first-side terminal part 500 in the front-rear direction.

The first phase terminal part 500, the first phase terminal part 500a, the second phase terminal part 500b, and the third phase terminal part 500c are arranged in order in the second direction, and the first phase terminal part 501a of the second side terminal part 501, the second phase terminal part 501b, and the third phase terminal part 501c are arranged in order in the second direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b. 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

The second-side terminal part 501 and the load-side terminal part 502 are arranged such that the first phase terminal part 501a, 502a, the second phase terminal part 501b, 502b, and the third phase terminal part 501c. 502c are arranged in order in the second direction.

In addition, in the second direction, in the band-like area A extending in a direction including from the first phase terminal part 500a of the first terminal part 500 and the first phase terminal part 501a of the second terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side terminal part 500, and second secondary terminal part 31 and the primary terminal part 40 are arranged in the second direction on the other side of the second side terminal part 501.

Therefore, changeover switch 5 of the present embodiment is disposed between the first circuit part 2, the second circuit part 3, and the loading circuit part 4 in the first direction. In addition, changeover switch 5 of the present embodiment is disposed on the other side of the relay circuit part 6 in the first direction. Therefore, as shown in FIG. 64, in the present embodiment, the relay electrical device 62 is disposed on one side of the switching control part 51 in the first direction.

As shown in FIG. 63, the switching main body 50 is switchable between a state in which the first side terminal part 500 and the load side terminal part 502 are electrically connected to each other and the second side terminal part 501 and the load side terminal part 502 are electrically disconnected from each other (the first power supply state), and a state in which the first side terminal part 500 and the load side terminal part 502 are electrically disconnected from each other and the second side terminal part 501 and the load side terminal part 502 are electrically connected to each other (the second power supply state), and the switching control part 51 is configured to switch the first power supply state and the second power supply state by operating the switching main body 50.

The switching control part 51 may be configured to automatically switch between the first power supply state and the second power supply state of the switching main body 50, but may be configured to manually switch between the first power supply state and the second power supply state, or may be configured to manually switch between the first power supply state and the second power supply state by remote control from the outside.

Further, for example, the switching control part 51 may be configured to switch the switching main body part 50 from the first power supply state to the second power supply state when it is detected that the power supply from the first power supply system P1 is interrupted, and to switch the switching main body part 50 from the second power supply state to the first power supply state when it is detected that the power supply from the first power supply system P1 is restored.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 321 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction. The device secondary terminal part 621 of the relay electric device 62 is disposed on one side of the switching control part 51 in the first direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

In the relay electric device 62, the first phase terminal part 620a, the second phase terminal part 620b, and the third phase terminal part 620c are arranged in the first direction (so as to be aligned), and the first phase terminal part 621a, the second phase terminal part 621b, and the third phase terminal part 621c are also arranged in the first direction (so as to be aligned).

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 621 of the relay electrical device 62) in the second direction, and to be within the band-shaped area B extending in the first direction.

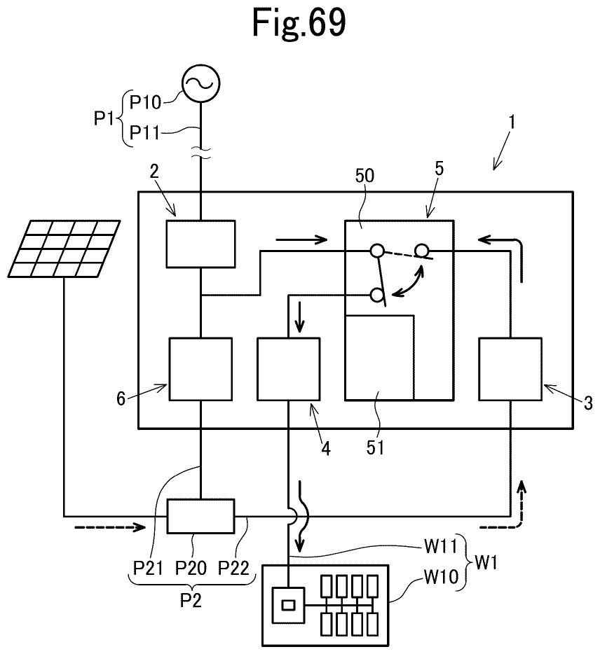

As shown in FIG. 69, the housing 7 has a housing part 70 in which the first circuit part 2, the second circuit part 3, the loading circuit part 4, changeover switch 5, and the relay circuit part 6 can be accommodated.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of the first electric device 22 in the second direction relative to first primary terminal part 20 or changeover switch 5 (in the present embodiment, on one side of the first electric device 22 in the second direction). Therefore, the first conductor insertion part 7010a allows the first conductor P110 to be inserted into and out of the housing 7 on one side of first primary terminal part 20 or changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric device 22, and the switching-side first conductor insertion part 7010ab is disposed directly above changeover switch 5 and the second electric device 32. In the present embodiment, as shown in FIG. 64, the first conductor P110 is inserted inside the housing 7 via the first-side first conductor insertion part 7010aa.

In the present embodiment, the first-side first conductor insertion part 7010aa is formed to cover the entire area of the first electric device 22 in the first direction, and the switching-side first conductor insertion part 7010ab is formed to cover the entire area of changeover switch 5 in the first direction. The first conductive insertion part 7010a is also formed on one side of the second electric device 32 in the second direction. The switching-side first conductive insertion part 7010ab is also formed on one side of the load electric device 42 and the second electric device 32 in the second direction, and is formed so as to cover the entire area of the load electric device 42 and the second electric device 32 in the first direction. Therefore, the first conductive insertion part 7010a of the present embodiment is formed so as to correspond to the entire length of the first electric device 22, changeover switch 5, the load electric device 42, and the second electric device 32 in the first direction.

The second conductive insertion part 7010b is provided on the other side (directly below) of the device primary terminal part 320 of the second electric device 32 in the second direction. Therefore, the second conductor insertion part 7010b allows the second conductor P220 to be inserted into and out of the housing 7 on the other side of the device primary terminal part 320 of the second electric device 32 in the second direction. In the present embodiment, the second conductive insertion part 7010b is formed over the entire area of the second electric device 32 in the first direction.

The second conductive insertion part 7010b extends to one side in the first direction from the second electric device 32. In the second conductor insertion part 7010b, a part extending to one side in the first direction relative to the second electric device 32 has a part that is the same as the loading conductor insertion part 7010c described later. Therefore, the second conductive insertion part 7010b is formed in the first direction longer than the length of the second electric device 32 in the first direction.

The load conductor insertion part 7010c is provided on the other side (directly below) of the load device secondary terminal part 421 of the load electric device 42 in the second direction. Therefore, the load conductor insertion part 7010c allows the load conductor W110 to be inserted into and out of the housing 7 on the other side of the load device secondary terminal part 421 of the load electric device 42 in the second direction. The load-conductor insertion part 7010c is formed to extend in the first direction. In the present embodiment, the load conductor insertion part 7010c is formed so as to extend over the entire area of the load electric device 42 in the first direction.

Further, the load-conductor insertion part 7010c and the second conductor insertion part 7010b are formed at positions aligned in the first direction, and are formed so as to be continuous with each other. Therefore, the load-conductor insertion part 7010c and the second conductor insertion part 7010b are also used. Therefore, for example, the second conductor P220 can be inserted into and out of the housing 7 from the load conductor insertion part 7010c which also serves as the second conductor insertion part 7010b. Further, the load-conductor insertion part 7010c and the second conductor insertion part 7010b are formed so as to extend to one side and the other side in the first direction. Therefore, the continuous insertion part (not numbered) in which the second conductor insertion part 7010b and the load conductor insertion part 7010c are combined is formed so as to correspond to the entire area of the second electric device 32 and the load electric device 42 arranged side by side in the first direction in the first direction. Specifically, the continuous insertion part is formed so as to extend from a position immediately below the second electric device 32 to a position immediately below the load electric device 42 in the first direction.

In addition, the second conductor insertion part 7010b and the load conductor insertion part 7010c are disposed so as to extend over the other sides of the second electric device 32, the load electric device 42, and changeover switch 5 in the second direction. Therefore, the continuously inserted part of the present embodiment is disposed directly under the second electric device 32, the loading electric device 42, and changeover switch 5. Therefore, in the present embodiment, the second conductor P220 and the load conductor W110 are inserted from the outside to the inside of the housing 7 by using the continuous insertion part in which the second conductor insertion part 7010b and the load conductor insertion part 7010c are combined.

As shown in FIG. 64, the second conductor insertion part 7010b and the loaded conductor insertion part 7010c are arranged in the second direction so as to extend in the band-shaped area B and the other side of the band-shaped area B in the second direction. Therefore, the second conductor insertion part 7010b and the loaded conductor insertion part 7010c of the present embodiment are included in the band-shaped area B and the band-shaped area B.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction.

The positioning arrangement 702 includes a first circuit-part positioning section 7023 for positioning the first circuit part 2 with respect to the back surface section 701, and a relay circuit part positioning section 7024 for positioning the relay circuit part 6 with respect to the back surface section 701.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The second electric device 32, the load electric device 42, and the relay electric device 62 are arranged such that the operation direction of the operation part matches the second direction. As described above, the second electric device 32 and the load electric device 42 are arranged such that the second electric device 32 and the relay electric device 62 arranged at a position away from the load electric device 42 have the same operating orientation of the operating part.

As described above, according to changeover switch built-in board 1 of the present embodiment, the first changeover switch 5 and the relay circuit part 6, which are arranged in the first direction with respect to the first circuit part 2 (in the present embodiment, changeover switch 5), can connect the first conductive part 231 to the first side terminal part 500 along the first direction because the first conductive part 231 extending in the first direction has terminal part (the first side terminal part 500) facing end part 2310 in the first direction.

Among the changeover switch 5 and the relay circuit part 6, those aligned in the second direction with respect to the first circuit part 2 (the relay circuit part 6 in the present embodiment) have the relay primary terminal part 60 facing end part 2320 of the second conductive part 232 extending in the second direction in the second direction, so that the second conductive part 232 can be connected to the relay primary terminal part 60 along the second direction.

As described above, since the first conductive part 231 and the second conductive part 232 can be connected along the first direction or the second direction in which changeover switch 5 or the relay circuit part 6 is aligned with the first circuit part 2, it is possible to reduce the size of changeover switch built-in board 1.

In first conductive connection part 23 of the present embodiment, since the first conductive part 231 is formed so that the proximal conductive part 2311a extends straight from the second conductive part 232 toward the connection target (the first side terminal part 500), the first conductive part 231 may not be oriented with respect to the direction in which the second conductive part 232 extends from the connection fixing part 230. Therefore, in the present embodiment, the space between the first electrical device 22 and the relay electrical device 62 is reduced.

In addition, in changeover switch built-in board 1 of the present embodiment, since first conductive connection part 23 is formed of a plate material having conductivity, first conductive connection part 23 can be formed in a configuration along the wire path, and the space required for changing the direction of first conductive connection part 23 can be reduced.

Further, in changeover switch built-in board 1 of the present embodiment, the base end part side (intermediate part 2321) of the second conductive part 232 is formed so as to be located on the front side in the front-rear direction of the connecting fixing part 230 and conductive part 232 in end part 2320, and the space on the rear side of the first conductive part 231 can be used as a space for, for example, a wire or the like because the first conductive part 231 branches from intermediate part 2321 of the second conductive part 232 toward the first direction.

Further, the plurality of first conductive connection part 23 can be prevented from spreading in the second direction because the proximal conductive part 2311a of the respective first conductive connection part 23 are arranged in a row in the front-rear direction.

In particular, the three proximal conductive part 2311a can be arranged closer to each other in the front-rear direction and the plurality of second conductive part 232 can be arranged closer to each other in the first direction because they are arranged side by side from the front side to the rear side in the front-rear direction in order from the one extending from the second conductive part 232 which is arranged at the one-most position in the first direction (the position farthest from changeover switch 5 in the first direction). As a result, it is possible to suppress the extension of the space in which the plurality of first conductive connection part 23 are arranged in the first direction.

Further, in changeover switch built-in board 1 of the present embodiment, since the identification display 2311c attached to the front surface of each of the front-end-side conductive part 2311b is configured to be exposed to the front side, the identification display 2311c attached to each of the plurality of first conductive connection part 23 becomes easy to see, and the type of each of first conductive connection part 23 becomes easy to distinguish.

Further, first primary terminal part 20 is disposed toward one side in the second direction perpendicular to the first direction and the front-rear direction, the first electric device 22 or changeover switch 5 is a terminal block on one side in the second direction, since the first conductor insertion part 7010a is provided, the first conductor insertion part from 7010a of the first conductor insertion part without significantly changing the direction of the first conductor P110 to introduce the first conductor P110 to the inside of the housing 7, the first conductor P110 can be connected to first primary terminal part 20, the first conductor P110 can be easily and smoothly connected to the first electric device 22, thereby, it is possible to easily perform the wiring operation.

Further, in the present embodiment, first primary terminal part 20 is disposed toward one side in the second direction, the first-side first conductor insertion part 7010aa is disposed on one side (directly above) in the second direction of the terminal block as the first electric device 22, and the switching-side first conductor insertion part 7010ab is disposed on one side (directly above) in the second direction of changeover switch 5 and the second electric device 32. The first conductor P110 introduced into the inside of the housing 7 is connected to first primary terminal part 20 via the first-side first conductor insertion part 7010aa. Therefore, the first conductive P110 and first primary terminal part 20 can be easily connected in the second direction.

Since first secondary terminal part and second secondary terminal part 31 in the strip area A including the first side terminal part 500 and the second side terminal part 501 are arranged on one side and the other side of the first direction, the first side of changeover switch 5 connected by first conductive connection part 23 to each other terminal part 500 and first secondary terminal part of the first circuit part 2 in the vicinity it is possible to place second secondary terminal part 31 of the second side 501 and the second circuit part 3 of changeover switch 5 in the vicinity, it is possible to simplify the first circuit part 2 and changeover switch 5 and the second circuit part 3 interconnection path.

In this embodiment, the first phase, terminal part 220a, second phase, terminal part 220b, and third phase terminal part 220c of the device primary terminal part 220 as a first secondary terminal part can be placed in the cingulate area A. In addition, the first phase, terminal part 321a, second phase terminal part 321b, and third phase terminal part 321c of the device secondary terminal part 321 as a second secondary terminal part 31 can be placed in the cingulate area A. Therefore, when the first circuit part 2, changeover switch 5, and the second circuit part 3 are electrically connected to each other, the interconnection path can be simplified because terminal part required for the electrical connection between the first circuit part 2, changeover switch 5, and the second circuit part 3 can be arranged in the belt-like area A.

Therefore, the first side terminal part 500 of changeover switch 5 connected by first conductive connection part 23 and first secondary terminal part of the first circuit part 2 can be arranged in the vicinity, the second side terminal part 501 of changeover switch 5 and second secondary terminal part 31 of the second circuit part 3 since it is possible to place in the vicinity, it is possible to simplify the first circuit part 2 and changeover switch 5 and the second circuit part 3 routing path.

Further, according to changeover switch built-in board 1 of the present embodiment, since the load-side terminal part 502 is disposed on the front side of the second-side terminal part 501, it is possible to effectively use the space in the front-rear direction inside the housing 7.

Further, in changeover switch built-in board 1 of the present embodiment, the device secondary terminal part 321 of the second electric device 32 is disposed closer to the second side terminal part 501 in the second direction than the device primary terminal part 320, so that the second side terminal part 501 and the device secondary terminal part 321 can be disposed closer to each other. Further, the load primary terminal part 420 is positioned closer to the load side terminal part 502 in a second orientation than the load secondary terminal part 421 so that the load side terminal part 502 and the load primary terminal part 420 can be positioned closer to each other. Therefore, according to the present embodiment, by arranging the second-side terminal part 501 and the device secondary terminal part 321 close to each other, the wiring path of changeover switch 5 and the second electric device 32 can be simplified, and by arranging the load-side terminal part 502 and the load primary terminal part 420 close to each other, the wiring path of changeover switch 5 and the load electric device 42 can be simplified.

In particular, in the present embodiment, the first phase terminal part 501a of the second-side terminal part 501, the second phase terminal part 501b, and the third phase terminal part 501c are arranged in order in the second direction, whereas the first phase terminal part 321a of the device secondary terminal part 321, the second phase terminal part 321b, and the third phase terminal part 321c are arranged in order in the first direction. Therefore, when the second conductive connection part 33 is used to connect the second-side terminal part 501 and the device secondary terminal part 321, the second-side terminal part 501 and the device secondary terminal part 321 can be electrically connected to each other by connecting one end part 330 from the other side in the first direction to terminal part of each phase of the second-side terminal part 501 and connecting the other end part 333 from one side in the second direction to terminal part of each phase of the device secondary terminal part 321. The same applies to the connection between the load-side terminal part 502 and the load device primary terminal part 420.

Further, according to the present embodiment, the device primary terminal part 320 of the second electric device 32 and the load secondary terminal part 421 of the load electric device 42 are disposed on the other side in the first direction with respect to the switching control part 51. Therefore, the space on the other side in the first direction can be used more effectively than the switching control part 51. Further, in the present embodiment, since the device secondary terminal part 621 of the relay electric device 62 is disposed on one side of the switching control part 51 in the first direction, it is possible to effectively use the space on the one side of the first direction rather than the switching control part 51.

In the present embodiment, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a. Further, the load-side terminal part 502 is disposed forward and backward of the second-side terminal part 501. Therefore, it is possible to secure an insulating distance between the load-side terminal part 502 and the second-side terminal part 501 which are arranged at substantially the same position in the second direction.

Further, since changeover switch 5 is disposed on one side in the first direction, the load electric device 42 is disposed on the other side in the first direction, and the load conductor insertion part 7010c is formed on the other side in the second direction of the load electric device 42 in the housing 7, the load conductor W110 can be inserted into the outer side and the inner side of the housing 7 from the load conductor insertion part 7010c formed in the second direction perpendicular to the first direction in which changeover switch 5 and the load electric device 42 are arranged side by side.

Further, by the load conductor insertion part 7010c extends to one side and the other side of the first direction, it is possible to secure a space for inserting the load conductor W110 to the outside and the inside of the housing 7, considering the bending radius of the load conductor W110, the load conductor W110 can be inserted from the outside to the inside of the housing 7.

Further, changeover switch 5, the second electric device 32, and the load electric device 42 are arranged side by side in the first direction, and the second conductor insertion part 7010b is disposed on the other side of the second electric device 32 in the second direction in the housing 7, and the load conductor insertion part 7010c is formed on the other side of the load electric device 42 in the second direction, so that the second conductor P220 and the load conductor W110 can be inserted inside the housing 7 from the second conductor insertion part 7010b and the load conductor insertion part 7010c on the other side of the second electric device 32 and the load electric device 42 in the second direction arranged in the first direction, respectively.

As described above, since the second-side terminal part 501 and the device secondary terminal part 321 can be arranged close to each other and the load-side terminal part 502 and the load primary terminal part 420 can be arranged close to each other, the wiring path between changeover switch 5 and the second electric device 32 and the wiring path between changeover switch 5 and the load electric device 42 can be simplified.

Next, changeover switch built-in board 1 according to the second embodiment will be described. Note that, in describing changeover switch built-in board 1 according to the second embodiment, configurations and operations that differ from those of changeover switch built-in board 1 according to the first embodiment will be described, and descriptions of the same configurations and operations will be omitted.

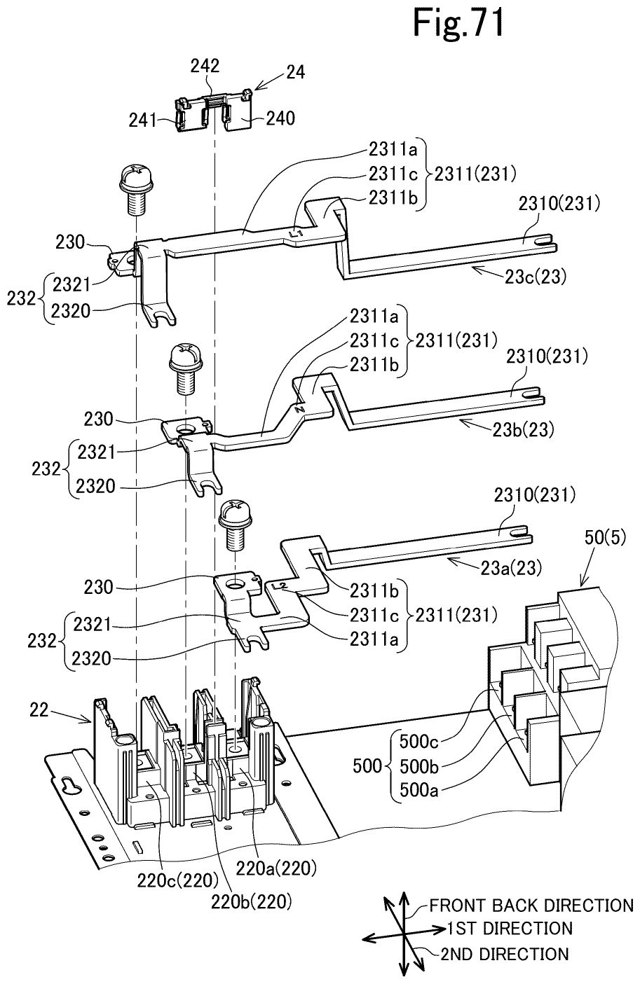

As shown in FIG. 71, first conductive connection part 23 of the second embodiment differs from the first embodiment in form. Specifically, end part 2310 is formed longer in the first direction than in the first embodiment. In addition, unlike the first embodiment, the distal-side conductive part 2311b is formed to be long in the second direction.

In the second circuit part 3 of the second embodiment, as in the first embodiment, the device primary terminal part 320 and the device secondary terminal part 321 are arranged so as to be aligned in the second direction. Further, the device primary terminal part 320 is disposed to face the other side in the second direction, and the device secondary terminal part 321 is disposed to face the one side in the second direction.

In the second embodiment, the second electric device 32 is arranged so that the device secondary terminal part 321 is arranged on the other side of the second side terminal part 501 of changeover switch 5 in the second direction. Specifically, the first phase terminal part 501a of the second side terminal part 501, the second phase terminal part 501b, and the other side of the third phase terminal part 501c in the second direction, which are arranged so as to be arranged in order in the second direction, are arranged so that the first phase terminal part 321a of the device secondary terminal part 321, the second phase terminal part 321b, and the third phase terminal part 321c are arranged in order in the first direction. Therefore, the second electric device 32 is disposed on the other side of the switching control part 51 in the first direction.

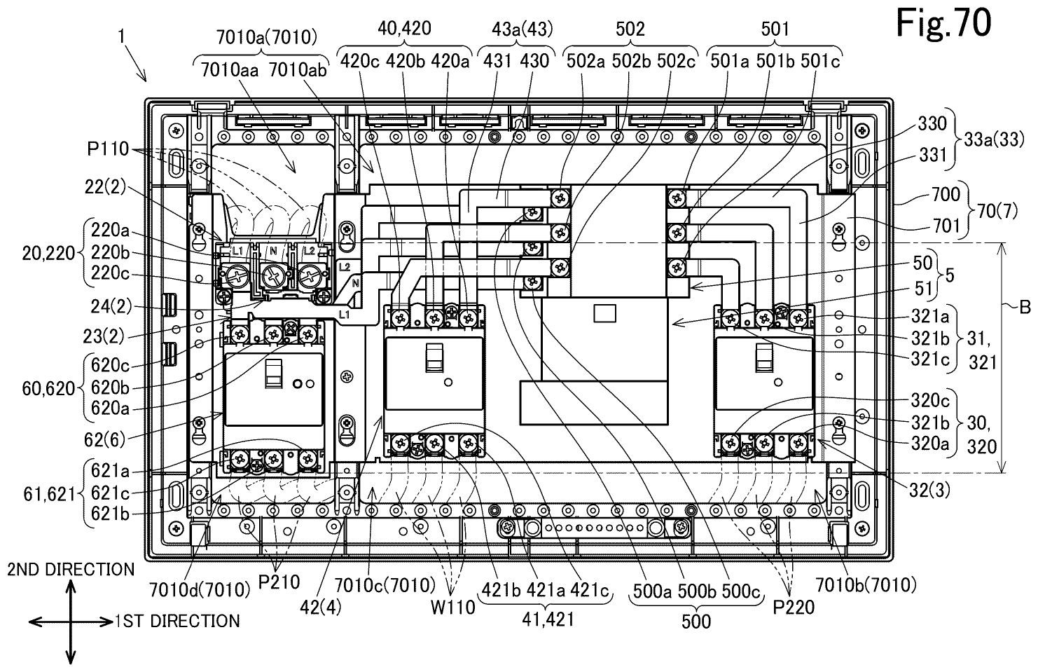

The second conductive connection part 33 of the second embodiment is shaped differently from the first embodiment. The second conductive connection part 33 includes one end 330 connected to the second-side terminal part 501 and the other end 331 connected to the device secondary terminal part 321. As shown in FIG. 70, one end part 330 extends in the first direction and the other end part 331 extends in the second direction. The second conductive connection part 33 has one end part 330 and the other end part 331 formed continuously.

The second circuit part 3 of the second embodiment also has three second conductive connection part 33 (a first phase conductive connection 33a, a second phase conductive connection (not numbered), and a third phase conductive connection (not numbered)). In the three second conductive connection part 33, one end part 330 is aligned along the second direction, and the other end parts 331 are aligned along the first direction.

In the load circuit part 4 of the second embodiment, as in the first embodiment, the load device primary terminal part 420 and the load device secondary terminal part 421 are arranged so as to be aligned in the second direction. Further, the load device primary terminal part 420 is disposed to face one side in the second direction, and the load device secondary terminal part 421 is disposed to face the other side in the second direction.

The loading circuit part 4 of the second embodiment is arranged on one side of changeover switch 5 in the first direction. Specifically, as shown in FIG. 70, the load electrical device 42 is disposed between the relay electrical device 62 and the switching control part 51 in the first direction. Therefore, in the second embodiment, the loading electrical device 42 is spaced apart from the second electrical device 32 in the first direction with respect to changeover switch 5. Further, the load electric appliance 42 is arranged such that the load appliance primary terminal part 420 is arranged on the other side of the load side terminal part 502 of changeover switch 5 in the second direction. In addition, the load-secondary terminal part 421 is arranged on one side of the first direction with respect to the switching control part 51.

In addition, in the second embodiment, the load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

Connection part 43 of the second embodiment is shaped differently from the first embodiment. The load conductive connection part 43 includes one end 430 connected to the load-side terminal part 502 and the other end 431 connected to the load primary terminal part 40. As shown in FIG. 70, one end part 430 extends in the first direction and the other end part 431 extends in the second direction. The loaded conductive connection part 43 has one end part 430 and the other end part 431 formed continuously.

As shown in FIG. 70, the loaded conductive connection part 43 of the second embodiment is disposed in front of first conductive connection part 23 in the front-rear direction in the housing 7. Therefore, the loaded conductive connection part 43 and first conductive connection part 23 overlap each other in the front-rear direction while the inside of the housing 7 is viewed from the front.

In changeover switch 5 of the second embodiment, unlike the first embodiment, the second side terminal part 501 and the load-side terminal part 502 are provided at separate ends in the first direction of changeover switch 5. Specifically, the load-side terminal part 502 is arranged so as to face one side of the first direction and one side of the first direction than the second-side terminal part 501. Therefore, in changeover switch 5 of the second embodiment, the first side terminal part 500 and the load-side terminal part 502 are provided at one end part in the first direction. Thus, changeover switch 5 is arranged in a first direction between the first circuit part 2 and the loading circuit part 4 and the second circuit part 3.

In addition, in the second embodiment, the first side terminal part 500 and the second side terminal part 501 are disposed at different positions in the second direction. Here, in the second embodiment, the load-side terminal part 502 and the second-side terminal part 501 are arranged side by side (so as to be aligned) in the first direction so that the arrangement positions in the second direction are the same position. Therefore, in the second embodiment, in the second direction, the third phase terminal part 502c is disposed between the second phase terminal part 500b and the third phase terminal part 500c, the second phase terminal part 502b is disposed between the first phase terminal part 500a and the second phase terminal part 500b, and the first phase terminal part 502a is disposed on one side of the first phase terminal part 500a.

Further, in the second embodiment, the load-side terminal part 502 is disposed forward and backward of the first side terminal part 500. Therefore, as shown in FIG. 70, in the second embodiment, end part 2310 connected to the first side terminal part 500 is disposed rearward, and the one end 430 connected to the load-side terminal part 502 is disposed forward in the front-rear direction. In the second embodiment, the load-side terminal part 502 is disposed at the same position as the second-side terminal part 501 in the front-rear direction.

The switching-side first conductor-insertion part 7010ab of the second embodiment is disposed over changeover switch 5, the load-side electric device 42, and the second electric device 32 as in the present embodiment.

As in the first embodiment, the second conductive insertion part 7010b of the second embodiment is provided on the other side (directly below) of the device primary terminal part 320 of the second electric device 32 in the second direction. Further, the second conductive insertion part 7010b extends to one side in the first direction.

As in the first embodiment, the load conductor insertion part 7010c of the second embodiment is provided on the other side (directly below) of the load device secondary terminal part 421 of the load electric device 42 in the second direction. The load-conductor insertion part 7010c is formed so as to extend to the other side in the first direction. Here, in the second embodiment, the load electrical device 42 is disposed between the relay electrical device 62 and the switching control part 51 in the first direction. Therefore, the load conductor insertion part 7010c of the second embodiment is formed on the other side of the relay conductor insertion part 7010d in the first direction with a part of the back surface part 701 along a virtual straight line in the second direction passing between the relay electric device 62 and the load electric device 42 as a border.

The load-conductor insertion part 7010c and the second conductor insertion part 7010b of the second embodiment are formed so as to be aligned in the first direction, as in the first embodiment, and are continuous with each other. Here, the load-conductor insertion part 7010c and the second conductor insertion part 7010b of the second embodiment are continuous via the other side of changeover switch 5 in the second direction. Therefore, the load conductor insertion part 7010c and the second conductor insertion part 7010b of the second embodiment are formed so as to extend to the other side of the load electrical device 42 in the second direction, the other side of changeover switch 5 in the second direction, and the other side of the second electrical device 32 in the second direction. The load-conductor insertion part 7010c and the second conductor insertion part 7010b of the second embodiment are formed to have substantially the same length as the switching-side first conductor insertion part 7010ab in the first direction.

As in the first embodiment, the continuous insertion part (not numbered) of the second embodiment is formed so as to extend from directly under the second electric device 32 to directly under the load electric device 42. Here, in the second embodiment, changeover switch 5 is disposed between the loading circuit part 4 and the second circuit part 3. Therefore, unlike the first embodiment, the continuously inserted part of the second embodiment is formed so as to extend directly under the second electric device 32, changeover switch 5, and the loading electric device 42.

In the second embodiment, the second electric device 32 is arranged such that the device secondary terminal part 321 is arranged on the other side in the second direction than the second side terminal part 501 of changeover switch 5, and the load electric device 42 is arranged such that the load device primary terminal part 420 is arranged on the other side in the second direction than the load side terminal part 502 of changeover switch 5. Therefore, as shown in FIG. 70, the second conductive connection part 33 and the loaded conductive connection part 43 can have a simple configuration including one end part 330 and 430 extending in the first direction and the other end part 331,431 extending in the second direction.

In the second embodiment, the first phase terminal part 501a of the second side terminal part 501, the second phase terminal part 501b, and the other side of the third phase terminal part 501c in the second direction, which are arranged in order in the second direction, are arranged so that the first phase terminal part 321a of the device secondary terminal part 321, the second phase terminal part 321b, and the third phase terminal part 321c are arranged in the first direction. Therefore, when connecting using the second conductive connection part 33, on one side in the second direction, one end part 330 from the other side in the first direction can be connected to terminal part of each phase of the second side terminal part 501, and on the other side in the second direction, the other end part 331 can be connected to terminal part of each phase of the device secondary terminal part 321 from one side to the other side in the second direction. Therefore, when the second-side terminal part 501 is connected to the device secondary terminal part 321, the wire path can be shortened.

Further, the first phase terminal part 502a, the second phase terminal part 502b, and the third phase terminal part 502c of the load side terminal part 502 arranged in order in the second direction are arranged on the other side in the second direction so that the first phase terminal part 420a, the second phase terminal part 420b, and the third phase terminal part 420c of the load primary terminal part 420 are arranged in the first direction. Therefore, when connecting using the load conductive connection part 43, one end part 430 from one side in the first direction can be connected to terminal part of each phase of the load side terminal part 502 on one side in the second direction, and the other end part 431 can be connected to terminal part of each phase of the load primary terminal part 420 from one side to the other side in the second direction. Therefore, in the second embodiment, the wire path can be shortened even when the load-side terminal part 502 is connected to the load primary terminal part 420.

Further, according to the second embodiment, the device primary terminal part 320 of the second electric device 32 is disposed on the other side in the first direction with respect to the switching control part 51, and the load-secondary terminal part 421 is disposed on the one side in the first direction with respect to the switching control part 51. Therefore, the space on one side and the space on the other side in the first direction can be used more effectively than the switching control part 51.

Changeover switch built-in board of the present disclosure is not limited to the above-described embodiment, and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply.

For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the load device primary terminal part 420 and the load device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the device primary terminal part 220 of the first electric device 22 is configured to have the first phase terminal part 220a, the second phase terminal part 220b, and the third phase terminal part 220c, but is not limited to this configuration. For example, in the case of having only the first phase terminal part 220a, in addition to the case of having the first phase terminal part 220a and the second phase terminal part 220b, in the case of having the first phase terminal part 220a, the second phase terminal part 220b, and the third phase terminal part 220c, it may also be a case of having the fourth phase terminal part. That is, the device primary terminal part 220 may include at least a first phase terminal part 220a.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

Also in this case, the second conductive part 232 may be integrally formed with the first conductive part 231 as in the above-described embodiment, or may be separately attached to the first conductive part 231.

In the above embodiment, the first circuit part 2 is configured to have three first conductive connection part 23, but is not limited to this configuration, for example, the first circuit part 2 may be configured to have one first conductive connection part 23, or may be configured to have two or four or more first conductive connection part 23. That is, the first circuit part 2 may be configured to have at least one first conductive connection part 23.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2.

As a result, the load circuit part 4 can be electrically disconnected from the first power supply system P1 and the second power supply system P2, and can further improve electric safety such as when inspecting the load device or the like connected to the load circuit part 4.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 extends to the other side in the second direction with respect to the connecting fixing part 230, but is not limited to this configuration. The second conductive part 232 may extend, for example, to one side in the second orientation relative to the connecting fixing part 230. Again, the first conductive part 231 may be configured to extend to the other side of the first direction relative to the connection fixing part 230, and the first conductive part 231 may be configured to extend to the one side of the first direction relative to the connection fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

In the first embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the description of the strip-shaped area A of the above embodiment, the arrangement position of the first side terminal part 500 and the arrangement position of the second side terminal part 501 in the second direction has been given an example of the same, for example, the arrangement position of the first side terminal part 500 in the second direction and the arrangement position of the second side terminal part 501 are different from each other even in the second direction, the first phase terminal part 500a and the second side terminal part 501 of the first side terminal part 500 in the second direction it may be a strip-shaped area A area extending in a range including up to the third phase terminal part 501c of the third phase terminal part 500c and the second side terminal part 500 of the first side terminal part 501a.

In the load electric device 42 of the above embodiment, the load device primary terminal part 420 is provided at one end in the second direction, and the load device secondary terminal part 421 is provided at the other end in the second direction. However, the present invention is not limited thereto, and for example, in the load electric device 42, the load device primary terminal part 420 may be provided at the other end in the second direction, and the load device secondary terminal part 421 may be provided at the one end in the second direction.

In the above embodiment, changeover switch 5 includes the second-side terminal part 501 and the load-side terminal part 502 at the other end in the first direction. However, the present invention is not limited thereto, and for example, changeover switch 5 may include the second-side terminal part 501 and the load-side terminal part 502 at one end in the second direction.

In the above embodiment, the second conductive insertion part 7010b is disposed on the other side of second primary terminal part 30 in the second direction. However, the present invention is not limited thereto, and for example, the second conductive insertion part 7010b may be disposed on one side of second primary terminal part 30 in the second direction.

In the above embodiment, the arrangement positions of the device primary terminal part 320 and the device secondary terminal part 321 of the second electric device 32 in the first direction are the same. However, the present invention is not limited thereto, and for example, the arrangement positions of the device primary terminal part 320 and the device secondary terminal part 321 of the second electric device 32 in the first direction may be different from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, the first conductive insertion part 7010a is provided on one side of first primary terminal part 20 or changeover switch 5 in the second direction. However, the present invention is not limited thereto, and for example, the first conductive insertion part 7010a may be disposed on one side of first primary terminal part 20 in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

The first conductor-insertion part 7010a may be provided in the second direction just above one side of first primary terminal part 20 or just above one side of changeover switch 5.

In the above-described embodiment, as shown in FIG. 64, the positions of the second-side terminal part 501 and the load-side terminal part 502 in the first direction differ from each other. However, for example, the second-side terminal part 501 and the load-side terminal part 502 may be arranged such that the arrangement positions in the first direction are the same (that is, they overlap in the front-rear direction so as to be arranged along an imaginary straight line extending in the second direction).

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the first embodiment, the load side terminal part 502 is disposed on the front side of the second side terminal part 501 in the front-rear direction, and in the second embodiment, the load side terminal part 502 is disposed on the front side of the first side terminal part 500 in the front-rear direction. That is, in the first and second embodiments, the load-side terminal part 502 is disposed on the front side of the first-side terminal part 500 or the second-side terminal part 501. However, the present invention is not limited thereto, and for example, the load-side terminal part 502 may be disposed on the front side of the first side terminal part 500 and the second side terminal part 501 in the front-rear direction. The load-side terminal part 502 may also be located behind the first-side terminal part 500 and/or the second-side terminal part 501.

In the first embodiment, the load-side terminal part 502 is disposed at the same position as the first-side terminal part 500 in the front-rear direction. In the second embodiment, the load-side terminal part 502 is disposed at the same position as the second-side terminal part 501 in the front-rear direction. However, the present invention is not limited thereto, and for example, in the first embodiment, the load-side terminal part 502 may be disposed on the rear side of the first-side terminal part 500 in the front-rear direction. In addition, in the second embodiment, the load-side terminal part 502 may be disposed on the rear side of the second side terminal part 501 in the front-rear direction.

In the above embodiment, the device primary terminal part 320 of the second electric device 32 is disposed on the other side in the second direction, and the device secondary terminal part 321 is disposed on one side in the second direction, but the present invention is not limited thereto, and the device primary terminal part 320 may be disposed on one side in the second direction and the device secondary terminal part 321 may be disposed on the other side in the second direction. Here, the switching-side first conductor insertion part 7010ab directly above the second electric device 32 functions as the second conductor insertion part 7010b. The same applies to the load electric device 42.

Next, a changeover switch built-in board according to another embodiment will be described. Changeover switch built-in board according to the present disclosure incorporates a changeover switch.

As a power supply switching device which is a conventional changeover switch built-in board, for example, there is a device described in Japanese Patent No. 5284832. The input side of the power supply switching device is connected to a commercial power supply input line from a commercial power supply and a generator power supply input line from a generator power supply, and the output side is collectively connected to a load.

On the commercial power supply line side connected to the commercial power supply, a line switch is inserted into the power supply side, a delay switch is interposed on the load side, the line switch is constituted by a contact part and a coil, the contact part is always biased to close, the coil is energized when the power is supplied from being switched to open, the delay switch is constituted by a contact part and a coil, the contact part is always energized to open, the coil is energized when the power is supplied from being switched to open, the output end of the contact part of the line switch is connected to the input end of the contact part of the delay switch.

On the generator power supply line side connected to the generator power supply, a leakage breaker is inserted to prevent leakage, a line switch is interposed on the power supply side, a delay switch is inserted on the load side, the line switch is constituted by a contact part and a coil, the contact part is always biased to close, and the coil is energized when the power is supplied to the coil and switched to open, the delay switch is constituted by a contact part and a coil, the contact part is always biased to open, and the coil is energized when the power is supplied to the coil and switched from open to closed, and the output end of the contact part of the line switch is connected to the input end of the contact part of the delay switch.

Incidentally, in the power supply switching device described in Japanese Patent No. 5284832, various switches such as the line switch and the delay switch are housed in the cabinet. Therefore, in order for the commercial power supply line and the generator power supply line to be connected to the input side of the power switching device, it is necessary to insert the commercial power supply line and the generator power supply line into the cabinet for the board. Here, the commercial power supply line and the generator power supply line to be inserted into the cabinet for a board are generally configured by bundling a plurality of metal busbars. Therefore, in order to connect to the input side of the power supply switching device, it is necessary to bend the commercial power supply line and the generator power supply line in accordance with the directions of the various switches.

However, a force is required to bend the commercial power supply line and the generator power supply line. Further, the commercial power supply line and the generator power supply line inserted into the cabinet for the board, while taking into consideration the bending radius and the position of the various switches housed in the cabinet for the board, it is difficult to bend. Therefore, in the power supply switching device described in Japanese Patent No. 5284832, it is difficult to perform a wiring operation such that the commercial power supply line and the generator power supply line are connected to the input side of the power supply switching device.

In view of the above, an object of the present disclosure is to provide a changeover switch built-in board that facilitates a wiring operation of a first conductor.

The present invention comprises: Changeover switch built-in board is characterized in that includes changeover switch for switching a power supply for supplying electricity to a load to a first power supply system or a second power supply system, and a first circuit part electrically connected to the first power supply system and the changeover switch, and a housing for housing changeover switch and the first circuit part, and the first circuit part includes a first electric device having a device primary terminal part arranged toward one side in one direction of a first direction orthogonal to a front-rear direction and a second direction orthogonal to the front-rear direction and the first direction in the housing, and the device primary terminal part is connected to a first conductor included in the first power supply system, and the changeover switch and the first electric device are arranged side by side in the other direction of the first direction and the second direction, and the changeover switch includes the first terminal part electrically connected to the first circuit part, and the first side terminal part is arranged toward the first electrical device in the other direction, and the first conductor insertion part for inserting the first conductor into the outside and inside of the housing is formed in the housing on one side of changeover switch and the first electric device.

According to the above configuration, the first circuit part includes a first electric device having a device primary terminal part disposed toward one side of the one direction, and the device primary terminal part is connected to a first conductor included in the 1 power supply system, and the first conductor insertion part is formed on one side of the one direction of the changeover switch and the first electric device, so that the first conductor can be inserted into the outside and the inside of the housing via the first conductor insertion part on one side of the one direction of the changeover switch and the first electric device, and the first conductor is inserted into the device primary terminal part in consideration of a bending radius in the first conductor, a position of the first electric device, and the like In addition, the changeover switch and the first electric device are arranged side by side in the other direction, the changeover switch is arranged toward the first electric device in the other direction, since it has the first side terminal part electrically connected to the first circuit part, A space for the first conductor insertion part may be formed on one side of the changeover switch in the first direction.

Further, the present disclosure may include a second circuit part including a second electric device housed in the housing and electrically connected to the second power supply system, wherein the first electric device, changeover switch, and the second electric device may be arranged side by side in the other direction, and the first conductive insertion part may be formed on one side of the second electric device in the one direction.

According to the above configuration, since the first conductor insertion part is formed on one side of the one direction of the second electric device, the first conductor can be inserted into the outside and the inside of the housing via the first conductor insertion part, and the first conductor insertion part is formed on one side of the one direction of changeover switch and the second electric device arranged side by side in the other direction, whereby the first conductor is easily inserted into the outside and the inside of the housing.

Further, the present disclosure may include a load circuit part including a load electric device housed in the housing and electrically connected to a load system including the load, wherein the first electric device, changeover switch, and the load electric device may be arranged side by side in the other direction, and the first conductor insertion part may be formed on one side of the load electric device in the one direction.

According to the configuration, since the first conductor insertion part is formed on one side of the load electric device in the one direction, the first conductor can be inserted into the outside and the inside of the housing via the first conductor insertion part, and the first conductor insertion part is formed on one side of the one direction of changeover switch and the load electric device arranged side by side in the other direction, whereby the first conductor is easily inserted into the outside and the inside of the housing.

In addition, the first electric apparatus and the second electric apparatus may include a device primary terminal part in which the first electric apparatus is disposed on one side of changeover switch in the other direction, the second electric apparatus is disposed on the other side of changeover switch in the other direction, and the second electric apparatus is disposed on the other side in the other direction, and the second electric apparatus is disposed on the other side in the other direction, and a second conductor insertion part through which a second conductor connected to the device primary terminal part of the second electric apparatus is inserted to the outside and the inside of the housing is formed on the other side in the other direction of the device primary terminal part of the second electric apparatus, and the second conductor insertion part may be configured to extend to at least one of one side and the other side in the one direction.

According to the above configuration, the second conductor inserted from the second conductor insertion part formed on the other side in the other direction of the second electric device primary terminal part to the outside and the inside of the housing is easily connected to the device primary terminal part arranged on the other side in the other direction, and the second conductor insertion part is configured to extend to at least one of one side and the other side in the one direction, and therefore, for example, when the second conductor is inserted from the second conductor insertion part to the outside and the inside of the housing, the second conductor can be inserted into the inside and the outside of the housing in view of the bending radii in the second conductor, so that the second conductor can be inserted into the inside and the outside of the housing, so that the wiring work is easily performed.

As described above, according to the present disclosure, the first conductor can be inserted through the first conductor insertion part on one side of the one direction of changeover switch or the first electric device to the outside and the inside of the housing, and the first conductor can be connected to the device primary terminal part while considering the bending radii of the first conductor, the positions of the first electric device and changeover switch, and the like, so that the first conductor can be easily wired.

Hereinafter, a changeover switch built-in board according to a first embodiment of the present disclosure will be described referring to the accompanying drawings.

Changeover switch built-in board is installed between a plurality of power supply systems and a load, and is configured to switch between a plurality of power supply systems and a load.

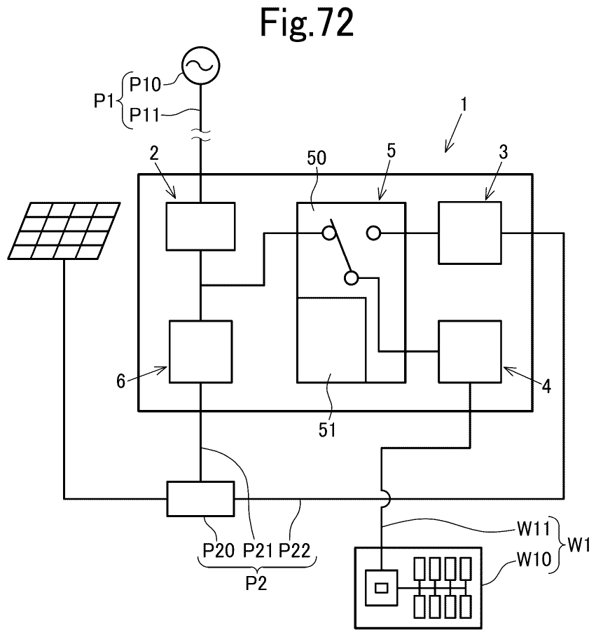

For example, as shown in FIG. 72, when changeover switch built-in board is installed in a house, a first power supply system P1 through which commercial power flows, a second power supply system P2 including a distributed power supply, and a load system W10 including a load W1 are electrically connected to changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

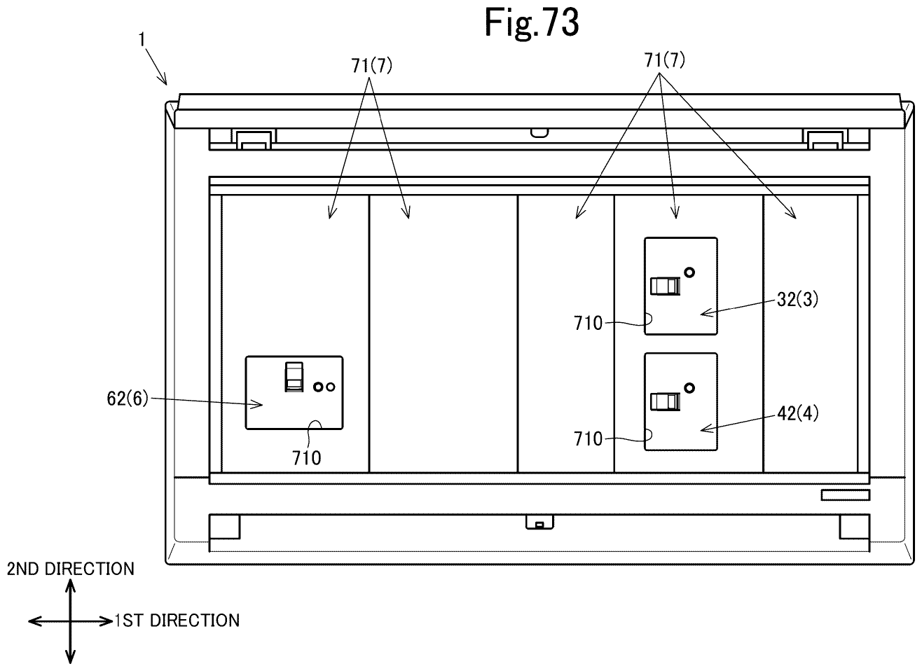

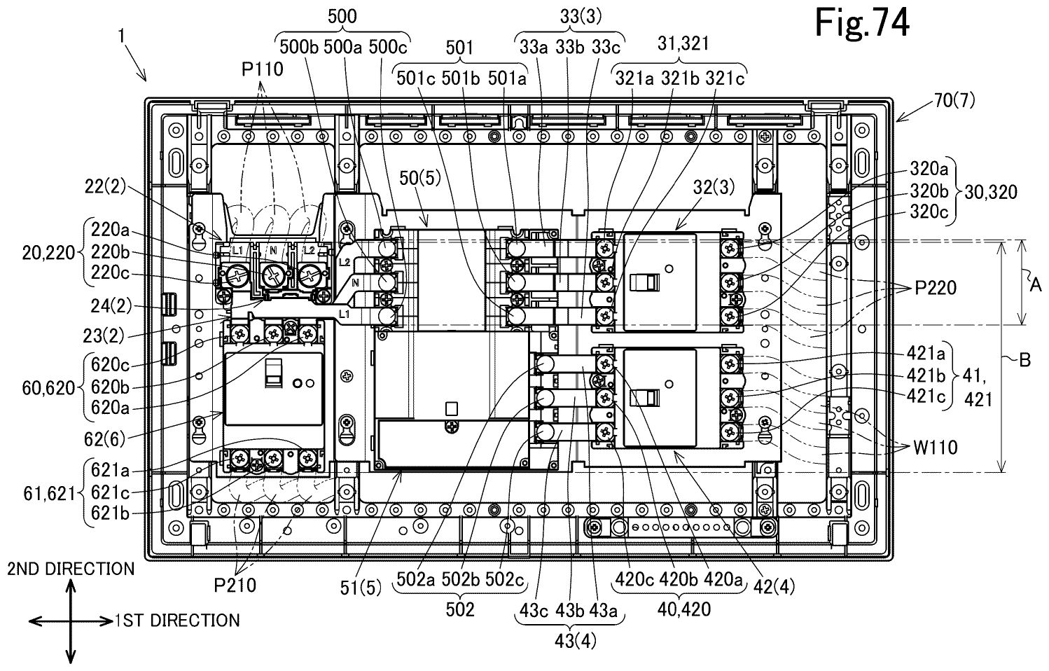

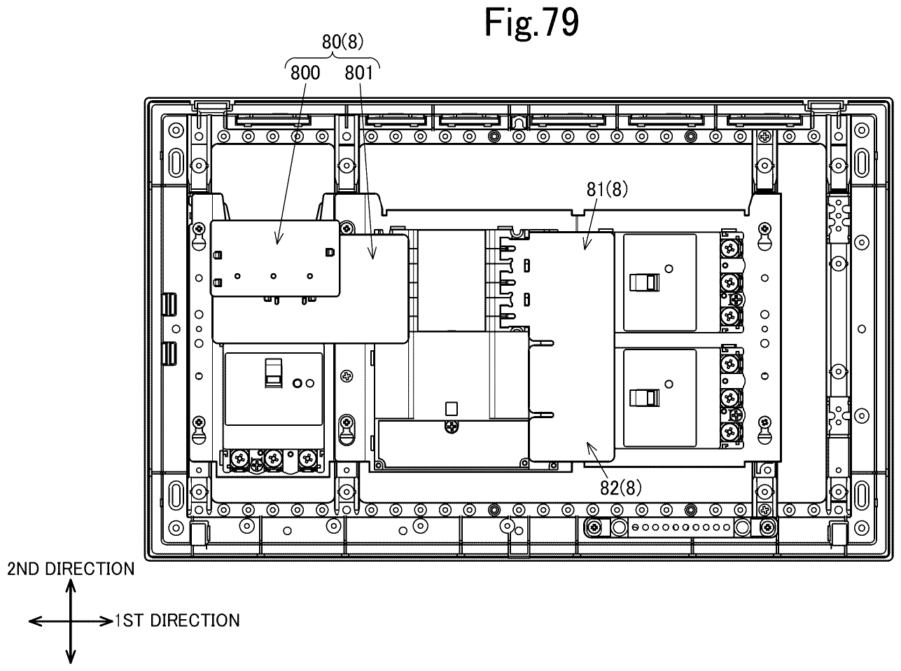

As shown in FIG. 74, changeover switch built-in board 1 is electrically connected to the first power supply system P1, the first circuit part 2 electrically connected to the second power supply system P2, the load circuit part 3 to which the load system W1 is connected, and changeover switch 5 for switching the power supply which supplies electricity to the load system W1 to the first power supply system P1 or the second power supply system P2A housing 7 (see FIG. 73) for housing the relay circuit part 6 to be connected, the first circuit part 2, the second circuit part 3, the relay circuit part 6, changeover switch 5, and the load P2 4, and a cover-structure 8 (see FIG. 79) for covering the charging part in the housing 7 are provided.

In the present embodiment, a direction in which the front surface and the back surface of changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction of a surface formed by the first direction and the second direction is referred to as a board surface direction.

In the present embodiment, the first direction is a direction corresponding to the left-right direction in a state where changeover switch built-in board 1 in the installed state is viewed from the front, and the one side in the first direction is a left side and the other side in the first direction is a right side.

In addition, the second direction is a direction corresponding to the up-down direction in a state where changeover switch built-in board 1 in the installed state is viewed from the front, the one side in the second direction is the upper side, and the other side in the second direction is the lower side.

The first circuit part 2 is electrically connected to the first power supply system P1 and changeover switch 5. The first circuit part 2 is disposed on one side of changeover switch 5 in the first direction.

The first circuit part 2 of the present embodiment has a first power supply system P1 electrically connected to a first primary terminal part 20, and a changeover switch 5 (a first-side terminal part 500 to be described later) and a relay circuit part 6 electrically connected to a first secondary terminal part (not numbered). In the first circuit part 2 of the present embodiment, first primary terminal part 20 also serves as a first secondary terminal part.

In the first circuit part 2, first primary terminal part 20 is disposed toward one side in the second direction, and is connectable to first primary terminal part 20 in a direction extending from first primary terminal part 20 to one side in the second direction with the first power supply P10 (in the present embodiment, the first power distribution path P11) and the first conductive P110 connected to first primary terminal part 20.

The first circuit part 2 includes a first electric device 22, a first conductive connection part 23 fixed to the first electric device 22 so as to be electrically connected to the first conductive P110, and a partition member 24 for preventing a short circuit of first conductive connection part 23.

The first electrical device 22 is a terminal block. Further, the first electric device 22 is a terminal block including a first primary terminal part 20 electrically connected to the first power supply system P1, and a first power distribution path P11 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 includes a device primary terminal part 220 capable of fixing the first conductive P110, and a device secondary terminal part (not numbered) capable of fixing first conductive connection part 23. In the first electric device 22, the device primary terminal part 220 also serves as a device secondary terminal part.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and first conductive connection part 23 are fixed to the device primary terminal part 220, the first conductor P110 and first conductive connection part 23 are electrically connected to each other. The device primary terminal part 220 of the present embodiment is configured such that the first conductive P110 and first conductive connection part 23 can be fixed by screws.

In addition, the device primary terminal part 220 may be configured to conduct each other by directly contacting the first conductive P110 and first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

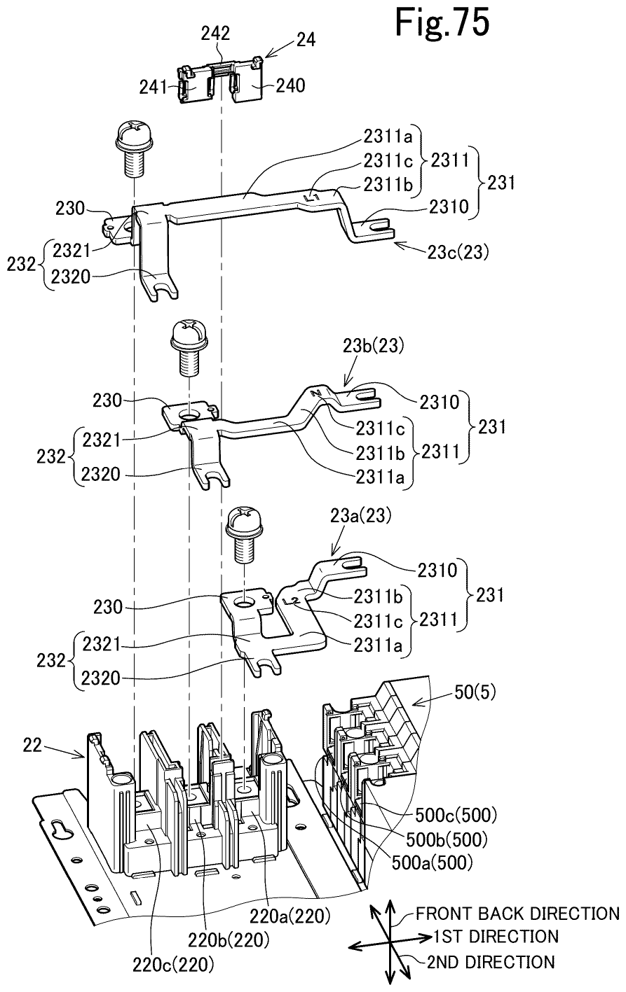

As shown in FIG. 75, first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the distal end side of the connection fixing part 230 is branched into the other side in the second direction and the other side in the first direction in first conductive connection part 23. First conductive connection part 23 of the present embodiment is made of a conductive plate material.

The first conductive part 231 includes a end part 2310 fixed to a first-side terminal part 500 of changeover switch 5, which will be described later, and a intermediate part 2311 that is contiguous with end part 2310 and the second conductive part 232 (a intermediate part 2321 of the second conductive part 232, which will be described later).

The first conductive part 231 intermediate part 2311 is a part interposed between the second conductive part 232 and end part 2310 of the first conductive part 231. Intermediate part 2311 of the first conductive part 231 of the present embodiment includes a proximal end side conductive part 2311a disposed between the first electric device 22 and the relay circuit part 6 (the other side in the second direction than the first electric device 22), a distal end side conductive part 2311b disposed between the first electric device 22 and changeover switch 5 (the other side in the first direction than the first electric device 22), and an identification 2311c attached to a front surface (one surface disposed toward the front side in the front-rear direction) of the distal end side conductive part 2311b. The identification 2311c may be formed by digging in intermediate part 2311 of the first conductive part 231 by direct marking, or may be formed by printing with a laser or the like.

The identification-display 2311c indicates the type of first conductive connection part 23. The identification-display 2311c of the present embodiment is constituted by characters of “L1” indicating L1 phase, “N” indicating the N phase, and “L2” indicating L2 phase.

The second conductive part 232 includes a end part 2320 fixed to a relay primary terminal part (relay device primary terminal part) of the relay circuit part 6, which will be described later, and a intermediate part 2321 connected to end part 2320 and the connecting fixing part 230.

Here, the first circuit part 2 has three first conductive connection part 23 corresponding to the numbers of the device primary terminal part 220. The three first conductive connection part 23, respectively, first conductive connection part 23 for the first phase (first phase conductive connection 23a), first conductive connection part 23 for the second phase (second phase conductive connection 23b), first conductive connection part 23 for the third phase (third phase conductive connection 23c).

The three first conductive connection part 23 are arranged such that the respective second conductive part 232 are aligned in the first direction in the front view.

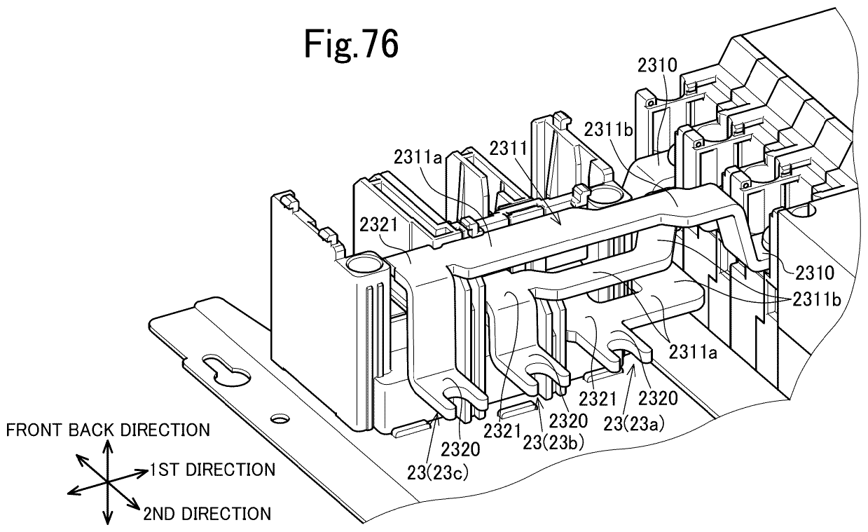

As shown in FIG. 76, intermediate part 2321 of the second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second 232 for the first phase, which is disposed on the most other side in the first direction, is disposed on the most rear side in the front-rear direction.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the conductive connection part 23) for the third phase conductive connection part 23c(L1 phase is disposed on the most front side in the front-rear direction, and the distal end side conductive part 2311b included in the second phase conductive connection part 23b and the third phase conductive connection part 23b (conductive connection part 23 for the N-phase) is disposed on one side in the front-rear direction and in the second direction with respect to the distal end side conductive part 2311b included in the second phase conductive connection part 23c is disposed on one side in the front-rear direction and in the second direction with respect to the distal end side conductive part 2311b included in the third phase conductive connection part conductive part 2311b, and is disposed on one side in the front-rear direction and in the second direction with respect to the distal end side 23a(L2 included in the first phase conductive connection part 23a(L2 23).

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the second phase conductive connection part 23b is also arranged so as to cross the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

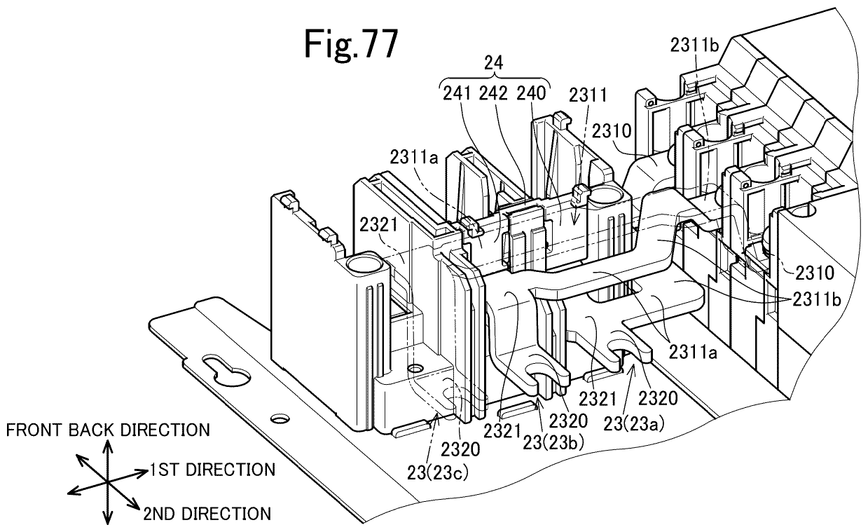

More specifically, as shown in FIG. 77, the partition member 24 has a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 74, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the first direction, and is connectable to second primary terminal part 30 in a direction extending from second primary terminal part 30 to the other side in the first direction with the second power supply P20 (the second power distribution path P22 in the present embodiment) and the second conductive P220 connected to second primary terminal part 30.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The device primary terminal part 320 and the device secondary terminal part 321 are arranged side by side in a first direction, and the arrangement position of the device primary terminal part 320 in the second direction and the arrangement position of the device secondary terminal part 321 in the second direction are the same. Further, in the present embodiment, the second electric device 32 is arranged such that the device primary terminal part 320 faces the other side of the first direction and the device secondary terminal part 321 faces the one side of the first direction.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductive P220 of the second distribution path P22 is fixed to the device primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductive P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the second direction, and the first phase terminal part 321a of the device secondary terminal part 321, the second phase terminal part 321b, and the third phase terminal part 321c are also arranged to align with each other in the second direction.

The second conductive connection part 33 is formed so as to extend along the first direction (i.e., formed in a straight line shape). One longitudinal end of the second conductive connection part 33 is fixed to the device secondary terminal part 321.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, since the first phase terminal part 321a, the second phase terminal part 321b, and the third phase terminal part 321c of the device secondary terminal part 321 are arranged so as to be aligned along the second direction, the three second conductive connection part 33 are also arranged along the second direction while being fixed to the first phase terminal part 321a, the second phase terminal part 321b, and the third phase terminal part 321c, respectively.

The second electric apparatus of the present embodiment is a circuit breaker. Therefore, in a state in which the second conductive terminal part 320 is fixed with the second conductive P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading appliance 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

The load device primary terminal part 420 and the load device secondary terminal part 421 are arranged side by side in the first direction, the load device primary terminal part 420 is provided at one end of the load device 42 in the first direction, and the load device secondary terminal part 421 is provided at the other end of the load device 42 in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical device 42 is arranged side by side in the second direction with respect to the second circuit part 3, and the load device primary terminal part 420 of the load electrical device 42 and the device secondary terminal part 321 of the second electrical device 32 are arranged in the second direction, and the load device secondary terminal part 421 of the load electrical device 42 and the device primary terminal part 320 of the second electrical device 32 are arranged in the second direction. In the present embodiment, the load electrical device 42 is disposed at a position spaced apart from the second electrical device 32 in the second direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged so as to be aligned in the second direction, and the first phase terminal part 421a, the second phase terminal part 421b, and the third phase terminal part 421c of the load device secondary terminal part 421 are also arranged so as to be aligned in the second direction.

The load conductive connection part 43 is formed so as to extend along the first direction (i.e., is straight), and one end part in the longitudinal direction is fixed to the load primary terminal part 40.

The load circuit part 4 has three load conductive connection part 43 corresponding to the numbers of the first phase terminal part 420a, the second phase terminal part 420b, and the third phase terminal part 420c. The three load conductive connection part 43 are also a load conductive connection part 43 for the first phase (first phase conductive connection 43a), a load conductive connection part 43 for the second phase (second phase conductive connection 43b), and a load conductive connection part 43 for the third phase (third phase conductive connection 43c), respectively.

As described above, since the first phase terminal part 420a, the second phase terminal part 420b, and the third phase terminal part 420c of the load device primary terminal part 420 are arranged to be aligned along the second direction, the three load conductive connection part 43 are arranged to be aligned along the second direction in a state where they are fixed to the first phase terminal part 420a, the second phase terminal part 420b, and the third phase terminal part 420c, respectively.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching main body part 50 that switches between the first circuit part 2 and the second circuit part 3 and the load circuit part 4, and a switching control part 51 that operates the switching main body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500, the second side terminal part 501, and the load-side terminal part 502 are provided at separate ends in the first direction of changeover switch 5. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction. Thus, the first terminal part 500 is positioned towards the instrument primary terminal part 220.

Further, the second side terminal part 501 and the load side terminal part 502 are arranged side by side in the second direction in the same direction in the first direction, the second side terminal part 501 and second secondary terminal part 31 face each other in the first direction, and the load side terminal part 502 and the load primary terminal part 40 face each other in the first direction.

In the present embodiment, the second side terminal part 501 is disposed on one side in the second direction, and the load-side terminal part 502 is disposed on the other side in the second direction. Furthermore, the arrangement position of the second side terminal part 501 of the present embodiment in the first direction and the arrangement position of the load-side terminal part 502 in the first direction are different from each other. More specifically, the second side terminal part 501 is arranged to be located on one side of the load-side terminal part 502 in the first direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b, 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

In addition to the second-side terminal part 501, in each of the device secondary terminal part 321, the load-side terminal part 502, and the load-device primary terminal part 420 of the load electrical device 42 of the second electrical device 32, the first-phase terminal part 321a, 502a, 420a, the second-phase terminal part 321b, 502b, 420b, and the third-phase terminal part 321c. 502c, 420c are arranged so as to be aligned in the second direction.

Further, the second-side terminal part 501 and the device secondary terminal part 321 of the second electric device 32 are configured such that the first phase terminal part 501a, 321a of each other oppose each other in the first direction, the second phase terminal part 501b, 321b of each other oppose each other in the first direction, and the third phase terminal part 501c, 321c of each other oppose each other in the first direction. Note that the second-side terminal part 501 and the device secondary terminal part 321 of the second electric device 32 may be opposed to each other in a positional relationship, or may be substantially opposed to each other without being perfectly opposed to each other.

The load-side terminal part 502 and the load device primary terminal part 420 of the load electric device 42 are configured such that the first phase terminal part 502a, 420a of each other oppose each other in the first direction, the second phase terminal part 502b, 420b of each other oppose each other in the first direction, and the third phase terminal part 502c, 420c of each other oppose each other in the first direction. Note that the load-side terminal part 502 and the load device primary terminal part 420 of the load electric device 42 may be opposed to each other in a positional relationship, or may be substantially opposed to each other without being perfectly opposed to each other.

In addition, in the second direction, in the band-like area A that extends in a first direction from the first phase terminal part 500a of the first side terminal part 500 and the first phase terminal part 501a of the second side terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side than terminal part 500, and second secondary terminal part 31 is arranged in the second direction on the other side of the first side than terminal part 501.

Therefore, changeover switch 5 of the present embodiment is disposed between the first circuit part 2 and the second circuit part 3 in the first direction. Specifically, as shown in FIG. 74, changeover switch 5 is disposed between the first circuit part 2 and the second circuit part 3 which are disposed at the same position in the second direction by being disposed in the band-shaped area A extending in the first direction.

Further, in the present embodiment, since the load electric device 42 is disposed on the other side of changeover switch 5 in the first direction, changeover switch 5 is also disposed between the first circuit part 2 and the load circuit part 4 in the first direction.

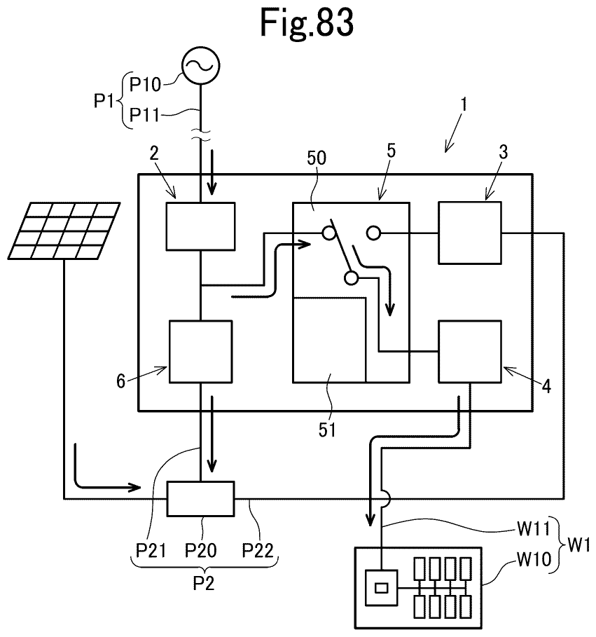

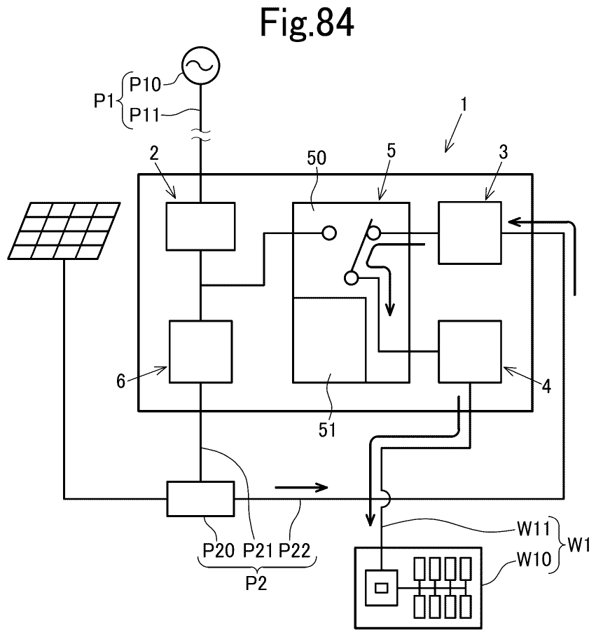

As shown in FIG. 83, the switching main body 50 is switchable between a state in which the first side terminal part 500 and the load side terminal part 502 are electrically connected to each other and the second side terminal part 501 and the load side terminal part 502 are electrically disconnected from each other (first power supply state), and a state in which the first side terminal part 500 and the load side terminal part 502 are electrically disconnected from each other and the second side terminal part 501 and the load side terminal part 502 are electrically connected to each other (second power supply state) as shown in FIG. 84, and the switching control part 51 is configured to switch the first power supply state and the second power supply state by operating the switching main body 50.

The switching control part 51 may be configured to automatically switch the first power supply state and the second power supply state of the switching main body 50 according to the respective power supply states, but may be configured to manually switch between the first power supply state and the second power supply state, or may be configured to switch between the first power supply state and the second power supply state by remote control from the outside.

In the present embodiment, as shown in FIG. 74, the switching main body 50 is disposed on one side in the second direction, and the switching control part 51 is disposed on the other side in the second direction.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 621 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 321 of the relay electrical device 62) in the second direction, and to be within the band-shaped area B extending in the first direction.

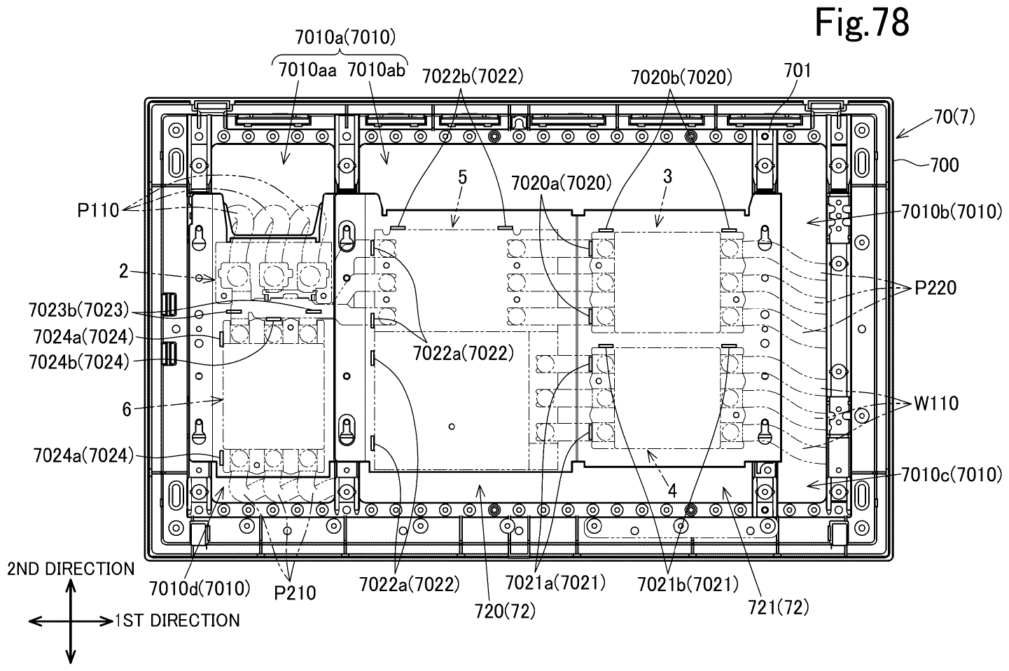

As shown in FIG. 78, the housing 7 includes a housing part 70 capable of housing the first circuit part 2, the second circuit part 3, the loading circuit part 4, changeover switch 5, and the relay circuit part 6 therein, and an intermediate cover part 71 (see FIG. 73) attached to the front surface of the housing part 70. Although not shown in FIG. 78, the housing 7 includes an outer lid part that covers the inner lid part 71 attached to the front surface of the housing part 70.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of first primary terminal part 20 and changeover switch 5 of the first electric device 22 in the second direction. Therefore, the first conductor insertion part 7010a allows the first conductor P110 to be inserted into and out of the housing 7 on one side of first primary terminal part 20 and changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric device 22, and the switching-side first conductor insertion part 7010ab is disposed directly above changeover switch 5 and the second electric device 32 (one side in the second direction). Therefore, the switching-side first conductive insertion part 7010ab is formed on one side of the load-electric device 42 in the second direction. Therefore, the switching-side first conductive insertion part 7010ab of the present embodiment is formed so as to correspond to the entire length of changeover switch 5 and the second electric device 32 in the first direction. In the present embodiment, as shown in FIG. 74, the first conductor P110 is inserted inside the housing 7 via the first-side first conductor insertion part 7010aa.

The first-side first conductive insertion part 7010aa is formed over the entire area of the first electric device 22 in the first direction. The switching-side first conductive insertion part 7010ab is formed so as to extend over the entire area in the first direction of changeover switch 5. The switching-side first conductive insertion part 7010ab is also formed to extend over the entire area of the second electric device 32 in the first direction. Therefore, the first conductive insertion part 7010a of the present embodiment is formed so as to correspond to the entire length of the first electric device 22, changeover switch 5, and the second electric device 32 in the first direction.

The second conductive insertion part 7010b is provided on the other side in the first direction than the device primary terminal part 320 of the second electric device 32. Therefore, the second conductor insertion part 7010b allows the second conductor P220 to be inserted into and out of the housing 7 on the other side in the first direction than the device primary terminal part 320 of the second electric device 32.

Further, the second conductive insertion part 7010b is disposed on the other side of the second electric device 32 in the first direction in the band-shaped area A, and the arrangement position in the second direction is the same as the arrangement position in the second direction of the second electric device 32. The second conductor insertion part 7010b is formed so as to extend to the same arrangement position as the arrangement position of the first conductor insertion part 7010a in the second direction on one side in the second direction than the strip-shaped area A.

The second conductive insertion part 7010b of the present embodiment extends to one side of the second electric device 32 in the second direction. The second conductive insertion part 7010b also extends to the other side of the second electric device 32 in the second direction. In the second conductor insertion part 7010b, part extending further toward the other side in the second direction than the second electric device 32 has the same part as the load conductor insertion part 7010c described later. Therefore, the second conductive insertion part 7010b of the present embodiment is formed to be longer than the length of the second electric device 32 in the second direction.

The load conductor insertion part 7010c is provided on the other side of the load device secondary terminal part 421 of the load electric device 42 in the first direction. Therefore, the load conductor insertion part 7010c allows the load conductor W110 to be inserted into and out of the housing 7 on the other side of the load device secondary terminal part 421 of the load electric device 42 in the first direction. Further, the load-conductor insertion part 7010c is formed so as to extend to the same arrangement position as the arrangement position of the relay conductor insertion part 7010d described later in the second direction.

The load conductor insertion part 7010c of the present embodiment extends to one side of the load electric device 42 in the second direction. The load conductor insertion part 7010c also extends to the other side of the load electric device 42 in the second direction. In the load conductor insertion part 7010c, part extending to one side of the load electric device 42 in the second direction is the same part as the second conductor insertion part 7010b. Therefore, the second conductive insertion part 7010b of the present embodiment is formed to be longer than the length of the second electric device 32 in the second direction.

Further, the load-conductor insertion part 7010c and the second conductor insertion part 7010b are formed at positions aligned in the second direction, and are formed so as to be continuous with each other. Therefore, the load-conductor insertion part 7010c and the second conductor insertion part 7010b are also used. Therefore, for example, the second conductor P220 can be inserted into and out of the housing 7 from the load conductor insertion part 7010c which also serves as the second conductor insertion part 7010b. Further, the loading conductor insertion part 7010c and the second conductor insertion part 7010b are formed so as to extend to one side and the other side in the second direction.

By combining the second conductor insertion part 7010b and the loading conductor insertion part 7010c, a continuous insertion part (not numbered) is formed. The continuous insertion part is formed so as to correspond to the entire area in the second direction of the second electric device 32 and the load electric device 42 arranged side by side in the second direction. Specifically, the continuous insertion part is formed so as to extend from a position on one side of the second electric device 32 to a position on the other side of the load electric device 42 in the second direction.

Therefore, in the present embodiment, the second conductor P220 and the load conductor W110 are inserted from the outside to the inside of the housing 7 by using the continuous insertion part in which the second conductor insertion part 7010b and the load conductor insertion part 7010c are combined.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction. The relay-conductor insertion part 7010d of the present embodiment is formed so as to extend over the entire area of the relay electric device 62 in the first direction.

A communication part 72 that communicates the inside and the outside of the housing 7 is formed on the other side of changeover switch 5 and the load-electric device 42 in the second direction. The communication part 72 is disposed on the other side of the relay-conductor insertion part 7010d in the first direction. In addition, the communication part 72 of the present embodiment includes a switching communication part 720 disposed directly below changeover switch 5, and a load communication part 721 disposed directly below the load electric device 42.

The switching communication part 720 is formed to cover the entire area in the first direction of changeover switch 5, and the load communication part 721 is formed to cover the entire area in the first direction of the load electric device 42. The switching communication part 720 and the load communication part 721 are formed to be continuous with each other in the first direction.

Therefore, in the present embodiment, the first circuit part 2, changeover switch 5, the second circuit part 3, and the load circuit part 4 are surrounded in three directions by the first conductor insertion part 7010a, the second conductor insertion part 7010b, the communication part 72, and the relay conductor insertion part 7010d.

The positioning structure 702 includes a second circuit part positioning part 7020 for positioning the second circuit part 3 with respect to the back surface part 701, a load circuit part positioning part 7021 for positioning the load circuit part 4 with respect to the back surface part 701, a changeover switch positioning part 7022 for positioning changeover switch 5 with respect to the back surface part 701, a first circuit part positioning part 7023 for positioning the first circuit part 2 with respect to the back surface part 701, and a relay circuit part positioning part 7024 for positioning the relay circuit part 6 with respect to the back surface part 701.

The second circuit part positioning part 7020 of the present embodiment is configured to position the second electrical device 32.

In addition, the second circuit part positioning part 7020 is configured to abut on two intersecting side surfaces of the second electrical device 32. More specifically, the second circuit part positioning part 7020 has a first contact part 7020a that protrudes from the back surface part 701 toward the front side in the front-rear direction and abuts on the side surface of the second electric device 32 on the one side in the first direction, and a second contact part 7020b that protrudes from the back surface part 701 toward the front side in the front-rear direction and abuts on the side surface of the second electric device 32 on the one side in the second direction.

Load circuit part positioning part 7021 is configured to position the load electric device 42.

In addition, the load circuit part positioning part 7021 is configured to abut on two intersecting side surfaces of the load electric device 42. More specifically, the load circuit part positioning part 7021 includes a first contact part 7021a that protrudes from the back surface part 701 toward the front side in the front-rear direction and abuts on a side surface of the load electrical device 42 on one side in the first direction, and a second contact part 7021b that protrudes from the back surface part 701 toward the front side in the front-rear direction and abuts on a side surface of the load electrical device 42 on one side in the second direction.

The changeover switch positioning part 7022 is configured to abut two intersecting sides of changeover switch 5. More specifically, the changeover switch positioning part 7022 has a first contact part 7022a that protrudes from the back surface part 701 toward the front side in the front-rear direction and abuts on the side surface on one side in the first direction of changeover switch 5, and a second contact part 7022b that protrudes from the back surface part 701 toward the front side in the front-rear direction and abuts on the side surface on one side in the second direction of changeover switch 5.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The inner lid part 71 is attached to the housing part 70 and is configured to cover the front surfaces of the first circuit part 2, the second circuit part 3, the loading circuit part 4, changeover switch 5, and the relay circuit part 6. Further, in the middle cover part 71 of the present embodiment, the windows 710 are formed in accordance with the positions of the non-charging part of the second circuit part 3 (specifically, the operation part of the second electric device 32), the non-charging part of the load circuit part 4 (specifically, the operation part of the load electric device 42), and the non-charging part of the relay circuit part 6 (specifically, the operation part of the relay electric device 62).

The second electric device 32 and the load electric device 42 are arranged in a state in which the operation direction of the operation part is aligned with the first direction, and the relay electric device 62 is arranged in a state in which the operation direction of the operation part is aligned with the second direction. As described above, the second electric appliance 32 and the load electric appliance 42 arranged at the positions close to each other are arranged so that the operation direction of the operation part is the same, and the relay electric appliance 62 arranged at the position away from the second electric appliance 32 and the load electric appliance 42 is arranged so that the operation direction of the operation part is different from the operation direction of the operation part of the second electric appliance 32 and the load electric appliance 42.

As shown in FIG. 79, the cover structure 8 includes a first cover part 80 that covers first conductive connection part 23, a second cover part 81 that covers the second conductive connection part 33, and a third cover part 82 that covers the loaded conductive connection part 43.

The first cover part 80 includes a first protection part 800 that covers the proximal end part of the first conductive part 231, and a second protection part 801 that covers the distal end part of the first conductive part 231 and the second conductive part 232.

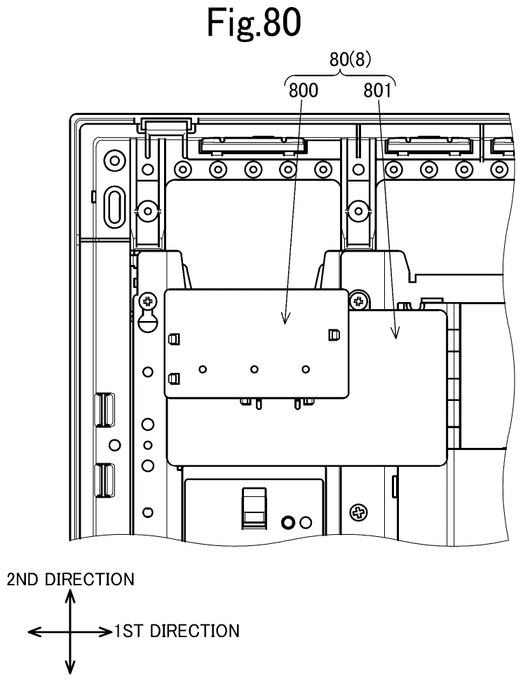

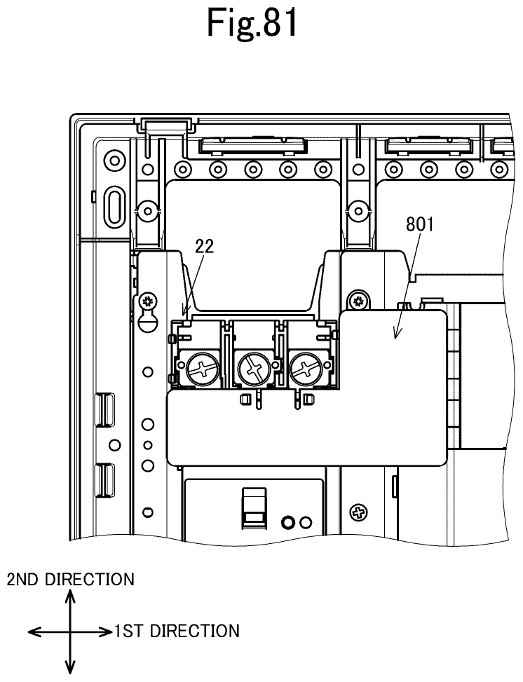

The first protective part 800 and the second protective part 801 are detachable separately, in a state in which the second protective part 801 covers the distal end side and the second conductive part 232 than the proximal end part of the first conductive part 231 from the front side, the first protective part 800 covers the proximal end part of the first conductive part 231 from the front side closed state, the first protective part 800 is configured to be switchable to an open state of opening the front of the proximal end part of the first conductive part 231 (see FIGS. 80 and 81).

Further, in a state in which both the first protection part 800 and the second protection part 801 are installed, the first protection part 800 is disposed on the front side in the front-rear direction relative to the second protection part 801, and the outer peripheral edge part of the first protection part and the outer peripheral edge part of the second protection part 801 are in a state of part overlapping with each other.

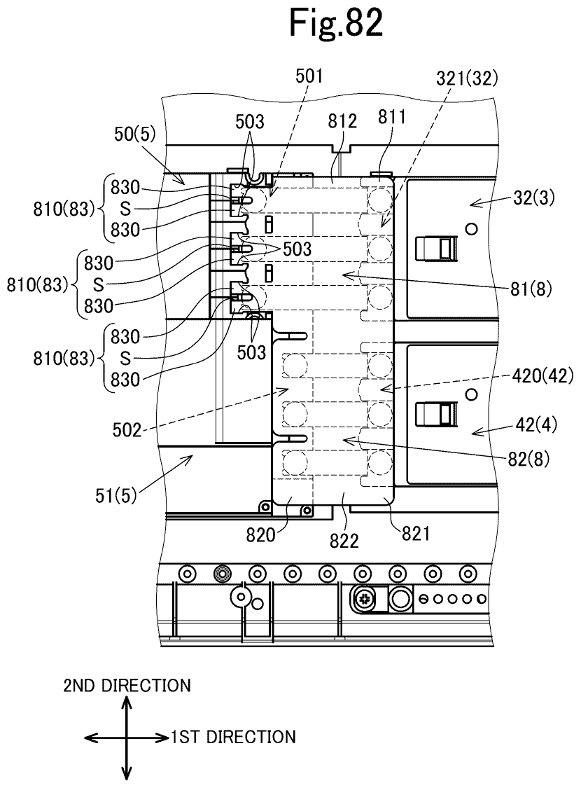

The second cover part 81 and the third cover part 82 are integrally formed by one member, in order to ensure the mounting and fixing of the cover, the second side terminal part 501 for the first phase (first phase terminal part 501a), the second side terminal part 501 for the second phase (second phase terminal part 501b), the second side terminal part 501 for the third phase (third phase terminal part 501c) It is formed with an engaging part that engages the insulating wall for maintaining the insulating between the respective phases. The engagement parts are arranged side by side in the second direction so as to correspond to the second-side terminal part 501 of the respective phases, and end part is formed to extend in the first direction. In addition, end part is provided with slits that divide end part in the second direction, so that it is easy to engage with the insulating walls. Incidentally, the engaging part provided in the second cover part 81 and the third cover part 82, the load-side terminal part 502 for the first phase (first phase terminal part 502a), the load-side terminal part 502 for the second phase (second phase terminal part 502b), the load-side terminal part 502 for the third phase (third phase terminal part 502c) may be formed with an engaging part that engages with the insulating walls for maintaining the insulating between the respective phases. The second cover part 81 and the third cover part 82 are integrally formed, but the second cover part 81 and the third cover part 82 may be separate members (see FIG. 82).

In the present embodiment, since the first side terminal part 500 disposed toward the device primary terminal part 220 can be connected along the first direction to end part 2310 of the first conductive part 231 extending in the first direction, a clearance for inserting the first conductive P110 into the inside and outside of the housing 7 can be secured on one side in the second direction of the first electric device 22 and changeover switch 5. In particular, as shown in FIGS. 74 and 78, when the first conductor P110 is linear (e.g., formed by bundling a plurality of metal wires), a clearance for bending the first conductor P110 can be secured on one side of the first electric device 22 and changeover switch 5 in the second direction.

Further, since the device primary terminal part 220 is disposed toward one side in the second direction, the first conductor 7010a and the device primary terminal part 220 can be connected to each other by using the first electric device 22 and the space on one side in the first direction of changeover switch 5 while considering the bending radius of the first conductor P110 inserted into the inside of the housing 7 from the first conductor insertion part P110 and the position of the first electric device 22 and changeover switch 5.

Further, the device primary terminal part 220 disposed toward one side in the second direction is connected to the first conductive P110 in the second direction, and the first side terminal part 500 is connected along the first direction with end part 2310 of the first conductive part 231, whereby the power flow from the outside of the housing 7 is performed in the second direction, and the electrical connection between the first electric device 22 and changeover switch 5 inside the housing 7 can be performed in the first direction. Therefore, the first conductive P1 10 and the first circuit part 2, the first circuit part 2, and changeover switch 5 can be visually distinguished from each other.

Further, since the switching-side first conductor insertion part 7010ab is formed on one side of the second electric device 32 and the load electric device 42 in the second direction, the first conductor P110 can be inserted from the outside to the inside of the housing 7 via the switching-side first conductor insertion part 7010ab.

Further, since the first conductor insertion part 7010a is formed on one side of the first electric device 22 and changeover switch 5 arranged side by side in the first direction and the second electric device 32 in the second direction, the first conductor P110 is easily inserted from the outside to the inside of the housing 7.

Further, the switching-side first conductor insertion part 7010ab is disposed directly above changeover switch 5 and the second electric device 32, so that the switching-side first conductor insertion part 7010ab is formed to be wide in the first direction, and the first conductor P110 is easily inserted into the housing 7.

Further, the first side first conductor insertion part 7010aa, in the second direction, since it is formed wider than the relay conductor insertion part 7010d, via the first side first conductor insertion part 7010aa, the first conductor P110 inside the housing 7 easily inserted.

Further, it is easy to connect to the device primary terminal part 320 and the load device secondary terminal part 421 via the second conductor insertion part 7010b and the load conductor insertion part 7010c formed on the other side in the first direction of each of the device primary terminal part 320 and the load device secondary terminal part 421, respectively, the second conductor P220 and the load conductor W110 inserted into the inside of the housing 7.

Further, since the load conductor insertion part 7010c and the second conductor insertion part 7010b is formed so as to extend to one side and the other side in the second direction, via the load conductor insertion part 7010c and the second conductor insertion part 7010b, respectively, when inserting the second conductor P220 and the load conductor W110 from the outside to the inside of the housing 7, considering the bending radius of the second conductor P220 and the load conductor W110 and the position of the respective electric devices, the second conductor P220 and the load conductor W110 can be inserted from the outside to the inside of the housing 7, it is easy to wire.

As described above, according to the present embodiment, it is possible to insert the first conductor changeover switch 5 or the first conductor insertion part 7010a on one side in the second direction of the first electric device 22 into the outer side and the inner side of the housing 7, and it is possible to connect the first conductor P110 to the device primary terminal part 220 while considering the bending radius of the first conductor P110, the position of the first electric device 22 and changeover switch 5, and the like, so that it is easy to perform the wiring operation of the first conductor P110.

Further, in the present embodiment, changeover switch 5 is disposed on one side in the first direction, the load electric device 42 is disposed on the other side in the first direction, and the housing 7 has the load conductor insertion part 7010c formed on the other side in the first direction of the load electric device 42, so that the load conductor W110 can be inserted into the outer side and the inner side of the housing 7 from the load conductor insertion part 7010c formed in the first direction in which changeover switch 5 and the load electric device 42 are arranged side by side.

Further, by the load conductor insertion part 7010c extends to one side and the other side in the second direction, it is possible to secure a space for inserting the load conductor W110 to the outside and the inside of the housing 7, considering the bending radius of the load conductor W110, the load conductor W110 can be inserted from the outside to the inside of the housing 7.

Further, in the present embodiment, the second electric device 32 and the load electric device 42 are arranged side by side in the second direction, and since the second conductor insertion part 7010b is formed on the other side in the first direction of the second electric device 32 in the housing 7, the second conductor P220 and the load conductor W110 can be inserted into the housing 7 from the second conductor insertion part 7010b and the load conductor insertion part 7010c on the other side in the first direction of the second electric device 32 and the load electric device 42 arranged in the second direction, respectively.

Further, since the second conductor insertion part 7010b and the load conductor insertion part 7010c are also used, when inserting the load conductor W110 from the load conductor insertion part 7010c to the inside and outside of the housing 7, so that the load conductor W110 is not damaged, while giving a margin to the bending of the load conductor W110, the load conductor W110 can be inserted from the outside to the inside of the housing 7.

As described above, in the present embodiment, a space for inserting the load conductor W110 can be secured inside the housing 7, and the load conductor W110 can be inserted from the outside to the inside of the housing 7 in view of the bending radius of the load conductor W110, so that the load conductor W110 can be easily wired.

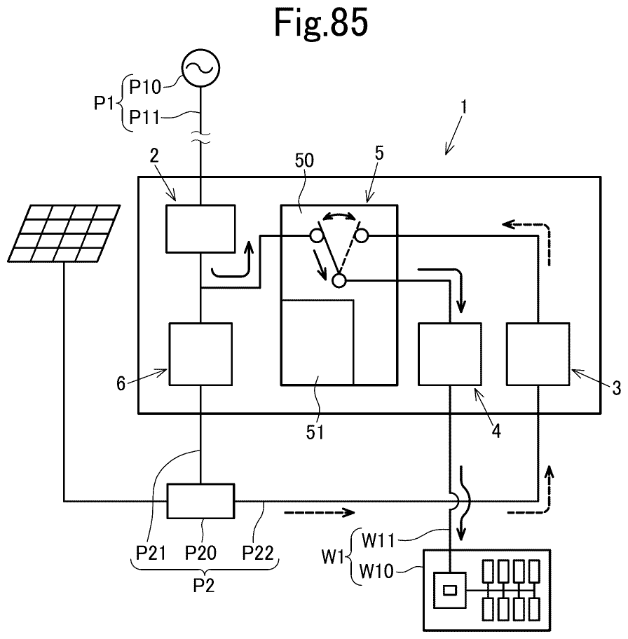

Next, changeover switch built-in board 1 according to the second embodiment of the present disclosure will be described referring to FIG. 85 to FIG. 87. Note that, in describing changeover switch built-in board 1 according to the second embodiment, configurations and operations that differ from those of changeover switch built-in board 1 according to the first embodiment will be described, and descriptions of the same configurations and operations will be omitted.

In the second circuit part 3 of the second embodiment, the device primary terminal part 320 and the device secondary terminal part 321 are arranged side by side in the second direction, and the arrangement position of the device primary terminal part 320 in the first direction and the arrangement position of the device secondary terminal part 321 in the first direction are the same. In the second embodiment, the device primary terminal part 320 is disposed to face the other side in the second direction, and the device secondary terminal part 321 is disposed to face the one side in the second direction. Further, the second electric device 32 of the second embodiment is disposed on the other side of the switching control part 51 in the first direction.

In a second embodiment, the first phase terminal part 320a, the second phase terminal part 320b, and the third phase terminal part 320c of the device primary terminal part 320 are arranged to align with each other in a first direction. In addition, the first phase terminal part 321a, the second phase terminal part 321b, and the third phase terminal part 321c of the device secondary terminal part 321 are arranged so as to be aligned with each other in the first direction.

The second conductive connection part 33 of the second embodiment extends in the first direction and the second direction, and thus differs from the first embodiment. The second conductive connection part 33 includes one end 330 connected to the second-side terminal part 501, a second conductive part 331 extending from the one end 330 in the second direction, a first conductive part 332 extending in the first direction continuously with the second conductive part 331, and the other end 333 connected to the device secondary terminal part 321.

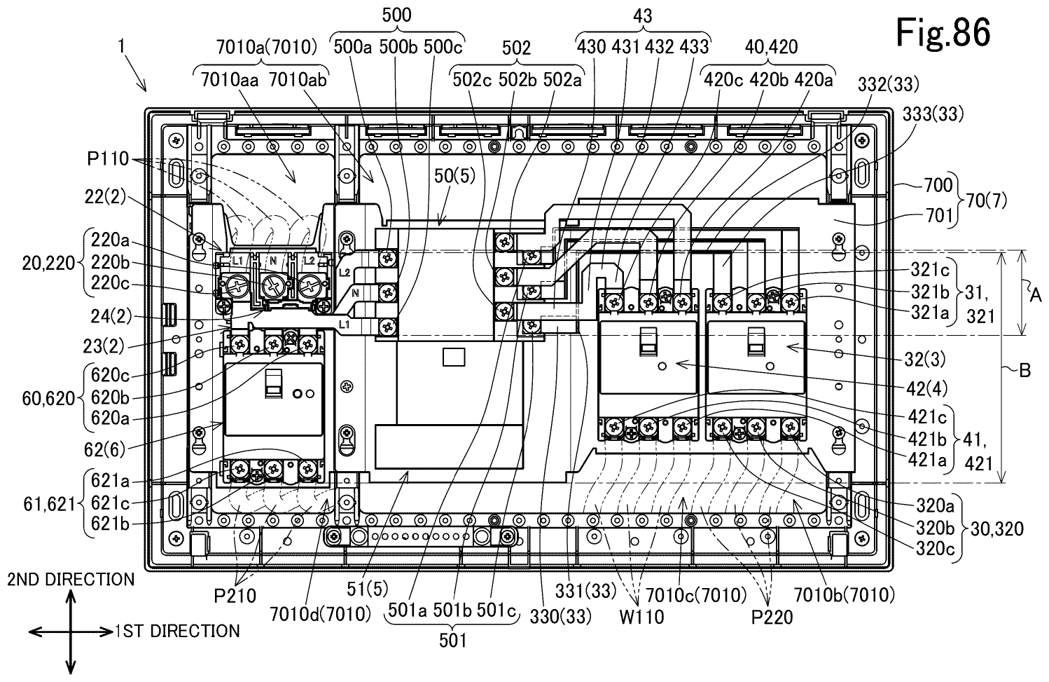

Specifically, as shown in FIG. 86, the second conductive part 331 extends from one end 330 extending in the first direction to one side in the second direction, the first conductive part 332 extends from the second conductive part 331 to the other side in the first direction, and the other end 333 extends from the first conductive part 332 to the other side in the second direction.

The second circuit part 3 of the second embodiment also has three second conductive connection part 33 (not shown, but a first phase conductive connection 33a, a second phase conductive connection 33b, and a third phase conductive connection 33c). Further, in the three second conductive connection part 33, one end part 330 is aligned along the second direction, the second conductive part 331 are aligned along the first direction, the first conductive part 332 are aligned along the second direction, and the other end parts 333 are aligned along the first direction.

In the load circuit part 4 of the second embodiment, the load device primary terminal part 420 and the load device secondary terminal part 421 are arranged to be aligned in the second direction, and the arrangement position of the load device primary terminal part 420 in the first direction and the arrangement position of the load device secondary terminal part 421 in the first direction are the same. In the second embodiment, the load device primary terminal part 420 is provided at one end of the load electrical device 42 in the second direction, and the load device secondary terminal part 421 is provided at the other end of the load electrical device 42 in the second direction. Further, the load electrical device 42 of the second embodiment is disposed on the other side of the switching control part 51 in the first direction.

The load electrical device 42 of the second embodiment is arranged so as to be arranged at a position spaced apart from the second electrical device 32 in the first direction. The load-electric device 42 is disposed on the other side of changeover switch 5 in the first direction. The load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

Further, in the second embodiment, the first phase terminal part 420a, the second phase terminal part 420b, and the third phase terminal part 420c of the primary terminal part 420 are arranged in the first direction. The first phase terminal part 421a, the second phase terminal part 421b, and the third phase terminal part 421c of the secondary terminal part 421 are also arranged (aligned) in the first direction.

The conductive connection part 43 of the second embodiment extends in the first direction and the second direction, and thus differs from the first embodiment. As shown in FIG. 86, the load conductive connection part 43 includes one end 430 connected to the load-side terminal part 502, a second conductive part 431 extending in the second direction from the one end 430, a first conductive part 432 extending in the first direction from the second conductive part 431, and the other end 433 connected to the load device primary terminal part 420.

Specifically, the second conductive part 431 extends from one end 430 extending in the first direction to one side in the second direction, the first conductive part 432 extends from the second conductive part 431 to the other side in the first direction, and the other end 433 extends from the first conductive part 432 to the other side in the second direction.

The load circuit part 4 of the second embodiment also has three load conductive connection part 43 (a first phase conductive connection 43a, a second phase conductive connection 43b, and a third phase conductive connection 43c). Further, in the three load-conducting connection part 43, one end part 430 is aligned along the second direction, the second conductive part 431 are aligned along the first direction, the first conductive part 432 are aligned along the second direction, and the other end parts 433 are aligned along the first direction.

As shown in FIG. 86, the loaded conductive connection part 43 of the second embodiment is disposed in front of the second conductive connection part 33 in the front-rear direction in the housing 7. Therefore, the loaded conductive connection part 43 and the second conductive connection part 33 overlap each other in the front-rear direction while the inside of the housing 7 is viewed from the front.

In changeover switch 5 of the second embodiment, the load-side terminal part 502 is disposed at one end of the first embodiment in the second direction. Here, as shown in FIG. 86, in the load-side terminal part 502, the second phase terminal part 502b and the third phase terminal part 502c are disposed in the band-shaped area A. Therefore, the load-side terminal part 502 of the second embodiment is disposed at substantially the same position as the second-side terminal part 501 in the second direction. Specifically, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a.

The load-side terminal part 502 of the second embodiment is disposed on one side of the second side terminal part 501 in the first direction. Further, the load-side terminal part 502 is disposed forward and backward of the second-side terminal part 501. Therefore, as shown in FIG. 86, in the second embodiment, one end part 430 connected to the second side terminal part 501 is disposed rearward and one end part 430 connected to the load-side terminal part 502 is disposed forward in the front-rear direction.

The second-side terminal part 501 and the load-side terminal part 502 of the second embodiment are arranged in the same direction in the first direction. Further, in the second embodiment, unlike the first embodiment, the second side terminal part 501 and the load side terminal part 502 are disposed to face the other side in the first direction, and second secondary terminal part 31 and the load device primary terminal part 420 are disposed to face the one side in the second direction.

As illustrated in FIG. 85, the switching control part 51 of the second embodiment is configured to switch the switching main body 50 between the first power supply state and the second power supply state by operating the switching main body 50 in the same manner as the first embodiment.

The switching-side first conductive insertion part 7010ab of the second embodiment is disposed over changeover switch 5, the load-side electric device 42, and the second electric device 32. In addition, as in the first embodiment, the switching-side first conductive insertion part 7010ab is formed to cover the entire area of changeover switch 5 and the second electric device 32 in the first direction. Here, the switching-side first conductive insertion part 7010ab of the second embodiment is formed so as to extend over the entire area of the load-electric device 42 in the first direction. Therefore, the switching-side first conductive insertion part 7010ab of the second embodiment is formed to correspond to the entire length of changeover switch 5, the second electric device 32, and the loading electric device 42 in the first direction.

The second conductor-insertion part 7010b of the second embodiment is provided on the other side of the strip-shaped area A and the device primary terminal part 320 of the second electric device 32 in the second direction. The second conductive insertion part 7010b is formed to extend in the first direction. Therefore, in the second embodiment, the second conductor P220 can be inserted into and out of the housing 7 via the second conductor insertion part 7010b on the other side in the second direction.

The load conductor insertion part 7010c of the second embodiment is provided on the other side in the second direction than the load device secondary terminal part 421 of the load electric device 42. The load-conductor insertion part 7010c is formed so as to extend in the first direction. Therefore, in the second embodiment, the load conductor W110 can be inserted into and out of the housing 7 via the load conductor insertion part 7010c on the other side in the second direction.

The load-conductor insertion part 7010c and the second conductor insertion part 7010b of the second embodiment are formed so as to be aligned in the first direction, and are continuous with each other. Further, the load conductor insertion part 7010c and the second conductor insertion part 7010b of the second embodiment are disposed over changeover switch 5, the load electric device 42, and the second conductor insertion part 7010b. Therefore, the load-conductor insertion part 7010c and the second conductor insertion part 7010b are formed so as to extend to one side and the other side in the first direction. Further, the load-conductor insertion part 7010c and the second conductor insertion part 7010b of the second embodiment are formed to have substantially the same length as the switching-side first conductor insertion part 7010ab in the first direction.

Therefore, the second conductor insertion part 7010b of the second embodiment extends to one side in the first direction from the second electric device 32, and the load conductor insertion part 7010c extends to one side and the other side in the first direction from the load electric device 42. Specifically, the second conductor insertion part 7010b and the loaded conductor insertion part 7010c extend from the other side of the second electric device 32 in the second direction to the other side of changeover switch 5 in the second direction. The load conductor insertion part 7010c may be configured to extend from the other side of the load electric device 42 in the second direction to the other side of changeover switch 5 in the second direction.

In addition, the load-conductor insertion part 7010c and the second conductor insertion part 7010b of the second embodiment are formed to be larger than the switching-side first conductor insertion part 7010ab in the second direction.

Unlike the first embodiment, the continuous insertion part (not numbered) of the second embodiment is formed so as to correspond to the entire area of the second electric device 32 and the load electric device 42 arranged side by side in the first direction in the first direction. Specifically, the continuous insertion part is formed so as to extend from a position immediately below the second electric device 32 to a position immediately below the load electric device 42 in the first direction.

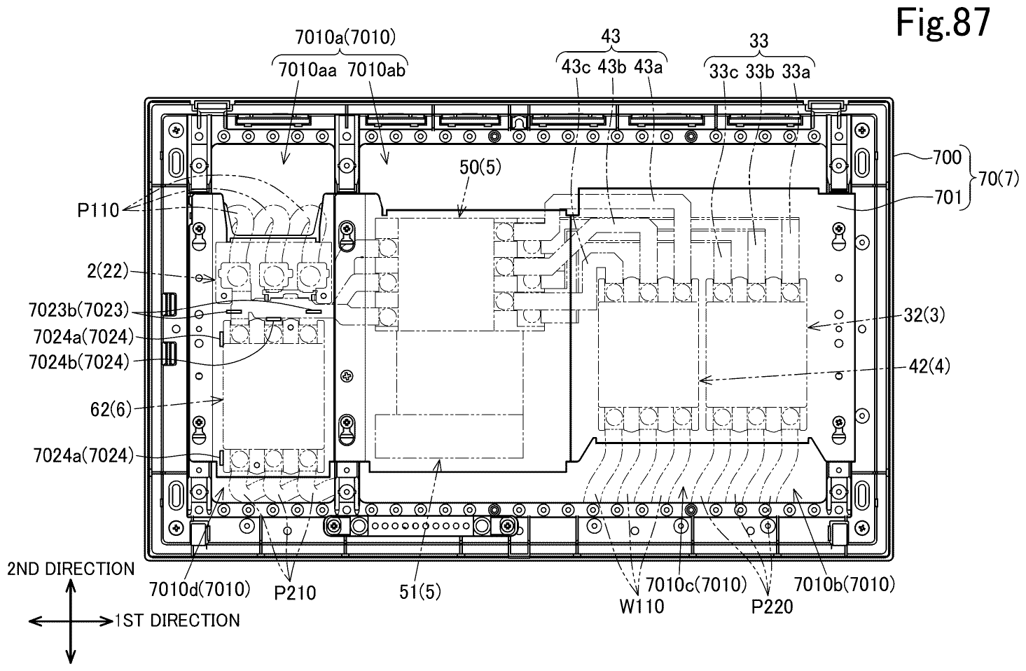

As illustrated in FIG. 87, the positioning structure 702 of the second embodiment includes a first circuit-section positioning part 7023 and a relay circuit part positioning part 7024. In FIG. 87, the second circuit part positioning part 7020, the load circuit part positioning part 7021, and the changeover switch positioning part 7022 are omitted, but the positioning structure 702 may include the second circuit part positioning part 7020, the load circuit part positioning part 7021, and the changeover switch positioning part 7022.

In the second embodiment, the second electric device 32 and the loading electric device 42 are arranged such that the operation direction of the operation part is aligned with the second direction. Therefore, in the second embodiment, the second electric device 32, the load electric device 42, and the relay electric device 62 are arranged in the same direction as the operation direction of the operation part.

In the second embodiment, the load electrical device 42 and the second electrical device 32 are arranged side by side in the first direction. For this reason, the load communication part and the second communication part of the second embodiment are arranged side by side in the first direction.

In the second embodiment, the load conductor insertion part 7010c and the second conductor insertion part 7010b are formed larger than the switching-side first conductor insertion part 7010ab in the second direction, and therefore, from each of the load conductor insertion part 7010c and the second conductor insertion part 7010b, the second conductor P220 and the load conductor W110 are easily inserted from the outside to the inside of the housing 7.

In the second embodiment, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a. Further, the load-side terminal part 502 is disposed forward and backward of the second-side terminal part 501. Therefore, it is possible to secure an insulating distance between the load-side terminal part 502 and the second-side terminal part 501 which are arranged at substantially the same position in the second direction.

Changeover switch 5 is disposed on one side of the first direction, the load electric device 42 is disposed on the other side of the first direction, and the housing 7 has the load conductor insertion part 7010c formed on the other side of the load electric device 42 in the second direction, so that the load conductor W110 can be inserted into the outer side and the inner side of the housing 7 from the load conductor insertion part 7010c formed in the second direction perpendicular to the first direction in which changeover switch 5 and the load electric device 42 are disposed side by side.

Further, by the load conductor insertion part 7010c extends to one side and the other side of the first direction, it is possible to secure a space for inserting the load conductor W110 to the outside and the inside of the housing 7, considering the bending radius of the load conductor W110, the load conductor W110 can be inserted from the outside to the inside of the housing 7.

Further, since changeover switch 5, the second electric device 32, and the load electric device 42 are arranged side by side in the first direction, and the second conductor insertion part 7010b is formed on the other side in the second direction of the second electric device 32 in the housing 7, the second conductor P220 and the load conductor W110 can be inserted into the housing 7 from the second conductor insertion part 7010b and the load conductor insertion part 7010c on the other side in the second direction of the second electric device 32 and the load electric device 42 arranged in the first direction, respectively.

Further, since the second conductor insertion part 7010b and the load conductor insertion part 7010c are also used, when the load conductor W110 is inserted from the load conductor insertion part 7010c to the outside and inside of the housing 7, the load conductor W110 can be inserted from the outside to the inside of the housing 7 while considering the bending radius and arrangement of the second conductor P220.

Next, changeover switch built-in board 1 according to the third embodiment will be described. In describing changeover switch built-in board 1 according to the third embodiment, configurations and operations that differ from those of changeover switch built-in board 1 according to the first and second embodiments will be described, and description of the same configurations and operations will be omitted.

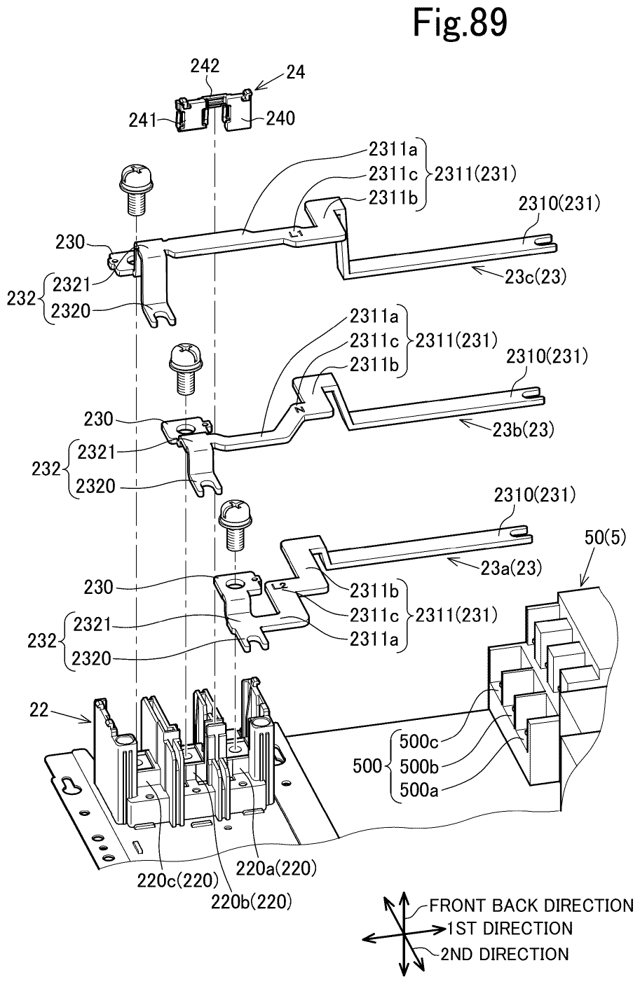

As shown in FIG. 89, first conductive connection part 23 of the third embodiment differs in form from the first embodiment and the second embodiment. Specifically, end part 2310 is formed longer in the first direction than in the first and second embodiments. In addition, unlike the first embodiment and the second embodiment, the distal end-side conductive part 2311b is formed to be long in the second direction.

In the second circuit part 3 of the third embodiment, as in the second embodiment, the device primary terminal part 320 and the device secondary terminal part 321 are arranged so as to be aligned in the second direction. Further, the device primary terminal part 320 is disposed to face the other side in the second direction, and the device secondary terminal part 321 is disposed to face the one side in the second direction.

In the third embodiment, the second electric device 32 is arranged so that the device secondary terminal part 321 is arranged on the other side of the second side terminal part 501 of changeover switch 5 in the second direction. Specifically, the second electrical device 32 is disposed on the other side of the switching control part 51 in the first direction.

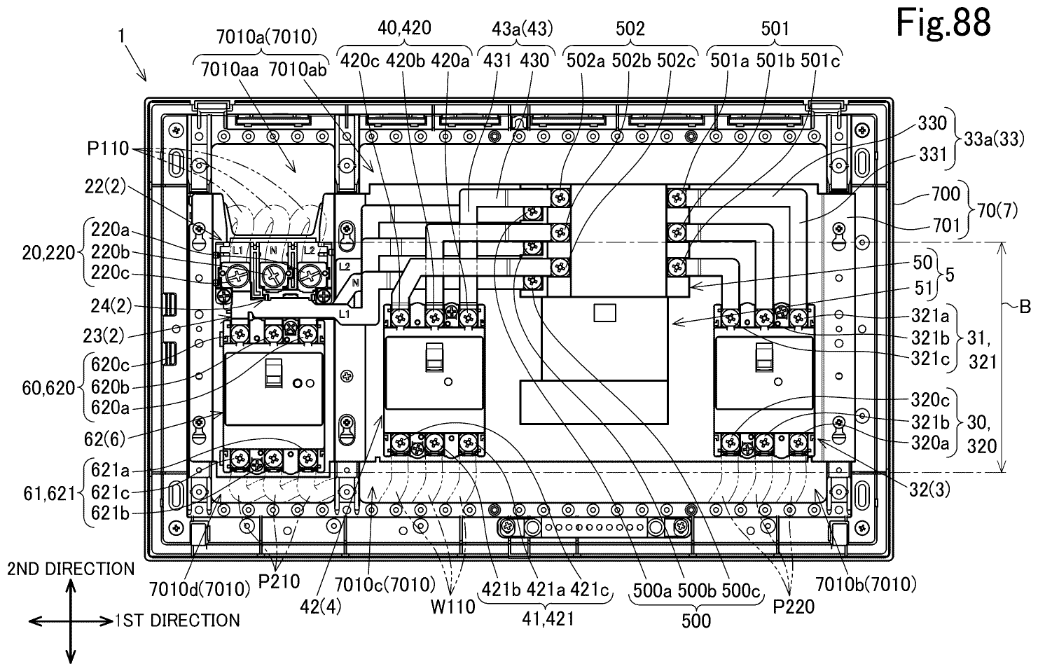

The second conductive connection part 33 of the third embodiment is shaped differently from the first embodiment and the second embodiment. The second conductive connection part 33 includes one end 330 connected to the second-side terminal part 501 and the other end 331 connected to the device secondary terminal part 321. As shown in FIG. 88, one end part 330 extends in the first direction and the other end part 331 extends in the second direction. The second conductive connection part 33 has one end part 330 and the other end part 331 formed continuously.

The second circuit part 3 of the third embodiment also has three second conductive connection part 33 (not shown, but a first phase conductive connection 33a, a second phase conductive connection 33b, and a third phase conductive connection 33c). In the three second conductive connection part 33, one end part 330 is aligned along the second direction, and the other end parts 331 are aligned along the first direction.

In the load circuit part 4 of the third embodiment, similarly to the second embodiment, the load device primary terminal part 420 and the load device secondary terminal part 421 are arranged so as to be aligned in the second direction. Further, the load device primary terminal part 420 is disposed to face one side in the second direction, and the load device secondary terminal part 421 is disposed to face the other side in the second direction.

The loading circuit part 4 of the third embodiment is arranged on one side of changeover switch 5 in the first direction. Specifically, as illustrated in FIG. 88, the load electrical device 42 is disposed between the relay electrical device 62 and the switching control part 51 in the first direction. Therefore, in the third embodiment, the loading electrical device 42 is spaced apart from the second electrical device 32 in the first direction with respect to changeover switch 5. Further, the load electric appliance 42 is arranged such that the load appliance primary terminal part 420 is arranged on the other side of the load side terminal part 502 of changeover switch 5 in the second direction.

In addition, in the third embodiment, the load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

Connection part 43 of the third embodiment differs from the first and second embodiments in form. The load conductive connection part 43 includes one end 430 connected to the load-side terminal part 502 and the other end 431 connected to the load primary terminal part 40. As shown in FIG. 88, one end part 430 extends in the first direction and the other end part 431 extends in the second direction. The loaded conductive connection part 43 has one end part 430 and the other end part 431 formed continuously.

As shown in FIG. 88, the loaded conductive connection part 43 of the third embodiment is disposed in front of first conductive connection part 23 in the front-rear direction in the housing 7. Therefore, the loaded conductive connection part 43 and first conductive connection part 23 overlap each other in the front-rear direction while the inside of the housing 7 is viewed from the front.

In changeover switch 5 of the third embodiment, unlike the second embodiment, the second side terminal part 501 and the load-side terminal part 502 are provided at separate ends in the first direction of changeover switch 5. Specifically, the load-side terminal part 502 is arranged so as to face one side of the first direction and one side of the first direction than the second-side terminal part 501.

In addition, in the third embodiment, the first side terminal part 500 and the second side terminal part 501 are disposed at different positions in the second direction. Here, the load-side terminal part 502 and the second-side terminal part 501 are arranged side by side in the first direction. Therefore, in the second direction, the third phase terminal part 502c is disposed between the second phase terminal part 500b and the third phase terminal part 500c, the second phase terminal part 502b is disposed between the first phase terminal part 500a and the second phase terminal part 500b, and the first phase terminal part 502a is disposed on one side of the first phase terminal part 500a.

Further, in the third embodiment, the load-side terminal part 502 is disposed forward and backward of the first-side terminal part 500. Therefore, as shown in FIG. 88, in the third embodiment, in the front-rear direction, one end part 430 connected to the load-side terminal part 502 is disposed forward with end part 2310 connected to the first-side terminal part 500 disposed rearward.

As in the second embodiment, the switching-side first conductive insertion part 7010ab of the third embodiment is disposed over changeover switch 5, the load-side electric device 42, and the second electric device 32.

The second conductive insertion part 7010b of the third embodiment is provided on the other side of the second electric device 32 in the second direction with respect to the device primary terminal part 320 as in the second embodiment. Further, the second conductive insertion part 7010b is formed so as to extend to one side in the first direction. The second conductive insertion part 7010b of the third embodiment extends from the other side in the second direction of the second electric device 32 to the other side in the second direction of the loading electric device 42 via the other side in the second direction of changeover switch 5.

As in the second embodiment, the load conductor insertion part 7010c of the third embodiment is provided on the other side of the load device secondary terminal part 421 of the load electric device 42 in the second direction. The load-conductor insertion part 7010c is formed so as to extend to the other side in the first direction. The load conductor insertion part 7010c extends from the other side in the second direction of the load electrical device 42 to the other side in the second direction of the second electrical device 32 via the other side in the second direction of changeover switch 5. Further, the load conductor insertion part 7010c is formed on the other side of the relay conductor insertion part 7010d in the first direction with a part of the back surface part 701 along a virtual straight line in the second direction passing between the relay electric device 62 and the load electric device 42 as a border.

As in the second embodiment, the continuous insertion part (not numbered) of the third embodiment is formed so as to extend from directly under the second electric device 32 to directly under the load electric device 42. Here, in the third embodiment, changeover switch 5 is disposed between the loading circuit part 4 and the second circuit part 3. Therefore, unlike the second embodiment, the continuously inserted part of the third embodiment is formed so as to extend directly under the second electric device 32, changeover switch 5, and the loading electric device 42.

The load-conductor insertion part 7010c and the second conductor insertion part 7010b of the third embodiment are formed so as to be aligned in the first direction, as in the second embodiment, and are continuous with each other. In addition, the load-conductor insertion part 7010c and the second conductor insertion part 7010b are formed to have substantially the same length as the switching-side first conductor insertion part 7010ab in the first direction.

In the third embodiment, the second electric device 32 is arranged such that the device secondary terminal part 321 is arranged on the other side in the second direction than the second side terminal part 501 of changeover switch 5, and the load electric device 42 is arranged such that the load device primary terminal part 420 is arranged on the other side in the second direction than the load side terminal part 502 of changeover switch 5. Therefore, as shown in FIG. 88, the second conductive connection part 33 and the loaded conductive connection part 43 can have a simple configuration including one end part 330 and 430 extending in the first direction and 331 and 431 extending in the second direction.

Note that changeover switch built-in board is not limited to the first embodiment, the second embodiment, and the third embodiment (hereinafter, referred to as the above embodiment), and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply. For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the load device primary terminal part 420 and the load device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the device primary terminal part 220 of the first electric device 22 is configured to have the first phase terminal part 220a, the second phase terminal part 220b, and the third phase terminal part 220c, but is not limited to this configuration. For example, in the case of having only the first phase terminal part 220a, in addition to the case of having the first phase terminal part 220a and the second phase terminal part 220b, in the case of having the first phase terminal part 220a, the second phase terminal part 220b, and the third phase terminal part 220c, it may also be a case of having the fourth phase terminal part. That is, the device primary terminal part 220 may include at least a first phase terminal part 220a.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

In addition, the second conductive part 232 may be integrally formed with the first conductive part 231 as in the above-described embodiment, or may be separately attached to the first conductive part 231.

In the above embodiment, the first circuit part 2 is configured to have three first conductive connection part 23, but is not limited to this configuration, for example, the first circuit part 2 may be configured to have one first conductive connection part 23, or may be configured to have two or four or more first conductive connection part 23. That is, the first circuit part 2 may be configured to have at least one first conductive connection part 23.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2. As a result, the load circuit part 4 can be electrically disconnected from the first power supply system P1 and the second power supply system P2, and can further improve electric safety such as when inspecting the load device or the like connected to the load circuit part 4.

Although not specifically mentioned in the above embodiment, first conductive connection part 23 may be configured so that the second conductive part 232 is also screwed to the first electric device 22. In this case, for example, as shown in FIGS. 85 and 86, the first electric device 22 may be provided with the fixing base part 25 having the screw hole formed therein.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

Further, in the above embodiment, the first side terminal part 500 and the second side terminal part 501 are arranged in a straight line in the first direction and the arrangement positions in the second direction are the same position, but the present invention is not limited thereto, and for example, the arrangement positions of the first side terminal part 500 and the second side terminal part 501 in the second direction may be different from each other.

In the above embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the above embodiment, the second side terminal part 501 and the load side terminal part 502 are arranged in the second direction, and the second side terminal part 501 is arranged on one side in the second direction, and the load side terminal part 502 is arranged on the other side in the second direction, but the present invention is not limited thereto, and for example, the second side terminal part 501 may be arranged on the other side in the second direction and the load side terminal part 502 may be arranged on one side in the second direction. In this case, it is conceivable that the second circuit part 3 is arranged on the other side in the second direction and the loading circuit part 4 is arranged on the one side in the second direction.

In the description of the strip-shaped area A of the above embodiment, the arrangement position of the first side terminal part 500 and the arrangement position of the second side terminal part 501 in the second direction has been given an example of the same, for example, the arrangement position of the first side terminal part 500 in the second direction and the arrangement position of the second side terminal part 501 are different from each other even in the second direction, the first phase terminal part 500a and the second side terminal part 501 of the first side terminal part 500 in the second direction it may be a strip-shaped area A area extending in a range including up to the third phase terminal part 501c of the third phase terminal part 500c and the second side terminal part 500 of the first side terminal part 501a.

In the above embodiment, changeover switch built-in board 1 includes the load circuit part 4, but the present invention is not limited thereto, and for example, changeover switch built-in board 1 may not include the load circuit part 4. A load conductor W110 may be connected to the load-side terminal part 502 of changeover switch 5.

In the load electric device 42 of the above embodiment, the load device primary terminal part 420 is provided at one end of the first direction, and the load device secondary terminal part 421 is provided at the other end of the first direction. However, the present invention is not limited thereto, and for example, in the load electric device 42, the load device primary terminal part 420 may be provided at the other end part in the first direction, and the load device secondary terminal part 421 may be provided at the one end part in the first direction.

In addition, changeover switch 5 may include a first side terminal part 500 and a load-side terminal part 502 at one end in the first direction. Here, the first side terminal part 500 and the load side terminal part 502 may be arranged so as to be oriented in the same direction in the first direction and aligned in the second direction. In addition, the loading circuit part 4 may be disposed on one side of changeover switch 5 in the first direction.

In the above embodiment, the arrangement positions of the device primary terminal part 320 and the device secondary terminal part 321 of the second electric device 32 in the second orientation are the same. However, the present invention is not limited thereto, and for example, the arrangement positions of the device primary terminal part 320 and the device secondary terminal part 321 of the second electric device 32 in the second direction may differ from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

In the above-described embodiment, as shown in FIG. 74, the positions of the second-side terminal part 501 and the load-side terminal part 502 in the first direction differ from each other. However, for example, the second-side terminal part 501 and the load-side terminal part 502 may be arranged such that their positions in the first direction are the same (that is, they are arranged along an imaginary straight line extending in the second direction).

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the above embodiment, the arrangement positions of the device primary terminal part 320 and the device secondary terminal part 321 are the same in the second orientation. However, the present invention is not limited thereto, and for example, the device primary terminal part 320 and the device secondary terminal part 321 of the second electric device 32 may be arranged at different positions in the second direction.

In the above embodiment, the load circuit part 4 includes the load electric device 42 as a circuit breaker, but the present invention is not limited thereto, and the load circuit part 4 may be configured to include the power distribution circuit part. Specifically, the load circuit part 4 may be configured to include a main switch connected to the load side terminal part 502 of changeover switch 5, and a plurality of branch switches connected to the secondary side of the main switch via a bus. The housing 7 is sized to accommodate the power distribution circuit part as well.

In the above-described embodiment, since the device primary terminal part 220 also serves as the device secondary terminal part, the device secondary terminal part is arranged so as to be directed in the second direction, but the present invention is not limited thereto, and for example, the device primary terminal part 220 and the device secondary terminal part may be configured so as to be separate from each other, and the device secondary terminal part and the first-side terminal part 500 may be configured so as to face each other in the first direction.

In the above embodiment, the second circuit part 3 is disposed on the other side of the first circuit part 2 and changeover switch 5 in the first direction, but the present invention is not limited thereto, and for example, the second circuit part 3 may be disposed on the one side of the first circuit part 2 and changeover switch 5 in the first direction. The same applies to the load circuit part 4, and the load circuit part 4 may be disposed on one side of the first circuit part 2 and changeover switch 5 in the first direction.

In the third embodiment, the second circuit part 3 is disposed on the other side of changeover switch 5 in the first direction and the load circuit part 4 is disposed on the one side of changeover switch 5 in the first direction, but the present invention is not limited thereto, and the second circuit part 3 may be disposed on the one side of changeover switch 5 in the first direction and the load circuit part 4 may be disposed on the other side of changeover switch 5 in the first direction.

In the first embodiment, the load conductor insertion part 7010c and the second conductor insertion part 7010b have been described as being formed so as to extend to one side and the other side in the second direction, but the present invention is not limited thereto, and for example, the load conductor insertion part 7010c and the second conductor insertion part 7010b may be formed so as to extend to one side or the other side in the second direction.

In the above embodiment, the switching-side first conductor insertion part 7010ab is disposed directly above changeover switch 5 and the second electric device 32, but the present invention is not limited thereto, and for example, the switching-side first conductor insertion part 7010ab may be partitioned on one side and the other side of the first direction with a part of the second direction along a virtual straight line in the second direction passing between changeover switch 5 and the second electric device in the first direction as a border.

In the first embodiment, the load conductor insertion part 7010c is formed so as to extend to one side and the other side in the second direction, but the present invention is not limited thereto, for example, the load conductor insertion part 7010c may be configured so as to extend to one side or the other side in the second direction.

Although the load electric device 42 of the second embodiment has been described as being arranged so as to be arranged at a position spaced apart from the second electric device 32 in one direction, the load electric device 42 may be arranged on one side in the first direction and the other side in the first direction from the second electric device 32. Here, the second side terminal part 501 may be disposed forward in the front-rear direction and the load-side terminal part 502 may be disposed rearward in the front-rear direction.

In the second embodiment, the device primary terminal part 320 is disposed on the other side in the second direction and the device secondary terminal part 321 is disposed on one side in the second direction, but the device primary terminal part 320 may be disposed on one side in the second direction and the device secondary terminal part 321 may be disposed on the other side in the second direction. In addition, the load device secondary terminal part 421 may be disposed on one side in the second direction, and the load device primary terminal part 420 may be disposed on the other side in the second direction. For example, the device primary terminal part 320 and the loading device secondary terminal part 421 may be disposed on one side of the strip-shaped area A in the second direction.

In the above embodiment, the switching body part 50 is disposed on one side in the second direction, the switching control part 51 has been described as being disposed on the other side in the second direction, not limited thereto, for example, such that the switching body part 50 and the switching control part 51 are aligned in the first direction, the switching body part 50 and the switching control part 51 may be arranged so as to be aligned in the front-rear direction.

Next, a changeover switch built-in board according to another embodiment will be described. Changeover switch built-in board according to the present disclosure incorporates a changeover switch.

As a power supply switching device which is a conventional changeover switch built-in board, for example, there is a device described in Japanese Patent No. 5284832. The input side of the power supply switching device is connected to a commercial power supply input line from a commercial power supply and a generator power supply input line from a generator power supply, and the output side is collectively connected to a load.

On the commercial power supply line side connected to the commercial power supply, a line switch is inserted into the power supply side, a delay switch is interposed on the load side, the line switch is constituted by a contact part and a coil, the contact part is always biased to close, the coil is energized when the power is supplied from being switched to open, the delay switch is constituted by a contact part and a coil, the contact part is always energized to open, the coil is energized when the power is supplied from being switched to open, the output end of the contact part of the line switch is connected to the input end of the contact part of the delay switch.

On the generator power supply line side connected to the generator power supply, a leakage breaker is inserted to prevent leakage, a line switch is interposed on the power supply side, a delay switch is inserted on the load side, the line switch is constituted by a contact part and a coil, the contact part is always biased to close, and the coil is energized when the power is supplied to the coil and switched to open, the delay switch is constituted by a contact part and a coil, the contact part is always biased to open, and the coil is energized when the power is supplied to the coil and switched from open to closed, and the output end of the contact part of the line switch is connected to the input end of the contact part of the delay switch.

Incidentally, in the power supply switching device described in Japanese Patent No. 5284832, various switches such as the line switch and the delay switch are housed in the cabinet. Therefore, in order to collectively connect the output side of the power supply switching device to the load, it is necessary to insert the commercial power supply line and the generator power supply line into the cabinet for the board. Here, the commercial power supply line and the generator power supply line inserted into the cabinet for a board are generally configured by bundling a plurality of metal busbars. Therefore, in order to connect to the output side of the power supply switching device, it is necessary to bend the commercial power supply line and the generator power supply line in accordance with the directions of the various switches.

However, a force is required to bend the commercial power supply line and the generator power supply line. Further, the commercial power supply line and the generator power supply line inserted into the cabinet for the panel, while taking into consideration the bending radius and the position of the various switches housed in the cabinet for the panel, it is difficult to bend. Therefore, in the power supply switching device described in Japanese Patent No. 5284832, it is difficult to perform wiring work such that the commercial power supply line and the generator power supply line are connected to the output side of the power supply switching device.

In view of the above, an object of the present disclosure is to provide a changeover switch built-in board that is easy to wire a load-conductor.

The present invention comprises: Changeover switch built-in board is characterized in that includes changeover switch for switching a power supply for supplying electricity to a load to a first power supply system or a second power supply system, and a load circuit part comprising a load electrical device electrically connected to a load system comprising said load, and a housing for housing the changeover switch and the load circuit part, and the changeover switch and the load electric device are arranged on one side in one direction of a first direction orthogonal to the front-rear direction and a second direction orthogonal to the front-rear direction and the first direction in the housing, and the load electrical device is disposed on the other side of the one direction, and the load conductor insertion portion is formed in the housing so as to insert a load conductor electrically connected to the load electrical device on the other side of the load electrical device in the one direction into the outside and the inside of the housing, and the load conductor insertion part is configured to extend to at least one of one side and the other side in the other direction of the first direction and the second direction

According to the above configuration, since changeover switch is disposed on one side in the one direction, the load electric device is disposed on the other side in the one direction, and a load conductor insertion part is formed on the other side in the one direction of the load electric device in the housing, the load conductor can be inserted into the outside and the inside of the housing from the load conductor insertion part formed in a direction in which changeover switch and the load electric device are arranged side by side, and the load conductor insertion part extends to at least one of one side and the other side in the other direction, whereby a space for inserting the load conductor can be secured on the outside and the inside of the housing, and the load conductor can be inserted into the outside and the inside of the housing while considering a bending radius in the load conductor.

Further, the present disclosure may include a second circuit part including a second electric device housed in the housing and electrically connected to the second power supply system, wherein the second electric device and the load electric device may be arranged side by side in the other direction, and the housing may have a second conductor insertion part in which a second conductor electrically connected to the second electric device is inserted into the outside and the inside of the housing on the other side of the one direction of the second electric device, and the second conductor insertion part and the load conductor insertion part may also be used.

According to the configuration, the second electric device and the load electric device are arranged side by side in the other direction, and the second conductor insertion part is formed on the other side of the one direction of the second electric device in the housing, and therefore, the second conductor and the load conductor can be inserted into the housing from the second conductor insertion part and the load conductor insertion part on the other side of the one direction of the second electric device and the load electric device arranged in the other direction, respectively, and the second conductor insertion part and the load conductor insertion part are also used, and therefore, for example, when the load conductor is inserted into the inside and outside of the housing, the load conductor can be inserted into the outside and inside of the housing while taking into consideration the bending radius and the arrangement of the second conductor.

Further, the present disclosure may include the changeover switch for switching a power supply for supplying electricity to a load to a first power supply system or a second power supply system and the load circuit part comprising load electrical equipment electrically connected to a load system comprising said load and the and a housing for housing the changeover switch and the load circuit part, and the changeover switch and the load electric device are arranged so that the changeover switch is disposed on one side of one of a first direction orthogonal to the front-rear direction and a second direction orthogonal to the front-rear direction and the first direction in the housing, and the load electric device is arranged on the other side of the one direction, and the load conductor insertion part is formed in the housing so as to insert a load conductor electrically connected to the load electric device on one side of the other direction of the first direction and the 2 direction of the load electric device into the outside and inside of the housing, and the load conductor insertion part extend to at least one of the one side and the other side in the one direction.

According to the above configuration, since changeover switch is disposed on one side of the one direction, the load electric device is disposed on the other side of the one direction, and a load conductor insertion part is formed in the housing on one side of the other direction of the load electric device, the load conductor can be inserted into the outside and the inside of the housing from the load conductor insertion part formed in a direction perpendicular to a direction in which changeover switch and the load electric device are arranged side by side, and the load conductor insertion part extends to at least one of the one side and the other side in the one direction, whereby a space for inserting the load conductor can be secured on the outside and the inside of the housing, and the load conductor can be inserted into the outside and the inside of the housing while taking into account the bending radius of the load conductor, the position of the load electric device and changeover switch, and the like.

Further, the present disclosure may include a second circuit part including a second electric device housed in the housing and electrically connected to the second power supply system, wherein changeover switch and the second electric device and the load electric device may be arranged side by side in the one direction, and a second conductor insertion part through which a second conductor electrically connected to the second electric device is inserted to the outside and the inside of the housing may be formed on one side of the other direction of the second electric device, and the second conductor insertion part and the load conductor insertion part may also be used.

According to the above configuration, changeover switch, the second electric device, and the load electric device are arranged side by side in the one direction, and the second conductor insertion part is formed on one side of the other direction of the second electric device in the housing, so that the second conductor and the load conductor can be inserted into the housing from the second conductor insertion part and the load conductor insertion part on one side of the other direction of the second electric device and the load electric device arranged in the one direction, respectively, and the second conductor insertion part and the load conductor insertion part are also used, and therefore, for example, when the load conductor is inserted into the inside and outside of the housing, the load conductor can be inserted into the outside and inside of the housing while taking into account the bending radius and the arrangement of the second conductor.

As described above, according to the present invention, a space through which the load conductor is inserted can be secured inside the housing, and the load conductor can be inserted into the outside and the inside of the housing in consideration of a bending radius or the like, so that wiring work of the load conductor can be easily performed.

Hereinafter, a changeover switch built-in board according to a first embodiment of the present disclosure will be described referring to the accompanying drawings.

Changeover switch built-in board is installed between a plurality of power supply systems and a load, and is configured to switch between a plurality of power supply systems and a load.

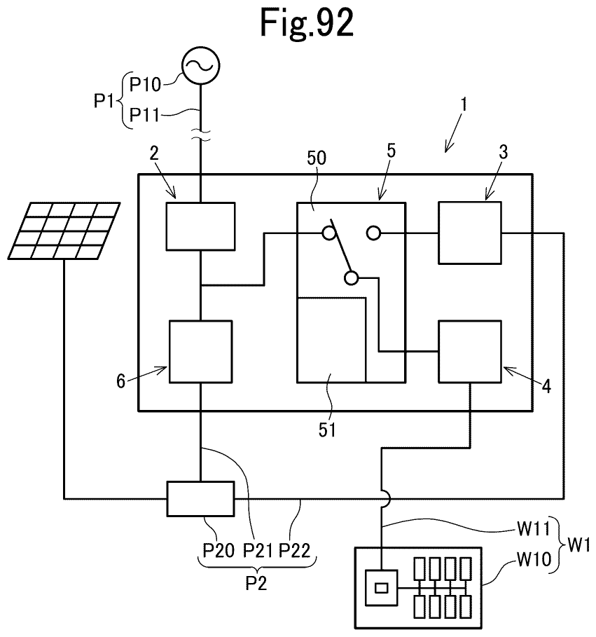

For example, as shown in FIG. 92, when changeover switch built-in board is installed in a house, a first power supply system P1 through which commercial power flows, a second power supply system P2 including a distributed power supply, and a load system W10 including a load W1 are electrically connected to changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

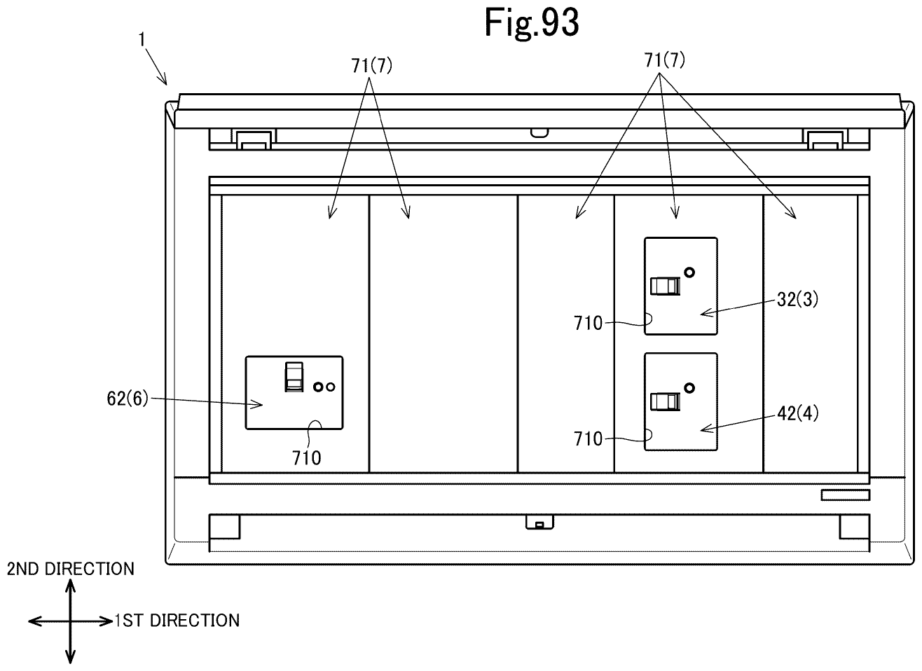

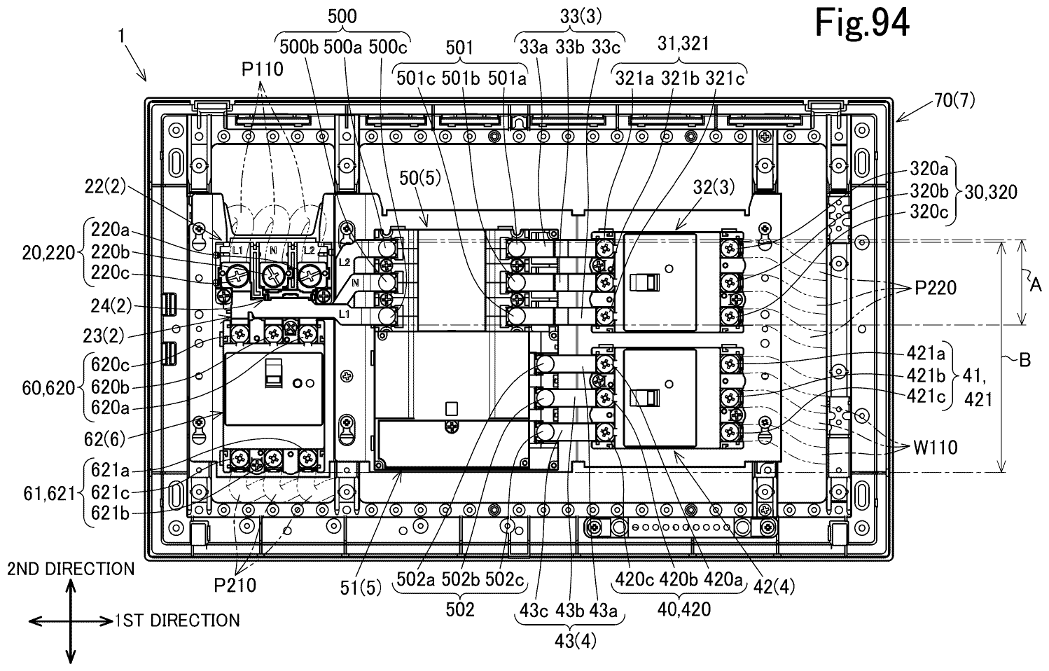

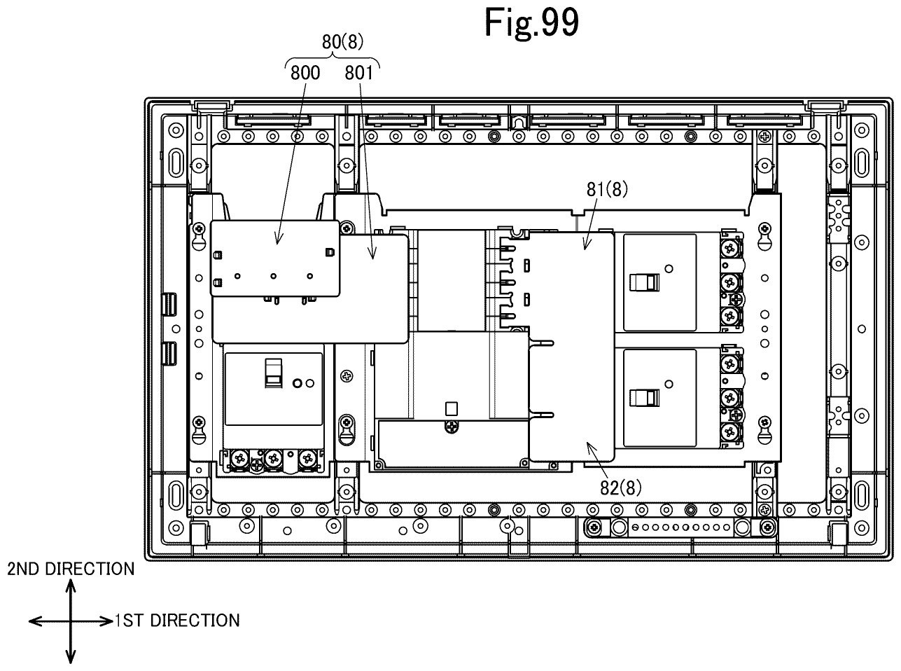

As shown in FIG. 94, changeover switch built-in board 1 is electrically connected to the first power supply system P1, the first circuit part 2 electrically connected to the second power supply system P2, the load circuit part 3 to which the load system W1 is connected, and changeover switch 5 which switches the power supply which supplies electricity to the load system W1 to the first power supply system P1 or the second power supply system P2A housing 7 (see FIG. 93) for housing the relay circuit part 6 to be connected, the first circuit part 2, the second circuit part 3, the relay circuit part 6, changeover switch 5, and the load P2 4, and a cover-structure 8 (see FIG. 99) for covering the charging part in the housing 7 are provided.

In the present embodiment, a direction in which the front surface and the back surface of changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction of a surface formed by the first direction and the second direction is referred to as a board surface direction.

In the present embodiment, the first direction is a direction corresponding to the left-right direction in a state where changeover switch built-in board 1 in the installed state is viewed from the front, and the one side in the first direction is a left side and the other side in the first direction is a right side.

In addition, the second direction is a direction corresponding to the up-down direction in a state where changeover switch built-in board 1 in the installed state is viewed from the front, the one side in the second direction is the upper side, and the other side in the second direction is the lower side.

The first circuit part 2 is electrically connected to the first power supply system P1 and changeover switch 5. The first circuit part 2 is disposed on one side of changeover switch 5 in the first direction.

The first circuit part 2 of the present embodiment has a first power supply system P1 electrically connected to a first primary terminal part 20, and a changeover switch 5 (a first-side terminal part 500 to be described later) and a relay circuit part 6 electrically connected to a first secondary terminal part (not numbered). In the first circuit part 2 of the present embodiment, first primary terminal part 20 also serves as a first secondary terminal part.

In the first circuit part 2, first primary terminal part 20 is disposed toward one side in the second direction, and is connectable to first primary terminal part 20 in a direction extending from first primary terminal part 20 to one side in the second direction with the first power supply P10 (in the present embodiment, the first power distribution path P11) and the first conductive P110 connected to first primary terminal part 20.

The first circuit part 2 includes a first electric device 22, a first conductive connection part 23 fixed to the first electric device 22 so as to be electrically connected to the first conductive P110, and a partition member 24 for preventing a short circuit of first conductive connection part 23.

The first electrical device 22 is a terminal block. Further, the first electric device 22 is a terminal block including a first primary terminal part 20 electrically connected to the first power supply system P1, and a first power distribution path P11 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 includes a device primary terminal part 220 capable of fixing the first conductive P110, and a device secondary terminal part (not numbered) capable of fixing first conductive connection part 23. In the first electric device 22, the device primary terminal part 220 also serves as a device secondary terminal part.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and first conductive connection part 23 are fixed to the device primary terminal part 220, the first conductor P110 and first conductive connection part 23 are electrically connected to each other. The device primary terminal part 220 of the present embodiment is configured such that the first conductive P110 and first conductive connection part 23 can be fixed by screws.

In addition, the device primary terminal part 220 may be configured to conduct each other by directly contacting the first conductive P110 and first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

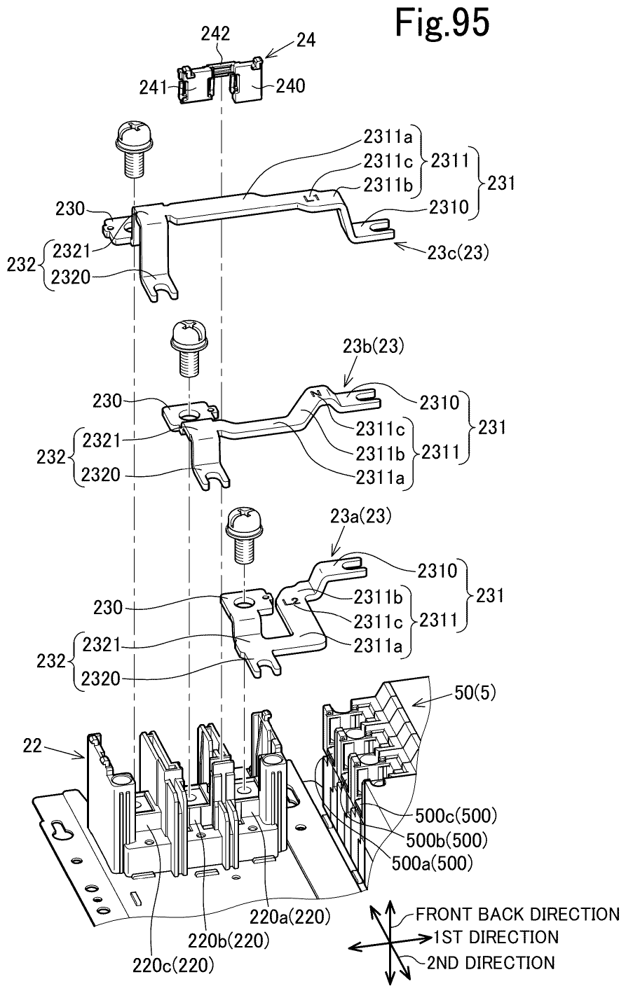

As shown in FIG. 95, first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the distal end side of the connection fixing part 230 is branched into the other side in the second direction and the other side in the first direction in first conductive connection part 23. First conductive connection part 23 of the present embodiment is made of a conductive plate material.

The first conductive part 231 includes a end part 2310 fixed to a first-side terminal part 500 of changeover switch 5, which will be described later, and a intermediate part 2311 that is contiguous with end part 2310 and the second conductive part 232 (a intermediate part 2321 of the second conductive part 232, which will be described later).

The first conductive part 231 intermediate part 2311 is a part interposed between the second conductive part 232 and end part 2310 of the first conductive part 231. Intermediate part 2311 of the first conductive part 231 of the present embodiment includes a proximal end side conductive part 2311a disposed between the first electric device 22 and the relay circuit part 6 (the other side in the second direction than the first electric device 22), a distal end side conductive part 2311b disposed between the first electric device 22 and changeover switch 5 (the other side in the first direction than the first electric device 22), and an identification 2311c attached to a front surface (one surface disposed toward the front side in the front-rear direction) of the distal end side conductive part 2311b. The identification 2311c may be formed by digging in intermediate part 2311 of the first conductive part 231 by direct marking, or may be formed by printing with a laser or the like.

The identification-display 2311c indicates the type of first conductive connection part 23. The identification-display 2311c of the present embodiment is constituted by characters of “L1” indicating L1 phase, “N” indicating the N phase, and “L2” indicating L2 phase.

The second conductive part 232 includes a end part 2320 fixed to a relay primary terminal part (relay device primary terminal part) of the relay circuit part 6, which will be described later, and a intermediate part 2321 connected to end part 2320 and the connecting fixing part 230.

Here, the first circuit part 2 has three first conductive connection part 23 corresponding to the numbers of the device primary terminal part 220. The three first conductive connection part 23, respectively, first conductive connection part 23 for the first phase (first phase conductive connection 23a), first conductive connection part 23 for the second phase (second phase conductive connection 23b), first conductive connection part 23 for the third phase (third phase conductive connection 23c).

The three first conductive connection part 23 are arranged such that the respective second conductive part 232 are aligned in the first direction in the front view.

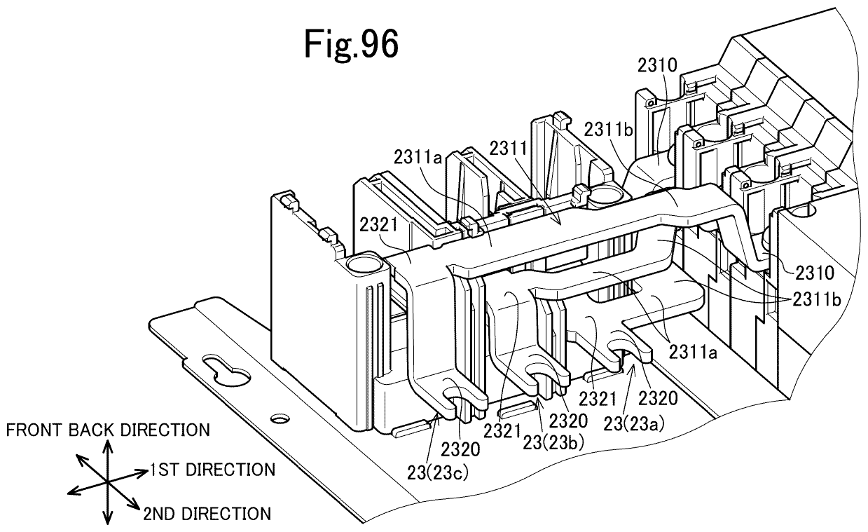

As shown in FIG. 96, intermediate part 2321 of the second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second 232 for the first phase, which is disposed on the most other side in the first direction, is disposed on the most rear side in the front-rear direction.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the conductive connection part 23) for the third phase conductive connection part 23c(L1 phase is disposed on the most front side in the front-rear direction, and the distal end side conductive part 2311b included in the second phase conductive connection part 23b and the third phase conductive connection part 23b (conductive connection part 23 for the N-phase) is disposed on one side in the front-rear direction and in the second direction with respect to the distal end side conductive part 2311b included in the second phase conductive connection part 23c is disposed on one side in the front-rear direction and in the second direction with respect to the distal end side conductive part 2311b included in the third phase conductive connection part conductive part 2311b, and is disposed on one side in the front-rear direction and in the second direction with respect to the distal end side 23a(L2 included in the first phase conductive connection part 23a(L2 23).

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the second phase conductive connection part 23b is also arranged so as to cross the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

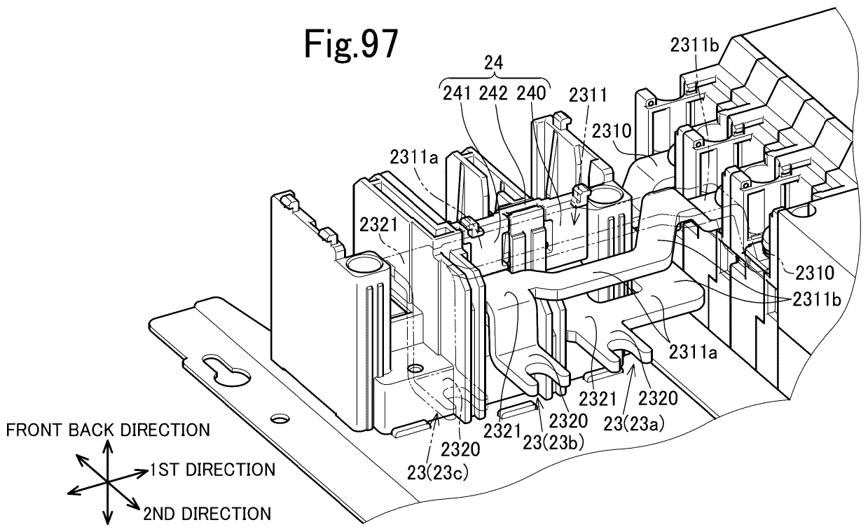

More specifically, as shown in FIG. 97, the partition member 24 has a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 94, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the first direction, and is connectable to second primary terminal part 30 in a direction extending from second primary terminal part 30 to the other side in the first direction with the second power supply P20 (the second power distribution path P22 in the present embodiment) and the second conductive P220 connected to second primary terminal part 30.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The device primary terminal part 320 and the device secondary terminal part 321 are arranged side by side in a first direction, and the arrangement position of the device primary terminal part 320 in the second direction and the arrangement position of the device secondary terminal part 321 in the second direction are the same. Further, in the present embodiment, the second electric device 32 is arranged such that the device primary terminal part 320 faces the other side of the first direction and the device secondary terminal part 321 faces the one side of the first direction.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductive P220 of the second distribution path P22 is fixed to the device primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductive P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the second direction, and the first phase terminal part 321a of the device secondary terminal part 321, the second phase terminal part 321b, and the third phase terminal part 321c are also arranged to align with each other in the second direction.

The second conductive connection part 33 is formed so as to extend along the first direction (i.e., formed in a straight line shape). One longitudinal end of the second conductive connection part 33 is fixed to the device secondary terminal part 321.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, since the first phase terminal part 321a, the second phase terminal part 321b, and the third phase terminal part 321c of the device secondary terminal part 321 are arranged so as to be aligned along the second direction, the three second conductive connection part 33 are also arranged along the second direction while being fixed to the first phase terminal part 321a, the second phase terminal part 321b, and the third phase terminal part 321c, respectively.

The second electric apparatus of the present embodiment is a circuit breaker. Therefore, in a state in which the second conductive terminal part 320 is fixed with the second conductive P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading appliance 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

The load device primary terminal part 420 and the load device secondary terminal part 421 are arranged side by side in the first direction, the load device primary terminal part 420 is provided at one end of the load device 42 in the first direction, and the load device secondary terminal part 421 is provided at the other end of the load device 42 in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical device 42 is arranged side by side in the second direction with respect to the second circuit part 3, and the load device primary terminal part 420 of the load electrical device 42 and the device secondary terminal part 321 of the second electrical device 32 are arranged in the second direction, and the load device secondary terminal part 421 of the load electrical device 42 and the device primary terminal part 320 of the second electrical device 32 are arranged in the second direction. In the present embodiment, the load electrical device 42 is disposed at a position spaced apart from the second electrical device 32 in the second direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged so as to be aligned in the second direction, and the first phase terminal part 421a, the second phase terminal part 421b, and the third phase terminal part 421c of the load device secondary terminal part 421 are also arranged so as to be aligned in the second direction.

The load conductive connection part 43 is formed so as to extend along the first direction (i.e., is straight), and one end part in the longitudinal direction is fixed to the load primary terminal part 40.

The load circuit part 4 has three load conductive connection part 43 corresponding to the numbers of the first phase terminal part 420a, the second phase terminal part 420b, and the third phase terminal part 420c. The three load conductive connection part 43 are also a load conductive connection part 43 for the first phase (first phase conductive connection 43a), a load conductive connection part 43 for the second phase (second phase conductive connection 43b), and a load conductive connection part 43 for the third phase (third phase conductive connection 43c), respectively.

As described above, since the first phase terminal part 420a, the second phase terminal part 420b, and the third phase terminal part 420c of the load device primary terminal part 420 are arranged to be aligned along the second direction, the three load conductive connection part 43 are arranged to be aligned along the second direction in a state where they are fixed to the first phase terminal part 420a, the second phase terminal part 420b, and the third phase terminal part 420c, respectively.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching main body part 50 that switches between the first circuit part 2 and the second circuit part 3 and the load circuit part 4, and a switching control part 51 that operates the switching main body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500, the second side terminal part 501, and the load-side terminal part 502 are provided at separate ends in the first direction of changeover switch 5. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction. Thus, the first terminal part 500 is positioned towards the instrument primary terminal part 220.

Further, the second side terminal part 501 and the load side terminal part 502 are arranged side by side in the second direction in the same direction in the first direction, the second side terminal part 501 and second secondary terminal part 31 face each other in the first direction, and the load side terminal part 502 and the load primary terminal part 40 face each other in the first direction.

In the present embodiment, the second side terminal part 501 is disposed on one side in the second direction, and the load-side terminal part 502 is disposed on the other side in the second direction. Furthermore, the arrangement position of the second side terminal part 501 of the present embodiment in the first direction and the arrangement position of the load-side terminal part 502 in the first direction are different from each other. More specifically, the second side terminal part 501 is arranged to be located on one side of the load-side terminal part 502 in the first direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b, 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

In addition to the second-side terminal part 501, in each of the device secondary terminal part 321, the load-side terminal part 502, and the load-device primary terminal part 420 of the load electrical device 42 of the second electrical device 32, the first-phase terminal part 321a, 502a, 420a, the second-phase terminal part 321b, 502b, 420b, and the third-phase terminal part 321c, 502c, 420c are arranged so as to be aligned in the second direction.

Further, the second-side terminal part 501 and the device secondary terminal part 321 of the second electric device 32 are configured such that the first phase terminal part 501a, 321a of each other oppose each other in the first direction, the second phase terminal part 501b, 321b of each other oppose each other in the first direction, and the third phase terminal part 501c, 321c of each other oppose each other in the first direction. Note that the second-side terminal part 501 and the device secondary terminal part 321 of the second electric device 32 may be opposed to each other in a positional relationship, or may be substantially opposed to each other without being perfectly opposed to each other.

The load-side terminal part 502 and the load device primary terminal part 420 of the load electric device 42 are configured such that the first phase terminal part 502a, 420a of each other oppose each other in the first direction, the second phase terminal part 502b, 420b of each other oppose each other in the first direction, and the third phase terminal part 502c, 420c of each other oppose each other in the first direction. Note that the load-side terminal part 502 and the load device primary terminal part 420 of the load electric device 42 may be opposed to each other in a positional relationship, or may be substantially opposed to each other without being perfectly opposed to each other.

In addition, in the second direction, in the band-like area A that extends in a first direction from the first phase terminal part 500a of the first side terminal part 500 and the first phase terminal part 501a of the second side terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side than terminal part 500, and second secondary terminal part 31 is arranged in the second direction on the other side of the first side than terminal part 501.

Therefore, changeover switch 5 of the present embodiment is disposed between the first circuit part 2 and the second circuit part 3 in the first direction. Specifically, as shown in FIG. 94, changeover switch 5 is disposed between the first circuit part 2 and the second circuit part 3 which are disposed at the same position in the second direction by being disposed in the band-shaped area A extending in the first direction.

Further, in the present embodiment, since the load electric device 42 is disposed on the other side of changeover switch 5 in the first direction, changeover switch 5 is also disposed between the first circuit part 2 and the load circuit part 4 in the first direction.

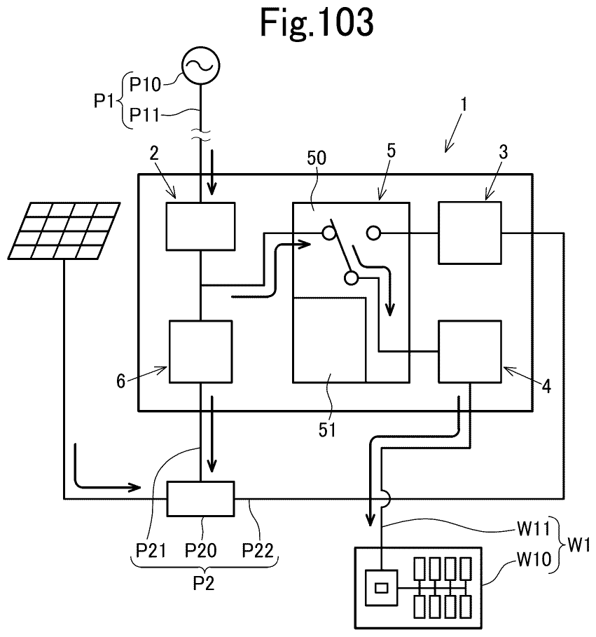

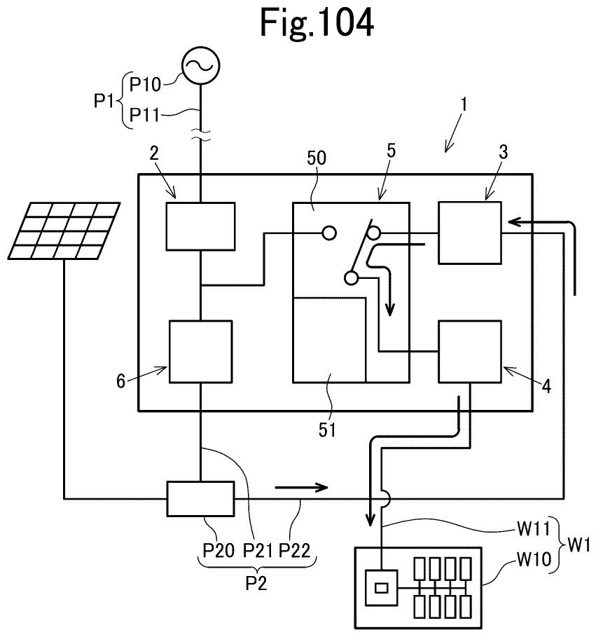

As shown in FIG. 103, the switching main body 50 is switchable between a state in which the first side terminal part 500 and the load side terminal part 502 are electrically connected to each other and the second side terminal part 501 and the load side terminal part 502 are electrically disconnected from each other (first power supply state), and a state in which the first side terminal part 500 and the load side terminal part 502 are electrically disconnected from each other and the second side terminal part 501 and the load side terminal part 502 are electrically connected to each other (second power supply state) as shown in FIG. 104, and the switching control part 51 is configured to switch the first power supply state and the second power supply state by operating the switching main body 50.

The switching control part 51 may be configured to automatically switch the first power supply state and the second power supply state of the switching main body 50 according to the respective power supply states, but may be configured to manually switch between the first power supply state and the second power supply state, or may be configured to switch between the first power supply state and the second power supply state by remote control from the outside.

In the present embodiment, as shown in FIG. 94, the switching main body 50 is disposed on one side in the second direction, and the switching control part 51 is disposed on the other side in the second direction.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 621 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 321 of the relay electrical device 62) in the second direction, and to be within the band-shaped area B extending in the first direction.

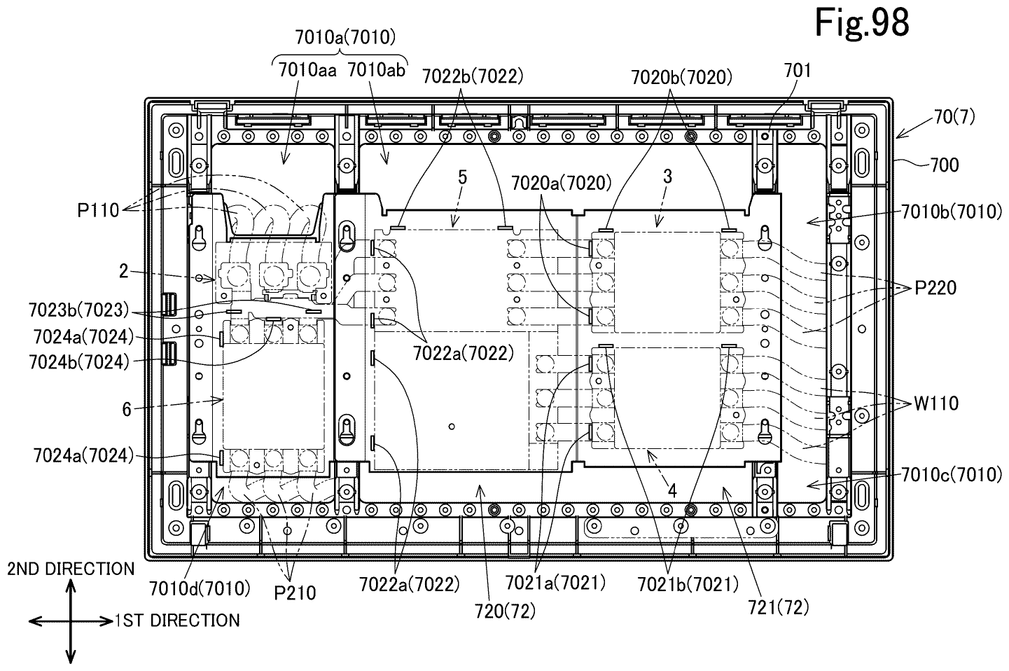

As shown in FIG. 98, the housing 7 includes a housing part 70 capable of housing the first circuit part 2, the second circuit part 3, the loading circuit part 4, changeover switch 5, and the relay circuit part 6 therein, and an intermediate cover part 71 (see FIG. 93) attached to the front surface of the housing part 70. Although not shown in FIG. 98, the housing 7 includes an outer lid part that covers the inner lid part 71 attached to the front surface of the housing part 70.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of first primary terminal part 20 and changeover switch 5 of the first electric device 22 in the second direction. Therefore, the first conductor insertion part 7010a allows the first conductor P110 to be inserted into and out of the housing 7 on one side of first primary terminal part 20 and changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric device 22, and the switching-side first conductor insertion part 7010ab is disposed directly above changeover switch 5 and the second electric device 32 (one side in the second direction). Therefore, the switching-side first conductive insertion part 7010ab is formed on one side of the load-electric device 42 in the second direction. Therefore, the switching-side first conductive insertion part 7010ab of the present embodiment is formed so as to correspond to the entire length of changeover switch 5 and the second electric device 32 in the first direction. In the present embodiment, as shown in FIG. 94, the first conductor P110 is inserted inside the housing 7 via the first-side first conductor insertion part 7010aa.

The first-side first conductive insertion part 7010aa is formed over the entire area of the first electric device 22 in the first direction. The switching-side first conductive insertion part 7010ab is formed so as to extend over the entire area in the first direction of changeover switch 5. The switching-side first conductive insertion part 7010ab is also formed to extend over the entire area of the second electric device 32 in the first direction. Therefore, the first conductive insertion part 7010a of the present embodiment is formed so as to correspond to the entire length of the first electric device 22, changeover switch 5, and the second electric device 32 in the first direction.

The second conductive insertion part 7010b is provided on the other side in the first direction than the device primary terminal part 320 of the second electric device 32. Therefore, the second conductor insertion part 7010b allows the second conductor P220 to be inserted into and out of the housing 7 on the other side in the first direction than the device primary terminal part 320 of the second electric device 32.

Further, the second conductive insertion part 7010b is disposed on the other side of the second electric device 32 in the first direction in the band-shaped area A, and the arrangement position in the second direction is the same as the arrangement position in the second direction of the second electric device 32. The second conductor insertion part 7010b is formed so as to extend to the same arrangement position as the arrangement position of the first conductor insertion part 7010a in the second direction on one side in the second direction than the strip-shaped area A.

The second conductive insertion part 7010b of the present embodiment extends to one side of the second electric device 32 in the second direction. The second conductive insertion part 7010b also extends to the other side of the second electric device 32 in the second direction. In the second conductor insertion part 7010b, part extending further toward the other side in the second direction than the second electric device 32 has the same part as the load conductor insertion part 7010c described later. Therefore, the second conductive insertion part 7010b of the present embodiment is formed to be longer than the length of the second electric device 32 in the second direction.

The load conductor insertion part 7010c is provided on the other side of the load device secondary terminal part 421 of the load electric device 42 in the first direction. Therefore, the load conductor insertion part 7010c allows the load conductor W110 to be inserted into and out of the housing 7 on the other side of the load device secondary terminal part 421 of the load electric device 42 in the first direction. Further, the load-conductor insertion part 7010c is formed so as to extend to the same arrangement position as the arrangement position of the relay conductor insertion part 7010d described later in the second direction.

The load conductor insertion part 7010c of the present embodiment extends to one side of the load electric device 42 in the second direction. The load conductor insertion part 7010c also extends to the other side of the load electric device 42 in the second direction. In the load conductor insertion part 7010c, part extending to one side of the load electric device 42 in the second direction is the same part as the second conductor insertion part 7010b. Therefore, the second conductive insertion part 7010b of the present embodiment is formed to be longer than the length of the second electric device 32 in the second direction.

Further, the load-conductor insertion part 7010c and the second conductor insertion part 7010b are formed at positions aligned in the second direction, and are formed so as to be continuous with each other. Therefore, the load-conductor insertion part 7010c and the second conductor insertion part 7010b are also used. Therefore, for example, the second conductor P220 can be inserted into and out of the housing 7 from the load conductor insertion part 7010c which also serves as the second conductor insertion part 7010b. Further, the loading conductor insertion part 7010c and the second conductor insertion part 7010b are formed so as to extend to one side and the other side in the second direction.

By combining the second conductor insertion part 7010b and the loading conductor insertion part 7010c, a secondary insertion part (not numbered) is formed. The secondary insertion part is formed so as to correspond to the entire area in the second direction of the second electric device 32 and the load electric device 42 arranged side by side in the second direction. Specifically, the secondary insertion part is formed so as to extend from a position on one side of the second electric device 32 to a position on the other side of the load electric device 42 in the second direction.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction. The relay-conductor insertion part 7010d of the present embodiment is formed so as to extend over the entire area of the relay electric device 62 in the first direction.

A communication part 72 that communicates the inside and the outside of the housing 7 is formed on the other side of changeover switch 5 and the load-electric device 42 in the second direction. The communication part 72 is disposed on the other side of the relay-conductor insertion part 7010d in the first direction. In addition, the communication part 72 of the present embodiment includes a switching communication part 720 disposed directly below changeover switch 5, and a load communication part 721 disposed directly below the load electric device 42.

The switching communication part 720 is formed to cover the entire area in the first direction of changeover switch 5, and the load communication part 721 is formed to cover the entire area in the first direction of the load electric device 42. The switching communication part 720 and the load communication part 721 are formed to be continuous with each other in the first direction.

Therefore, in the present embodiment, the first circuit part 2, changeover switch 5, the second circuit part 3, and the load circuit part 4 are surrounded in three directions by the first conductor insertion part 7010a, the second conductor insertion part 7010b, the communication part 72, and the relay conductor insertion part 7010d.

The positioning structure 702 includes a second circuit part positioning part 7020 for positioning the second circuit part 3 with respect to the back surface part 701, a load circuit part positioning part 7021 for positioning the load circuit part 4 with respect to the back surface part 701, a changeover switch positioning part 7022 for positioning changeover switch 5 with respect to the back surface part 701, a first circuit part positioning part 7023 for positioning the first circuit part 2 with respect to the back surface part 701, and a relay circuit part positioning part 7024 for positioning the relay circuit part 6 with respect to the back surface part 701.

The second circuit part positioning part 7020 of the present embodiment is configured to position the second electrical device 32.

In addition, the second circuit part positioning part 7020 is configured to abut on two intersecting side surfaces of the second electrical device 32. More specifically, the second circuit part positioning part 7020 has a first contact part 7020a that protrudes from the back surface part 701 toward the front side in the front-rear direction and abuts on the side surface of the second electric device 32 on the one side in the first direction, and a second contact part 7020b that protrudes from the back surface part 701 toward the front side in the front-rear direction and abuts on the side surface of the second electric device 32 on the one side in the second direction.

Load circuit part positioning part 7021 is configured to position the load electric device 42.

In addition, the load circuit part positioning part 7021 is configured to abut on two intersecting side surfaces of the load electric device 42. More specifically, the load circuit part positioning part 7021 includes a first contact part 7021a that protrudes from the back surface part 701 toward the front side in the front-rear direction and abuts on a side surface of the load electrical device 42 on one side in the first direction, and a second contact part 7021b that protrudes from the back surface part 701 toward the front side in the front-rear direction and abuts on a side surface of the load electrical device 42 on one side in the second direction.

The changeover switch positioning part 7022 is configured to abut two intersecting sides of changeover switch 5. More specifically, the changeover switch positioning part 7022 has a first contact part 7022a that protrudes from the back surface part 701 toward the front side in the front-rear direction and abuts on the side surface on one side in the first direction of changeover switch 5, and a second contact part 7022b that protrudes from the back surface part 701 toward the front side in the front-rear direction and abuts on the side surface on one side in the second direction of changeover switch 5.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The inner lid part 71 is attached to the housing part 70 and is configured to cover the front surfaces of the first circuit part 2, the second circuit part 3, the loading circuit part 4, changeover switch 5, and the relay circuit part 6. Further, in the middle cover part 71 of the present embodiment, the windows 710 are formed in accordance with the positions of the non-charging part of the second circuit part 3 (specifically, the operation part of the second electric device 32), the non-charging part of the load circuit part 4 (specifically, the operation part of the load electric device 42), and the non-charging part of the relay circuit part 6 (specifically, the operation part of the relay electric device 62).

The second electric device 32 and the load electric device 42 are arranged in a state in which the operation direction of the operation part is aligned with the first direction, and the relay electric device 62 is arranged in a state in which the operation direction of the operation part is aligned with the second direction. As described above, the second electric appliance 32 and the load electric appliance 42 arranged at the positions close to each other are arranged so that the operation direction of the operation part is the same, and the relay electric appliance 62 arranged at the position away from the second electric appliance 32 and the load electric appliance 42 is arranged so that the operation direction of the operation part is different from the operation direction of the operation part of the second electric appliance 32 and the load electric appliance 42.

As shown in FIG. 99, the cover structure 8 includes a first cover part 80 that covers first conductive connection part 23, a second cover part 81 that covers the second conductive connection part 33, and a third cover part 82 that covers the loaded conductive connection part 43.

The first cover part 80 includes a first protection part 800 that covers the proximal end part of the first conductive part 231, and a second protection part 801 that covers the distal end part of the first conductive part 231 and the second conductive part 232.

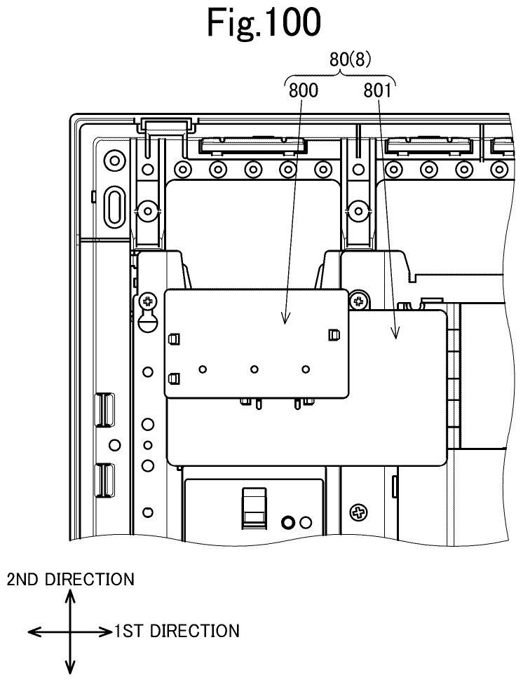

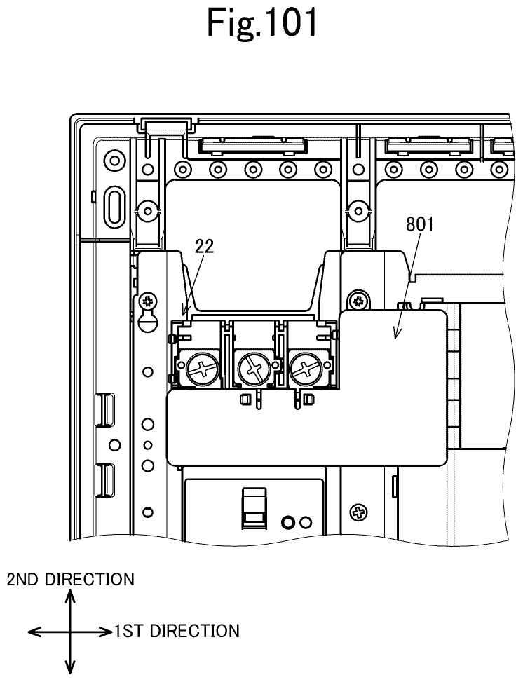

The first protective part 800 and the second protective part 801 are detachable separately, in a state in which the second protective part 801 covers the distal end side and the second conductive part 232 than the proximal end part of the first conductive part 231 from the front side, the first protective part 800 covers the proximal end part of the first conductive part 231 from the front side closed state, the first protective part 800 is configured to be switchable to an open state of opening the front of the proximal end part of the first conductive part 231 (see FIGS. 100 and 101).

Further, in a state in which both the first protection part 800 and the second protection part 801 are installed, the first protection part 800 is disposed on the front side in the front-rear direction relative to the second protection part 801, and the outer peripheral edge part of the first protection part and the outer peripheral edge part of the second protection part 801 are in a state of part overlapping with each other.

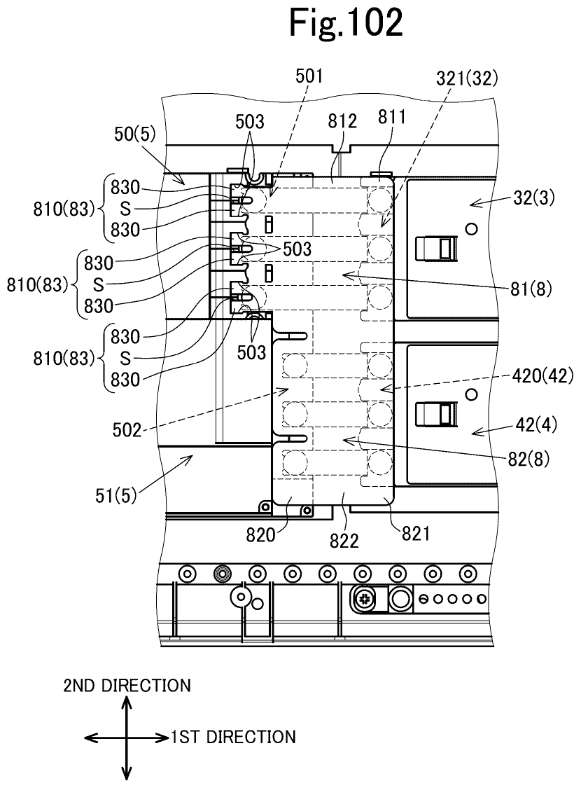

The second cover part 81 and the third cover part 82 are integrally formed by one member, in order to ensure the mounting and fixing of the cover, the second side terminal part 501 for the first phase (first phase terminal part 501a), the second side terminal part 501 for the second phase (second phase terminal part 501b), the second side terminal part 501 for the third phase (third phase terminal part 501c) It is formed with an engaging part that engages the insulating wall for maintaining the insulating between the respective phases. The engagement parts are arranged side by side in the second direction so as to correspond to the second-side terminal part 501 of the respective phases, and end part is formed to extend in the first direction. In addition, end part is provided with slits that divide end part in the second direction, so that it is easy to engage with the insulating walls. Incidentally, the engaging part provided in the second cover part 81 and the third cover part 82, the load-side terminal part 502 for the first phase (first phase terminal part 502a), the load-side terminal part 502 for the second phase (second phase terminal part 502b), the load-side terminal part 502 for the third phase (third phase terminal part 502c) may be formed with an engaging part that engages with the insulating walls for maintaining the insulating between the respective phases. The second cover part 81 and the third cover part 82 are integrally formed, but the second cover part 81 and the third cover part 82 may be separate members (see FIG. 102).

In the present embodiment, since the first side terminal part 500 disposed toward the device primary terminal part 220 can be connected along the first direction to end part 2310 of the first conductive part 231 extending in the first direction, a clearance for inserting the first conductive P110 into the inside and outside of the housing 7 can be secured on one side in the second direction of the first electric device 22 and changeover switch 5. In particular, as shown in FIGS. 94 and 98, when the first conductor P110 is linear (e.g., formed by bundling a plurality of metal wires), a clearance for bending the first conductor P110 can be secured on one side of the first electric device 22 and changeover switch 5 in the second direction.

Further, since the device primary terminal part 220 is disposed toward one side in the second direction, the first conductor 7010a and the device primary terminal part 220 can be connected to each other by using the first electric device 22 and the space on one side in the second direction of changeover switch 5 while considering the bending radius of the first conductor P110 inserted into the inside of the housing 7 from the first conductor insertion part P110 and the position of the first electric device 22 and changeover switch 5.

Further, the device primary terminal part 220 disposed toward one side in the second direction is connected to the first conductive P110 in the second direction, and the first side terminal part 500 is connected along the first direction with end part 2310 of the first conductive part 231, whereby the power flow from the outside of the housing 7 is performed in the second direction, and the electrical connection between the first electric device 22 and changeover switch 5 inside the housing 7 can be performed in the first direction. Therefore, the first conductive P110 and the first circuit part 2, the first circuit part 2, and changeover switch 5 can be visually distinguished from each other.

Further, since the switching-side first conductor insertion part 7010ab is formed on one side of the second electric device 32 and the load electric device 42 in the second direction, the first conductor P110 can be inserted from the outside to the inside of the housing 7 via the switching-side first conductor insertion part 7010ab.

Further, since the first conductor insertion part 7010a is formed on one side of the first electric device 22 and changeover switch 5 arranged side by side in the first direction and the second electric device 32 in the second direction, the first conductor P110 is easily inserted from the outside to the inside of the housing 7.

Further, the switching-side first conductor insertion part 7010ab is disposed directly above changeover switch 5 and the second electric device 32, so that the switching-side first conductor insertion part 7010ab is formed to be wide in the first direction, and the first conductor P110 is easily inserted into the housing 7.

Further, the first side first conductor insertion part 7010aa, in the second direction, since it is formed wider than the relay conductor insertion part 7010d, via the first side first conductor insertion part 7010aa, the first conductor P110 inside the housing 7 easily inserted.

Further, it is easy to connect to the device primary terminal part 320 and the load device secondary terminal part 421 via the second conductor insertion part 7010b and the load conductor insertion part 7010c formed on the other side in the first direction of each of the device primary terminal part 320 and the load device secondary terminal part 421, respectively, the second conductor P220 and the load conductor W110 inserted into the inside of the housing 7.

Further, since the load conductor insertion part 7010c and the second conductor insertion part 7010b is formed so as to extend to one side and the other side in the second direction, via the load conductor insertion part 7010c and the second conductor insertion part 7010b, respectively, when inserting the second conductor P220 and the load conductor W110 from the outside to the inside of the housing 7, considering the bending radius of the second conductor P220 and the load conductor W110 and the position of the respective electric devices, the second conductor P220 and the load conductor W110 can be inserted from the outside to the inside of the housing 7, it is easy to wire.

As described above, according to the present embodiment, it is possible to insert the first conductor changeover switch 5 or the first conductor insertion part 7010a on one side in the second direction of the first electric device 22 into the outer side and the inner side of the housing 7, and to connect the first conductor P110 to the device primary terminal part 220 while considering the bending radii of the first conductor P110, the positions of the first electric device 22 and changeover switch 5, and the like, so that it is easy to wire the first conductor P110.

Further, in the present embodiment, changeover switch 5 is disposed on one side in the first direction, the load electric device 42 is disposed on the other side in the first direction, and the housing 7 has the load conductor insertion part 7010c formed on the other side in the first direction of the load electric device 42, so that the load conductor W110 can be inserted into the outer side and the inner side of the housing 7 from the load conductor insertion part 7010c formed in the first direction in which changeover switch 5 and the load electric device 42 are arranged side by side.

Further, by the load conductor insertion part 7010c extends to one side and the other side in the second direction, it is possible to secure a space for inserting the load conductor W110 to the outside and the inside of the housing 7, considering the bending radius of the load conductor W110, the load conductor W110 can be inserted from the outside to the inside of the housing 7.

Further, in the present embodiment, the second electric device 32 and the load electric device 42 are arranged side by side in the second direction, and since the second conductor insertion part 7010b is formed on the other side in the first direction of the second electric device 32 in the housing 7, the second conductor P220 and the load conductor W110 can be inserted into the housing 7 from the second conductor insertion part 7010b and the load conductor insertion part 7010c on the other side in the first direction of the second electric device 32 and the load electric device 42 arranged in the second direction, respectively.

Further, since the second conductor insertion part 7010b and the load conductor insertion part 7010c are also used, the load conductor W110 can be inserted from the outside to the inside of the housing 7 while considering the bending radii and the arrangement of the second conductor P220.

As described above, in the present embodiment, a space for inserting the load conductor W110 can be secured inside the housing 7, and the load conductor W110 can be inserted from the outside to the inside of the housing 7 in view of the bending radius of the load conductor W110, so that the load conductor W110 can be easily wired.

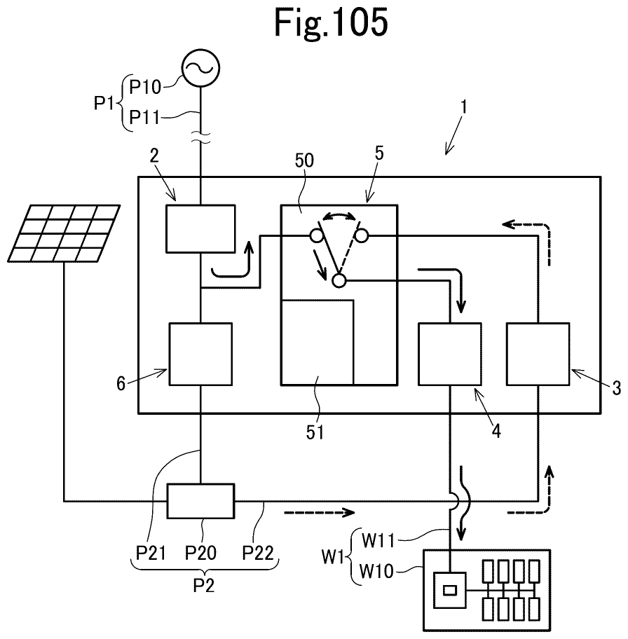

Next, changeover switch built-in board 1 according to the second embodiment of the present disclosure will be described referring to FIGS. 105 to 107. Note that, in describing changeover switch built-in board 1 according to the second embodiment, configurations and operations that differ from those of changeover switch built-in board 1 according to the first embodiment will be described, and descriptions of the same configurations and operations will be omitted.

In the second circuit part 3 of the second embodiment, the device primary terminal part 320 and the device secondary terminal part 321 are arranged side by side in the second direction, and the arrangement position of the device primary terminal part 320 in the first direction and the arrangement position of the device secondary terminal part 321 in the first direction are the same. In the second embodiment, the device primary terminal part 320 is disposed to face the other side in the second direction, and the device secondary terminal part 321 is disposed to face the one side in the second direction. Further, the second electric device 32 of the second embodiment is disposed on the other side of the switching control part 51 in the first direction.

In a second embodiment, the first phase terminal part 320a, the second phase terminal part 320b, and the third phase terminal part 320c of the device primary terminal part 320 are arranged to align with each other in a first direction. In addition, the first phase terminal part 321a, the second phase terminal part 321b, and the third phase terminal part 321c of the device secondary terminal part 321 are arranged so as to be aligned with each other in the first direction.

The second conductive connection part 33 of the second embodiment extends in the first direction and the second direction, and thus differs from the first embodiment. The second conductive connection part 33 includes one end 330 connected to the second-side terminal part 501, a second conductive part 331 extending from the one end 330 in the second direction, a first conductive part 332 extending in the first direction continuously with the second conductive part 331, and the other end 333 connected to the device secondary terminal part 321.

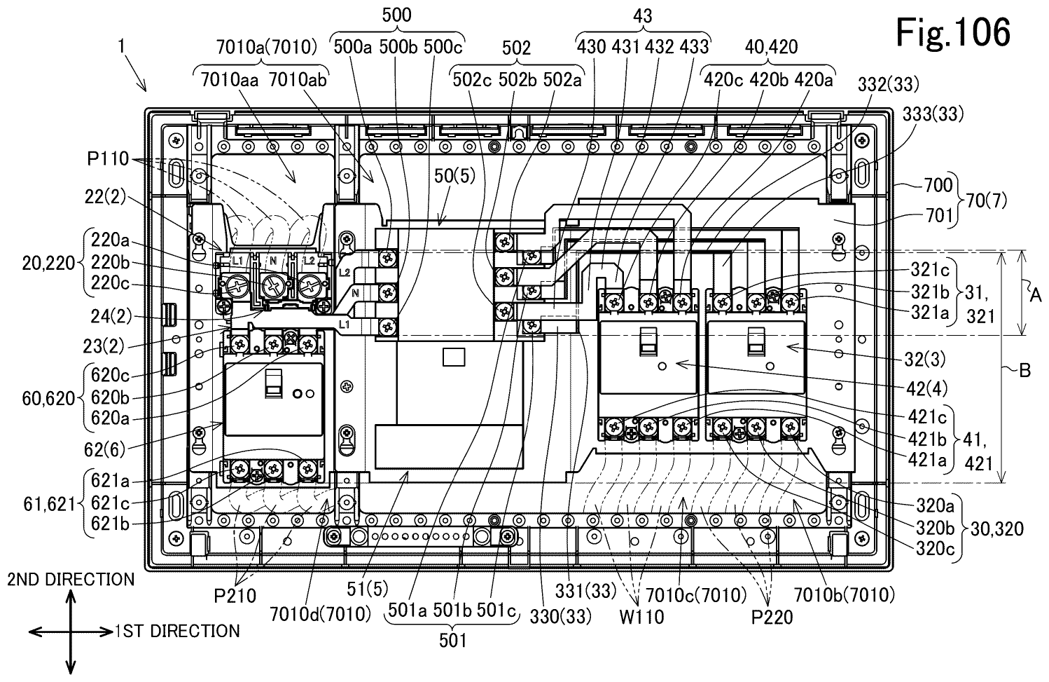

Specifically, as shown in FIG. 106, the second conductive part 331 extends from one end 330 extending in the first direction to one side in the second direction, the first conductive part 332 extends from the second conductive part 331 to the other side in the first direction, and the other end 333 extends from the first conductive part 332 to the other side in the second direction.

The second circuit part 3 of the second embodiment also has three second conductive connection part 33 (not shown, but a first phase conductive connection 33a, a second phase conductive connection 33b, and a third phase conductive connection 33c). Further, in the three second conductive connection part 33, one end part 330 is aligned along the second direction, the second conductive part 331 are aligned along the first direction, the first conductive part 332 are aligned along the second direction, and the other end parts 333 are aligned along the first direction.

In the load circuit part 4 of the second embodiment, the load device primary terminal part 420 and the load device secondary terminal part 421 are arranged to be aligned in the second direction, and the arrangement position of the load device primary terminal part 420 in the first direction and the arrangement position of the load device secondary terminal part 421 in the first direction are the same. In the second embodiment, the load device primary terminal part 420 is provided at one end of the load electrical device 42 in the second direction, and the load device secondary terminal part 421 is provided at the other end of the load electrical device 42 in the second direction. Further, the load electrical device 42 of the second embodiment is disposed on the other side of the switching control part 51 in the first direction.

The load electrical device 42 of the second embodiment is arranged so as to be arranged at a position spaced apart from the second electrical device 32 in the first direction. The load-electric device 42 is disposed on the other side of changeover switch 5 in the first direction. The load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

Further, in the second embodiment, the first phase terminal part 420a, the second phase terminal part 420b, and the third phase terminal part 420c of the primary terminal part 420 are arranged in the first direction. The first phase terminal part 421a, the second phase terminal part 421b, and the third phase terminal part 421c of the secondary terminal part 421 are also arranged (aligned) in the first direction.

The conductive connection part 43 of the second embodiment extends in the first direction and the second direction, and thus differs from the first embodiment. As shown in FIG. 106, the load conductive connection part 43 includes one end 430 connected to the load-side terminal part 502, a second conductive part 431 extending in the second direction from the one end 430, a first conductive part 432 extending in the first direction from the second conductive part 431, and the other end 433 connected to the load device primary terminal part 420.

Specifically, the second conductive part 431 extends from one end 430 extending in the first direction to one side in the second direction, the first conductive part 432 extends from the second conductive part 431 to the other side in the first direction, and the other end 433 extends from the first conductive part 432 to the other side in the second direction.

The load circuit part 4 of the second embodiment also has three load conductive connection part 43 (a first phase conductive connection 43a, a second phase conductive connection 43b, and a third phase conductive connection 43c). Further, in the three load-conducting connection part 43, one end part 430 is aligned along the second direction, the second conductive part 431 are aligned along the first direction, the first conductive part 432 are aligned along the second direction, and the other end parts 433 are aligned along the first direction.

As shown in FIG. 106, the loaded conductive connection part 43 of the second embodiment is disposed in front of the second conductive connection part 33 in the front-rear direction in the housing 7. Therefore, the loaded conductive connection part 43 and the second conductive connection part 33 overlap each other in the front-rear direction while the inside of the housing 7 is viewed from the front.

In changeover switch 5 of the second embodiment, the load-side terminal part 502 is disposed at one end of the first embodiment in the second direction. Here, as shown in FIG. 106, in the load-side terminal part 502, the second phase terminal part 502b and the third phase terminal part 502c are disposed in the band-shaped area A. Therefore, the load-side terminal part 502 of the second embodiment is disposed at substantially the same position as the second-side terminal part 501 in the second direction. Specifically, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a.

The load-side terminal part 502 of the second embodiment is disposed on one side of the second side terminal part 501 in the first direction. Further, the load-side terminal part 502 is disposed forward and backward of the second-side terminal part 501. Therefore, as shown in FIG. 106, in the second embodiment, one end part 430 connected to the second side terminal part 501 is disposed rearward and one end part 430 connected to the load-side terminal part 502 is disposed forward in the front-rear direction.

The second-side terminal part 501 and the load-side terminal part 502 of the second embodiment are arranged in the same direction in the first direction. Further, in the second embodiment, unlike the first embodiment, the second side terminal part 501 and the load side terminal part 502 are disposed to face the other side in the first direction, and second secondary terminal part 31 and the load primary terminal part 40 are disposed to face the one side in the second direction.

As shown in FIG. 105, the switching control part 51 of the second embodiment is configured to switch the switching main body 50 between the first power supply state and the second power supply state by operating the switching main body 50 in the same manner as the first embodiment.

The switching-side first conductive insertion part 7010ab of the second embodiment is disposed over changeover switch 5, the load-side electric device 42, and the second electric device 32. In addition, as in the first embodiment, the switching-side first conductive insertion part 7010ab is formed to cover the entire area of changeover switch 5 and the second electric device 32 in the first direction. Here, the switching-side first conductive insertion part 7010ab of the second embodiment is formed so as to extend over the entire area of the load-electric device 42 in the first direction. Therefore, the switching-side first conductive insertion part 7010ab of the second embodiment is formed to correspond to the entire length of changeover switch 5, the second electric device 32, and the loading electric device 42 in the first direction.

The second conductor-insertion part 7010b of the second embodiment is provided on the other side of the strip-shaped area A and the device primary terminal part 320 of the second electric device 32 in the second direction. The second conductive insertion part 7010b is formed to extend in the first direction. Therefore, in the second embodiment, the second conductor P220 can be inserted into and out of the housing 7 via the second conductor insertion part 7010b on the other side in the second direction.

The load conductor insertion part 7010c of the second embodiment is provided on the other side in the second direction than the load device secondary terminal part 421 of the load electric device 42. The load-conductor insertion part 7010c is formed so as to extend in the first direction. Therefore, in the second embodiment, the load conductor W110 can be inserted into and out of the housing 7 via the load conductor insertion part 7010c on the other side in the second direction.

The load-conductor insertion part 7010c and the second conductor insertion part 7010b of the second embodiment are formed so as to be aligned in the first direction, and are continuous with each other. Further, the load conductor insertion part 7010c and the second conductor insertion part 7010b of the second embodiment are disposed over changeover switch 5, the load electric device 42, and the second electric device 32. Therefore, the load-conductor insertion part 7010c and the second conductor insertion part 7010b are formed so as to extend to one side and the other side in the first direction. Further, the load-conductor insertion part 7010c and the second conductor insertion part 7010b of the second embodiment are formed to have substantially the same length as the switching-side first conductor insertion part 7010ab in the first direction.

Therefore, the second conductor insertion part 7010b of the second embodiment extends to one side in the first direction from the second electric device 32, and the load conductor insertion part 7010c extends to one side and the other side in the first direction from the load electric device 42. Specifically, the second conductor insertion part 7010b and the loaded conductor insertion part 7010c extend from the other side of the second electric device 32 in the second direction to the other side of changeover switch 5 in the second direction. The load conductor insertion part 7010c may be configured to extend from the other side of the load electric device 42 in the second direction to the other side of changeover switch 5 in the second direction.

In addition, the load-conductor insertion part 7010c and the second conductor insertion part 7010b of the second embodiment are formed to be larger than the switching-side first conductor insertion part 7010ab in the second direction.

Unlike the first embodiment, the continuous insertion part (not numbered) of the second embodiment is formed so as to correspond to the entire area of the second electric device 32 and the load electric device 42 arranged side by side in the first direction in the first direction. Specifically, the continuous insertion part is formed so as to extend from a position immediately below the second electric device 32 to a position immediately below the load electric device 42 in the first direction.

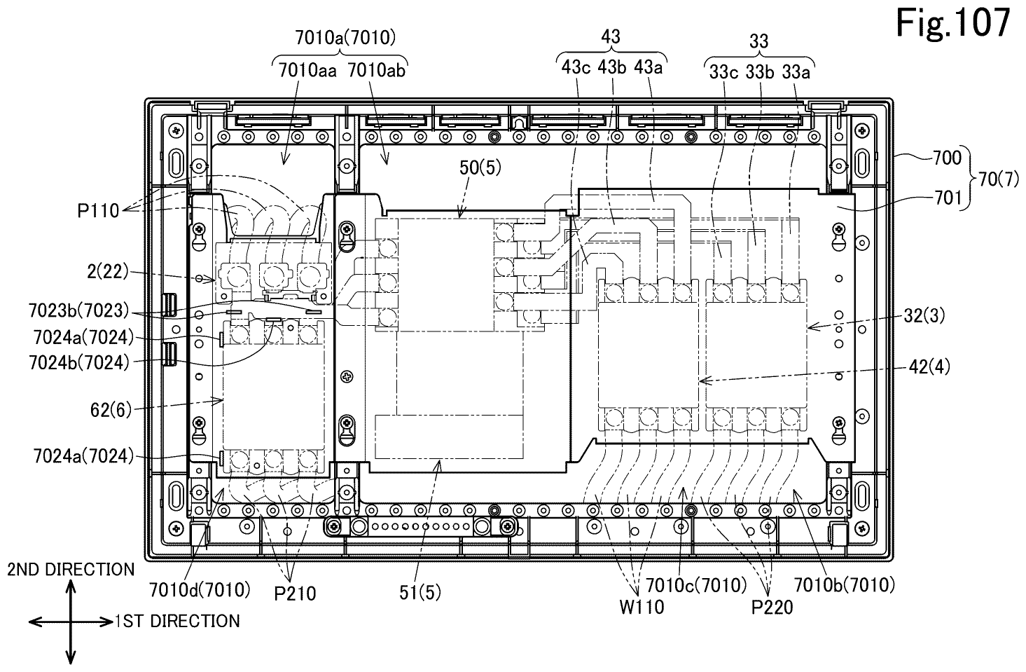

As illustrated in FIG. 107, the positioning structure 702 of the second embodiment includes a first circuit-part positioning part 7023 and a relay circuit part positioning part 7024. Although FIG. 107 omits the second circuit part position determination part 7020, the load circuit part positioning part 7021, and the changeover switch positioning part 7022, the position determination structure 702 may include the second circuit part position determination part 7020, the load circuit part positioning part 7021, and the changeover switch positioning part 7022.

In the second embodiment, the second electric device 32 and the loading electric device 42 are arranged such that the operation direction of the operation part is aligned with the second direction. Therefore, in the second embodiment, the second electric device 32, the load electric device 42, and the relay electric device 62 are arranged in the same direction as the operation direction of the operation part.

In the second embodiment, the load electrical device 42 and the second electrical device 32 are arranged side by side in the first direction. For this reason, the load communication part and the second communication part of the second embodiment are arranged side by side in the first direction.

In the second embodiment, the load conductor insertion part 7010c and the second conductor insertion part 7010b are formed larger than the switching-side first conductor insertion part 7010ab in the second direction, and therefore, from each of the load conductor insertion part 7010c and the second conductor insertion part 7010b, the second conductor P220 and the load conductor W110 are easily inserted from the outside to the inside of the housing 7.

In the second embodiment, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a. Further, the load-side terminal part 502 is disposed forward and backward of the second-side terminal part 501. Therefore, it is possible to secure an insulating distance between the load-side terminal part 502 and the second-side terminal part 501 which are arranged at substantially the same position in the second direction.

Changeover switch 5 is disposed on one side of the first direction, the load electric device 42 is disposed on the other side of the first direction, and the housing 7 has the load conductor insertion part 7010c formed on the other side of the load electric device 42 in the second direction, so that the load conductor W110 can be inserted into the outer side and the inner side of the housing 7 from the load conductor insertion part 7010c formed in the second direction perpendicular to the first direction in which changeover switch 5 and the load electric device 42 are disposed side by side.

Further, by the load conductor insertion part 7010c extends to one side and the other side of the first direction, it is possible to secure a space for inserting the load conductor W110 to the outside and the inside of the housing 7, considering the bending radius of the load conductor W110, the load conductor W110 can be inserted from the outside to the inside of the housing 7.

Further, since changeover switch 5, the second electric device 32, and the load electric device 42 are arranged side by side in the first direction, and the second conductor insertion part 7010b is formed on the other side in the second direction of the second electric device 32 in the housing 7, the second conductor P220 and the load conductor W110 can be inserted into the housing 7 from the second conductor insertion part 7010b and the load conductor insertion part 7010c on the other side in the second direction of the second electric device 32 and the load electric device 42 arranged in the first direction, respectively.

Further, since the second conductor insertion part 7010b and the load conductor insertion part 7010c are also used, when inserting the load conductor W110 from the load conductor insertion part 7010c to the outside and inside of the housing 7, so that the load conductor W110 is not damaged, while giving a margin to the bending of the load conductor W110, the load conductor W110 can be inserted from the outside to the inside of the housing 7.

Next, changeover switch built-in board 1 according to the third embodiment will be described. In describing changeover switch built-in board 1 according to the third embodiment, configurations and operations that differ from those of changeover switch built-in board 1 according to the first and second embodiments will be described, and description of the same configurations and operations will be omitted.

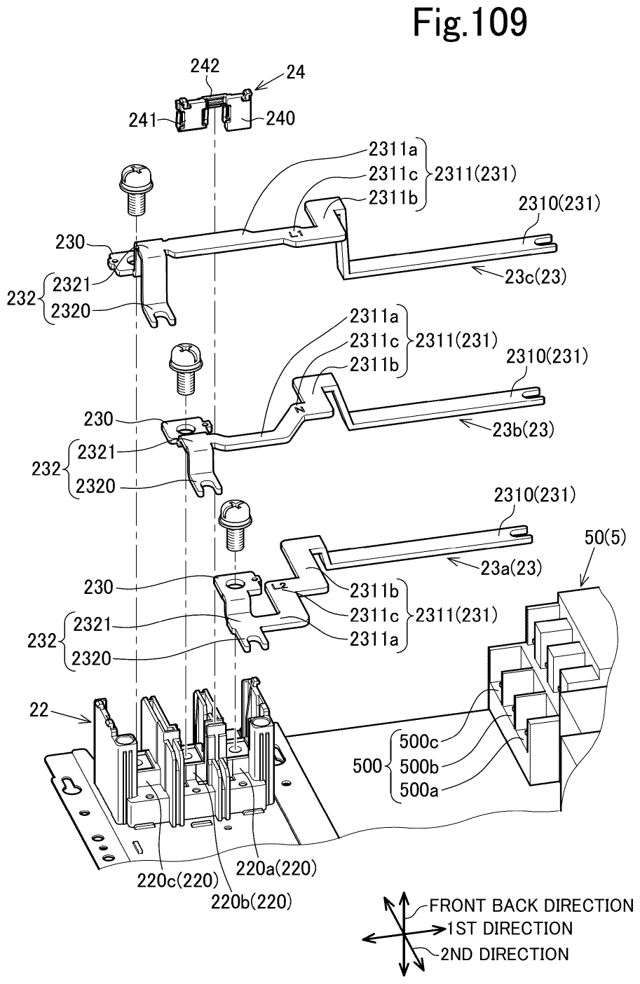

As shown in FIG. 109, first conductive connection part 23 of the third embodiment differs in form from the first embodiment and the second embodiment. Specifically, end part 2310 is formed longer in the first direction than in the first and second embodiments. In addition, unlike the first embodiment and the second embodiment, the distal end-side conductive part 2311b is formed to be long in the second direction.

In the second circuit part 3 of the third embodiment, as in the second embodiment, the device primary terminal part 320 and the device secondary terminal part 321 are arranged so as to be aligned in the second direction. Further, the device primary terminal part 320 is disposed to face the other side in the second direction, and the device secondary terminal part 321 is disposed to face the one side in the second direction.

In the third embodiment, the second electric device 32 is arranged so that the device secondary terminal part 321 is arranged on the other side of the second side terminal part 501501 of changeover switch 5 in the second direction. Specifically, the second electrical device 32 is disposed on the other side of the switching control part 51 in the first direction.

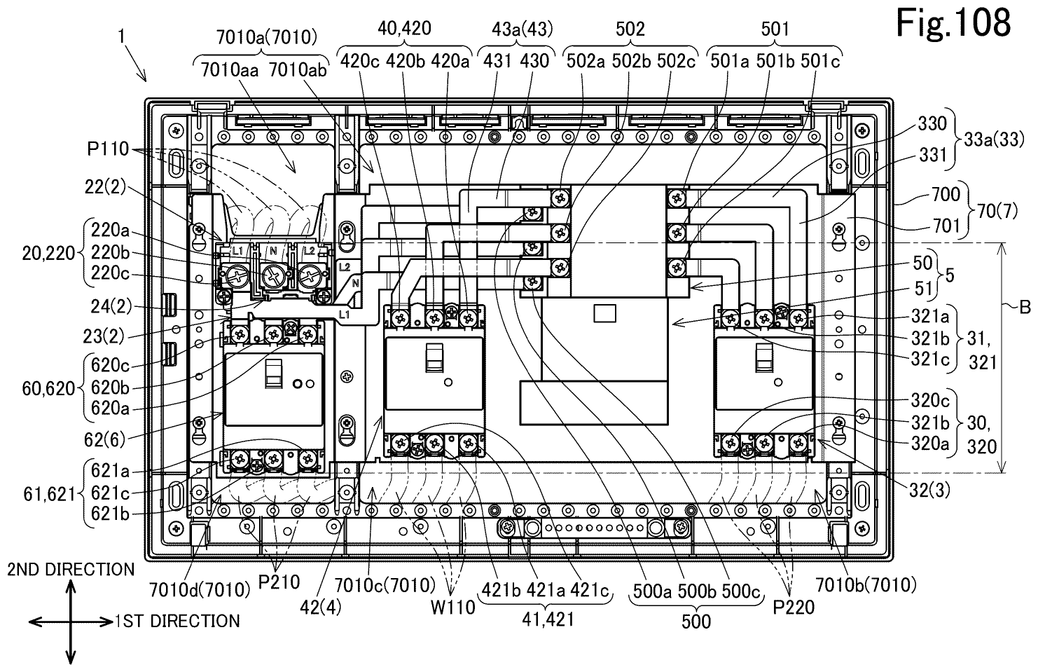

The second conductive connection part 33 of the third embodiment is shaped differently from the first embodiment and the second embodiment. The second conductive connection part 33 includes one end 330 connected to the second-side terminal part 501 and the other end 331 connected to the device secondary terminal part 321. As shown in FIG. 108, one end 330 extends in a first direction and the other end 331 extends in a second direction. The second conductive connection part 33 has one end part 330 and the other end part 331 formed continuously.

The second circuit part 3 of the third embodiment also has three second conductive connection part 33 (not shown, but a first phase conductive connection 33a, a second phase conductive connection 33b, and a third phase conductive connection 33c). In the three second conductive connection part 33, one end part 330 is aligned along the second direction, and the other end parts 331 are aligned along the first direction.

In the load circuit part 4 of the third embodiment, similarly to the second embodiment, the load device primary terminal part 420 and the load device secondary terminal part 421 are arranged so as to be aligned in the second direction. Further, the load device primary terminal part 420 is disposed to face one side in the second direction, and the load device secondary terminal part 421 is disposed to face the other side in the second direction.

The loading circuit part 4 of the third embodiment is arranged on one side of changeover switch 5 in the first direction. Specifically, as shown in FIG. 108, the load electrical device 42 is disposed between the relay electrical device 62 and the switching control part 51 in the first direction. Therefore, in the third embodiment, the loading electrical device 42 is spaced apart from the second electrical device 32 in the first direction with respect to changeover switch 5. Further, the load electric appliance 42 is arranged such that the load appliance primary terminal part 420 is arranged on the other side of the load side terminal part 502 of changeover switch 5 in the second direction.

In addition, in the third embodiment, the load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

Connection part 43 of the third embodiment differs from the first and second embodiments in form. The load conductive connection part 43 includes one end 430 connected to the load-side terminal part 502 and the other end 431 connected to the load device primary terminal part 420. As shown in FIG. 108, one end 430 extends in a first direction and the other end 431 extends in a second direction. The loaded conductive connection part 43 has one end part 430 and the other end part 431 formed continuously.

As shown in FIG. 108, the loaded conductive connection part 43 of the third embodiment is disposed in front of first conductive connection part 23 in the front-rear direction in the housing 7. Therefore, the loaded conductive connection part 43 and first conductive connection part 23 overlap each other in the front-rear direction while the inside of the housing 7 is viewed from the front.

In changeover switch 5 of the third embodiment, unlike the second embodiment, the second side terminal part 501 and the load-side terminal part 502 are provided at separate ends in the first direction of changeover switch 5. Specifically, the load-side terminal part 502 is arranged so as to face one side of the first direction and one side of the first direction than the second-side terminal part 501.

In addition, in the third embodiment, the first side terminal part 500 and the second side terminal part 501 are disposed at different positions in the second direction. Here, the load-side terminal part 502 and the second-side terminal part 501 are arranged side by side in the first direction. Therefore, in the second direction, the third phase terminal part 502c is disposed between the second phase terminal part 500b and the third phase terminal part 500c, the second phase terminal part 502b is disposed between the first phase terminal part 500a and the second phase terminal part 500b, and the first phase terminal part 502a is disposed on one side of the first phase terminal part 500a.

Further, in the third embodiment, the load-side terminal part 502 is disposed forward and backward of the first-side terminal part 500. Therefore, as shown in FIG. 108, in the third embodiment, in the front-rear direction, one end part 430 connected to the load-side terminal part 502 and end part 2310 connected to the first-side terminal part 500 are disposed on the rear side is disposed on the front side.

As in the second embodiment, the switching-side first conductive insertion part 7010ab of the third embodiment is disposed over changeover switch 5, the load-side electric device 42, and the second electric device 32.

The second conductive insertion part 7010b of the third embodiment is provided on the other side of the second electric device 32 in the second direction with respect to the device primary terminal part 320 as in the second embodiment. Further, the second conductive insertion part 7010b is formed so as to extend to one side in the first direction. The second conductive insertion part 7010b of the third embodiment extends from the other side in the second direction of the second electric device 32 to the other side in the second direction of the loading electric device 42 via the other side in the second direction of changeover switch 5.

As in the second embodiment, the load conductor insertion part 7010c of the third embodiment is provided on the other side of the load device secondary terminal part 421 of the load electric device 42 in the second direction. The load-conductor insertion part 7010c is formed so as to extend to the other side in the first direction. The load conductor insertion part 7010c extends from the other side in the second direction of the load electrical device 42 to the other side in the second direction of the second electrical device 32 via the other side in the second direction of changeover switch 5. Further, the load conductor insertion part 7010c is formed on the other side of the relay conductor insertion part 7010d in the first direction with a part of the back surface part 701 along a virtual straight line in the second direction passing between the relay electric device 62 and the load electric device 42 as a border.

The load-conductor insertion part 7010c and the second conductor insertion part 7010b of the third embodiment are formed so as to be aligned in the first direction, as in the second embodiment, and are continuous with each other. In addition, the load-conductor insertion part 7010c and the second conductor insertion part 7010b are formed to have substantially the same length as the switching-side first conductor insertion part 7010ab in the first direction.

As in the second embodiment, the continuous insertion part (not numbered) of the third embodiment is formed so as to extend from directly under the second electric device 32 to directly under the load electric device 42. Here, in the third embodiment, changeover switch 5 is disposed between the loading circuit part 4 and the second circuit part 3. Therefore, unlike the second embodiment, the continuously inserted part of the third embodiment is formed so as to extend directly under the second electric device 32, changeover switch 5, and the loading electric device 42.

In the third embodiment, the second electric device 32 is arranged such that the device secondary terminal part 321 is arranged on the other side in the second direction than the second side terminal part 501501 of changeover switch 5, and the load electric device 42 is arranged such that the load device primary terminal part 420 is arranged on the other side in the second direction than the load side terminal part 502 of changeover switch 5. Therefore, as shown in FIG. 108, the second conductive connection part 33 and the loaded conductive connection part 43 can have a simple configuration including one end part 330 and 430 extending in the first direction and 331,431 extending in the second direction.

Note that changeover switch built-in board is not limited to the first embodiment, the second embodiment, and the third embodiment (hereinafter, referred to as the above embodiment), and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply. For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the load device primary terminal part 420 and the load device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the device primary terminal part 220 of the first electric device 22 is configured to have the first phase terminal part 220a, the second phase terminal part 220b, and the third phase terminal part 220c, but is not limited to this configuration. For example, in the case of having only the first phase terminal part 220a, in addition to the case of having the first phase terminal part 220a and the second phase terminal part 220b, in the case of having the first phase terminal part 220a, the second phase terminal part 220b, and the third phase terminal part 220c, it may also be a case of having the fourth phase terminal part. That is, the device primary terminal part 220 may include at least a first phase terminal part 220a.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

In addition, the second conductive part 232 may be integrally formed with the first conductive part 231 as in the above-described embodiment, or may be separately attached to the first conductive part 231.

In the above embodiment, the first circuit part 2 is configured to have three first conductive connection part 23, but is not limited to this configuration, for example, the first circuit part 2 may be configured to have one first conductive connection part 23, or may be configured to have two or four or more first conductive connection part 23. That is, the first circuit part 2 may be configured to have at least one first conductive connection part 23.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2. As a result, the load circuit part 4 can be electrically disconnected from the first power supply system P1 and the second power supply system P2, and can further improve electric safety such as when inspecting the load device or the like connected to the load circuit part 4.

Although not specifically mentioned in the above embodiment, first conductive connection part 23 may be configured so that the second conductive part 232 is also screwed to the first electric device 22. In this case, for example, as shown in FIGS. 105 and 106, the first electrical device 22 may be provided with a fixing base part 25 having a screw hole formed therein.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

Further, in the above embodiment, the first side terminal part 500 and the second side terminal part 501 are arranged in a straight line in the first direction and the arrangement positions in the second direction are the same position, but the present invention is not limited thereto, and for example, the arrangement positions of the first side terminal part 500 and the second side terminal part 501 in the second direction may be different from each other.

In the above embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the above embodiment, the second side terminal part 501 and the load side terminal part 502 are arranged in the second direction, and the second side terminal part 501 is arranged on one side in the second direction, and the load side terminal part 502 is arranged on the other side in the second direction, but the present invention is not limited thereto, and for example, the second side terminal part 501 may be arranged on the other side in the second direction and the load side terminal part 502 may be arranged on one side in the second direction. In this case, it is conceivable that the second circuit part 3 is arranged on the other side in the second direction and the loading circuit part 4 is arranged on the one side in the second direction.

In the description of the strip-shaped area A of the above embodiment, the arrangement position of the first side terminal part 500 and the arrangement position of the second side terminal part 501 in the second direction has been given an example of the same, for example, the arrangement position of the first side terminal part 500 in the second direction and the arrangement position of the second side terminal part 501 are different from each other even in the second direction, the first phase terminal part 500a and the second side terminal part 501 of the first side terminal part 500 in the second direction it may be a strip-shaped area A area extending in a range including up to the third phase terminal part 501c of the third phase terminal part 500c and the second side terminal part 500 of the first side terminal part 501a.

In the above embodiment, changeover switch built-in board 1 includes the load circuit part 4, but the present invention is not limited thereto, and for example, changeover switch built-in board 1 may not include the load circuit part 4. A load conductor W110 may be connected to the load-side terminal part 502 of changeover switch 5.

In the load electric device 42 of the above embodiment, the load device primary terminal part 420 is provided at one end of the first direction, and the load device secondary terminal part 421 is provided at the other end of the first direction. However, the present invention is not limited thereto, and for example, in the load electric device 42, the load device primary terminal part 420 may be provided at the other end part in the first direction, and the load device secondary terminal part 421 may be provided at the one end part in the first direction.

In addition, changeover switch 5 may include a first side terminal part 500 and a load-side terminal part 502 at one end in the first direction. Here, the first side terminal part 500 and the load side terminal part 502 may be arranged so as to be oriented in the same direction in the first direction and aligned in the second direction. In addition, the loading circuit part 4 may be disposed on one side of changeover switch 5 in the first direction.

In the above embodiment, the arrangement positions of the device primary terminal part 320 and the device secondary terminal part 321 of the second electric device 32 in the second orientation are the same. However, the present invention is not limited thereto, and for example, the arrangement positions of the device primary terminal part 320 and the device secondary terminal part 321 of the second electric device 32 in the second direction may differ from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, the first conductive insertion part 7010a is provided on one side of first primary terminal part 20 or changeover switch 5 in the second direction. However, the present invention is not limited thereto, and for example, the first conductive insertion part 7010a may be disposed on one side of first primary terminal part 20 in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

The first conductor-insertion part 7010a may be provided in the second direction just above one side of first primary terminal part 20 or just above one side of changeover switch 5.

In the above embodiment, as shown in FIG. 94, the positions of the second-side terminal part 501 and the load-side terminal part 502 in the first direction differ from each other. However, for example, the second-side terminal part 501 and the load-side terminal part 502 may be arranged such that their positions in the first direction are the same (that is, they are arranged along an imaginary straight line extending in the second direction).

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the above embodiment, the arrangement positions of the device primary terminal part 320 and the device secondary terminal part 321 are the same in the second orientation. However, the present invention is not limited thereto, and for example, the device primary terminal part 320 and the device secondary terminal part 321 of the second electric device 32 may be arranged at different positions in the second direction.

In the above embodiment, the load circuit part 4 includes the load electric device 42 as a circuit breaker, but the present invention is not limited thereto, and the load circuit part 4 may be configured to include the power distribution circuit part. Specifically, the load circuit part 4 may be configured to include a main switch connected to the load side terminal part 502 of changeover switch 5, and a plurality of branch switches connected to the secondary side of the main switch via a bus. The housing 7 is sized to accommodate the power distribution circuit part as well.

In the above-described embodiment, since the device primary terminal part 220 also serves as the device secondary terminal part, the device secondary terminal part is arranged so as to be directed in the second direction, but the present invention is not limited thereto, and for example, the device primary terminal part 220 and the device secondary terminal part may be configured so as to be separate from each other, and the device secondary terminal part and the first-side terminal part 500 may be configured so as to face each other in the first direction.

In the above embodiment, the second circuit part 3 is disposed on the other side of the first circuit part 2 and changeover switch 5 in the first direction, but the present invention is not limited thereto, and for example, the second circuit part 3 may be disposed on the one side of the first circuit part 2 and changeover switch 5 in the first direction. The same applies to the load circuit part 4, and the load circuit part 4 may be disposed on one side of the first circuit part 2 and changeover switch 5 in the first direction.

In the third embodiment, the second circuit part 3 is disposed on the other side of changeover switch 5 in the first direction and the load circuit part 4 is disposed on the one side of changeover switch 5 in the first direction, but the present invention is not limited thereto, and the second circuit part 3 may be disposed on the one side of changeover switch 5 in the first direction and the load circuit part 4 may be disposed on the other side of changeover switch 5 in the first direction.

In the first embodiment, the load conductor insertion part 7014c and the second conductor insertion part 7010b have been described as being formed so as to extend to one side and the other side in the second direction, but the present invention is not limited thereto, and for example, the load conductor insertion part 7010c and the second conductor insertion part 7010b may be formed so as to extend to one side or the other side in the second direction.

In the above embodiment, the switching-side first conductor insertion part 7010ab is disposed directly above changeover switch 5 and the second electric device 32, but the present invention is not limited thereto, and for example, the switching-side first conductor insertion part 7010ab may be partitioned on one side and the other side of the first direction with a part of the second direction along a virtual straight line in the second direction passing between changeover switch 5 and the second electric device in the first direction as a border.

In the first embodiment, the load conductor insertion part 7010c is formed so as to extend to one side and the other side in the second direction, but the present invention is not limited thereto, for example, the load conductor insertion part 7010c may be configured so as to extend to one side or the other side in the second direction.

Although the load electric device 42 of the second embodiment has been described as being arranged so as to be arranged at a position spaced apart from the second electric device 32 in one direction, the load electric device 42 may be arranged on one side in the first direction and the other side in the first direction from the second electric device 32. Here, the second side terminal part 501 may be disposed forward in the front-rear direction and the load-side terminal part 502 may be disposed rearward in the front-rear direction.

In the second embodiment, the device primary terminal part 320 is disposed on the other side in the second direction and the device secondary terminal part 321 is disposed on one side in the second direction, but the device primary terminal part 320 may be disposed on one side in the second direction and the device secondary terminal part 321 may be disposed on the other side in the second direction. In addition, the load device secondary terminal part 421 may be disposed on one side in the second direction, and the load device primary terminal part 420 may be disposed on the other side in the second direction. For example, the device primary terminal part 320 and the loading device secondary terminal part 421 may be disposed on one side of the strip-shaped area A in the second direction.

In the above embodiment, the switching body part 50 is disposed on one side in the second direction, the switching control part 51 has been described as being disposed on the other side in the second direction, not limited thereto, for example, such that the switching body part 50 and the switching control part 51 are aligned in the first direction, the switching body part 50 and the switching control part 51 may be arranged so as to be aligned in the front-rear direction.

Next, a changeover switch built-in board according to another embodiment will be described. Changeover switch built-in board according to the present disclosure incorporates a changeover switch.

As a power supply switching device which is a conventional changeover switch built-in board, for example, there is a device described in Japanese Patent No. 5284832. The input side of the power switching device is connected to a commercial power supply line from a commercial power source and a generator power supply line from a generator power source, and the output side is connected to a load collectively.

In this power supply switching device, a line switch is inserted into the power supply side of the commercial power supply line, and a delay switch is inserted into the load side. Further, a timer control part as a delay part is interposed in the commercial power supply line side. On the other hand, on the generator power supply line side, a leakage breaker for countermeasures against leakage is inserted, a line switch is inserted on the power supply side, and a delay switch is inserted on the load side. Further, a timer control part is interposed in the generator power supply line side. In addition, the power supply switching devices of these electrical configurations are connected to a cabinet for a board by using a terminal block.

However, in the power switching device described in Japanese Patent No. 5284832, the line switch of each of the commercial power supply line side and the generator power supply side, the delay switch, and the timer control part are housed in a cabinet for a panel. Therefore, when the power supply switching device is operated in a state in which the line switch, the delay switch, and the timer control part are accommodated in the cabinet for the panel, each of the line switch, the delay switch, and the timer control part generates heat. Therefore, in the power supply switching device described in Japanese Patent No. 5284832, the line switch, the delay switch, by the heat generated by each of the timer control part remains in the cabinet for the panel, there is a possibility that leads to a failure of the various switches and the power supply switching device. Such a problem occurs not only when the power supply line to the load is automatically switched between the commercial power supply line and the generator power supply line, but also when the power supply line to the load is automatically switched between a plurality of power supply lines. Further, such a problem is not limited to the line switch, the delay switch, if the timer control part is housed in the cabinet for the board, occurs when the electrical device for generating heat in the cabinet is housed.

Therefore, an object of the present disclosure is to provide a changeover switch built-in board capable of performing heat dissipation.

The present invention comprises: Changeover switch built-in board is characterized in that includes changeover switch for switching a power supply for supplying electricity to a load to a first power supply system or a second power supply system, and a changeover switch and a load circuit part electrically connecting the load and changeover switch, and a housing for housing the changeover switch and the load circuit part, and the changeover switch includes a switching body part for switching between supply of electricity from the first power supply system and supply of electricity from the second power supply system, and a switching control part for controlling switching by the switching body part, and the load circuit part includes a load electric device electrically connected to the load system, and the changeover switch and the load electric device are arranged side by side in one of a first direction orthogonal to the front-rear direction and a second direction orthogonal to the front-rear direction and the first direction in the housing, and the housing formed with switching communication part that communicate between the inside and the outside of the housing on one side and the other side of the changeover switch in the other of the first direction and the second direction.

According to the configuration, since the switching communication part is formed on one side and the other side in the other direction of changeover switch in the housing, for example, air flowing inside the housing through the switching communication part on the other side in the other direction flows to the outside of the housing through the switching communication part on the one side in the other direction, so that air can flow in the other direction inside the housing to replace air inside the housing, and changeover switch and the load electric apparatus can be arranged side by side in the one direction in the housing, so that the flow of air inside the housing can be set in a direction perpendicular to the direction in which changeover switch and the load electric apparatus are arranged side by side.

In addition, in the present invention, the housing may have a load communication part that communicates the inside and the outside of the housing with one side and the other side of the load electrical device in the other direction.

According to the above configuration, since the load communication part is formed on one side and the other side of the other direction of the load electric apparatus, for example, air flowing inside the housing through the switching communication part and the load communication part on one side of the other direction flows to the outside of the housing through the switching communication part and the load communication part on the other side of the other direction, so that more air can flow in a direction perpendicular to the direction in which changeover switch and the load electric apparatus are arranged side by side, so that more air can be exchanged inside the housing.

In the present invention, the switching main body may be disposed on one side in the other direction, and the switching control part may be disposed on the other side in the other direction.

According to the configuration, since the switching main body part is disposed on one side of the other direction and the switching control part is disposed on the other side, for example, air flowing inside the housing through the switching communication part on the other side in the other direction flows from one side in the other direction to the outside of the housing, whereby the air can flow in the other direction inside the housing.

In addition, the present disclosure may include a relay circuit part including a relay electric device housed in the housing and electrically connected to the first power supply system and an external facility, wherein changeover switch and the relay electric device may be arranged side by side in the one direction, and a relay communication part that communicates the inside and the outside of the housing with one side and the other side in the other direction of the relay electric device may be formed in the housing.

According to the above configuration, since the relay communication part is formed on one side and the other side in the other direction of the relay electric apparatus, the air flowing inside the housing through the relay communication part on the other side in the other direction flows from one side in the other direction to the outside of the housing, whereby the air inside the housing can be exchanged, and since changeover switch and the relay electric apparatus are arranged side by side in the one direction, the air can flow in a direction perpendicular to the direction in which changeover switch and the relay electric apparatus are arranged.

As described above, according to the present disclosure, since the switching communication part is formed on one side and the other side of changeover switch in the other direction, air inside the housing can be exchanged, and heat inside the housing can be dissipated.

Hereinafter, a changeover switch built-in board according to a first embodiment of the present disclosure will be described referring to the accompanying drawings.

Changeover switch built-in board is installed between a plurality of power supply systems and a load, and is configured to switch between a plurality of power supply systems and a load.

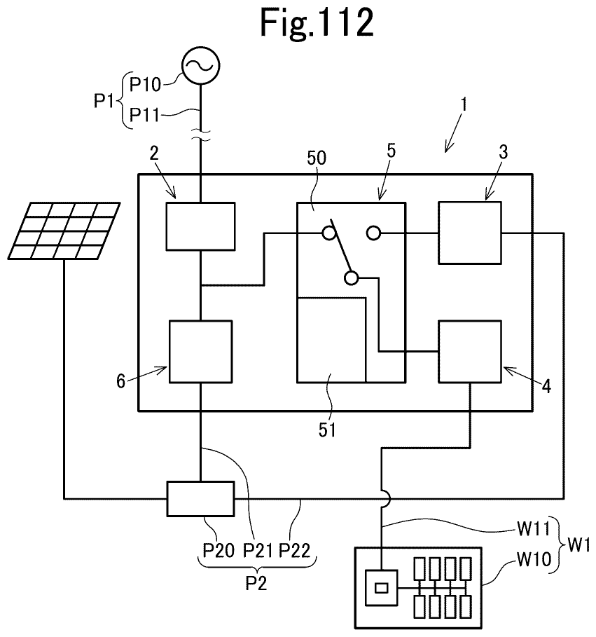

For example, as shown in FIG. 112, when a changeover switch built-in board is installed in a house, a first power supply system P1 through which commercial power flows, a second power supply system P2 including a distributed power supply, and a load system W10 including a load W1 are electrically connected to changeover switch built-in board 1.

First, the configuration of the first power supply system P1 and the second power supply system P2 will be described.

The first power supply system P1 of the present embodiment is a power supply system through which commercial power flows. The first power supply system P1 includes a first power supply P10 that is a commercial power supply (such as a power generation facility) and a first power distribution path P11 that is electrically connected to the first power supply P10.

The second power supply system P2 is a power supply system including a distributed power supply.

The second power supply system P2 includes a second power supply P20 that is a distributed power supply, a primary-side external power path (referred to as a relay power distribution path in the present embodiment) P21 that is electrically connected to the primary side of the second power supply P20, and a secondary-side external power path (referred to as a second power distribution path in the present embodiment) P22 that is electrically connected to the secondary side of the second power supply P20.

The second power supply P20 of the present embodiment is constituted by a storage battery. That is, the second power supply system P2 is a power supply system capable of charging and discharging the second power supply P20.

The second power supply P20 of the present embodiment is connected to a solar panel and is configured to be charged by receiving electric power generated by a solar cell.

The relay distribution path P21 is an electric path through which electric power supplied to the second power supply P20 flows. When the second power supply P20 is composed of a so-called power conditioner and a storage battery, power for operating the power conditioner flows through the relay distribution path P21. The second power distribution path P22 is an electric path through which the electric power emitted from the second power supply P20 flows.

The load system W1 includes a load W10 and a load distribution path W11 electrically connected to the load W10. In the present embodiment, the loading W10 is a distribution board. Specifically, the distribution board includes a main switch, a bus bar, a branch switch, and a distribution housing.

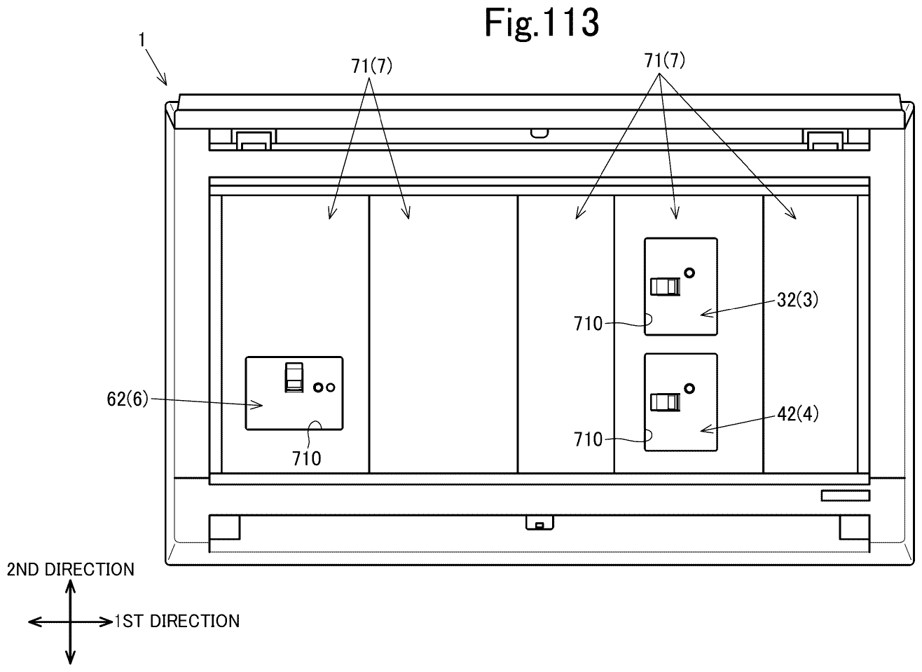

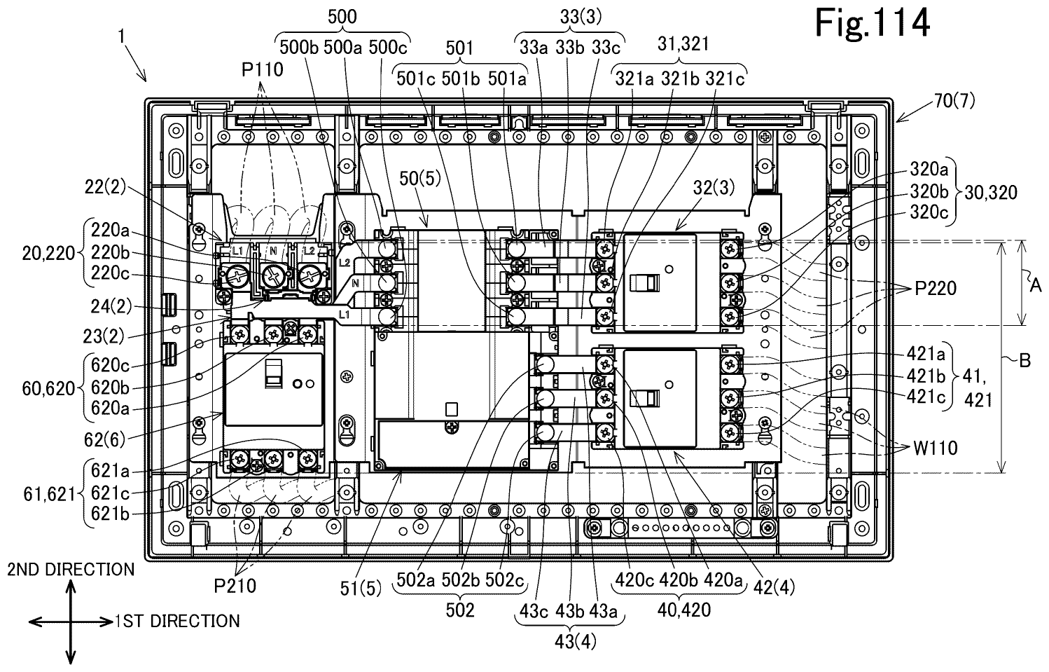

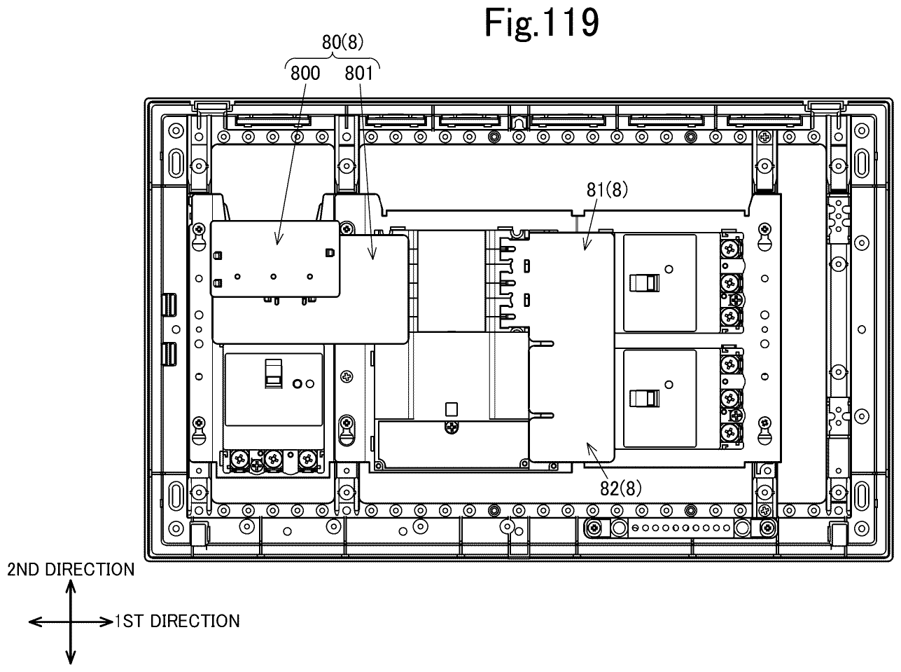

As shown in FIG. 114, changeover switch built-in board 1 is electrically connected to the first power supply system P1, the first circuit part 2 electrically connected to the second power supply system P2, the load circuit part 4 to which the load system W1 is connected, and changeover switch 5 for switching the power supply for supplying electricity to the load system W1 to the first power supply system P1 or the second power supply system P2A housing 7 (see FIG. 113) for accommodating a relay circuit part 6 to be connected, a first circuit part 2, a second circuit part 3, a relay circuit part 6, a changeover switch 5, and a loading P2 4, and a covering structure 8 (see FIG. 119) for covering a charging part in the housing 7 are provided.

In the present embodiment, a direction in which the front surface and the back surface of changeover switch built-in board 1 are arranged is referred to as a front-rear direction, a direction orthogonal to the front-rear direction is referred to as a first direction, and a direction orthogonal to the front-rear direction and the first direction is referred to as a second direction.

Specifically, one of the first direction and the second direction orthogonal to the front-rear direction and orthogonal to each other is defined as a first direction, and the other direction is defined as a second direction. In addition, a surface direction of a surface formed by the first direction and the second direction is referred to as a board surface direction.

In the present embodiment, the first direction is a direction corresponding to the left-right direction in a state where changeover switch built-in board 1 in the installed state is viewed from the front, and the one side in the first direction is a left side and the other side in the first direction is a right side.

In addition, the second direction is a direction corresponding to the up-down direction in a state where changeover switch built-in board 1 in the installed state is viewed from the front, the one side in the second direction is the upper side, and the other side in the second direction is the lower side.

The first circuit part 2 is electrically connected to the first power supply system P1 and changeover switch 5. The first circuit part 2 is disposed on one side of changeover switch 5 in the first direction.

The first circuit part 2 of the present embodiment has a first power supply system P1 electrically connected to a first primary terminal part 20, and a changeover switch 5 (a first-side terminal part 500 to be described later) and a relay circuit part 6 electrically connected to a first secondary terminal part (not numbered). In the first circuit part 2 of the present embodiment, first primary terminal part 20 also serves as a first secondary terminal part.

In the first circuit part 2, first primary terminal part 20 is disposed toward one side in the second direction, and is connectable to first primary terminal part 20 in a direction extending from first primary terminal part 20 to one side in the second direction with the first power supply P10 (in the present embodiment, the first power distribution path P11) and the first conductive P110 connected to first primary terminal part 20.

The first circuit part 2 includes a first electric device 22, a first conductive connection part 23 fixed to the first electric device 22 so as to be electrically connected to the first conductive P110, and a partition member 24 for preventing a short circuit of first conductive connection part 23.

The first electrical device 22 is a terminal block. Further, the first electric device 22 is a terminal block including a first primary terminal part 20 electrically connected to the first power supply system P1, and a first power distribution path P11 (a first conductive P110 included in the first power distribution path P11) is fixed to first primary terminal part 20.

The first electric device 22 of the present embodiment is disposed on one side of changeover switch 5 in the first direction. The first electric device 22 is disposed at a position spaced apart from changeover switch 5 in the first direction.

The first electric device 22 includes a device primary terminal part 220 capable of fixing the first conductive P110, and a device secondary terminal part (not numbered) capable of fixing first conductive connection part 23. In the first electric device 22, the device primary terminal part 220 also serves as a device secondary terminal part.

Circuit part 2 first primary terminal part 20 is configured by the device primary terminal part 220 of the first electrical device 22, and first secondary terminal part is configured by the device secondary terminal part of the first electrical device 22, but first primary terminal part 20 and first secondary terminal part are configured by the device primary terminal part 220 of the first electrical device 22 in the first circuit part 2 of the present embodiment because the device primary terminal part 220 also serves as first secondary terminal part.

The first electric device 22 is configured such that when the first conductor P110 and first conductive connection part 23 are fixed to the device primary terminal part 220, the first conductor P110 and first conductive connection part 23 are electrically connected to each other. The device primary terminal part 220 of the present embodiment is configured such that the first conductive P110 and first conductive connection part 23 can be fixed by screws.

In addition, the device primary terminal part 220 may be configured to conduct each other by directly contacting the first conductive P110 and first conductive connection part 23, or may be configured to conduct each other by indirectly contacting.

The device primary terminal part 220 of the first electric device 22 of the present embodiment includes a device primary terminal part 220 (first phase terminal part 220a) for the first phase, a device primary terminal part 220 (second phase terminal part 220b) for the second phase, and a device primary terminal part 220 (third phase terminal part 220c) for the third phase. In the present embodiment, the first phase terminal part 220a, the second phase terminal part 220b, and the third phase terminal part 220c are arranged so as to be aligned in the first direction.

Note that changeover switch built-in board 1 is premised on transmitting power in a single-phase three-wire system, and in the present embodiment, L2 phase is referred to as the first phase, the N phase is referred to as the second phase, and L1 phase is referred to as the third phase.

In the first electric device 22, the third phase terminal part 220c is disposed on the most one side in the first direction, the first phase terminal part 220a is disposed on the most other side in the first direction, and the second phase terminal part 220b is disposed between the first phase terminal part 220a and the third phase terminal part 220c in the first direction.

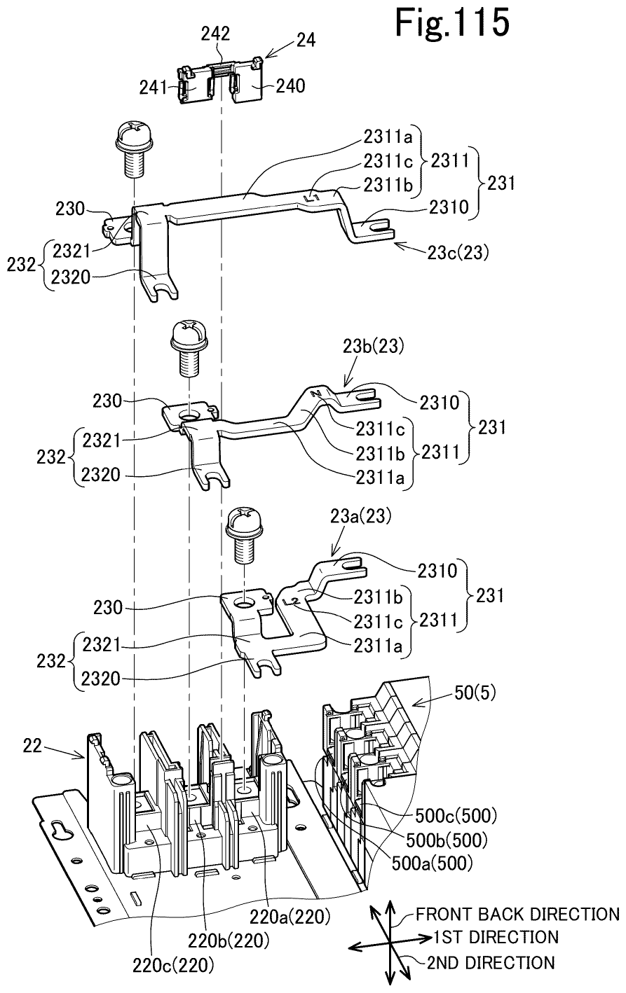

As shown in FIG. 115, first conductive connection part 23 includes a connection fixing part 230 fixed to the terminal block, a first conductive part 231 extending toward the first direction (the other side in the first direction in the present embodiment) with respect to the connection fixing part 230, and a second conductive part 232 extending toward the second direction (the other side in the second direction in the present embodiment) with respect to the connection fixing part 230.

Since the connection fixing part 230, the first conductive part 231, and the second conductive part 232 are integrally formed, the distal end side of the connection fixing part 230 is branched into the other side in the second direction and the other side in the first direction in first conductive connection part 23. First conductive connection part 23 of the present embodiment is made of a conductive plate material.

The first conductive part 231 includes a end part 2310 fixed to a first-side terminal part 500 of changeover switch 5, which will be described later, and a intermediate part 2311 that is contiguous with end part 2310 and the second conductive part 232 (a intermediate part 2321 of the second conductive part 232, which will be described later).

The first conductive part 231 intermediate part 2311 is a part interposed between the second conductive part 232 and end part 2310 of the first conductive part 231. Intermediate part 2311 of the first conductive part 231 of the present embodiment includes a proximal end side conductive part 2311a disposed between the first electric device 22 and the relay circuit part 6 (the other side in the second direction than the first electric device 22), a distal end side conductive part 2311b disposed between the first electric device 22 and changeover switch 5 (the other side in the first direction than the first electric device 22), and an identification 2311c attached to a front surface (one surface disposed toward the front side in the front-rear direction) of the distal end side conductive part 2311b. The identification 2311e may be formed by digging in intermediate part 2311 of the first conductive part 231 by direct marking, or may be formed by printing with a laser or the like.

The identification-display 2311c indicates the type of first conductive connection part 23. The identification-display 2311c of the present embodiment is constituted by characters of “L1” indicating L1 phase, “N” indicating the N phase, and “L2” indicating L2 phase.

The second conductive part 232 includes a end part 2320 fixed to a relay primary terminal part (relay device primary terminal part) of the relay circuit part 6, which will be described later, and a intermediate part 2321 connected to end part 2320 and the connecting fixing part 230.

Here, the first circuit part 2 has three first conductive connection part 23 corresponding to the numbers of the device primary terminal part 220. The three first conductive connection part 23, respectively, first conductive connection part 23 for the first phase (first phase conductive connection 23a), first conductive connection part 23 for the second phase (second phase conductive connection 23b), first conductive connection part 23 for the third phase (third phase conductive connection 23c).

The three first conductive connection part 23 are arranged such that the respective second conductive part 232 are aligned in the first direction in the front view.

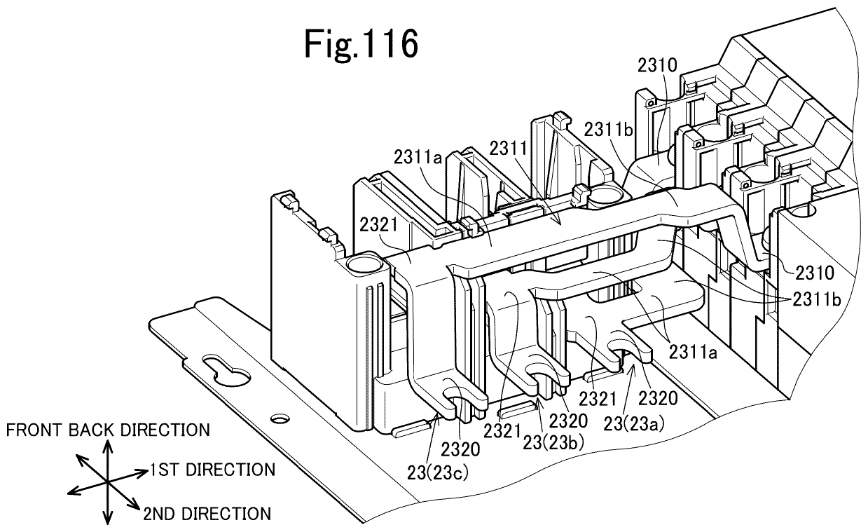

As shown in FIG. 116, intermediate part 2321 of the second conductive part 232 is disposed on the front side in the front-rear direction relative to intermediate part 2321 arranged next to each other on the other side in the first direction.

In addition, intermediate part 2321 of the second conductive part 232 for the third phase, which is disposed on the one side in the first direction, is disposed on the most front side in the front-rear direction, and intermediate part 2321 of the second 232 for the first phase, which is disposed on the most other side in the first direction, is disposed on the most rear side in the front-rear direction.

Further, the second conductive part 232 of the third-phase conductive connection part 23c and the second conductive part 232 of the second-phase conductive connection part 23b are formed so that intermediate part 2321 protrudes toward the front side in the front-rear direction with respect to the connection fixing part 230 and its own end part 2320. The height of intermediate part 2321 of the third-phase conductive connection part 23c (the height of the top part of intermediate part 2321 when the position of the connection fixing part 230 and the position of end part 2320 are used as a reference in the front-rear direction) is larger than the height of the second-phase conductive connection part 23b in intermediate part 2321 (the height of the top part of intermediate part 2321 when the position of the connection fixing part 230 and the position of end part 2320 are used as a reference in the front-rear direction).

The first phase conductive connection part 23a is formed so as to form a step at the boundary between the connection fixing part 230 and intermediate part 2321, and is formed so as to be disposed on the rear side in the front-rear direction relative to the connection fixing part 230 in end part 2320. In the first-phase conductive connection part 23a, a step is not formed at the boundary between intermediate part 2321 and end part 2320, and is formed flat from the boundary between the connection fixing part 230 and intermediate part 2321 to the front end.

In the present embodiment, the connection fixing part 230 of the first-phase conductive connection part 23a, the connection fixing part 230 of the second-phase conductive connection part 23b, and the connection fixing part 230 of the third-phase conductive connection part 23c are set at the same position in the front-rear direction, and the positions of end part 2320 of the second conductive part 232 and the second conductive part 232 of the third-phase conductive connection part 23c in the front-rear direction of end part 2320 of the second conductive part 232 of the first-phase conductive connection part 23a are set at the same position in the front-rear direction, respectively, in the second end part 2320, the second-phase conductive connection part 23b.

Therefore, each of the first-phase conductive connection part 23a, the second-phase conductive connection part 23b, and the third-phase conductive connection part 23c is arranged such that end part 2320 of the second conductive part 232 is located rearward and rearward of the connection fixing part 230.

On the other hand, since the first-phase conductive connection part 23a, the second-phase conductive connection part 23b, and the third-phase conductive connection part 23c have different positions in the front-rear direction of intermediate part 2321 of the respective second conductive part 232, the positions in the front-rear direction of the base-end-side conductive part 2311a branched from the respective second conductive part 232 are also different from each other. Thus, the three proximal conductive part 2311a diverge (extend) from intermediate part 2321 of the second conductive part 232 in the same direction, but do not interfere with each other.

The three proximal conductive part 2311a are arranged in a row spaced apart from each other in the anterior-posterior orientation. Further, the three proximal-end-side conductive part 2311a are arranged so as to be arranged from the front side to the rear side in the front-rear direction in order from the one extending from the second conductive part 232 located on the one-most side in the first direction.

Therefore, when changeover switch built-in board 1 is viewed from the front, the base-end-side conductive part 2311a included in the first phase conductive connection part 23a and the base-end-side conductive part 2311a included in the second phase conductive connection part 23b are hidden behind the base-end-side conductive part 2311a included in the third phase conductive connection part 23c.

The three front-side conductive part 2311b are also arranged in different positions in the front-rear direction, so that they do not interfere with each other.

The three distal conductive part 2311b are configured such that, in a front view, the respective distal ends (the boundary between the first conductive part 231 and end part 2310) are aligned in the second orientation. The three front-end-side conductive part 2311b are arranged side by side from the rear side to the front side in the front-rear direction in order from the one where end part 2310 is positioned on the most one side in the second direction.

In the present embodiment, the distal end side conductive part 2311b included in the conductive connection part 23) for the third phase conductive connection part 23c(L1 phase is disposed on the most front side in the front-rear direction, and the distal end side conductive part 2311b included in the second phase conductive connection part 23b and the third phase conductive connection part 23b (conductive connection part 23 for the N-phase) is disposed on one side in the front-rear direction and in the second direction with respect to the distal end side conductive part 2311b included in the second phase conductive connection part 23c is disposed on one side in the front-rear direction and in the second direction with respect to the distal end side conductive part 2311b included in the third phase conductive connection part conductive part 2311b, and is disposed on one side in the front-rear direction and in the second direction with respect to the distal end side 23a(L2 included in the first phase conductive connection part 23a(L2 23).

Therefore, the front end side conductive part 2311b included in the first phase conductive connection part 23a, the front end side conductive part 2311b included in the second phase conductive connection part 23b, and the front end side conductive part 2311b included in the third phase conductive connection part 23c are both exposed to the front side in the front-rear direction in the front view. Accordingly, the identification-display 2311c attached to the respective front-end-side conductive part 2311b are also exposed to the front side in the front-rear direction.

The partition member 24 is for preventing a short circuit between first conductive connection part 23.

In the present embodiment, in a front view, the first conductive part 231 included in the third phase conductive connection part 23c and the first conductive part 231 included in the second phase conductive connection part 23b are arranged so as to cross the region on the lower side (the other side in the second direction) of the connection fixing part 230 included in the first phase conductive connection part 23a, and further, the region on the lower side (the other side in the second direction) of the connection fixing part 230 included in the second phase conductive connection part 23b is also arranged so as to cross the first conductive part 231 included in the third phase conductive connection part 23c.

Therefore, the partition member 24 is configured to insulate between the connection fixing part 230 included in the first phase conductive connection part 23a and the first conductive part 231 included in the second phase conductive connection part 23b and the first conductive part 231 included in the third phase conductive connection part 23c, and between the connection fixing part 230 included in the second phase conductive connection part 23b and the first conductive part 231 included in the third phase conductive connection part 23c.

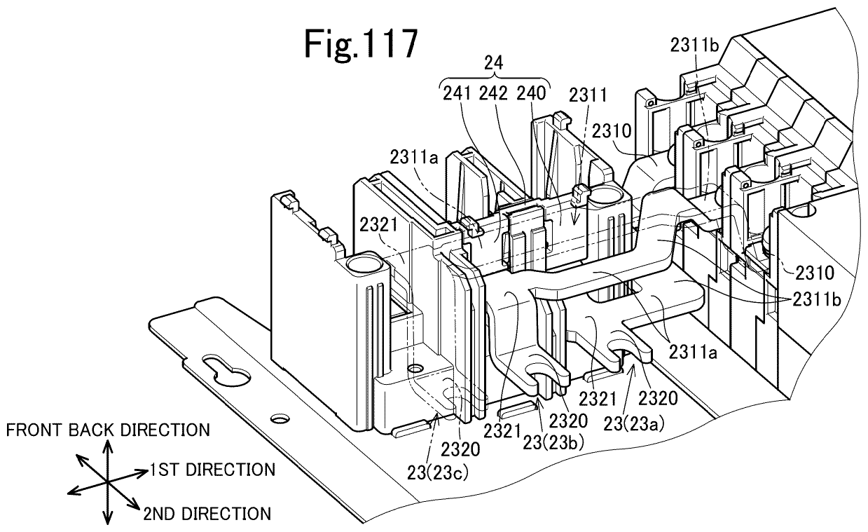

More specifically, as shown in FIG. 117, the partition member 24 includes a connection fixing part 230 included in the first phase conductive connection part 23a, a first partition part 240 disposed between the first conductive part 231 included in the second phase conductive connection part 23b and the first conductive part 231 included in the third phase conductive connection part 23c, a connection fixing part 230 included in the second phase conductive connection part 23b, a second partition part 241 disposed between the first conductive part 231 included in the third phase conductive connection part 23c, and a connecting part 242 connected to the first partition part 240 and the second partition part 241.

Each of the first partition part 240, the second partition part 241, and the connecting part 242 has an insulating property.

As shown in FIG. 114, the second circuit part 3 is electrically connected to the second power supply system P2 and changeover switch 5. The second circuit part 3 is disposed on the other side of changeover switch 5 in the first direction.

The second circuit part 3 includes a second primary terminal part 30 electrically connected to the second power supply system P2, and a second secondary terminal part 31 electrically connected to a changeover switch 5 (a second-side terminal part 501 to be described later).

In the second circuit part 3, second primary terminal part 30 is disposed toward the other side in the first direction, and is connectable to second primary terminal part 30 in a direction extending from second primary terminal part 30 to the other side in the first direction with the second power supply P20 (the second power distribution path P22 in the present embodiment) and the second conductive P220 connected to second primary terminal part 30.

The second circuit part 3 of the present embodiment includes a second electric device 32 that receives electric power from the second power supply system P2, and a second conductive connection part 33 that electrically connects the second electric device 32 and a second-side terminal part 501, which will be described later, of changeover switch 5.

The second electric device 32 of the present embodiment is disposed on the other side of changeover switch 5 in the first direction. The second electric device 32 is disposed at a position spaced apart from changeover switch 5 in the first direction.

The second electric device 32 includes a device primary terminal part 320 electrically connected to the second power supply system P2, a device secondary terminal part 321 electrically connected to a second-side terminal part 501 described later of changeover switch 5 via the second conductive connection part 33, and a second functional part (not assigned).

The device primary terminal part 320 and the device secondary terminal part 321 are arranged side by side in a first direction, and the arrangement position of the device primary terminal part 320 in the second direction and the arrangement position of the device secondary terminal part 321 in the second direction are the same. Further, in the present embodiment, the second electric device 32 is arranged such that the device primary terminal part 320 faces the other side of the first direction and the device secondary terminal part 321 faces the one side of the first direction.

In the second electric device 32 of the present embodiment, the device primary terminal part 320 constitutes second primary terminal part 30, and the device secondary terminal part 321 constitutes second secondary terminal part 31. The device secondary terminal part 321 of the second electric device 32 is electrically connected as second secondary terminal part 31 to a second-side terminal part 501, which will be described later, of changeover switch 5.

A second conductive P220 of the second distribution path P22 is fixed to the device primary terminal part 320. A second conductive connection part 33 is fixed to the device secondary terminal part 321. The device secondary terminal part 321 of the present embodiment is a so-called screw-type terminal part, and is configured so that the second conductive connection part 33 can be fixed by screws. The instrument primary terminal part 320 is also screwed to secure the second conductive P220.

The device primary terminal part 320 of the second electric device 32 of the present embodiment includes a device primary terminal part 320 (first phase terminal part 320a) for the first phase, a device primary terminal part 320 (second phase terminal part 320b) for the second phase, and a device primary terminal part 320 (third phase terminal part 320c) for the third phase.

The device secondary terminal part 321 of the second electric device 32 includes a device secondary terminal part 321 (first phase terminal part 321a) for the first phase, a device secondary terminal part 321 (second phase terminal part 321b) for the second phase, and a device secondary terminal part 321 (third phase terminal part 321c) for the third phase.

The first phase terminal part 320, the second phase terminal part 320a, the second phase terminal part 320b, and the third phase terminal part 320c are arranged to align with each other in the second direction, and the first phase terminal part 321a of the device secondary terminal part 321, the second phase terminal part 321b, and the third phase terminal part 321c are also arranged to align with each other in the second direction.

The second conductive connection part 33 is formed so as to extend along the first direction (i.e., formed in a straight line shape). One longitudinal end of the second conductive connection part 33 is fixed to the device secondary terminal part 321.

The second circuit part 3 has three second conductive connection part 33 corresponding to the number of the device secondary terminal part 321. The three second conductive connection part 33 are also a second conductive connection part 33 for the first phase (first phase conductive connection 33a), a second conductive connection part 33 for the second phase (second phase conductive connection 33b), and a second conductive connection part 33 for the third phase (third phase conductive connection 33c).

As described above, since the first phase terminal part 321a, the second phase terminal part 321b, and the third phase terminal part 321c of the device secondary terminal part 321 are arranged so as to be aligned along the second direction, the three second conductive connection part 33 are also arranged along the second direction while being fixed to the first phase terminal part 321a, the second phase terminal part 321b, and the third phase terminal part 321c, respectively.

The second electric apparatus of the present embodiment is a circuit breaker. Therefore, in a state in which the second conductive terminal part 320 is fixed with the second conductive P220 and the second conductive connection part 33 is fixed to the device secondary terminal part 321, the second functional part is configured to be switchable between a state in which the second power distribution path P22 and the second conductive connection part 33 are electrically connected (closed state) and a state in which the second power distribution path P22 and the second conductive connection part 33 are electrically disconnected (open state).

As described above, the second electric device 32 can switch the state in which the second power supply system P2 and changeover switch 5 are electrically connected to each other and the state in which the second power supply system P2 and changeover switch 5 are electrically disconnected from each other.

The load circuit part 4 is electrically connected to the load W10 and changeover switch 5. The load circuit part 4 includes a load primary terminal part 40 electrically connected to changeover switch 5 (a load-side terminal part 502 described later), and a load secondary terminal part 41 electrically connected to the load W10.

The load circuit part 4 of the present embodiment includes a load electrical device 42 that receives power from changeover switch 5, and a load conductive connection part 43 that is electrically connected to changeover switch 5 and the load electrical device 42.

The load-electric device 42 of the present embodiment is disposed on the other side of changeover switch 5 in the first direction. The loading appliance 42 is spaced apart from changeover switch 5 in a first direction.

The load electrical device 42 includes a load device primary terminal part 420 electrically connected to a load-side terminal part 502 described later in changeover switch 5, a load device secondary terminal part 421 electrically connected to a load W10, and a load function part (not assigned).

In the load electric device 42 of the present embodiment, the load primary terminal part 40 is configured by the load device primary terminal part 420 of the load electric device 42, and the load secondary terminal part 41 is configured by the load device secondary terminal part 421 of the load electric device 42. The load device primary terminal part 420 of the load electrical device 42 is electrically connected as a load primary terminal part 40 to a load-side terminal part 502, which will be described later, of changeover switch 5.

The load device primary terminal part 420 and the load device secondary terminal part 421 are arranged side by side in the first direction, the load device primary terminal part 420 is provided at one end of the load device 42 in the first direction, and the load device secondary terminal part 421 is provided at the other end of the load device 42 in the first direction.

A load conductive connection part 43 is fixed to the load device primary terminal part 420. A load conductor W110 connected to the load distribution path W11 is fixed to the load device secondary terminal part 421. The load device secondary terminal part 421 of the present embodiment is a so-called screw-type terminal part, and is configured so that the load conductive W110 can be fixed by screws. The load device primary terminal part 420 is also screwed to secure the load conductive connection part 43.

The load electrical device 42 is arranged side by side in the second direction with respect to the second circuit part 3, and the load device primary terminal part 420 of the load electrical device 42 and the device secondary terminal part 321 of the second electrical device 32 are arranged in the second direction, and the load device secondary terminal part 421 of the load electrical device 42 and the device primary terminal part 320 of the second electrical device 32 are arranged in the second direction. In the present embodiment, the load electrical device 42 is disposed at a position spaced apart from the second electrical device 32 in the second direction.

The load device primary terminal part 420 of the load electric device 42 of the present embodiment includes a load device primary terminal part 420 (first phase terminal part 420a) for the first phase, a load device primary terminal part 420 (second phase terminal part 420b) for the second phase, and a load device primary terminal part 420 (third phase terminal part 420c) for the third phase.

The load device secondary terminal part 421 of the load electric device 42 includes a load device secondary terminal part 421 (first phase terminal part 421a) for the first phase, a load device secondary terminal part 421 (second phase terminal part 421b) for the second phase, and a load device secondary terminal part 421 (third phase terminal part 421c) for the third phase.

Further, in the load electric device 42, the first phase terminal part 420a, the second phase terminal part 420b, and the third phase terminal part 420c of the load device primary terminal part 420 are arranged so as to be aligned in the second direction, and the first phase terminal part 421a, the second phase terminal part 421b, and the third phase terminal part 421c of the load device secondary terminal part 421 are also arranged so as to be aligned in the second direction.

The load conductive connection part 43 is formed so as to extend along the first direction (i.e., is straight), and one end part in the longitudinal direction is fixed to the load primary terminal part 40.

The load circuit part 4 has three load conductive connection part 43 corresponding to the numbers of the first phase terminal part 420a, the second phase terminal part 420b, and the third phase terminal part 420c. The three load conductive connection part 43 are also a load conductive connection part 43 for the first phase (first phase conductive connection 43a), a load conductive connection part 43 for the second phase (second phase conductive connection 43b), and a load conductive connection part 43 for the third phase (third phase conductive connection 43c), respectively.

As described above, since the first phase terminal part 420a, the second phase terminal part 420b, and the third phase terminal part 420c of the load device primary terminal part 420 are arranged to be aligned along the second direction, the three load conductive connection part 43 are arranged to be aligned along the second direction in a state where they are fixed to the first phase terminal part 420a, the second phase terminal part 420b, and the third phase terminal part 420c, respectively.

The load electrical device 42 of the present embodiment is a circuit breaker. Therefore, in a state in which the load conductive connection part 43 is fixed to the load device primary terminal part 420 and the load conductor W110 is fixed to the load device secondary terminal part 421, the load function part is configured to be switchable between a state in which the load conductive connection part 43 and the load conductor W110 are electrically connected (closed state) and a state in which the load conductive connection part 43 and the load conductor W110 are electrically disconnected (open state).

As described above, the load electric device 42 can switch between a state in which changeover switch 5 and the load system W1 are electrically connected and a state in which changeover switch 5 and the load system W1 are electrically disconnected.

Changeover switch 5 includes a switching main body part 50 that switches between the first circuit part 2 and the second circuit part 3 and the load circuit part 4, and a switching control part 51 that operates the switching main body part 50.

The switching body 50 includes a first side terminal part 500 electrically connected to the first circuit part 2 via first conductive connection part 23, a second side terminal part 501 electrically connected to the second circuit part 3 via the second conductive connection part 33, and a load side terminal part 502 electrically connected to the load system W1 via the load conductive connection part 43.

The first side terminal part 500, the second side terminal part 501, and the load side terminal part 502 of the present embodiment are so-called screw-type terminal part, and each of first conductive connection part 23, the second conductive connection part 33, and the load conductive connection part 43 can be fixed by screws.

The first side terminal part 500 of changeover switch 5 of the present embodiment includes a first side terminal part 500 (first phase terminal part 500a) for the first phase, a first side terminal part 500 (second phase terminal part 500b) for the second phase, and a first side terminal part 500 (third phase terminal part 500c) for the third phase. The first phase terminal part 500a, the second phase terminal part 500b, and the third phase terminal part 500c are arranged to be aligned in the second direction.

The second side terminal part 501 of changeover switch 5 of the present embodiment includes a second side terminal part 501 (first phase terminal part 501a) for the first phase, a second side terminal part 501 (second phase terminal part 501b) for the second phase, and a second side terminal part 501 (third phase terminal part 501c) for the third phase. The first phase terminal part 501a, the second phase terminal part 501b, and the third phase terminal part 501c are arranged to be aligned in the second direction.

The load-side terminal part 502 of changeover switch 5 of the present embodiment includes a load-side terminal part 502 for the first phase (first phase terminal part 502a), a load-side terminal part 502 for the second phase (second phase terminal part 502b), and a load-side terminal part 502 for the third phase (third phase terminal part 502c). The first phase terminal part 502a, the second phase terminal part 502b, and the third phase terminal part 502c are arranged to be aligned in the second direction.

The first side terminal part 500, the second side terminal part 501, and the load-side terminal part 502 are provided at separate ends of changeover switch 50 in the first direction. In addition, in changeover switch 5 of the present embodiment, the first side terminal part 500 and the second side terminal part 501 are arranged side by side (so as to be aligned) in the first direction in the opposite direction in the first direction.

More specifically, the first side terminal part 500 is disposed toward one side of the first direction, the second side terminal part 501 is disposed toward the other side of the first direction, and the second side terminal part 501 faces second secondary terminal part 31 in the first direction. Thus, the first terminal part 500 is positioned towards the instrument primary terminal part 220.

Further, the second side terminal part 501 and the load side terminal part 502 are arranged side by side in the second direction in the same direction in the first direction, the second side terminal part 501 and second secondary terminal part 31 face each other in the first direction, and the load side terminal part 502 and the load primary terminal part 40 face each other in the first direction.

In the present embodiment, the second side terminal part 501 is disposed on one side in the second direction, and the load-side terminal part 502 is disposed on the other side in the second direction. Furthermore, the arrangement position of the second side terminal part 501 of the present embodiment in the first direction and the arrangement position of the load-side terminal part 502 in the first direction are different from each other. More specifically, the second side terminal part 501 is arranged to be located on one side of the load-side terminal part 502 in the first direction.

In addition, the first phase terminal part 500a, 501a is arranged so as to be aligned on a straight line or a substantially straight line (on a straight line or a substantially straight line in the first direction) in a state where the connecting directions are opposite to each other in the first direction, and the second phase terminal part 500b, 501b is also arranged so as to be aligned on a straight line or a substantially straight line (on a straight line or a substantially straight line in the first direction) in a state where the connecting directions are opposite to each other in the first direction, and the third phase terminal part 500c, 501c is also arranged so as to be aligned on a straight line or a substantially straight line (on a straight line or a substantially straight line in the first direction) in a state where the connecting directions are opposite to each other in the first direction.

In addition to the second-side terminal part 501, in each of the device secondary terminal part 321, the load-side terminal part 502, and the load-device primary terminal part 420 of the load electrical device 42 of the second electrical device 32, the first-phase terminal part 321a, 502a, 420a, the second-phase terminal part 321b, 502b. 420b, and the third-phase terminal part 321c, 502c, 420c are arranged so as to be aligned in the second direction.

Further, the second-side terminal part 501 and the device secondary terminal part 321 of the second electric device 32 are configured such that the first phase terminal part 501a, 321a of each other oppose each other in the first direction, the second phase terminal part 501b, 321b of each other oppose each other in the first direction, and the third phase terminal part 501c, 321c of each other oppose each other in the first direction. Note that the second-side terminal part 501 and the device secondary terminal part 321 of the second electric device 32 may be opposed to each other in a positional relationship, or may be substantially opposed to each other without being perfectly opposed to each other.

The load-side terminal part 502 and the load device primary terminal part 420 of the load electric device 42 are configured such that the first phase terminal part 502a, 420a of each other oppose each other in the first direction, the second phase terminal part 502b, 420b of each other oppose each other in the first direction, and the third phase terminal part 502c, 420c of each other oppose each other in the first direction. Note that the load-side terminal part 502 and the load device primary terminal part 420 of the load electric device 42 may be opposed to each other in a positional relationship, or may be substantially opposed to each other without being perfectly opposed to each other.

In addition, in the second direction, in the band-like area A that extends in a first direction from the first phase terminal part 500a of the first side terminal part 500 and the first phase terminal part 501a of the second side terminal part 501 to the third phase terminal part 500c of the first side terminal part 500 and the third phase terminal part 501c of the second side terminal part 501, first secondary terminal part (first primary terminal part 20 serving as first secondary terminal part in the present embodiment) is arranged in the first direction on the other side of the first side than terminal part 500, and second secondary terminal part 31 is arranged in the second direction on the other side of the first side than terminal part 501.

Therefore, changeover switch 5 of the present embodiment is disposed between the first circuit part 2 and the second circuit part 3 in the first direction. Specifically, as shown in FIG. 114, changeover switch 5 is disposed between the first circuit part 2 and the second circuit part 3 which are disposed at the same position in the second direction by being disposed in the band-shaped area A extending in the first direction.

Further, in the present embodiment, since the load electric device 42 is disposed on the other side of changeover switch 5 in the first direction, changeover switch 5 is also disposed between the first circuit part 2 and the load circuit part 4 in the first direction.

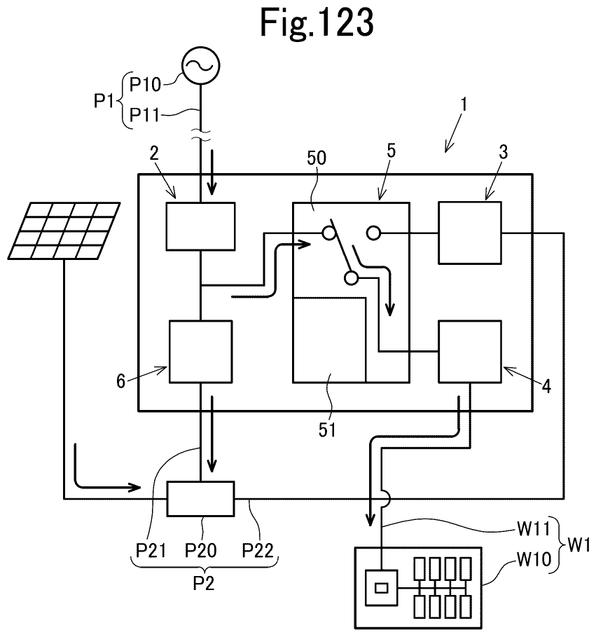

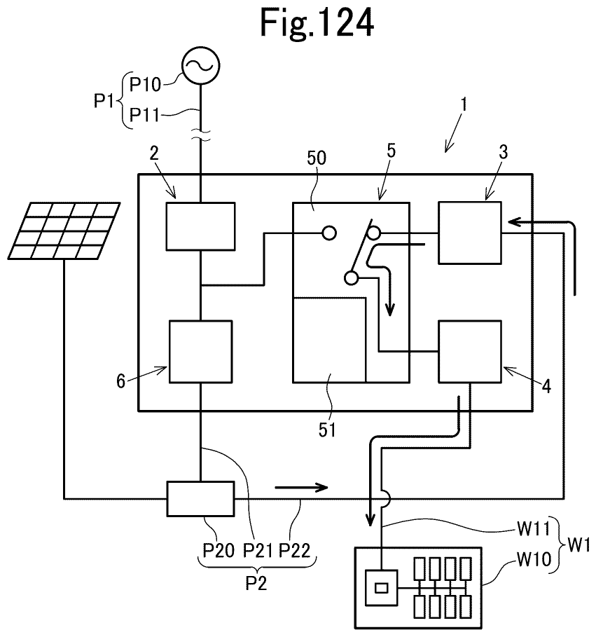

As shown in FIG. 123, the switching main body 50 is switchable between a state in which the first side terminal part 500 and the load side terminal part 502 are electrically connected to each other and the second side terminal part 501 and the load side terminal part 502 are electrically disconnected from each other (first power supply state), and a state in which the first side terminal part 500 and the load side terminal part 502 are electrically disconnected from each other and the second side terminal part 501 and the load side terminal part 502 are electrically connected to each other (second power supply state) as shown in FIG. 124, and the switching control part 51 is configured to switch the first power supply state and the second power supply state by operating the switching main body 50.

The switching control part 51 may be configured to automatically switch the first power supply state and the second power supply state of the switching main body 50 according to the respective power supply states, but may be configured to manually switch between the first power supply state and the second power supply state, or may be configured to switch between the first power supply state and the second power supply state by remote control from the outside.

In the present embodiment, as shown in FIG. 114, the switching main body 50 is disposed on one side in the second direction, and the switching control part 51 is disposed on the other side in the second direction.

The relay circuit part 6 includes a relay primary terminal part 60 electrically connected to the first circuit part 2 via first conductive connection part 23, and a relay secondary terminal part 61 electrically connected to the second power supply system P2 via the relay conductors P210.

The relay circuit part 6 of the present embodiment includes a relay electric device 62 that receives power from the first power supply system P1 via the first circuit part 2. When transmitting power to the first power supply system P1, the relay electric device 62 may be configured to supply power to changeover switch 5 in addition to the commercial power.

The relay electric device 62 includes a device primary terminal part 620 to which first conductive connection part 23 is fixed, a device secondary terminal part 621 to which the relay conductive P210 is fixed, and a relay function part (not assigned).

In the relay circuit part 6 of the present embodiment, the device primary terminal part 620 of the relay electrical device 62 constitutes the relay primary terminal part 60, and the device secondary terminal part 621 of the relay electrical device 62 constitutes the relay secondary terminal part 61.

Further, to the device primary terminal part 620 of the relay electric device 62, a second first conductive connection part 23 conductive part 232 (end part 2320 of the second conductive part 232) is fixed, and to the device secondary terminal part 621 of the relay electric device 62, a relay conductive P210 is fixed. The device secondary terminal part 621 of the present embodiment is configured such that the relay conductive P210 can be fixed by screws. The instrument primary terminal part 620 is also screwed to secure end part 2320 of first conductive connection part 23.

Further, in the relay electric device 62, the device primary terminal part 620 and the device secondary terminal part 621 are arranged so as to be aligned in the second direction. The device primary terminal part 620 of the relay electrical device 62 is arranged to face the device primary terminal part 220 of the first electrical device 22 in the second direction.

The device primary terminal part 620 of the relay electric device 62 of the present embodiment includes a device primary terminal part 620 (first phase terminal part 620a) for the first phase, a device primary terminal part 620 (second phase terminal part 620b) for the second phase, and a device primary terminal part 620 (third phase terminal part 620c) for the third phase.

The device secondary terminal part 621 of the relay electric device 62 of the present embodiment includes a device secondary terminal part 621 (first phase terminal part 621a) for the first phase, a device secondary terminal part 621 (second phase terminal part 621b) for the second phase, and a device secondary terminal part 621 (third phase terminal part 621c) for the third phase.

The relay electrical device 62 of the present embodiment is a circuit breaker. Therefore, the relay function part is configured to be switchable between a state in which first conductive connection part 23 and the relay conductor P210 are connected (closed state) and a state in which first conductive connection part 23 and the relay conductor P210 are electrically disconnected (open state) in a state in which first conductive connection part 23 is fixed to the device primary terminal part 620 and the relay conductor P210 connected to the relay distribution path P21 is fixed to the device secondary terminal part 621.

As described above, the relay function part can switch between a state in which the first circuit part 2 and the second power supply system P2 are electrically connected to each other and a state in which the first circuit part 2 and the second power supply system P2 are electrically disconnected from each other.

It should be noted that changeover switch 5, the second circuit part 3, and the load circuit part 4 are arranged so as to be within a range (width dimension) including from first primary terminal part 20 of the first circuit part 2 (the device primary terminal part 220 of the first electrical device 22) to the relay secondary terminal part 61 of the relay circuit part 6 (the device secondary terminal part 321 of the relay electrical device 62) in the second direction, and to be within the band-shaped area B extending in the first direction.

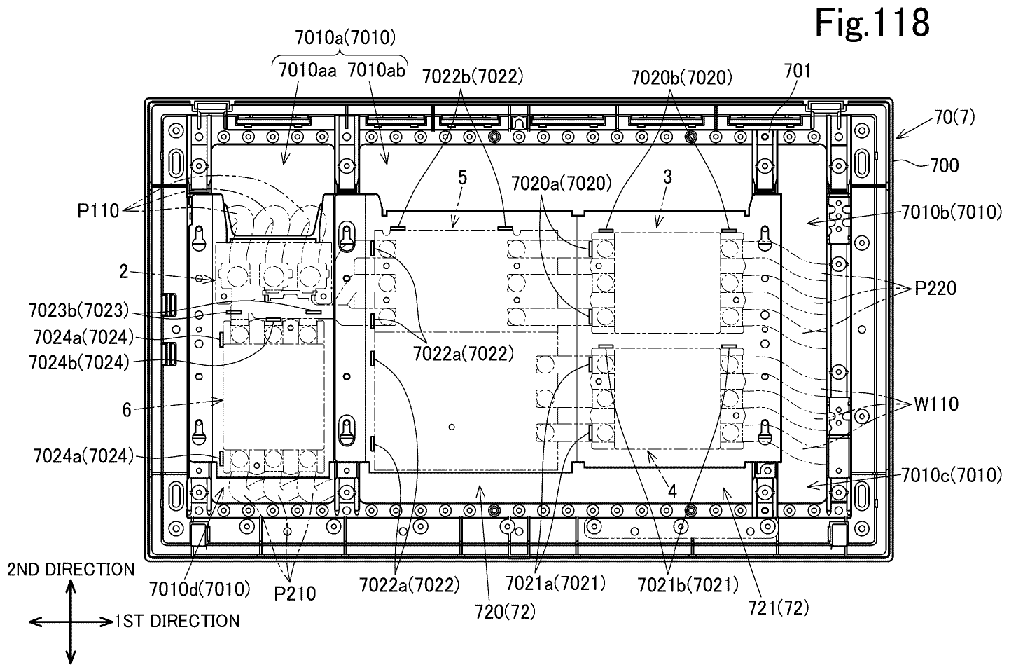

As shown in FIG. 118, the housing 7 includes a housing part 70 capable of housing the first circuit part 2, the second circuit part 3, the loading circuit part 4, changeover switch 5, and the relay circuit part 6 therein, and an intermediate cover part 71 (see FIG. 113) attached to the front surface of the housing part 70. Although not shown in FIG. 118, the housing 7 includes an outer lid part that covers the inner lid part 71 attached to the front surface of the housing part 70.

The housing part 70 has a circumferential annular frame part 700, a back surface part 701 located in the frame part 700, and a positioning structure 702 for positioning a device disposed in the back surface part 701.

The frame part 700 of the present embodiment is formed to have a rectangular shape in a front view. Further, the frame part 700, the front surface disposed toward the front side in the front-rear direction of the housing 7, since it is formed so as to be positioned on the front side in the front-rear direction of the housing 7 than the back surface part 701, a closed region of a rectangular shape (rectangular shape in front view) in front of the back surface part 701 is formed. The front-rear direction of the housing 7 corresponds to the front-rear direction of changeover switch built-in board 1.

Changeover switch built-in board 1 is installed by fixing the rear surface part 701 from the rear surface side to the wall surface. Further, the back surface part 701 is formed in a planar shape extending in the board surface direction.

The rear surface part 701 is provided with a conductor insertion part 7010 penetrating in the front-rear direction. The rear surface part 701 of the present embodiment is provided with a plurality of conductor insertion parts 7010.

The plurality of conductor insertion parts 7010, a first conductor insertion part 7010a through which the first conductor P110 can be inserted through the inside and outside of the housing 7, a second conductor insertion part 7010b through which the second conductor P220 can be inserted through the inside and outside of the housing 7, a load conductor insertion part 7010c through which the load conductor W110 can be inserted through the inside and outside of the housing 7, and a relay conductor insertion part 7010d through which the relay conductor P210 can be inserted through the inside and outside of the housing 7 are included.

The first conductive insertion part 7010a is provided on one side of first primary terminal part 20 and changeover switch 5 of the first electric device 22 in the second direction. Therefore, the first conductor insertion part 7010a allows the first conductor P110 to be inserted into and out of the housing 7 on one side of first primary terminal part 20 and changeover switch 5 of the first electric device 22 in the second direction.

The first conductor insertion part 7010a of the present embodiment includes, in the first direction, a first-side first conductor insertion part 7010aa disposed on one side and a switching-side first conductor insertion part 7010ab disposed on the other side. Specifically, the first conductor insertion part 7010a is partitioned into a first side first conductor insertion part 7010aa and a switching side first conductor insertion part 7010ab with a part of the back surface part 701 along a virtual straight line in the second direction passing between the first electric device 22 and changeover switch 5 which are separated in the first direction as a border. The first-side first conductor insertion part 7010aa is disposed directly above the first electric device 22, and the switching-side first conductor insertion part 7010ab is disposed directly above changeover switch 5 and the second electric device 32 (one side in the second direction). Therefore, the switching-side first conductive insertion part 7010ab is formed on one side of the load-electric device 42 in the second direction. Therefore, the switching-side first conductive insertion part 7010ab of the present embodiment is formed so as to correspond to the entire length of changeover switch 5 and the second electric device 32 in the first direction. In the present embodiment, as shown in FIG. 115, the first conductor P110 is inserted inside the housing 7 via the first-side first conductor insertion part 7010aa.

The first-side first conductive insertion part 7010aa is formed over the entire area of the first electric device 22 in the first direction. The switching-side first conductive insertion part 7010ab is formed so as to extend over the entire area in the first direction of changeover switch 5. The switching-side first conductive insertion part 7010ab is also formed to extend over the entire area of the second electric device 32 in the first direction. Therefore, the first conductive insertion part 7010 of the present embodiment is formed so as to correspond to the entire length of the first electric device 22, changeover switch 5, and the second electric device 32 in the first direction.

The second conductive insertion part 7010b is provided on the other side in the first direction than the device primary terminal part 320 of the second electric device 32. Therefore, the second conductor insertion part 7010b allows the second conductor P220 to be inserted into and out of the housing 7 on the other side in the first direction than the device primary terminal part 320 of the second electric device 32.

Further, the second conductive insertion part 7010b is disposed on the other side of the second electric device 32 in the first direction in the band-shaped area A, and the arrangement position in the second direction is the same as the arrangement position in the second direction of the second electric device 32. The second conductor insertion part 7010b is formed so as to extend to the same arrangement position as the arrangement position of the first conductor insertion part 7010a in the second direction on one side in the second direction than the strip-shaped area A.

The second conductive insertion part 7010b of the present embodiment extends to one side of the second electric device 32 in the second direction. The second conductive insertion part 7010b also extends to the other side of the second electric device 32 in the second direction. In the second conductor insertion part 7010b, part extending further toward the other side in the second direction than the second electric device 32 has the same part as the load conductor insertion part 7010c described later. Therefore, the second conductive insertion part 7010b of the present embodiment is formed to be longer than the length of the second electric device 32 in the second direction.

The load conductor insertion part 7010c is provided on the other side of the load device secondary terminal part 421 of the load electric device 42 in the first direction. Therefore, the load conductor insertion part 7010c allows the load conductor W110 to be inserted into and out of the housing 7 on the other side of the load device secondary terminal part 421 of the load electric device 42 in the first direction. Further, the load-conductor insertion part 7010c is formed so as to extend to the same arrangement position as the arrangement position of the relay conductor insertion part 7010d described later in the second direction.

The load conductor insertion part 7010c of the present embodiment extends to one side of the load electric device 42 in the second direction. The load conductor insertion part 7010c also extends to the other side of the load electric device 42 in the second direction. In the load conductor insertion part 7010c, part extending to one side of the load electric device 42 in the second direction is the same part as the second conductor insertion part 7010b. Therefore, the second conductive insertion part 7010b of the present embodiment is formed to be longer than the length of the second electric device 32 in the second direction.

Further, the load-conductor insertion part 7010c and the second conductor insertion part 7010b are formed at positions aligned in the second direction, and are formed so as to be continuous with each other. Therefore, the load-conductor insertion part 7010c and the second conductor insertion part 7010b are also used. Therefore, for example, the second conductor P220 can be inserted into and out of the housing 7 from the load conductor insertion part 7010c which also serves as the second conductor insertion part 7010b. Further, the loading conductor insertion part 7010c and the second conductor insertion part 7010b are formed so as to extend to one side and the other side in the second direction.

By combining the second conductor insertion part 7010b and the loading conductor insertion part 7010c, a secondary insertion part (not numbered) is formed. The secondary insertion part is formed so as to correspond to the entire area in the second direction of the second electric device 32 and the load electric device 42 arranged side by side in the second direction. Specifically, the secondary insertion part is formed so as to extend from a position on one side of the second electric device 32 to a position on the other side of the load electric device 42 in the second direction.

The relay-conductor insertion part 7010d is provided on the other side of the relay electric device 62 in the second direction relative to the device secondary terminal part 621. Therefore, the relay conductor insertion part 7010d allows the relay conductor P210 to be inserted into and out of the housing 7 on the other side of the device secondary terminal part 621 of the relay electric device 62 in the second direction. The relay-conductor insertion part 7010d of the present embodiment is formed so as to extend over the entire area of the relay electric device 62 in the first direction.

A communication part 72 that communicates the inside and the outside of the housing 7 is formed on the other side of changeover switch 5 and the load-electric device 42 in the second direction. The communication part 72 is disposed on the other side of the relay-conductor insertion part 7010d in the first direction. In addition, the communication part 72 of the present embodiment includes a switching-side communication part 720 disposed directly below changeover switch 5, and a load-side communication part 721 disposed directly below the load electric device 42.

The switching-side communication part 720 is formed to cover the entire area in the first direction of changeover switch 5, and the load-side communication part 721 is formed to cover the entire area in the first direction of the load electric device 42. The switching-side communication part 720 and the load-side communication part 721 are formed to be continuous with each other in the first direction.

In the present embodiment, the first-side first conductor insertion part 7010aa is formed to be wider than the relay conductor insertion part 7010d in the second direction. The relay conductor insertion part 7010d may be formed to be wider than the first-side first conductor insertion part 7010aa in the second direction.

The conductor insertion part 7010 of the present embodiment is configured as a communication part that communicates the inside and the outside of the housing 7. Specifically, a relay communication part is formed on one side and the other side in the second direction of the relay electric apparatus 62, a switching communication part is formed on one side and the other side in the second direction of changeover switch 5, a load communication part is formed on one side and the other side in the second direction of the load electric apparatus 42, and a second communication part is formed on one side and the other side in the second direction of the second electric apparatus 32.

In the present embodiment, the first-side first conductor insertion part 7010aa and the relay conductor insertion part 7010d are configured as relay communication parts.

The switching communication part includes a part of the switching-side first-conductor insertion part 7010ab directly above changeover switch 5 and a switching-side communication part 720 directly below changeover switch 5.

The load communication part of the present embodiment includes a part of the switching-side first conductor insertion part 7010ab directly above the load electric device 42 and the load-side communication part 721 directly below the load electric device 42. The second communication part includes a part of the switching-side first conductive insertion part 7010ab directly above the second electric device 32 and a load-side communication part 721 directly below the second electric device 32. Here, in the present embodiment, the second electric device 32 and the load electric device 42 are arranged side by side in the second direction. Therefore, the load-side communication part 721 is also used as a communication part directly under the load electric device 42 and the second electric device 32.

In the present embodiment, the first circuit part 2, changeover switch 5, the second circuit part 3, and the load circuit part 4 are surrounded in three directions by the first conductor insertion part 7010a, the second conductor insertion part 7010b, the communication part 72, and the relay conductor insertion part 7010d.

The positioning structure 702 includes a second circuit part positioning part 7020 for positioning the second circuit part 3 with respect to the back surface part 701, a load circuit part positioning part 7021 for positioning the load circuit part 4 with respect to the back surface part 701, a changeover switch positioning part 7022 for positioning changeover switch 5 with respect to the back surface part 701, a first circuit part positioning part 7023 for positioning the first circuit part 2 with respect to the back surface part 701, and a relay circuit part positioning part 7024 for positioning the relay circuit part 6 with respect to the back surface part 701.

The second circuit part positioning part 7020 of the present embodiment is configured to position the second electrical device 32.

In addition, the second circuit part positioning part 7020 is configured to abut on two intersecting side surfaces of the second electrical device 32. More specifically, the second circuit part positioning part 7020 has a first contact part 7020a that protrudes from the back surface part 701 toward the front side in the front-rear direction and abuts on the side surface of the second electric device 32 on the one side in the first direction, and a second contact part 7020b that protrudes from the back surface part 701 toward the front side in the front-rear direction and abuts on the side surface of the second electric device 32 on the one side in the second direction.

Load circuit part positioning part 7021 is configured to position the load electric device 42.

In addition, the load circuit part positioning part 7021 is configured to abut on two intersecting side surfaces of the load electric device 42. More specifically, the load circuit part positioning part 7021 includes a first contact part 7021a that protrudes from the back surface part 701 toward the front side in the front-rear direction and abuts on a side surface of the load electrical device 42 on one side in the first direction, and a second contact part 7021b that protrudes from the back surface part 701 toward the front side in the front-rear direction and abuts on a side surface of the load electrical device 42 on one side in the second direction.

The changeover switch positioning part 7022 is configured to abut two intersecting sides of changeover switch 5. More specifically, the changeover switch positioning part 7022 has a first contact part 7022a that protrudes from the back surface part 701 toward the front side in the front-rear direction and abuts on the side surface on one side in the first direction of changeover switch 5, and a second contact part 7022b that protrudes from the back surface part 701 toward the front side in the front-rear direction and abuts on the side surface on one side in the second direction of changeover switch 5.

The first circuit-part positioning part 7023 has a second contact part 7023b that protrudes from the rear surface part 701 toward the front side in the front-rear direction and abuts on the other side surface of the first electric device 22 in the second direction.

The relay circuit part positioning part 7024 has a first contact part 7024a that protrudes from the back surface part 701 toward the front side in the front-rear direction and abuts on a side surface of the relay electric device 62 on one side in the first direction, and a second contact part 7024b that protrudes from the back surface part 701 toward the front side in the front-rear direction and abuts on a side surface of the relay electric device 62 on one side in the second direction.

The inner lid part 71 is attached to the housing part 70 and is configured to cover the front surfaces of the first circuit part 2, the second circuit part 3, the loading circuit part 4, changeover switch 5, and the relay circuit part 6. Further, in the middle cover part 71 of the present embodiment, the windows 710 are formed in accordance with the positions of the non-charging part of the second circuit part 3 (specifically, the operation part of the second electric device 32), the non-charging part of the load circuit part 4 (specifically, the operation part of the load electric device 42), and the non-charging part of the relay circuit part 6 (specifically, the operation part of the relay electric device 62).

The second electric device 32 and the load electric device 42 are arranged in a state in which the operation direction of the operation part is aligned with the first direction, and the relay electric device 62 is arranged in a state in which the operation direction of the operation part is aligned with the second direction. As described above, the second electric appliance 32 and the load electric appliance 42 arranged at the positions close to each other are arranged so that the operation direction of the operation part is the same, and the relay electric appliance 62 arranged at the position away from the second electric appliance 32 and the load electric appliance 42 is arranged so that the operation direction of the operation part is different from the operation direction of the operation part of the second electric appliance 32 and the load electric appliance 42.

As shown in FIG. 119, the cover structure 8 includes a first cover part 80 that covers first conductive connection part 23, a second cover part 81 that covers the second conductive connection part 33, and a third cover part 82 that covers the loaded conductive connection part 43.

The first cover part 80 includes a first protection part 800 that covers the proximal end part of the first conductive part 231, and a second protection part 801 that covers the distal end part of the first conductive part 231 and the second conductive part 232.

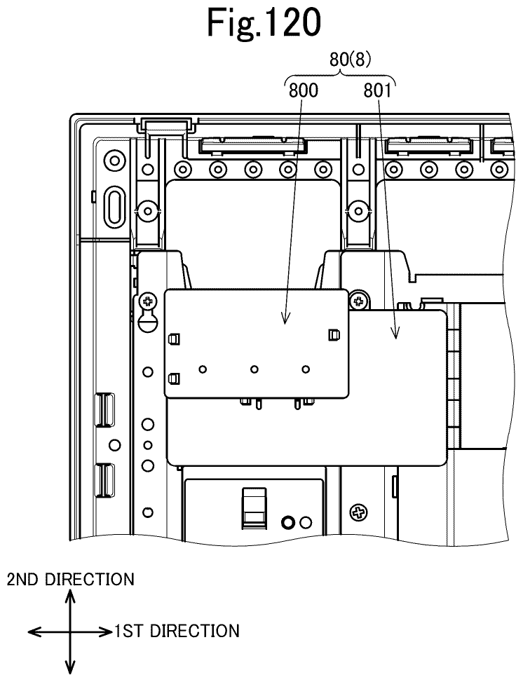

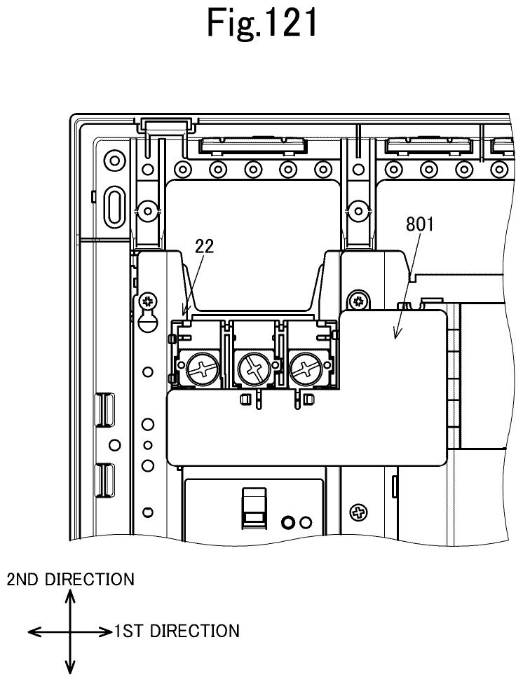

The first protective part 800 and the second protective part 801 are detachable separately, in a state in which the second protective part 801 covers the distal end side and the second conductive part 232 from the front side than the proximal end part of the first conductive part 231, the first protective part 800 covers the proximal end part of the first conductive part 231 from the front side and a closed state in which the first protective part 800 is configured to be switchable to an open state of opening the front of the proximal end part of the first conductive part 231 (see FIGS. 120 and 121).

Further, in a state in which both the first protection part 800 and the second protection part 801 are installed, the first protection part 800 is disposed on the front side in the front-rear direction relative to the second protection part 801, and the outer peripheral edge part of the first protection part and the outer peripheral edge part of the second protection part 801 are in a state of part overlapping with each other.

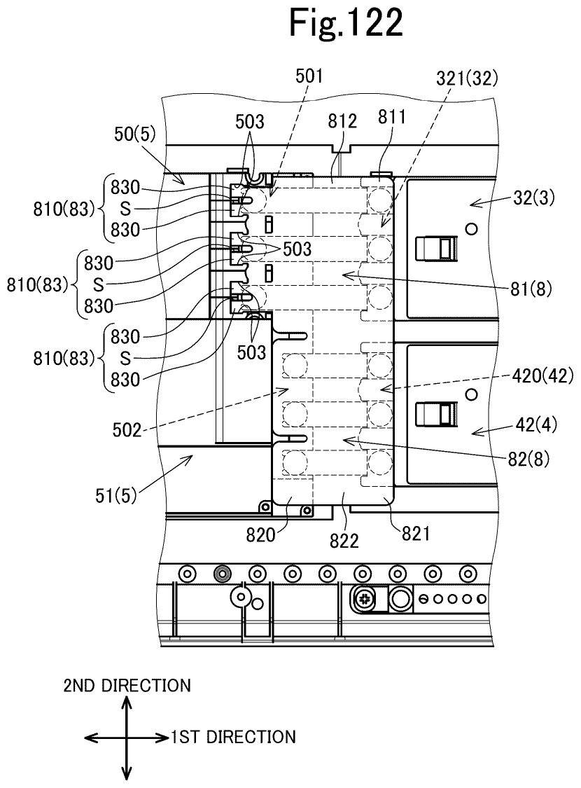

The second cover part 81 and the third cover part 82 are integrally formed by one member, in order to ensure the mounting and fixing of the cover, the second side terminal part 501 for the first phase (first phase terminal part 501a), the second side terminal part 501 for the second phase (second phase terminal part 501b), the second side terminal part 501 for the third phase (third phase terminal part 501c) It is formed with an engaging part that engages the insulating wall for maintaining the insulating between the respective phases. The engagement parts are arranged side by side in the second direction so as to correspond to the second-side terminal part 501 of the respective phases, and end part is formed to extend in the first direction. In addition, end part is provided with slits that divide end part in the second direction, so that it is easy to engage with the insulating walls. Incidentally, the engaging part provided in the second cover part 81 and the third cover part 82, the load-side terminal part 502 for the first phase (first phase terminal part 502a), the load-side terminal part 502 for the second phase (second phase terminal part 502b), the load-side terminal part 502 for the third phase (third phase terminal part 502c) may be formed with an engaging part that engages with the insulating walls for maintaining the insulating between the respective phases. The second cover part 81 and the third cover part 82 are integrally formed, but the second cover part 81 and the third cover part 82 may be separate members (see FIG. 122).

In the present embodiment, since the first side terminal part 500 disposed toward the device primary terminal part 220 can be connected along the first direction to end part 2310 of the first conductive part 231 extending in the first direction, a clearance for inserting the first conductive P110 into the inside and outside of the housing 7 can be secured on one side in the second direction of the first electric device 22 and changeover switch 5. In particular, as shown in FIGS. 114 and 118, when the first conductor P110 is linear (e.g., formed by bundling a plurality of metal wires), a clearance for bending the first conductor P110 can be secured on one side of the first electric device 22 and changeover switch 5 in the second direction.

In addition, since the device primary terminal part 220 is disposed toward one side in the second direction, the first conductor 7010a and the device primary terminal part 220 can be connected to each other by using a space on one side in the first direction between the first electric device 22 and P110 of changeover switch 5 while taking into account the bending radius of the first conductor inserted from the first conductor insertion part P110 to the inside of the housing 7, the positions of various electric devices and changeover switch 5, and the like.

Further, the device primary terminal part 220 disposed toward one side in the second direction is connected to the first conductive P110 in the second direction, and the first side terminal part 500 is connected along the first direction with end part 2310 of the first conductive part 231, whereby the power flow from the outside of the housing 7 is performed in the second direction, and the electrical connection between the first electric device 22 and changeover switch 5 inside the housing 7 can be performed in the first direction. Therefore, the first conductive P110 and the first circuit part 2, the first circuit part 2, and changeover switch 5 can be visually distinguished from each other.

Further, since the switching-side first conductor insertion part 7010ab is formed on one side of the second electric device 32 and the load electric device 42 in the second direction, the first conductor P110 can be inserted from the outside to the inside of the housing 7 via the switching-side first conductor insertion part 7010ab.

Further, since the first conductor insertion part 7010a is formed on one side of the first electric device 22 and changeover switch 5 arranged side by side in the first direction and the second electric device 32 in the second direction, the first conductor P110 is easily inserted from the outside to the inside of the housing 7.

Further, the switching-side first conductor insertion part 7010ab is disposed directly above changeover switch 5 and the second electric device 32, so that the switching-side first conductor insertion part 7010ab is formed to be wide in the first direction, and the first conductor P110 is easily inserted into the housing 7.

Further, the first side first conductor insertion part 7010aa, in the second direction, since it is formed wider than the relay conductor insertion part 7010d, via the first side first conductor insertion part 7010aa, the first conductor P110 inside the housing 7 easily inserted.

Further, it is easy to connect to the device primary terminal part 320 and the load device secondary terminal part 421 via the second conductor insertion part 7010b and the load conductor insertion part 7010c formed on the other side in the first direction of each of the device primary terminal part 320 and the load device secondary terminal part 421, respectively, the second conductor P220 and the load conductor W110 inserted into the inside of the housing 7.

Further, since the load conductor insertion part 7010c and the second conductor insertion part 7010b are formed so as to extend to one side and the other side in the second direction, via the load conductor insertion part 7010c and the second conductor insertion part 7010b, respectively, the second conductor P220 and the load conductor W110 bending radius and the position of the respective electric devices while taking into account, respectively, the second conductor P220 and the load conductor W110 can be inserted from the outside to the inside of the housing 7, it is easy to perform the wiring operation.

As described above, according to the present embodiment, it is possible to insert the first conductor changeover switch 5 or the first conductor insertion part 7010a on one side of the first electric device 22 in the second direction into the outer side and the inner side of the housing 7, and considering the bending radii of the first conductor P110, the positions of the first electric device 22 and changeover switch 5, and the like, it is easy to wire the first conductor P110.

Further, in the present embodiment, changeover switch 5 is disposed on one side in the first direction, the load electric device 42 is disposed on the other side in the first direction, and the housing 7 has the load conductor insertion part 7010c formed on the other side in the first direction of the load electric device 42, so that the load conductor W110 can be inserted into the outer side and the inner side of the housing 7 from the load conductor insertion part 7010c formed in the first direction in which changeover switch 5 and the load electric device 42 are arranged side by side.

Further, by the load conductor insertion part 7010c extends to one side and the other side in the second direction, it is possible to secure a space for inserting the load conductor W110 to the outside and the inside of the housing 7, considering the bending radius of the load conductor W110, the load conductor W110 can be inserted from the outside to the inside of the housing 7.

Further, in the present embodiment, the second electric device 32 and the load electric device 42 are arranged side by side in the second direction, and since the second conductor insertion part 7010b is formed on the other side in the first direction of the second electric device 32 in the housing 7, the second conductor P220 and the load conductor W110 can be inserted into the housing 7 from the second conductor insertion part 7010b and the load conductor insertion part 7010c on the other side in the first direction of the second electric device 32 and the load electric device 42 arranged in the second direction, respectively.

Further, since the second conductor insertion part 7010b and the load conductor insertion part 7010c are also used, the load conductor W110 can be inserted from the outside to the inside of the housing 7 while considering the bending radii and the arrangement of the second conductor P220.

As described above, in the present embodiment, a space for inserting the load conductor W110 can be secured inside the housing 7, and the load conductor W110 can be inserted from the outside to the inside of the housing 7 in view of the bending radii and the arrangement of the load conductor W110.

Further, the housing 7 of the present embodiment, since the switching communication part is formed on one side and the other side of the second direction of changeover switch 5, the air flowing inside the housing 7 through the switching communication part of the other side of the second direction, the second by flowing to the outside of the housing 7 through the switching communication part of the one side of the direction, the inside of the housing 7 by flowing air in the second direction can replace the air inside the housing 7.

Further, since changeover switch 5 and the load electric device 42 are arranged side by side in the first direction in the housing 7, the airflow inside the housing 7 can be made in the second direction perpendicular to the first direction in which changeover switch 5 and the load electric device 42 are arranged.

Further, since the load communication part is formed on one side and the other side in the second direction of the load electric apparatus 42, the air flowing inside the housing 7 through the switching communication part and the load communication part on the other side in the second direction flows to the outside of the housing 7 through the switching communication part and the load communication part on the one side in the second direction, so that more air can flow in a direction perpendicular to the direction in which changeover switch 5 and the load electric apparatus 42 are arranged side by side, and the air inside the housing 7 can be replaced more.

In particular, since the load electric device 42 receiving electric power from changeover switch 5 generates the most heat in the housing 7, the load communication part is formed on one side and the other side of the load electric device 42 in the second direction, so that the heat generated by the load electric device 42 can be dissipated.

Further, the switching main body part on one side in the second direction, since the switching control part is disposed on the other side, respectively, for example, via the switching communication part on the other side in the second direction, air flowing to the inside of the housing 7, by flowing from one side in the second direction to the outside of the housing 7, it is possible to flow air in the other direction inside the housing 7.

Further, since the relay communication part is formed on one side and the other side in the second direction of the relay electric apparatus 62, the outer side flowing inside the housing 7 flows from one side in the second direction to the outside of the housing 7 through the relay communication part on the other side in the second direction, whereby the air inside the housing 7 can be exchanged, and since changeover switch 5 and the relay electric apparatus 62 are arranged side by side in the first direction, the air can flow in the second direction perpendicular to the first direction in which changeover switch 5 and the relay electric apparatus 62 are arranged.

Therefore, according to the present embodiment, since the switching communication part is formed on one side and the other side of changeover switch 5 in the second direction, the air inside the housing 7 can be exchanged, and the heat inside the housing 7 can be dissipated.

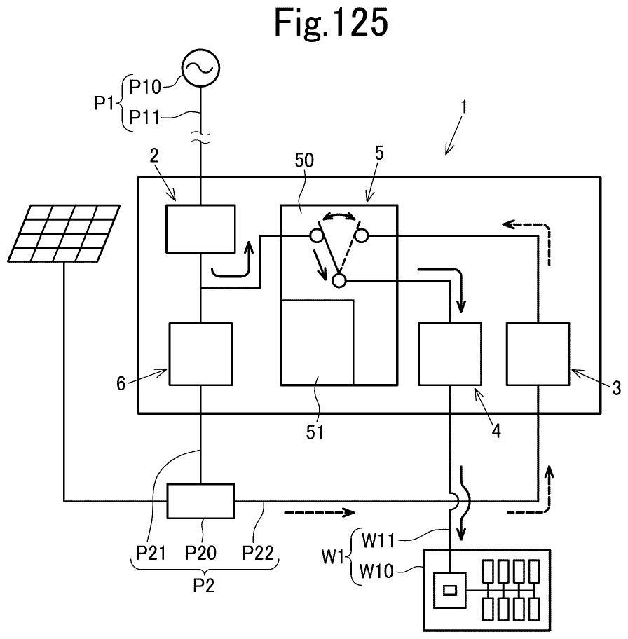

Next, changeover switch built-in board 1 according to the second embodiment of the present disclosure will be described referring to FIGS. 125 to 127. Note that, in describing changeover switch built-in board 1 according to the second embodiment, configurations and operations that differ from those of changeover switch built-in board 1 according to the first embodiment will be described, and descriptions of the same configurations and operations will be omitted.

In the second circuit part 3 of the second embodiment, the device primary terminal part 320 and the device secondary terminal part 321 are arranged side by side in the second direction, and the arrangement position of the device primary terminal part 320 in the first direction and the arrangement position of the device secondary terminal part 321 in the first direction are the same. In the second embodiment, the device primary terminal part 320 is disposed to face the other side in the second direction, and the device secondary terminal part 321 is disposed to face the one side in the second direction. Further, the second electric device 32 of the second embodiment is disposed on the other side of the switching control part 51 in the first direction.

In a second embodiment, the first phase terminal part 320a, the second phase terminal part 320b, and the third phase terminal part 320c of the device primary terminal part 320 are arranged to align with each other in a first direction. In addition, the first phase terminal part 321a, the second phase terminal part 321b, and the third phase terminal part 321c of the device secondary terminal part 321 are arranged so as to be aligned with each other in the first direction.

The second conductive connection part 33 of the second embodiment extends in the first direction and the second direction, and tlms differs from the first embodiment. The second conductive connection part 33 includes one end 330 connected to the second-side terminal part 501, a second conductive part 331 extending from the one end 330 in the second direction, a first conductive part 332 extending in the first direction continuously with the second conductive part 331, and the other end 333 connected to the device secondary terminal part 321.

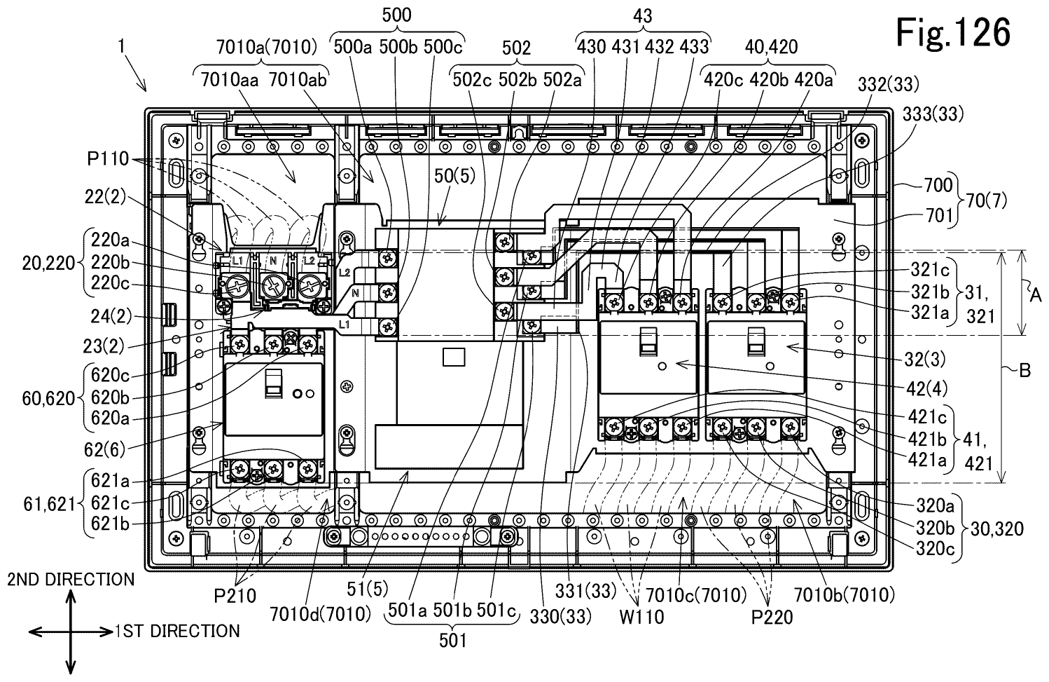

Specifically, as shown in FIG. 126, the second conductive part 331 extends from one end 330 extending in the first direction to one side in the second direction, the first conductive part 332 extends from the second conductive part 331 to the other side in the first direction, and the other end 333 extends from the first conductive part 332 to the other side in the second direction.

The second circuit part 3 of the second embodiment also has three second conductive connection part 33 (not shown, but a first phase conductive connection 33a, a second phase conductive connection 33b, and a third phase conductive connection 33c). Further, in the three second conductive connection part 33, one end part 330 is aligned along the second direction, the second conductive part 331 are aligned along the first direction, the first conductive part 332 are aligned along the second direction, and the other end parts 333 are aligned along the first direction.

In the load circuit part 4 of the second embodiment, the load device primary terminal part 420 and the load device secondary terminal part 421 are arranged to be aligned in the second direction, and the arrangement position of the load device primary terminal part 420 in the first direction and the arrangement position of the load device secondary terminal part 421 in the first direction are the same. In the second embodiment, the load device primary terminal part 420 is provided at one end of the load electrical device 42 in the second direction, and the load device secondary terminal part 421 is provided at the other end of the load electrical device 42 in the second direction. Further, the load electrical device 42 of the second embodiment is disposed on the other side of the switching control part 51 in the first direction.

The load electrical device 42 of the second embodiment is arranged so as to be arranged at a position spaced apart from the second electrical device 32 in the first direction. The load-electric device 42 is disposed on the other side of changeover switch 5 in the first direction. The load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

Further, in the second embodiment, the first phase terminal part 420a, the second phase terminal part 420b, and the third phase terminal part 420c of the primary terminal part 420 are arranged in the first direction. The first phase terminal part 421a, the second phase terminal part 421b, and the third phase terminal part 421c of the secondary terminal part 421 are also arranged (aligned) in the first direction.

The conductive connection part 43 of the second embodiment extends in the first direction and the second direction, and thus differs from the first embodiment. As shown in FIG. 126, the load conductive connection part 43 includes one end 430 connected to the load-side terminal part 502, a second conductive part 431 extending in the second direction from the one end 430, a first conductive part 432 extending in the first direction from the second conductive part 431, and the other end 433 connected to the load device primary terminal part 420.

Specifically, the second conductive part 431 extends from one end 430 extending in the first direction to one side in the second direction, the first conductive part 432 extends from the second conductive part 431 to the other side in the first direction, and the other end 433 extends from the first conductive part 432 to the other side in the second direction.

The load circuit part 4 of the second embodiment also has three load conductive connection part 43 (a first phase conductive connection 43a, a second phase conductive connection 43b, and a third phase conductive connection 43c). Further, in the three load-conducting connection part 43, one end part 430 is aligned along the second direction, the second conductive part 431 are aligned along the first direction, the first conductive part 432 are aligned along the second direction, and the other end parts 433 are aligned along the first direction.

As shown in FIG. 126, the loaded conductive connection part 43 of the second embodiment is disposed in front of the second conductive connection part 33 in the front-rear direction in the housing 7. Therefore, the loaded conductive connection part 43 and the second conductive connection part 33 overlap each other in the front-rear direction while the inside of the housing 7 is viewed from the front.

In changeover switch 5 of the second embodiment, the load-side terminal part 502 is disposed at one end of the first embodiment in the second direction. Here, as shown in FIG. 126, in the load-side terminal part 502, the second phase terminal part 502b and the third phase terminal part 502c are disposed in the band-shaped area A. Therefore, the load-side terminal part 502 of the second embodiment is disposed at substantially the same position as the second-side terminal part 501 in the second direction. Specifically, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a.

The load-side terminal part 502 of the second embodiment is disposed on one side of the second side terminal part 501 in the first direction. Further, the load-side terminal part 502 is disposed forward and backward of the second-side terminal part 501. Therefore, as shown in FIG. 126, in the second embodiment, one end part 430 connected to the second side terminal part 501 is disposed rearward and one end part 430 connected to the load-side terminal part 502 is disposed forward in the front-rear direction.

The second-side terminal part 501 and the load-side terminal part 502 of the second embodiment are arranged in the same direction in the first direction. Further, in the second embodiment, unlike the first embodiment, the second side terminal part 501 and the load side terminal part 502 are disposed to face the other side in the first direction, and second secondary terminal part 31 and the load primary terminal part 40 are disposed to face the one side in the second direction.

As shown in FIG. 125, the switching control part 51 of the second embodiment is configured to switch the switching main body 50 between the first power supply state and the second power supply state by operating the switching main body 50 in the same manner as the first embodiment.

The switching-side first conductive insertion part 7010ab of the second embodiment is disposed over changeover switch 5, the load-side electric device 42, and the second electric device 32. In addition, as in the first embodiment, the switching-side first conductive insertion part 7010ab is formed to cover the entire area of changeover switch 5 and the second electric device 32 in the first direction. Here, the switching-side first conductive insertion part 7010ab of the second embodiment is formed so as to extend over the entire area of the load-electric device 42 in the first direction. Therefore, the switching-side first conductive insertion part 7010ab of the second embodiment is formed to correspond to the entire length of changeover switch 5, the second electric device 32, and the loading electric device 42 in the first direction.

The second conductor-insertion part 7010b of the second embodiment is provided on the other side of the strip-shaped area A and the device primary terminal part 320 of the second electric device 32 in the second direction. The second conductive insertion part 7010b is formed to extend in the first direction. Therefore, in the second embodiment, the second conductor P220 can be inserted into and out of the housing 7 via the second conductor insertion part 7010b on the other side in the second direction.

The load conductor insertion part 7010c of the second embodiment is provided on the other side in the second direction than the load device secondary terminal part 421 of the load electric device 42. The load-conductor insertion part 7010c is formed so as to extend in the first direction. Therefore, in the second embodiment, the load conductor W110 can be inserted into and out of the housing 7 via the load conductor insertion part 7010c on the other side in the second direction.

The load-conductor insertion part 7010c and the second conductor insertion part 7010b of the second embodiment are formed so as to be aligned in the first direction, and are continuous with each other. Further, the load conductor insertion part 7010c and the second conductor insertion part 7010b of the second embodiment are disposed over changeover switch 5, the load electric device 42, and the second electric device 32. Therefore, the load-conductor insertion part 7010c and the second conductor insertion part 7010b are formed so as to extend to one side and the other side in the first direction. Further, the load-conductor insertion part 7010c and the second conductor insertion part 7010b of the second embodiment are formed to have substantially the same length as the switching-side first conductor insertion part 7010ab in the first direction.

Therefore, the second conductor insertion part 7010b of the second embodiment extends to one side in the first direction from the second electric device 32, and the load conductor insertion part 7010c extends to one side and the other side in the first direction from the load electric device 42. Specifically, the second conductor insertion part 7010b and the loaded conductor insertion part 7010c extend from the other side of the second electric device 32 in the second direction to the other side of changeover switch 5 in the second direction. The load conductor insertion part 7010c may be configured to extend from the other side of the load electric device 42 in the second direction to the other side of changeover switch 5 in the second direction.

In addition, the load-conductor insertion part 7010c and the second conductor insertion part 7010b of the second embodiment are formed to be larger than the switching-side first conductor insertion part 7010ab in the second direction.

Unlike the first embodiment, the continuous insertion part (not numbered) of the second embodiment is formed so as to correspond to the entire area of the second electric device 32 and the load electric device 42 arranged side by side in the first direction in the first direction. Specifically, the continuous insertion part is formed so as to extend from a position immediately below the second electric device 32 to a position immediately below the load electric device 42 in the first direction.

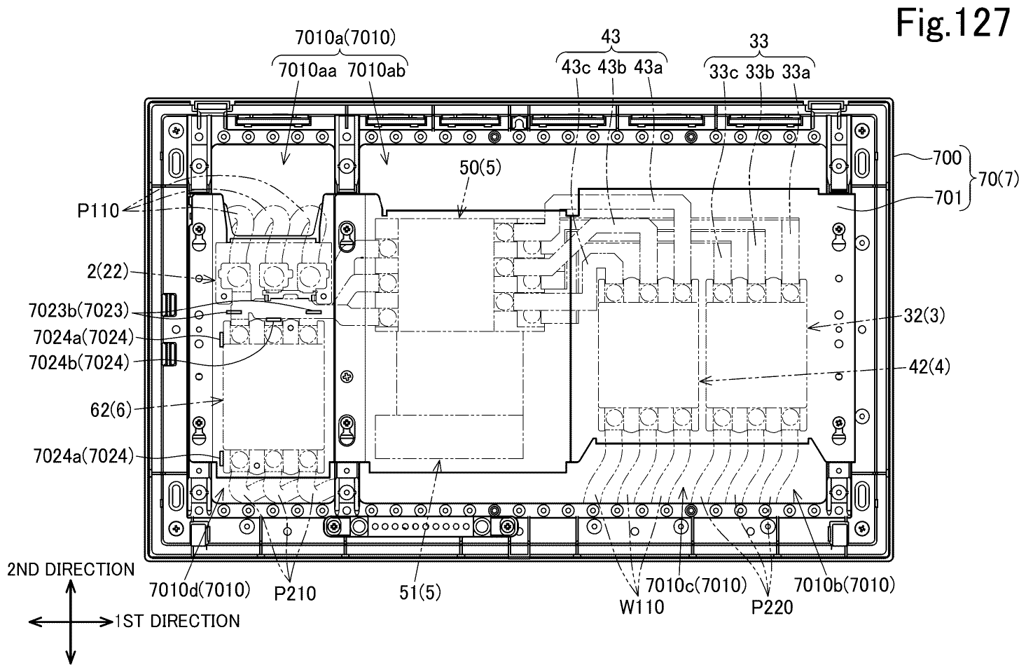

As illustrated in FIG. 127, the positioning structure 702 of the second embodiment includes a first circuit-part positioning part 7023 and a relay circuit part positioning part 7024. Although FIG. 127 omits the second circuit part position determination part 7020, the load circuit part positioning part 7021, and the changeover switch positioning part 7022, the position determination structure 702 may include the second circuit part position determination part 7020, the load circuit part positioning part 7021, and the changeover switch positioning part 7022.

In the second embodiment, the second electric device 32 and the loading electric device 42 are arranged such that the operation direction of the operation part is aligned with the second direction. Therefore, in the second embodiment, the second electric device 32, the load electric device 42, and the relay electric device 62 are arranged in the same direction as the operation direction of the operation part.

In the second embodiment, the load electrical device 42 and the second electrical device 32 are arranged side by side in the first direction. For this reason, the load communication part and the second communication part of the second embodiment are arranged side by side in the first direction.

In the second embodiment, the load conductor insertion part 7010c and the second conductor insertion part 7010b are formed larger than the switching-side first conductor insertion part 7010ab in the second direction, and therefore, from each of the load conductor insertion part 7010c and the second conductor insertion part 7010b, the second conductor P220 and the load conductor W110 are easily inserted from the outside to the inside of the housing 7.

In the second embodiment, in the second direction, the third phase terminal part 502c is disposed between the second phase terminal part 501b and the third phase terminal part 501c, the second phase terminal part 502b is disposed between the first phase terminal part 501a and the second phase terminal part 501b, and the first phase terminal part 502a is disposed on one side of the first phase terminal part 501a. Further, the load-side terminal part 502 is disposed forward and backward of the second-side terminal part 501. Therefore, it is possible to secure an insulating distance between the load-side terminal part 502 and the second-side terminal part 501 which are arranged at substantially the same position in the second direction.

Changeover switch 5 is disposed on one side of the first direction, the load electric device 42 is disposed on the other side of the first direction, and the housing 7 has the load conductor insertion part 7010c formed on the other side of the load electric device 42 in the second direction, so that the load conductor W110 can be inserted into the outer side and the inner side of the housing 7 from the load conductor insertion part 7010c formed in the second direction perpendicular to the first direction in which changeover switch 5 and the load electric device 42 are disposed side by side.

Further, by the load conductor insertion part 7010c extends to one side and the other side of the first direction, it is possible to secure a space for inserting the load conductor W110 to the outside and the inside of the housing 7, considering the bending radius of the load conductor W110, the load conductor W110 can be inserted from the outside to the inside of the housing 7.

Further, since changeover switch 5, the second electric device 32, and the load electric device 42 are arranged side by side in the first direction, and the second conductor insertion part 7010b is formed on the other side in the second direction of the second electric device 32 in the housing 7, the second conductor P220 and the load conductor W110 can be inserted into the housing 7 from the second conductor insertion part 7010b and the load conductor insertion part 7010c on the other side in the second direction of the second electric device 32 and the load electric device 42 arranged in the first direction, respectively.

Further, since the second conductor insertion part 7010b and the load conductor insertion part 7010c are also used, also when inserting the load conductor W110 from the load conductor insertion part 7010c to the outside and inside of the housing 7, so that the load conductor W110 is not damaged, while giving a margin in bending of the load conductor W110, the load conductor W110 can be inserted from the outside to the inside of the housing 7.

Next, a changeover switch built-in board according to a third embodiment of the present disclosure will be described. In describing changeover switch built-in board 1 according to the third embodiment, configurations and operations that differ from those of changeover switch built-in board 1 according to the first and second embodiments will be described, and description of the same configurations and operations will be omitted.

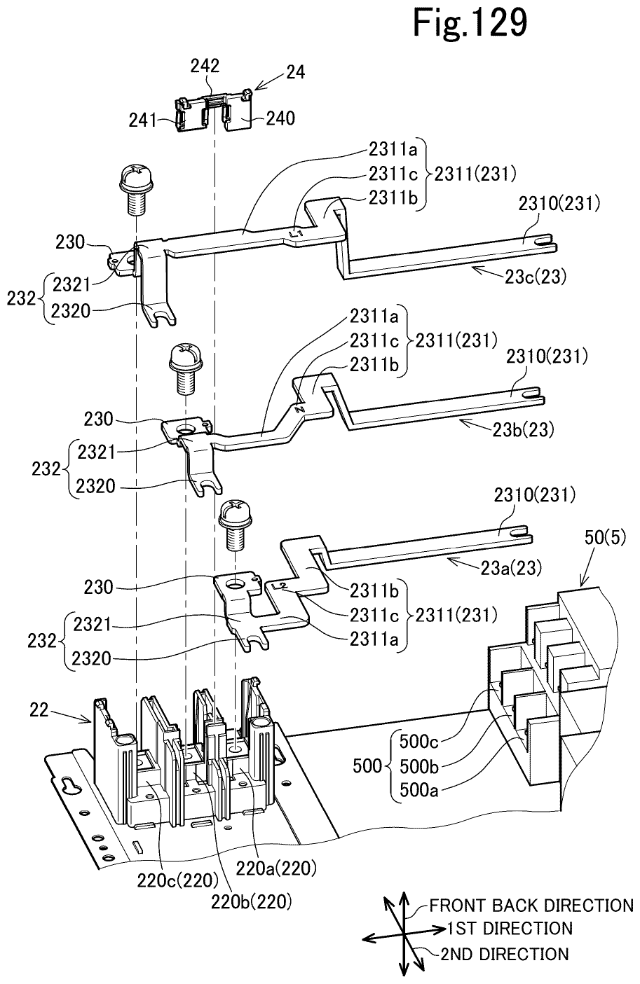

As shown in FIG. 129, first conductive connection part 23 of the third embodiment differs in form from the first embodiment and the second embodiment. Specifically, end part 2310 is formed longer in the first direction than in the first and second embodiments. In addition, unlike the first embodiment and the second embodiment, the distal end-side conductive part 2311b is formed to be long in the second direction.

In the second circuit part 3 of the third embodiment, as in the second embodiment, the device primary terminal part 320 and the device secondary terminal part 321 are arranged so as to be aligned in the second direction. Further, the device primary terminal part 320 is disposed to face the other side in the second direction, and the device secondary terminal part 321 is disposed to face the one side in the second direction.

In the third embodiment, the second electric device 32 is arranged so that the device secondary terminal part 321 is arranged on the other side of the second side terminal part 501 of changeover switch 5 in the second direction. Specifically, the second electrical device 32 is disposed on the other side of the switching control part 51 in the first direction.

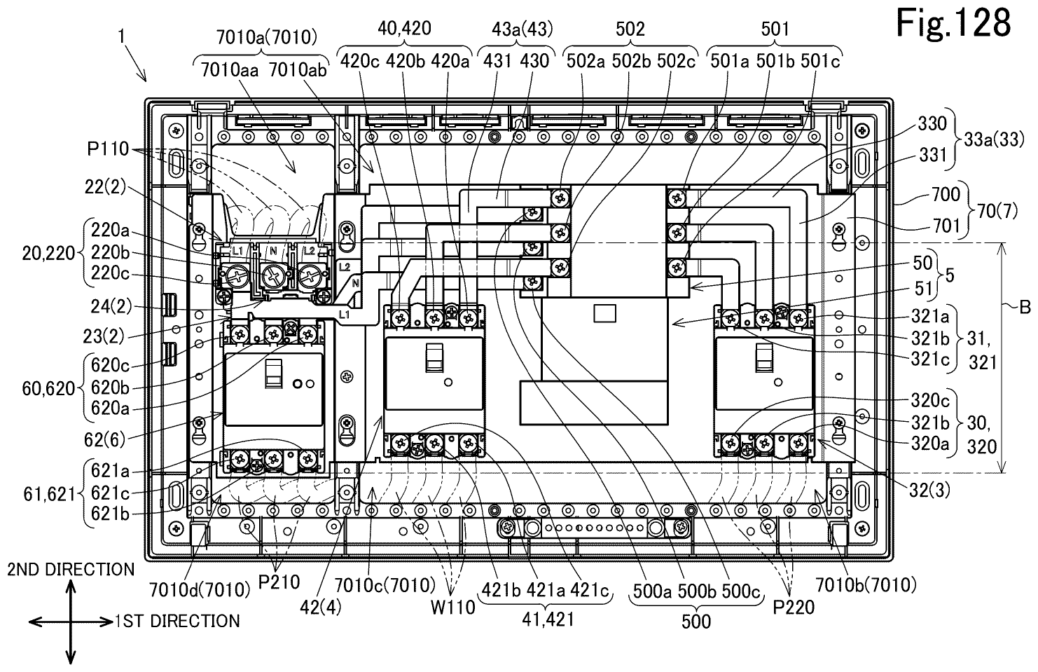

The second conductive connection part 33 of the third embodiment is shaped differently from the first embodiment and the second embodiment. The second conductive connection part 33 includes one end 330 connected to the second-side terminal part 501 and the other end 331 connected to the device secondary terminal part 321. As shown in FIG. 128, one end 330 extends in a first direction and the other end 331 extends in a second direction. The second conductive connection part 33 has one end part 330 and the other end part 331 formed continuously.

The second circuit part 3 of the third embodiment also has three second conductive connection part 33 (not shown, but a first phase conductive connection 33a, a second phase conductive connection 33b, and a third phase conductive connection 33c). In the three second conductive connection part 33, one end part 330 is aligned along the second direction, and the other end parts 331 are aligned along the first direction.

In the load circuit part 4 of the third embodiment, similarly to the second embodiment, the load device primary terminal part 420 and the load device secondary terminal part 421 are arranged so as to be aligned in the second direction. Further, the load device primary terminal part 420 is disposed to face one side in the second direction, and the load device secondary terminal part 421 is disposed to face the other side in the second direction.

The loading circuit part 4 of the third embodiment is arranged on one side of changeover switch 5 in the first direction. Specifically, as shown in FIG. 128, the load electrical device 42 is disposed between the relay electrical device 62 and the switching control part 51 in the first direction. Therefore, in the third embodiment, the loading electrical device 42 is spaced apart from the second electrical device 32 in the first direction with respect to changeover switch 5. Further, the load electric appliance 42 is arranged such that the load appliance primary terminal part 420 is arranged on the other side of the load side terminal part 502 of changeover switch 5 in the second direction.

In addition, in the third embodiment, the load device primary terminal part 420 and the device secondary terminal part 321 of the second electrical device 32 are aligned in the first direction, and the load device secondary terminal part 421 and the device primary terminal part 320 of the second electrical device 32 are aligned in the first direction.

Connection part 43 of the third embodiment differs from the first and second embodiments in form. The load conductive connection part 43 includes one end 430 connected to the load-side terminal part 502 and the other end 431 connected to the load device primary terminal part 420. As shown in FIG. 128, one end 430 extends in a first direction and the other end 431 extends in a second direction. The loaded conductive connection part 43 has one end part 430 and the other end part 431 formed continuously.

As shown in FIG. 128, the loaded conductive connection part 43 of the third embodiment is disposed in front of first conductive connection part 23 in the front-rear direction in the housing 7. Therefore, the loaded conductive connection part 43 and first conductive connection part 23 overlap each other in the front-rear direction while the inside of the housing 7 is viewed from the front.

In changeover switch 5 of the third embodiment, unlike the second embodiment, the second side terminal part 501 and the load-side terminal part 502 are provided at separate ends in the first direction of changeover switch 5. Specifically, the load-side terminal part 502 is arranged so as to face one side of the first direction and one side of the first direction than the second-side terminal part 501.

In addition, in the third embodiment, the first side terminal part 500 and the second side terminal part 501 are disposed at different positions in the second direction. Here, the load-side terminal part 502 and the second-side terminal part 501 are arranged side by side in the first direction. Therefore, in the second direction, the third phase terminal part 502c is disposed between the second phase terminal part 500b and the third phase terminal part 500c, the second phase terminal part 502b is disposed between the first phase terminal part 500a and the second phase terminal part 500b, and the first phase terminal part 502a is disposed on one side of the first phase terminal part 500a.

Further, in the third embodiment, the load-side terminal part 502 is disposed forward and backward of the first-side terminal part 500. Therefore, as shown in FIG. 128, in the third embodiment, in the front-rear direction, one end part 430 connected to the load-side terminal part 502 and end part 2310 connected to the first-side terminal part 500 are disposed on the rear side is disposed on the front side.

As in the second embodiment, the switching-side first conductive insertion part 7010ab of the third embodiment is disposed over changeover switch 5, the load-side electric device 42, and the second electric device 32.

The second conductive insertion part 7010b of the third embodiment is provided on the other side of the second electric device 32 in the second direction with respect to the device primary terminal part 320 as in the second embodiment. Further, the second conductive insertion part 7010b is formed so as to extend to one side in the first direction. The second conductive insertion part 7010b of the third embodiment extends from the other side in the second direction of the second electric device 32 to the other side in the second direction of the loading electric device 42 via the other side in the second direction of changeover switch 5.

As in the second embodiment, the load conductor insertion part 7010c of the third embodiment is provided on the other side of the load device secondary terminal part 421 of the load electric device 42 in the second direction. The load-conductor insertion part 7010c is formed so as to extend to the other side in the first direction. The load conductor insertion part 7010c extends from the other side in the second direction of the load electrical device 42 to the other side in the second direction of the second electrical device 32 via the other side in the second direction of changeover switch 5. Further, the load conductor insertion part 7010c is formed on the other side of the relay conductor insertion part 7010d in the first direction with a part of the back surface part 701 along a virtual straight line in the second direction passing between the relay electric device 62 and the load electric device 42 as a border.

The load-conductor insertion part 7010c and the second conductor insertion part 7010b of the third embodiment are formed so as to be aligned in the first direction, as in the second embodiment, and are continuous with each other. In addition, the load-conductor insertion part 7010c and the second conductor insertion part 7010b are formed to have substantially the same length as the switching-side first conductor insertion part 7010ab in the first direction.

As in the second embodiment, the continuous insertion part (not numbered) of the third embodiment is formed so as to extend from directly under the second electric device 32 to directly under the load electric device 42. Here, in the third embodiment, changeover switch 5 is disposed between the loading circuit part 4 and the second circuit part 3. Therefore, unlike the second embodiment, the continuously inserted part of the third embodiment is formed so as to extend directly under the second electric device 32, changeover switch 5, and the loading electric device 42.

In the third embodiment, the second electric device 32 is arranged such that the device secondary terminal part 321 is arranged on the other side in the second direction than the second side terminal part 501 of changeover switch 5, and the load electric device 42 is arranged such that the load device primary terminal part 420 is arranged on the other side in the second direction than the load side terminal part 502 of changeover switch 5. Therefore, as shown in FIG. 128, the second conductive connection part 33 and the loaded conductive connection part 43 can have a simple configuration including one end part 330 and 430 extending in the first direction and 331,431 extending in the second direction.

Note that changeover switch built-in board is not limited to the first embodiment, the second embodiment, and the third embodiment (hereinafter, referred to as the above embodiment), and various modifications can be made.

In the above-described embodiment, the first power supply system P1 is a commercial power supply system, and the second power supply system P2 is a power supply system including a distributed power supply, but the first power supply system P1 may be a type of power supply system other than the commercial power supply system, or the second power supply system P2 may be a type of power supply system other than the power supply system including a distributed power supply. For example, the first power supply system P1 and the second power supply system P2 may have different power supply configurations, that is, the first power supply system P1 may be a DC power supply, the second power supply system P2 may be an AC power supply, and both the first power supply system P1 and the second power supply system P2 may be DC. As a result, power sources having different characteristics can be connected and switched according to the load to be connected, and various power sources can be supplied to the load.

In the above-described embodiment, the second power supply system P2 is one in which a solar cell is connected to the second power supply P20 (photovoltaic power generation system), but is not limited to this configuration. For example, the second power supply system P2 may include a storage battery in which the second power supply P20 is mounted on an electric vehicle.

In the above embodiment, the second power supply system P2 is a rechargeable power supply system in which the second power supply P20 is rechargeable, but is not limited to this configuration. In the second power supply system P2, for example, the second power supply P20 may have only a power generation function.

In the above embodiment, changeover switch built-in board 1 is installed in a house, but for example, changeover switch built-in board 1 may be installed in a factory or the like. In addition, the present invention is not limited to being installed inside a building, and may be installed outside the building.

In addition, although only the power outputted from the first circuit part 2 flows in the relay circuit part 6 of the above-described embodiment, for example, the power directed to the first circuit part 2 may flow.

In the above-described embodiment, the second electric device 32 is a circuit breaker, but is not limited to this configuration. For example, the second electrical device 32 may be another type of electrical device. The same applies to the relay electric device 62 and the load electric device 42. Although the first electric device 22 is a terminal block, it may be constituted by an electric device such as a circuit breaker.

The device primary terminal part 220 of the first electric device 22 is configured to fix first conductive connection part 23 by screws, but may be configured to fix first conductive connection part 23 by means other than screws, for example. That is, the device primary terminal part 220 of the first electric device 22 may be configured by a terminal part other than a screw connection such as a plug-in connection, instead of a screw-type terminal part. The same applies to the device primary terminal part 320 and the secondary device terminal part 321 of the second electric device 32, the load device primary terminal part 420 and the load device secondary terminal part 421 of the load electric device 42, the first side terminal part 500 of changeover switch 5, the second side terminal part 501, the load side terminal part 502, and the device primary terminal part 620 and the device secondary terminal part 621 of the relay electric device 62.

In the above embodiment, the device primary terminal part 220 of the first electric device 22 is configured to have the first phase terminal part 220a, the second phase terminal part 220b, and the third phase terminal part 220c, but is not limited to this configuration. For example, in the case of having only the first phase terminal part 220a, in addition to the case of having the first phase terminal part 220a and the second phase terminal part 220b, in the case of having the first phase terminal part 220a, the second phase terminal part 220b, and the third phase terminal part 220c, it may also be a case of having the fourth phase terminal part. That is, the device primary terminal part 220 may include at least a first phase terminal part 220a.

In the above embodiment, the first conductive part 231 and the second conductive part 232 are integrally formed in first conductive connection part 23, but the configuration is not limited thereto. For example, the first conductive part 231 and the second conductive part 232 may be formed by combining components formed separately.

In the above embodiment, first conductive connection part 23 is made of a conductive plate material, but is not limited to this configuration. First conductive connection part 23 may be formed of a wire.

In addition, the second conductive part 232 may be integrally formed with the first conductive part 231 as in the above-described embodiment, or may be separately attached to the first conductive part 231.

In the above embodiment, the first circuit part 2 is configured to have three first conductive connection part 23, but is not limited to this configuration, for example, the first circuit part 2 may be configured to have one first conductive connection part 23, or may be configured to have two or four or more first conductive connection part 23. That is, the first circuit part 2 may be configured to have at least one first conductive connection part 23.

Although not specifically mentioned in the above embodiment, in addition to the first power supply state and the second power supply state, changeover switch 5 may be configured such that the load circuit part 4 can be switched to the first power supply system P1 or the neutral state not electrically connected to the second power supply system P2. As a result, the load circuit part 4 can be electrically disconnected from the first power supply system P1 and the second power supply system P2, and can further improve electric safety such as when inspecting the load device or the like connected to the load circuit part 4.

Although not specifically mentioned in the above embodiment, first conductive connection part 23 may be configured so that the second conductive part 232 is also screwed to the first electric device 22. In this case, for example, as shown in FIGS. 125 and 126, the first electrical device 22 may be provided with a fixing base part 25 having a screw hole formed therein.

In the above embodiment, changeover switch 5 is arranged in the first direction with respect to the first circuit part 2, and the relay circuit part 6 is arranged in the second direction with respect to the first circuit part 2. For example, changeover switch 5 may be arranged in the second direction with respect to the first circuit part 2, and the relay circuit part 6 may be arranged in the first direction with respect to the first circuit part 2.

That is, it is sufficient that one of changeover switch 5 and the relay circuit part 6 is arranged in the first direction with respect to the first circuit part 2, and the other is arranged in the second direction with respect to the first circuit.

When changeover switch 5 is arranged to be aligned in the first direction with respect to the first circuit part 2, it may be arranged on the other side in the first direction than the first circuit part 2 as in the above embodiment, or may be arranged on the one side in the first direction than the first circuit part 2. In addition, when changeover switch 5 is arranged to be aligned in the second direction with respect to the first circuit part 2, it may be arranged on one side in the second direction rather than the first circuit part 2, or may be arranged on the other side in the second direction than the first circuit part 2.

When the relay circuit part 6 is arranged to be aligned in the second direction with respect to the first circuit part 2, it may be arranged on the other side in the second direction than the first circuit part 2 as in the above-described embodiment, or may be arranged on the one side in the second direction than the first circuit part 2. In addition, when the relay circuit part 6 is arranged so as to be aligned in the first direction with respect to the first circuit part 2, it may be arranged on one side in the first direction rather than the first circuit part 2, or may be arranged on the other side in the first direction than the first circuit part 2.

Further, although first conductive connection part 23 of the above embodiment has the first conductive part 231 extending in the first direction with respect to the connection fixing part 230 and the second conductive part 232 extending in the second direction with respect to the connection fixing part 230, the direction in which the first conductive part 231 and the second conductive part 232 extend with respect to the connection fixing part 230 may be changed in accordance with the arrangement of changeover switch 5 and the relay circuit part 6 with respect to the first circuit part 2.

More specifically, in the above-described embodiment, the first conductive part 231 extends to the other side in the first direction with respect to the connecting fixing part 230, but is not limited to this configuration. The first conductive part 231 may extend, for example, to one side in a first direction relative to the connecting fixing part 230.

In the above embodiment, the second conductive part 232 is configured to extend along the second direction with respect to the connecting fixing part 230, but is not limited to this configuration. The second conductive part 232 may, for example, be configured to extend along a first direction relative to the connecting fixing part 230.

Here, the second conductive part 232 may extend to one side in the first direction with respect to the connection fixing part 230 or may extend to the other side in the first direction with respect to the connection fixing part 230.

Further, although the first conductive part 231 extends in the second direction with respect to the connection fixing part 230, the direction in which the first conductive part 231 extends with respect to the connection fixing part 230 may be one side in the second direction or the other side in the second direction.

Further, in the above embodiment, the first side terminal part 500 and the second side terminal part 501 are arranged in a straight line in the first direction and the arrangement positions in the second direction are the same position, but the present invention is not limited thereto, and for example, the arrangement positions of the first side terminal part 500 and the second side terminal part 501 in the second direction may be different from each other.

In the above embodiment, the second electric device 32 and the load electric device 42 are disposed on the other side of changeover switch 5 in the first direction. However, the present invention is not limited thereto, and for example, the second electric device 32 and the loading electric device 42 may be disposed on one side of changeover switch 5 in the second direction.

In the above embodiment, the second side terminal part 501 and the load side terminal part 502 are arranged in the second direction, and the second side terminal part 501 is arranged on one side in the second direction, and the load side terminal part 502 is arranged on the other side in the second direction, but the present invention is not limited thereto, and for example, the second side terminal part 501 may be arranged on the other side in the second direction and the load side terminal part 502 may be arranged on one side in the second direction. In this case, it is conceivable that the second circuit part 3 is arranged on the other side in the second direction and the loading circuit part 4 is arranged on the one side in the second direction.

In the description of the strip-shaped area A of the above embodiment, the arrangement position of the first side terminal part 500 and the arrangement position of the second side terminal part 501 in the second direction has been given an example of the same, for example, the arrangement position of the first side terminal part 500 in the second direction and the arrangement position of the second side terminal part 501 are different from each other even in the second direction, the first phase terminal part 500a and the second side terminal part 501 of the first side terminal part 500 in the second direction it may be a strip-shaped area A area extending in a range including up to the third phase terminal part 501c of the third phase terminal part 500c and the second side terminal part 500 of the first side terminal part 501a.

In the above embodiment, changeover switch built-in board 1 includes the load circuit part 4, but the present invention is not limited thereto, and for example, changeover switch built-in board 1 may not include the load circuit part 4. A load conductor W110 may be connected to the load-side terminal part 502 of changeover switch 5.

In the load electric device 42 of the above embodiment, the load device primary terminal part 420 is provided at one end of the first direction, and the load device secondary terminal part 421 is provided at the other end of the first direction. However, the present invention is not limited thereto, and for example, in the load electric device 42, the load device primary terminal part 420 may be provided at the other end part in the first direction, and the load device secondary terminal part 421 may be provided at the one end part in the first direction.

In addition, changeover switch 5 may include a first side terminal part 500 and a load-side terminal part 502 at one end in the first direction. Here, the first side terminal part 500 and the load side terminal part 502 may be arranged so as to be oriented in the same direction in the first direction and aligned in the second direction. In addition, the loading circuit part 4 may be disposed on one side of changeover switch 5 in the first direction.

In the above embodiment, the arrangement positions of the device primary terminal part 320 and the device secondary terminal part 321 of the second electric device 32 in the second orientation are the same. However, the present invention is not limited thereto, and for example, the arrangement positions of the device primary terminal part 320 and the device secondary terminal part 321 of the second electric device 32 in the second direction may differ from each other.

In the above embodiment, the case where the conductor insertion part 7010 is formed in the back surface part 701 has been described. However, the present invention is not limited thereto, and the conductor insertion part 7010 may be provided in the frame part 700. That is, in the frame part 700, the conductor insertion part 7010 is provided so as to penetrate in the first direction or the second direction. Therefore, for example, the second conductive insertion part 7010b may be formed by passing through the frame part 700 on one side or the other side in the second direction or the frame part 700 on the other side in the first direction.

In the above embodiment, the first conductive insertion part 7010a is provided on one side of first primary terminal part 20 or changeover switch 5 in the second direction. However, the present invention is not limited thereto, and for example, the first conductive insertion part 7010a may be disposed on one side of first primary terminal part 20 in the first direction.

In the above embodiment, first primary terminal part 20 is disposed toward one side in the second direction. However, the present invention is not limited thereto, and for example, first primary terminal part 20 may be disposed toward one side or the other side in the first direction.

In the above embodiment, the first conductor insertion part 7010a includes the first side first conductor insertion part 7010aa and the switching side first conductor insertion part 7010ab. However, the present invention is not limited thereto, and for example, the first conductive insertion part 7010a may be disposed directly above first primary terminal part 20 and changeover switch 5 and may be formed to be continuous in the first direction.

The first conductor-insertion part 7010a may be provided in the second direction just above one side of first primary terminal part 20 or just above one side of changeover switch 5.

In the above-described embodiment, as shown in FIG. 114, the positions of the second-side terminal part 501 and the load-side terminal part 502 in the first direction differ from each other. However, for example, the second-side terminal part 501 and the load-side terminal part 502 may be arranged such that their positions in the first direction are the same (that is, they are arranged along an imaginary straight line extending in the second direction).

In the first electric device 22 of the above-described embodiment, the first phase terminal part 320a, the second phase terminal part 320b, and the third phase terminal part 320c of the device primary terminal part 320 are arranged in the first direction, but the configuration is not limited thereto. For example, in the first electric device 22, the first phase terminal part 320a, the second phase terminal part 320b, and the third phase terminal part 320c may be arranged in the second direction. The first phase terminal part 320a, the second phase terminal part 320b, and the third phase terminal part 320c may be arranged in the same direction (i.e., the first phase terminal part 320a, the second phase terminal part 320b, and the third phase terminal part 320c are aligned in the second direction), or may be different from each other.

In the above embodiment, the arrangement positions of the device primary terminal part 320 and the device secondary terminal part 321 are the same in the second orientation. However, the present invention is not limited thereto, and for example, the device primary terminal part 320 and the device secondary terminal part 321 of the second electric device 32 may be arranged at different positions in the second direction.

In the above embodiment, the load circuit part 4 includes the load electric device 42 as a circuit breaker, but the present invention is not limited thereto, and the load circuit part 4 may be configured to include the power distribution circuit part. Specifically, the load circuit part 4 may be configured to include a main switch connected to the load side terminal part 502 of changeover switch 5, and a plurality of branch switches connected to the secondary side of the main switch via a bus. The housing 7 is sized to accommodate the power distribution circuit part as well.

In the above-described embodiment, since the device primary terminal part 220 also serves as the device secondary terminal part, the device secondary terminal part is arranged so as to be directed in the second direction, but the present invention is not limited thereto, and for example, the device primary terminal part 220 and the device secondary terminal part may be configured so as to be separate from each other, and the device secondary terminal part and the first-side terminal part 500 may be configured so as to face each other in the first direction.

In the above embodiment, the second circuit part 3 is disposed on the other side of the first circuit part 2 and changeover switch 5 in the first direction, but the present invention is not limited thereto, and for example, the second circuit part 3 may be disposed on the one side of the first circuit part 2 and changeover switch 5 in the first direction. The same applies to the load circuit part 4, and the load circuit part 4 may be disposed on one side of the first circuit part 2 and changeover switch 5 in the first direction.

In the third embodiment, the second circuit part 3 is disposed on the other side of changeover switch 5 in the first direction and the load circuit part 4 is disposed on the one side of changeover switch 5 in the first direction, but the present invention is not limited thereto, and the second circuit part 3 may be disposed on the one side of changeover switch 5 in the first direction and the load circuit part 4 may be disposed on the other side of changeover switch 5 in the first direction.

In the first embodiment, the load conductor insertion part 7010c and the second conductor insertion part 7010b have been described as being formed so as to extend to one side and the other side in the second direction, but the present invention is not limited thereto, and for example, the load conductor insertion part 7010c and the second conductor insertion part 7010b may be formed so as to extend to one side or the other side in the second direction.

In the above embodiment, the switching-side first conductor insertion part 7010ab is disposed directly above changeover switch 5 and the second electric device 32, but the present invention is not limited thereto, and for example, the switching-side first conductor insertion part 7010ab may be partitioned on one side and the other side of the first direction with a part of the second direction along a virtual straight line in the second direction passing between changeover switch 5 and the second electric device in the first direction as a border.

In the first embodiment, the load conductor insertion part 7010c is formed so as to extend to one side and the other side in the second direction, but the present invention is not limited thereto, for example, the load conductor insertion part 7010c may be configured so as to extend to one side or the other side in the second direction.

Although the load electric device 42 of the second embodiment has been described as being arranged so as to be arranged at a position spaced apart from the second electric device 32 in one direction, the load electric device 42 may be arranged on one side in the first direction and the other side in the first direction from the second electric device 32. Here, the second side terminal part 501 may be disposed forward in the front-rear direction and the load-side terminal part 502 may be disposed rearward in the front-rear direction.

In the second embodiment, the device primary terminal part 320 is disposed on the other side in the second direction and the device secondary terminal part 321 is disposed on one side in the second direction, but the device primary terminal part 320 may be disposed on one side in the second direction and the device secondary terminal part 321 may be disposed on the other side in the second direction. In addition, the load device secondary terminal part 421 may be disposed on one side in the second direction, and the load device primary terminal part 420 may be disposed on the other side in the second direction. For example, the device primary terminal part 320 and the loading device secondary terminal part 421 may be disposed on one side of the strip-shaped area A in the second direction.

In the above embodiment, the switching body part 50 is disposed on one side in the second direction, the switching control part 51 has been described as being disposed on the other side in the second direction, not limited thereto, for example, such that the switching body part 50 and the switching control part 51 are aligned in the first direction, the switching body part 50 and the switching control part 51 may be arranged so as to be aligned in the front-rear direction.

Next, the description will be made for the invention relating to a changeover switch for changing over the connection state of a plurality of power source systems with a load.

As the changeover switch, there is know a changeover switch as shown in, for example, FIG. 3 of JP2017-225230 A1 that includes: a terminal (to be referred as a 1st terminal) to which a 1st branch breaker for load receiving power from a commercial power source is connected; a terminal (to be referred as a 2nd terminal) to which a distributed power system is connected; and a terminal (to be referred as a 3rd terminal) to which a 2nd main breaker for load as a supply destination for power of the commercial power source received through the 1st branch breaker for load or power received from the distributed power source is connected.

The changeover switch is configured to supply the power of the commercial power source to the 2nd main breaker for load (load connected to the 2nd main breaker for load) in a normal time, and supply the power of the distributed power source in place of the commercial power source to the 2nd main breaker for load at the time of abnormalities such as failure of power supply at the commercial power source.

Meanwhile, in the above conventional changeover switch, short circuits may occur between the terminals, for example, when an operation is made to the 1st terminal, the 2nd terminal or the 3rd terminal (e.g., attaching, replacement, or maintenance of wiring members), or an operation is made in an area around the 1st terminal, the 2nd terminal, or the 3rd terminal.

In view of the above circumstance, an object of the present invention is to provide a changeover switch that makes short circuits hardly occur.

A changeover switch of the present invention is a changeover switch for changing over a power source for supplying power to a load system including a load between a 1st power supply system and a 2nd power supply system, the changeover switch including: a 1st side terminal to which power from the 1st power supply system is input; a 2nd side terminal to which power from the 2nd power supply system is input; and a load side terminal for outputting to a load system power from the 1st power supply system that is input to the 1st side terminal, or power from the 2nd power supply system that is input to the 2nd side terminal, wherein areas in which the 1st side terminal, the 2nd side terminal, and the load side terminal are respectively disposed are set at different locations from each other in a front view.

Since the areas in which the 1st side terminal, the 2nd side terminal, and the load side terminal are respectively disposed are set at different locations from each other in the front view, the 1st side terminal, the 2nd side terminal, and the load side terminal are disposed so as not to be overlapped with each other.

Therefore, in the changeover switch having the above configuration, operation areas respectively for the 1st side terminal, the 2nd side terminal, and the load side terminal, areas through which the wirings are drawn from the 1st side terminal, the 2nd side terminal, and the load side terminal are unlikely to be overlapped with each other, which makes short circuits hardly occur between the 1st side terminal, the 2nd side terminal, and the load side terminal.

The changeover switch of the present invention can be configured to include a changeover body that can change over the electrical connection state of the 1st side terminal and the 2nd side terminal with the load side terminal, and have the load side terminal disposed at a tip of a terminal conductor that extends from the changeover body.

According to the changeover switch having the above configuration, the load terminal can be easily disposed at a location away from the 1st side terminal or the 2nd side terminal, and therefore short circuits more hardly occur.

The changeover switch of the present invention can be configured such that the 1st side terminal and the 2nd side terminal are disposed to be aligned with each other in a right-left direction orthogonal to a front and back direction, and the load side terminal is disposed to be aligned with the 1st side terminal or the 2nd side terminal in a vertical direction orthogonal to the front-back direction and the right-left direction.

According to the changeover switch having the above configuration, the 1st side terminal and the 2nd side terminal to which power is input are disposed away from each other, and thereby short circuits hardly occur.

The changeover switch of the present invention can be configured such that the 1st side terminal and the 2nd side terminal are disposed to be aligned with each other in the vertical direction orthogonal to the front-back direction, and the load side terminal is disposed on the right side of the 1st side terminal and the 2nd side terminal in the right-left direction orthogonal to the front-back direction and the vertical direction.

In the changeover switch of the above configuration, too, the 1st side terminal and the 2nd side terminal to which power is input are disposed away from each other, and thereby short circuits hardly occur.

The changeover switch of the present invention can be configured to include a changeover body that can change over the electrical connection state of the 1st side terminal and the 2nd side terminal with the load side terminal, and the 1st side terminal and the 2nd side terminal are disposed to be oriented in the mutually opposite sides in the right-left direction.

According to the changeover switch of the above configuration, the wiring members connected to the 1st side terminal and the wiring members connected to the 2nd side terminal extend in the directions opposite from each other, and thereby short circuits hardly occur.

The changeover switch of the present invention can be configured such that it includes a changeover body that can change over the electrical connection state of the 1st side terminal and the 2nd side terminal with the load side terminal, and a changeover control part that controls the changeover of the electrical connection state of the 1st side terminal and the 2nd side terminal with the load side terminal by the changeover body, in which the 1st side terminal and the 2nd side terminal are disposed in the changeover body, and the load side terminal is disposed at a location adjacent to the changeover control part.

The above configuration can also have the 1st side terminal, the 2nd side terminal, and the load side terminal disposed so as not to be overlapped with each other in the front-back direction, thereby making short circuits hardly occur between the 1st side terminal, the 2nd side terminal, and the load side terminal.

Thus, the changeover switch of the present invention can produce an excellent effect of making short circuits hardly occur.

Hereinafter, a changeover switch according to one embodiment of the present invention will be described with reference to the accompanied drawings.

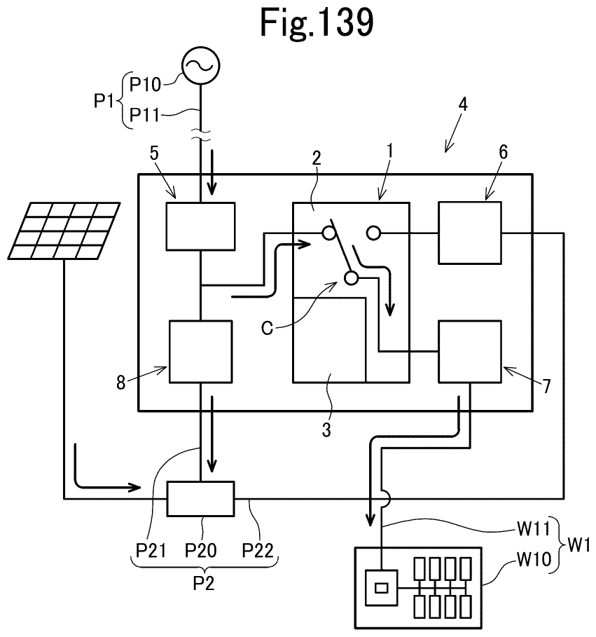

The changeover switch is configured to change over the power source which supplies power to a load system including a load to a 1st power source system or a 2nd power source system. For example, the changeover switch is sometimes incorporated into a changeover switch built-in board 4 as shown in FIG. 139.

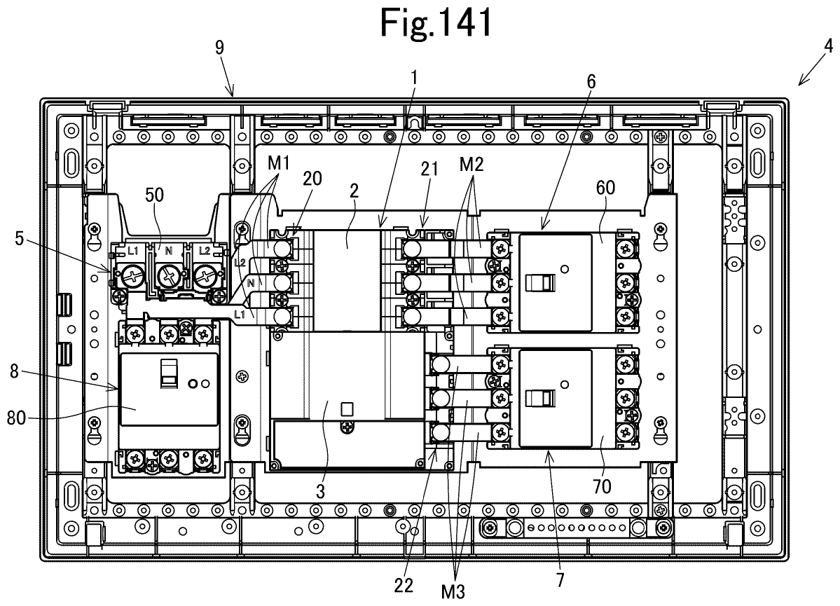

The changeover switch built-in board 4 shown in FIG. 139 includes, in addition to a changeover switch 1, a 1st circuit part 5 electrically connected to a 1st power source system P1, a 2nd circuit part 6 electrically connected to a 2nd power source system P2, a load circuit part 7 to which a load system W1 is connected, a relay circuit part 8 electrically connected to the 1st circuit part 5 and the 2nd power source system P2, and a housing 9 (see FIG. 141) for housing the 1st circuit part 5, the 2nd circuit part 6, the load circuit part 7, and the changeover switch 1.

For example, as shown in FIG. 139, when the changeover switch built-in board 4 is installed in a residence, the 1st power source system P1 through which commercial power is delivered, the 2nd power source system P2 including a distributed power source, and the load system W1 including a load W10 are electrically connected to the changeover switch built-in board 4.

The 1st power source system P1 is a power source system through which commercial power is delivered. The 1st power source system P1 includes a 1st power source P10 that is a commercial power source (e.g., power generation facility), and a 1st electrical path P11 electrically connected to the 1st power source P10.

The 2nd power source system P2 is a power source system including a distributed power source.

The 2nd power source system P2 includes a 2nd power source P20 that is a distributed power source, a primary side external path P21 (herein referred as relay path) electrically connected to a primary side of the 2nd power source P20, and a 2ndary side external path P22 (herein referred as 2nd path) electrically connected to a secondary side of the 2nd power source P20.

The 2nd power source P20 of this embodiment is composed of a storage battery. Specifically, the 2nd power source system P2 is a power source system that can charge and discharge the 2nd power source P20.

The 2nd power source P20 of this embodiment is connected to a solar panel, and configured to be charged by receiving power generated by a solar cell.

The relay path P21 is a path through which power to be supplied to the 2nd power source P20 is delivered. When the 2nd power source P20 is composed of, a so-called power conditioner and a storage battery, power is delivered to the relay path P21 to activate the power conditioner. The 2nd path P22 is a path through which power discharged from the 2nd power source P20 is delivered.

The load system W1 includes a load W10, and a load side path W11 electrically connected to the load W10. In this embodiment, the load W10 is a distribution board. Specifically, the distribution board includes a main switch, a bus bar, a distribution switch, and a distribution board housing.

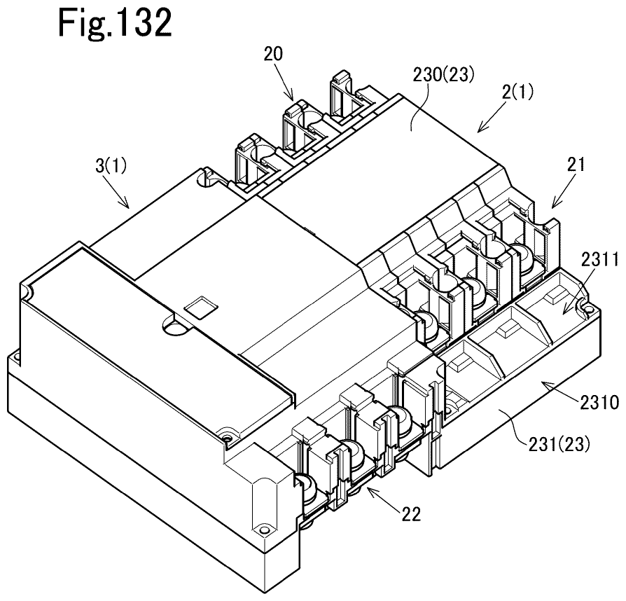

As shown in FIG. 132, the changeover switch 1 includes a changeover body 2 that includes a changeover circuit part C for changeover the power source for supplying power to the load system W1 to the 1st power source system P1 or the 2nd power source system P2 (see FIG. 139), and a changeover control part 3 that controls the changeover operation by the changeover body 2 (changeover circuit part C).

The changeover body 2 includes: a 1st side terminal 20 to which power from the 1st power source system P1 is input; a 2nd side terminal 21 to which power from the 2nd power source system P2 is input; a load side terminal 22 for outputting power from the 1st power source system P1 that has been input to the 1st side terminal 20, or power from the 2nd power source system P2 that has been input to the 2nd side terminal 21, and an exterior part 23 that forms a part of an exterior of the changeover switch 1 itself.

In this embodiment, a direction in which the front side of the changeover switch 1 (side facing the front side in the installed state) and a back side (side facing the back side in the installed state) is referred as a front-back direction, a direction orthogonal to the front-back direction is referred as a 1st direction, and a direction orthogonal to the front-back direction and the 1st direction is referred as a 2nd direction.

A direction of the plane defined by the 1st direction and the 2nd direction is referred as a plane direction.

In this embodiment, the 1st direction is a direction corresponding to the right-left direction when the changeover switch 1 in the installed state is seen from the front side, one side of the 1st direction is a left side, and the other side of the 1st direction is a right side.

The 2nd direction is a direction corresponding to the vertical direction when the changeover switch 1 in the installed state is seen from the front side, one side of the 2nd direction is an upper side, and the other side of the 2nd direction is a lower side.

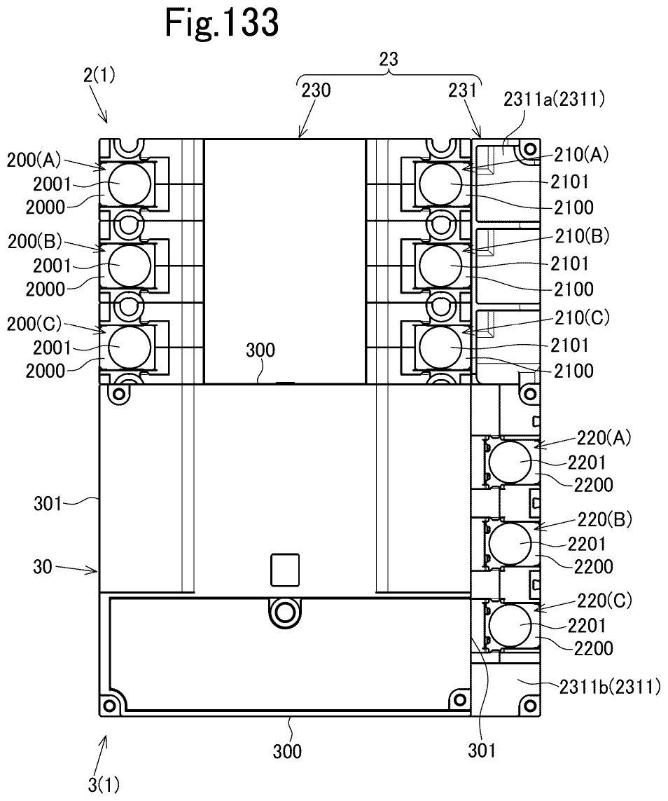

As shown in FIG. 133, the 1st side terminal 20 includes a plurality of 1st side connection terminals 200 that allow power distribution members (1st side power distribution members) M1 (see FIG. 141) for providing electrical connection between the 1st side terminal 20 itself and an external equipment (equipment separate from the changeover switch 1 itself; an electric device 50 of the 1st circuit part 5 in this embodiment) to be attachable to and detachable from the plurality of 1st side connection terminals 200.

The 1st side connection terminals 200 respectively include 1st side terminal plates 2000 that form a part of the changeover circuit part C and that are fixed to the exterior part 23 to allow the 1st side power distribution members M1 to be electrically connected to themselves, and 1st side fasteners 2001 for fixing the 1st side power distribution members M1 to the 1st side terminal plates 2000.

The changeover switch 1 of this embodiment is configured to receive power which has been sent with the single phase three wire system from the 2nd power source system P2, and send the power to the load system W1. Thus, the 1st side terminal 20 includes three 1st side connection terminals 200.

The three 1st side connection terminals 200 are respectively a 1st side connection terminal for the 1st phase (1st phase connection terminal) 200, a 1st side connection terminal for the 2nd phase (2nd phase connection terminal) 200, and a 1st side connection terminal for the 3rd phase (3rd phase connection terminal) 200.

The 1st phase connection terminal 200, the 2nd phase connection terminal 200, and the 3rd phase connection terminal 200 are lined up in a row in the 2nd direction to be aligned with each other in the 1st side terminal 20.

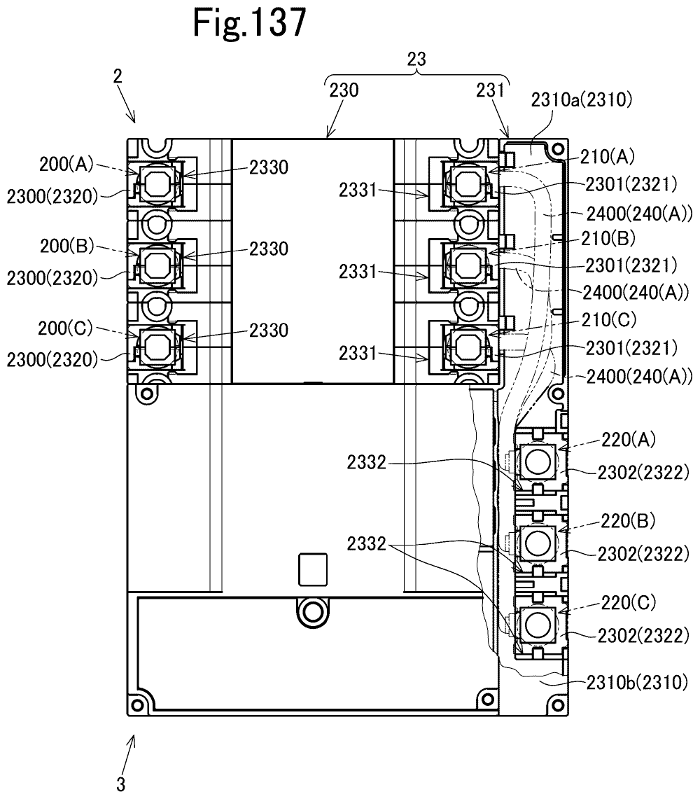

In this embodiment, the 1st phase is an L2 phase, the 2nd phase is an N phase, and the 3rd phase is an L1 phase, respectively. In FIG. 133 and FIG. 137, the reference code “A” is added to the 1st phase terminal 200, “B” to the 2nd phase terminal 200, and “C” to the 3rd phase terminal 200.

The 2nd side terminal 21 includes a plurality of 2nd side connection terminals 210 that allow power distribution members (2nd side distribution members) M2 (see FIG. 141) for providing electrical connection between the 2nd side terminal 21 itself and an eternal equipment (equipment separate from the changeover switch 1 itself: an electric device 60 of the 2nd circuit part 6 in this embodiment) to be attachable to and detachable from the plurality of 2nd side connection terminals 210.

The 2nd side connection terminals 210 respectively include 2nd side terminal plates 2100 that form a part of the changeover circuit part C and that are fixed to the exterior part 23 to allow the 2nd side power distribution members M2 to be electrically connected to themselves, and 2nd side fasteners 2101 for fixing the 2nd side power distribution members M2 to the 2nd side terminal plates 2100.

The changeover switch 1 as mentioned above is configured to receive power which has been transmitted with the single phase three wire system from the 1st power source system P1 or the 2nd power source system P2, and send the power to the load system W1. Thus, the 2nd side terminal 21 includes three 2nd side connection terminals 210.

The three 2nd side connection terminals 210 are respectively a 2nd side connection terminal for the 1st phase (1st phase connection terminal) 210, a 2nd side connection terminal for the 2nd phase (2nd phase connection terminal) 210, and a 2nd side connection terminal for the 3rd phase (3rd phase connection terminal) 210.

The 2nd phase connection terminal 210, the 2nd phase connection terminal 210, and the 3rd phase connection terminal 210 are lined up in a row in the 2nd direction to be aligned with each other in the 2nd side terminal 21.

For the 2nd side terminal 21, in FIG. 133 and FIG. 137, the reference code “A” is added to the 1st phase terminal 210, “B” to the 2nd phase terminal 210, and “C” to the 3rd phase terminal 210.

The load side terminal 22 includes a plurality of load side connection terminals 220 that allow power distribution members (load side distribution members) M3 (see FIG. 141) for providing electrical connection between the load side terminal 22 itself and an eternal equipment (equipment separate from the changeover switch 1 itself: an electric device 70 of the load circuit part 7 in this embodiment) to be attachable to and detachable from the plurality of load side connection terminals 220.

The load side connection terminals 220 respectively include load side terminal plates 2200 that are fixed to the exterior part 23 to allow the load side power distribution members M3 to be electrically connected to themselves, and load side fasteners 2201 for fixing the load side power distribution members M3 to the load side terminal plates 2200.

As described above, the changeover switch 1 is configured to receive power that has been sent with the single phase three wire system from the 1st power source system P1 or the 2nd power source system P2, and send the power to the load system W1. Thus, the load side terminal 22 includes three load side connection terminals 220.

These three load side connection terminals 220 are respectively a load side connection terminal for the 1st phase (1st phase connection terminal) 220, a load side connection terminal for the 2nd phase (2nd phase connection terminal) 220, and a load side connection terminal for the 3rd phase (3rd phase connection terminal) 220.

The 1st phase connection terminal 220, the 2nd phase connection terminal 220, and the 3rd phase connection terminal 220 are lined up in a row in the 2nd direction to be aligned with each other in the load side terminal 22.

Also, for the load side terminal 22, in FIG. 133 and FIG. 137, the reference code “A” is added to the 1st phase terminal 220, “B” to the 2nd phase terminal 220, and “C” to the 3rd phase terminal 220.

The changeover body 2 of this embodiment includes a terminal relay 24 for providing connection between the load side terminal 22 and the changeover circuit part C.

The terminal relay 24 includes a plurality of relay connection parts 240.

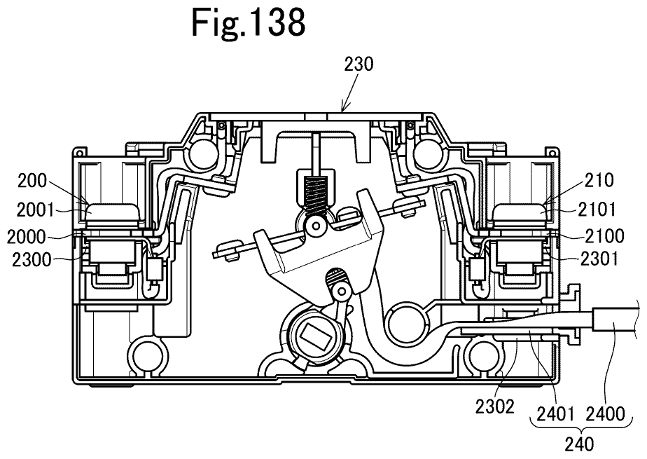

As shown in FIG. 137 and FIG. 138, each of the relay connection parts 240 includes a relay conductor (conductor for terminal) 2400 that has a tip part (end part in the longitudinal direction) electrically connected to a corresponding one of the load side terminal plates 2200, and a relay terminal plate 2401 (see FIG. 138) that is fixed to the exterior part 23 at a position different from the relay conductor 2400 and forms a part of the changeover circuit part C.

The changeover switch 1 as mentioned above is configured to receive power which has been transmitted with the single phase three wire system from the 1st power source system P1 or the 2nd power source system P2, and send the power to the load system W1. Thus, the terminal relay 24 includes three relay connection parts 240.

The three relay connection parts 240 are respectively a relay connection part for the 1st phase (1st phase relay connection part) 240, a relay connection part for the 2nd phase (2nd phase relay connection part) 240, and a relay connection part for the 3rd phase (3rd phase relay connection part) 240.

A base end part (end part connected to the changeover circuit part C) of the 1st phase relay connection part 240, a base end part (end part connected to the changeover circuit part C) of the 2nd phase relay connection part 240), and a base end part (end part connected to the changeover circuit part C) of the 3rd phase relay connection part 240 are lined up in a row in the 2nd direction in the terminal relay 24.

For the terminal relay 24, in FIG. 137, the reference code “A” is added to the 1st phase relay connection part 240, “B” to the 2nd phase relay connection part 240, and “C” to the 3rd phase relay connection part 240.

The exterior part 23 includes an exterior part 230 for mechanical component for housing the changeover circuit part C, and an exterior part 231 for wiring disposed on an outer surface of the exterior part 230 for mechanical component.

As shown in FIG. 138, the exterior part 230 for mechanical component includes 1st side mounting parts 2300 to which the 1st side connection terminals 200 are mounted, 2nd side mounting parts 2301 to which the 2nd side connection terminals 210 are mounted, and load side mounting parts 2302 to which the relay connection parts 240 which are connected to the load side connection terminals 220 are mounted.

As shown in FIG. 137, the exterior part 231 for wiring is arranged on one side of the outer periphery of the changeover switch 1, and extends toward the changeover control part 3 from the exterior part 230 for mechanical component. Therefore, the exterior part 231 for wiring is formed to straddle the changeover control part 3 and the exterior part 230 for mechanical component.

The exterior part 231 for wiring of this embodiment includes a wiring case part 2310 having an upper surface opened, and a wiring cover part 2311 disposed over the upper surface of the wiring case part 2310 (see FIG. 132).

The wiring case part 2310 includes a proximal end side case part 2310a adjacent to the exterior part 230 for mechanical component, and a distal end side case part 2310b adjacent to the changeover control part 3.

The proximal end side case part 2310a and the distal end side case part 2310b are aligned with each other in a direction along which the one side of the changeover switch 1 extends (2nd direction in this embodiment). The exterior part 231 for wiring of this embodiment is located along one side on the other side in the 1st direction of the changeover switch 1, the proximal end side case part 2310a is located adjacent to the side surface facing the other side in the 1st direction of the exterior part 230 for mechanical component, and the distal end side case part 2310b is located adjacent to the side surface facing the other side in the 1st direction of a later-described control case 30 of the changeover control part 3.

Provided inside the wring case part 2310 is a wiring space that is configured to house the relay conductor 2400, in which the wiring space is formed to extend between the proximal end side case part 2310a and the distal end side case part 2310b.

As shown in FIG. 133, the wiring cover part 2311 includes a proximal end side cover part 2311a arranged to be placed on the proximal end side case part 2310a, and a distal end side cover part 2311b arranged to be placed on the distal end side case part 2310b. The proximal end side cover part 2311a is located between the 2nd side mounting parts 2301 and the load side mounting parts 2302 on the outer surface of the exterior part 230 for mechanical component to be adjacent to each other.

As shown in FIG. 137, the exterior part 230 for mechanical component includes 1st side blocks 2320 for mounting the 1st side terminal 20, 2nd side blocks 2321 for mounting the 2nd side terminal 21, and load side blocks 2322 for mounting the load side terminal 22.

In this embodiment, the 1st side blocks 2320 are formed by the 1st side mounting parts 2300, the 2nd side blocks 2321 are formed by the 2nd side mounting parts 2301, and the load side blocks 2322 are formed by the load side mounting parts 2302.

The exterior part 230 for mechanical component includes 1st side insulation wall parts 2330 disposed upright on the 1st side blocks 2320, 2nd side insulation wall parts 2331 disposed upright on the 2nd side blocks 2321, and load side insulation wall parts 2332 disposed upright on the load side blocks 2322.

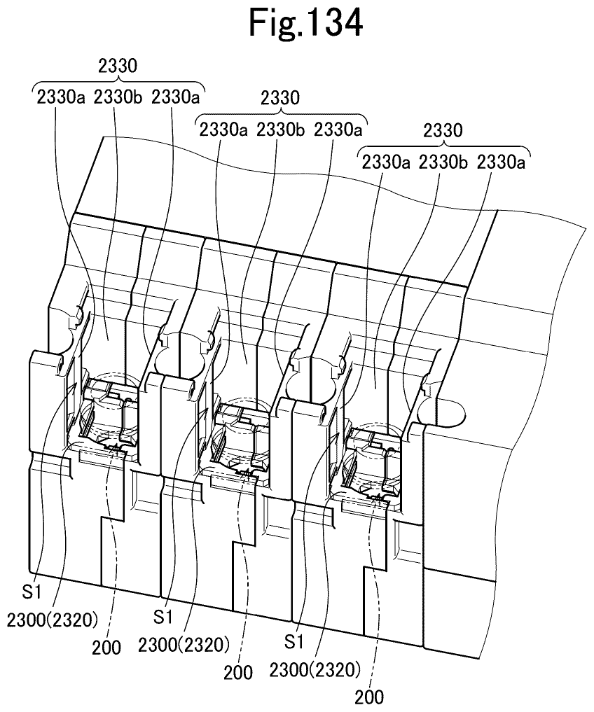

As shown in FIG. 134, the 1st side insulation wall parts 2330 respectively form 1st side wiring spaces S1 each being open in the plane direction to allow the 1st side power distribution members M1 to be disposed therein. That is, the 1st side insulation wall parts 2330 are respectively formed to partially surround the peripheries of the 1st side connection terminals 200.

Each of the 1st side insulation wall parts 2330 of this embodiment includes 1st wall parts 2330a disposed upright on the opposite sides in the 2nd direction of the 1st side connection terminal 200, and a 2nd wall part 2330a disposed upright on the other side in the 1st direction of the 1st side connection terminal 200. The 1st side wiring space S1 is formed between the 1st wall parts 2330a.

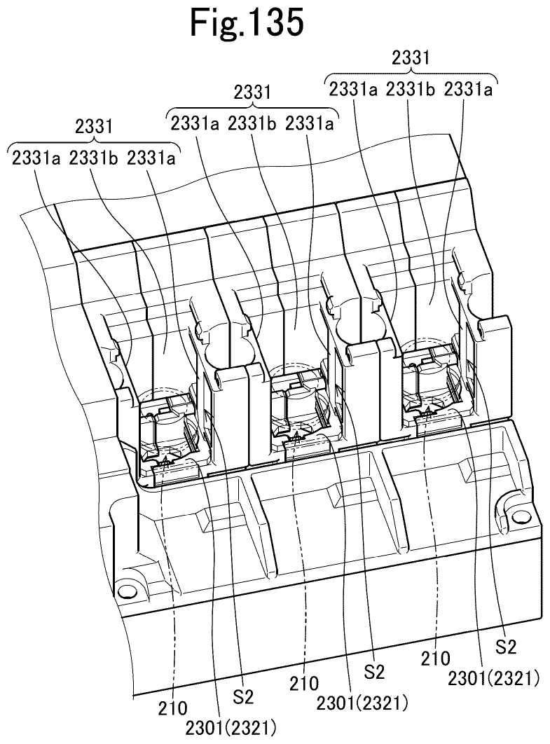

As shown in FIG. 135, the 2nd side insulation wall parts 2331 respectively form 2nd side wiring spaces S2 each being open in the plane direction to allow the 2nd side power distribution member M2 to be disposed therein. That is, the 2nd side insulation wall parts 2331 are respectively formed to partially surround the peripheries of the 2nd side connection terminals 210.

Each of the 2nd side insulation wall parts 2331 includes 1st wall parts 2331a disposed upright on the opposite sides in the 2nd direction of the 2nd side connection terminal 210, and a 2nd wall part 2331a disposed upright on one side in the 1st direction of the 2nd side connection terminal 210. The 2nd side wiring space S1 is formed between the 1st wall parts 2331a.

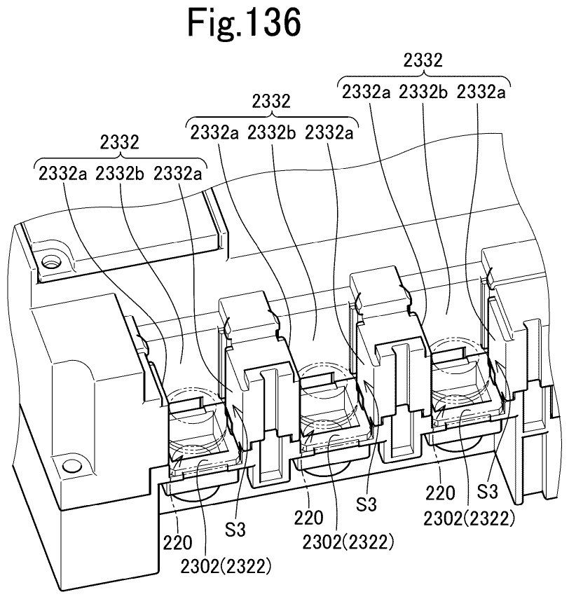

As shown in FIG. 136, the load side insulation wall parts 2332 respectively form load side wiring spaces S3 each being open in the plane direction to allow the load side power distribution member M3 to be disposed therein. That is, the load side insulation wall parts 2332 are respectively formed to partially surround the peripheries of the load side connection terminals 220.

Each of the load side insulation wall parts 2332 includes 1st wall parts 2332a disposed upright on the opposite sides in the 2nd direction of the load side connection terminal 220, and a 2nd wall part 2332b disposed upright on one side in the 1st direction of the load side connection terminal 220. The load side wiring space S3 is formed between the 1st wall parts 2332a.

In the changeover switch 1 of this embodiment, the arrangement areas of the 1st side blocks 2320, the 2nd side blocks 2321, and the load side blocks 2322 are set to be at locations different from each other in the front view (non-overlapping locations), and therefore the arrangement areas of the 1st side terminal 20, the 2nd side terminal 21, and the load side terminal 22 are set to be at locations different from each other in the front view (non-overlapping locations).

The 1st side blocks 2320 are located at different end parts of the changeover switch 1 in the 1st direction from the 2nd side blocks 2321 and the load side blocks 2322, and in this embodiment, the 1st side blocks 2320 are located at end parts on one side in the 1st direction of the changeover switch 1, and the 2nd side blocks 2321 and the load side blocks 2322 are located at end parts on the other side in the 1st direction of the changeover switch 1.

The 2nd side blocks 2321 and the load side blocks 2322 are aligned with each other in the 1st direction along the end parts on the other side in the 1st direction of the changeover switch 1, in which the load side blocks 2322 are displaced in positions from the 2nd side blocks 2321 to be closer to the other side in the 2nd direction than the 2nd side blocks 2321.

With the above configuration, the 1st side terminal 20 is located at the end part on the one side in the 1st direction of the changeover switch 1, and the 2nd side terminal 21 and the load side terminal 22 are located at the end parts on the other side in the 1st direction of the changeover switch 1. Further, the 2nd side terminal 21 and the load side terminal 22 are aligned with each other in the 1st direction at the end parts on the other side in the 1st direction of the changeover switch 1, in which the load side terminal 22 is displaced in position from the 2nd side terminal 21 to be closer to the other side in the 2nd direction than the 2nd side terminal 21.

In the 1st side insulation wall parts 2330 and the 2nd side insulation wall parts 2331 aligned with each other in the 1st direction, the plane direction in which the 1st side insulation wall parts 2330 open is opposite to the plane direction in which the 2nd side insulation wall parts 2331 open. The load side insulation wall parts 2332 of which the opening direction is the same as the 2nd side insulation wall parts 2331 are displaced in position from the 2nd side insulation wall parts 2331 in the 2nd direction (in this embodiment, the position displaced toward the other side in the 2nd direction than the 2nd side insulation wall parts 2331).

Therefore, when the direction in which the 1st side insulation wall parts 2330 outwardly face in the direction in which the 1st side insulation wall parts 2330 open in the plane direction, the direction in which the 2nd side insulation wall parts 2331 outwardly face in the direction in which the 2nd side insulation wall parts 2331 open in the plane direction, and the direction in which the load side insulation wall parts 2332 outwardly face in the direction in which the load side insulation wall parts 2332 open in the plane direction are respectively designated as the facing direction of the 1st side terminal 20, the facing direction of the 2nd side terminal 21, and the facing direction of the load side terminal 22, the 1st side terminal 20 and the 2nd side terminal 21 are aligned with each other in the 1st direction, while the facing direction of the 1st side terminal 20 is opposite to the facing direction of the 2nd side terminal 21 in the 1st direction. Also, the facing direction of the 2nd side terminal 21 is the same as the facing direction of the load side terminal 22 in the 1st direction, while the arrangement positions of these terminals are different from each other in the 2nd direction.

Therefore, the 1st side terminal 20, the 2nd side terminal 21, and the load side terminal 22 are respectively arranged to have no other terminals arranged on their forward sides (the side of the outward direction in the opening direction in the plane direction), so that the 1st side power distribution members M1 mounted to the 1st side terminal 20, the 2nd side power distribution member M2 mounted to the 2nd side terminal 21, and the load side power distribution member M3 mounted to the load side terminal 22 hardly interfere with each other.

The arrangement position in the 1st direction of the 2nd side terminal 21 is different from the arrangement position in the 1st direction of the load side terminal 22, in which the load side terminal 22 is arranged on the other side in the 1st direction of the 2nd side terminal 21. However, the arrangement position in the 1st direction of the 2nd side terminal 21 can be the same as the arrangement position in the 1st direction of the load side terminal 22, or the load side terminal 22 can be arranged on the one side in the 1st direction of the 2nd side terminal 21.

The changeover control part 3 includes the control case 30 adjacent to the exterior part 23. The control case 30 has a rectangular shape or a substantially rectangular shape in the front view. The outer circumferential edge of the control case 30 includes four side portions, more specifically, two 1st side portions 300 extending in the 1st direction, and two 2nd side portions 301 extending in the 2nd direction.

The exterior part 23 is configured to be located adjacent to the 1st side portion 300 and the 2nd side portion 301 respectively having one ends crossing each other (the 1st side portion and the 2nd side portion together forming an angular portion), out of the two 1st side portions 300 and the two 2nd side portions 30. In this embodiment, the exterior part 230 for mechanical component is located adjacent to the one 1st side portion 300, and the wiring case part 2310 (distal end side case part 2310b) is located adjacent to the one 2nd side portion 301.

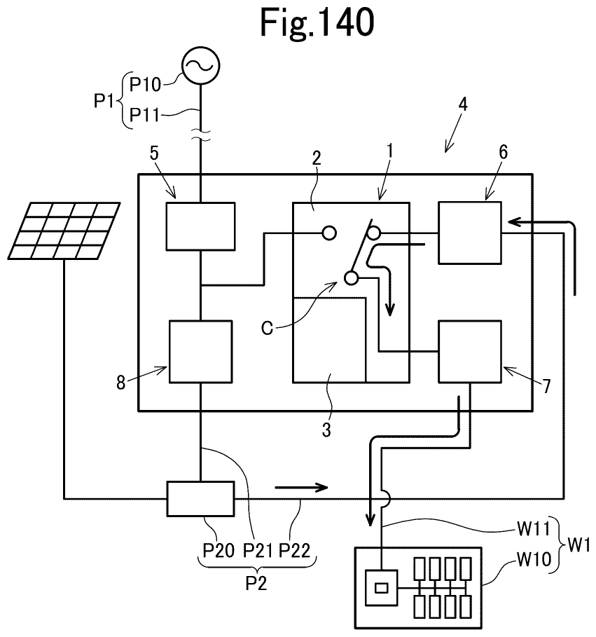

The changeover control part 3 is capable of switching the connection state between the state, as shown in FIG. 139, in which the 1st side terminal 20 and the load side terminal 22 are electrically connected with each other, and the 2nd side terminal 21 and the load side terminal 22 are electrically separated from each other (1st power supply state), and the state, as shown in FIG. 140, in which the 1st side terminal 20 and the load side terminal 22 are electrically separated from each other, and the 2nd side terminal 21 and the load side terminal 22 are electrically connected to each other (2nd power supply state). The changeover control part 3 is capable of actuating the changeover body 2 to switch between the 1st power supply state and the 2nd power supply state (that is, switching the electrical connection state of the 1st side terminal 20 and the 2nd side terminal 21 with the load side terminal 22).

The changeover control part 3 is configured to automatically switch the power supply state of the changeover body 2 between the 1st power supply state and the 2nd power supply state according to the respective power supply states. However, the changeover control part 3 can be configured such that the switching between the 1st power supply state and the 2nd power supply state is manually made, or the switching between the 1st power supply state and the 2nd power supply state is made by remote operation from the outside.

In the case where the 1st power supply state and the 2nd power supply state of the changeover body 2 is automatically changed, it is enough for a control unit for performing the switching between the 1st power supply state and the 2nd power supply state to be housed in the control case 30.

Further, the changeover control part 3 can be configured such that, for example, upon detection of the cutting off of the power supply from the 1st power source system P1, the changeover control part 3 controls the changeover body 2 to change the power supply state from the 1st power supply state to the 2nd power supply state, and upon detection of the return of the power supply from the 1st power source system P1, the changeover control part 3 controls the changeover body 2 to change the power supply state from the 2nd power supply state to the 1st power supply state.

As described above, according to the changeover switch 1 of this embodiment, the arrangement areas of the 1st side terminal 20, the 2nd side terminal 21, and the load side terminal 22 are set to lie at different locations from each other in the front view so that the 1st side terminal 20, the 2nd side terminal 21, and the load side terminal 22 are arranged not to overlap with each other.

Therefore, in the changeover switch 1, work areas for the 1st side terminal 20, the 2nd side terminal 21, and the load side terminal 22 are arranged not to overlap with each other.

As long as the work areas for the 1st side terminal 20, the 2nd side terminal 21, and the load side terminal 22 do not overlap with each other, the worker can perform the works in an environment where the others of the 1st side terminal 20, the 2nd side terminal 21, and the load side terminal 22 are kept away from himself or herself when the worker performs the work for any of the 1st side terminal 20, the 2nd side terminal 21, and the load side terminal 22. Thereby, short circuits between the terminal to be worked and the terminals not to be worked hardly occurs.

Thus, the changeover switch 1 of this embodiment produces an excellent effect of making short circuits hardly occur.

In the changeover switch 1 of this embodiment, the 1st side terminal 20 and the 2nd side terminal 21 aligned with each other in the 1st direction respectively face the opposite sides, and the 2nd side terminal 21 and the load side terminal 22 which face the same side in the 1st direction are arranged at the different places in the 2nd direction. Thus, the 1st side terminal 20, the 2nd side terminal 21, and the load side terminal 22 respectively have areas expanding forward from themselves which do not overlap with each other.

According to the above configuration, the 1st side power distribution members M1, the 2nd side power distribution member M2, and the load side power distribution member M3 which are respectively connected to the 1st side terminal 20, the 2nd side terminal 21, and the load side terminal 22 are unlikely to cross each other. Thus, the 1st side power distribution members M1, the 2nd side power distribution member M2, and the load side power distribution member M3 are respectively unlikely to contact other power distribution members or other terminals and thereby make short circuits hardly occur.

In particular, the 1st side power distribution members M1 connected to the 1st side terminal 20, and the 2nd side power distribution members M2 connected to the 2nd side terminal 21 respectively extend in directions toward the mutually opposite sides, and thus are more unlikely to cause short circuits.

As described above, in the exterior part 230 for mechanical component, the load side terminal 22 is mounted at the position overlapping with the 2nd side terminal 21 on the back side in the front-back direction. However, the position at which the load side power distribution members M3 are mounted to the load side terminal 22 is set to be different from the position at which the 2nd side power distribution members M2 are mounted to the 2nd side terminal 21 in the plane direction. Thus, short circuits are unlikely to occur.

In this embodiment, in the front view, the 2nd side mounting parts 2301 to which the 2nd side connection terminals 210 are mounted, and the load side mounting parts 2302 to which the relay connection parts 240 are connected are arranged at the places at which they are aligned with each other in the front-back direction. Accordingly, the relay conductors 2400 are arranged at the places at which they overlap with the front areas of the 2nd side connection terminals 210 on the back side in the front-back direction. However, the proximal end side cover part 2311a blocks between the 2nd side mounting parts 2301 and the load side mounting parts 2302 so that the 2nd side connection terminals 210 and the relay connection part 240 are insulated from each other.

Further, in the changeover switch 1 of this embodiment, the 1st side terminal 20 and the 2nd side terminal 21 are arranged to be aligned with each other in the right-left direction (1st direction) orthogonal to the front-back direction, and the load side terminal 22 is arranged to be aligned with the 1st side terminal 20 or the 2nd side terminal 21 in the vertical direction (2nd direction) orthogonal to the front-back direction and the right-left direction (1st direction). Thus, the 1st side terminal 20 and the 2nd side terminal 21 to which electric power is input are located away from each other so that short circuits are unlikely to occur.

The changeover switch of the present invention is not limited to the above embodiments and it is a matter of course that various modifications can be made.

Although not specifically mentioned in the above embodiment, in the changeover switch 1, the installation area of the 1st side terminal 20 and the installation area of the 2nd side terminal 21 are located away from each other. In this configuration, if the installation area of the 2nd side terminal 21 and the installation area of the load side terminal 22 are located adjacent to each other without overlapping with each other, it becomes easier to prevent short circuits. In this regard, in the front view, as long as the 1st side connection terminals 200, the 2nd side connection terminals 210, and the load side connection terminals 220 themselves do not overlap with each other, it is possible to obtain the effect of making short circuits hardly occur even if the installation areas themselves slightly overlap with each other.

In the above embodiment, the 1st side terminal 20 and the 2nd side terminal 21 are aligned with each other in the 1st direction. However, for example, the 1st side terminal 20 and the load side terminal 22 can be aligned with each other in the 1st direction, or the 2nd side terminal 21 and the load side terminal 22 can be aligned with each other in the 1st direction. In this case, among the 1st side terminal 20, the 2nd side terminal 21, and the load side terminal 22, it is enough for those with the mounting positions to the exterior part 230 for mechanical component overlapping with each other in the front-back direction to be installed in areas different from each other in the plane direction. Further, in the above embodiment, the terminal relay 24 is connected to the load side terminal 22. In employing the above configuration, it is enough for the terminal relay 24 to be connected to any of those with the mounting positions to the exterior part 230 for mechanical component overlapping with each other in the front-back direction, among the 1st side terminal 20, the 2nd side terminal 21, and the load side terminal 22.

In the above embodiment, the 1st side terminal 20 and the 2nd side terminal 21 are arranged to be aligned with each other in the right-left direction (1st direction) orthogonal to the front-back direction, and the load side terminal 22 is arranged to be aligned with the 1st side terminal 20 or the 2nd side terminal 21 in the vertical direction (2nd direction) orthogonal to the front-back direction and the right-left direction (1st direction). However, the present invention is not necessarily limited to this configuration. For example, the configuration can be such that the 1st side terminal 20 and the 2nd side terminal 21 are arranged to be aligned with each other in the vertical direction (1st direction) orthogonal to the front-back direction, and the load side terminal 22 is arranged on the right side or the left side of the 1st side terminal 20 and the 2nd side terminal 21 in the right-left direction (2nd direction) orthogonal to the front-back direction and the vertical direction (1st direction).

That is, the configuration can be such that the 1st side terminal 20 and the load side terminal 22 are aligned with each other in the 2nd direction, and the 2nd side terminal 21 is arranged at a position displaced in the 1st direction from the 1st side terminal 20 and the load side terminal 22, or the configuration can be such that the 2nd side terminal 21 and the load side terminal 22 are aligned with each other in the 2nd direction, and the 1st side terminal 20 is arranged at a position displaced in the 1st direction from the 2nd side terminal 21 and the load side terminal 22. In this case, too, the 1st side terminal 20 and the 2nd side terminal 21, to which power is input are located away from each other so that short circuits are unlikely to occur.

Thus, the changeover switch 1 can employ the layout that, among the 1st side terminal 20, the 2nd side terminal 21, and the load side terminal 22, two of them are arranged to be aligned with each other in the 1st direction or the 2nd direction, and the remaining one is arranged at a position displaced in the 1st direction or the 2nd direction. In this case, it is enough for the exterior part 23 to be connected to the one of the 1st side terminal 20, the 2nd side terminal 21, and the load side terminal 22 displaced in the 1st direction or the 2nd direction from the others.

In this embodiment, the 1st side terminal 20 and the 2nd side terminal 21 are aligned with each other in the 1st direction, and the load side terminal 22 is arranged at a position different in the 1st direction from the positions of the 1st side terminal 20 and the 2nd side terminal 21. However, for example, the 1st side terminal 20, the 2nd side terminal 21, and the load side terminal 22 can be lined up in a row in the 1st direction or the 2nd direction. In this case, as long as the 1st side terminal 20, the 2nd side terminal 21, and the load side terminal 22 each are arranged to face in a direction to have no other terminals respectively on each of their own front sides, it is possible to obtain an effect of making short circuits hardly occur. When the above configuration is employed, the changeover body 2 can be configured to include the terminal relay 24, or include no terminal relay 24.

In the above embodiment, the 1st side terminal 20, the 2nd side terminal 21, and the load side terminal 22 are configured to allow the 1st side power distribution members M1, the 2nd side power distribution member M2, and the load side power distribution member M3 to be fixed respectively to them by screwing. However, for example, fixing means other than the screwing, such as plug-in connection can be employed.

Although not specifically mentioned in the above embodiment, the electric device 50 of the 1st circuit part 5 can be a device such as a circuit breaker in addition to a terminal mount. The electric device 60 of the 2nd circuit part 6 and the electric device 70 of the load circuit part 7 each can be composed of a circuit breaker or another device.

The above embodiment was described by taking, for example, the case where the 1st power source system P1 is a commercial power supply system, and the 2nd power source system P2 is a power supply system including a distributed power system. However, the configuration can be such that the 1st power source system P1 is a power supply system of any kind other than the commercial power supply system, and the 2nd power source system P2 is a power supply system of any kind other than the power supply system including the distributed power system. For example, a power supply configuration which has power supply characteristics different between the 1st power source system P1 and the 2nd power source system P2 can be employed. That is, the configuration can be such that the 1st power source system P1 is a DC power source and the 2nd power source system P2 is an AC power source, or both the 1st power source system P1 and the 2nd power source system P2 are DC power sources. Thus, the connection or switching of the power sources having different characteristics can be made according to the load to be connected so that a variety of power sources can be supplied to the load.

In the 2nd power source system P2 of the above embodiment, the solar cell (solar power generation system) is connected to the 2nd power source P20 without limitation thereto. For example, in the 2nd power source system P2, the 2nd power source P20 can be composed of a storage battery installed on an electric vehicle.

In the 2nd power source system P2 of the above embodiment, the 2nd power source P20 is a power supply system of a charge type capable of being charged without limitation thereto. The 2nd power source system P2 can be configured such that, for example, the 2nd power source P20 includes only the power generation function.

Although not specifically mentioned in the above embodiment, the changeover switch built-in board 4 can be installed in a residence or a factory, or at a side outside a building without limitation to the installation inside the building.

The above embodiment was described by taking, for example, only the case where the power output from the 1st circuit part 5 flows into the relay circuit part 8. However, the configuration can be such that the power flowing toward the 1st circuit part 5 flows into the relay circuit part 8.

The above embodiment was described by taking, for example, the case where the 1st side terminal 20 includes three 1st side connection terminals 200. However, for example, the 1st side terminal 20 can include one or two 1st side connection terminals 200, or four or more 1st side connection terminals 200. The same applies to the 2nd side terminal 21 and the load side terminal 22.

Although not specifically mentioned in the above embodiment, the electric connection states over which the changeover switch 1 can switch include not only the 1st power supply state and the 2nd power supply state, but also a neutral state in which the load circuit part 7 is electrically connected to neither the 1st power source system P1 nor the 2nd power source system P2. Thereby, the load circuit 7 can be set to the electrically isolated state from the 1st power source system P1 and the 2nd power source system P2. As a result, it is possible to further improve electric safety in maintenance or the like for a load equipment connected to the load circuit 7.

Next, the invention relating to a contact device for opening and closing a current path in an electric circuit will be described.

As the contact device, for example, a switch device is known which is configured to be able to alternately open and close two current paths as illustrated in FIG. 4 of JP-A-6-17067.

Such a switch device includes a pair of fixed contacts fixed at a fixed position, a long plate-shaped conductor plate, a pair of movable contacts attached to each end in the longitudinal direction of the conductor plate, a central terminal for supporting the central part of the conductor plate in a fixed position, a state of pushing the surface of the conductor plate between the one movable contact and the central terminal, the other movable contact and the central terminal a driving body switchable to a state of pushing the surface of the conductor plate between the.

According to the switch device having the above-described configuration, when the driving body switches to a state in which the surface of the conductor plate is pressed between the one movable contact and the central terminal, one of the movable contact and one of the fixed contacts is closed and the other movable contact and the other fixed contact are opened, and when the driving body switches to a state in which the surface of the conductor plate is pressed between the other movable contact and the central terminal, one of the movable contact and one of the fixed contact are opened and the other movable contact and the other fixed contact are closed.

As described above, in the switch device having the above-described configuration, the current path connected to the central terminal can be switched by alternately switching the open/close state of one movable contact and one fixed contact and the open/close state of the other movable contact and the other fixed contact.

Incidentally, in the conventional switch device as described above, even when one of the fixed contact and one of the movable contacts is closed, one of the fixed contact and one of the movable contact may be separated from each other, and also when the other of the fixed contact and the other of the movable contact is closed, the other of the fixed contact and the other of the movable contact may be separated from each other in the same manner, so that it is desired to eliminate the cause that the current path is opened at an unintended timing.

In view of the above circumstances, an object of the present invention is to provide a contact device having a high contact force for pressing a movable contact to a fixed contact.

The contact device of the present invention includes a long plate-shaped conductive plate having conductivity, a movable contact attached to one end portion in the longitudinal direction of the conductive plate in a state of being exposed to the surface side of the conductive plate, a movable contact fixed in a fixed position and separated from the fixed contact, a passive member having a support portion for supporting the conductive plate from the back surface, the support portion is configured to move so as to push the conductive plate so that the movable contact is close to the fixed contact, and a biasing means for biasing the other end portion side of the support portion in the longitudinal direction of the conductive plate from the surface side, the distance between the supporting position of the conductive plate by the biasing means and the supporting position of the conductive plate by the supporting portion is equal to or more than the distance between the supporting position and the movable contact of the conductive plate by the supporting portion.

In the contact device having the above-described configuration, since the biasing means is configured to bias the center part side of the conductive plate rather than the support part for pushing and operating the conductive plate, the support part is the fulcrum of the conductive plate, the force point of the biasing means applies an external force to the conductive plate, the movable contact is the point of action.

The distance between the biasing position of the conductive plate by the biasing means and the supporting position of the conductive plate by the supporting part is equal to or larger than the distance between the supporting position of the conductive plate by the supporting part and the movable contact, thereby improving the contact force.

There are various causes of the phenomenon that the contact in the closed state opens, the contact device of the above configuration, focusing on the relationship between the contact force and the phenomenon that the contact in the closed state opens, the supporting part as a fulcrum, the biasing means as a force point, by devising the positional relationship between the movable contact as an action point, so that it is configured to exhibit a higher contact force than the conventional.

Further, in the contact device of the present invention, the support part may be configured to support the conductive plate at a position closer to one end than the biasing means in the longitudinal direction and a position closer to the other end than the biasing means.

According to the contact device having the above-described configuration, the conductive plate can be stably disposed with respect to the passive member.

Further, in the contact device of the present invention, the support part, the one end side contact part disposed at the position of the one end side of the conductive plate, the other end side contact part disposed at the position of the other end side of the conductive plate, in a state in which the movable contact is pressed against the fixed contact, the one end side contact part abuts against the conductive plate, and the other end side contact part may be separated from the conductive plate.

According to the contact device having the above-described configuration, the passive member can be rotated until only the one-end contact part comes into contact with the conductive plate, and as a result, the biasing force by the biasing means is converted into a force for pressing the movable contact via the one-end contact part without dispersing, so that the contact force between the movable contact and the fixed contact is improved.

Further, in the contact device of the present invention, the conductive plate may have a plate length engagement part, and the passive member may have a receiving length engagement part that engages with the plate length engagement part, and the conductive plate may be positioned in the longitudinal direction with respect to the passive member by engagement of the plate length engagement part and the receiving length engagement part.

According to the contact device having the above configuration, the conductive plate disposed on the passive member is positioned in the longitudinal direction.

Further, in the contact device of the present invention, the conductive plate may have a plate width engaging part, and the passive member may have a receiving width engaging part that engages with the plate width engaging part, and the conductive plate may be positioned in a width direction with respect to the passive member by engaging the plate width engaging part and the receiving width engaging part.

According to the contact device having the above configuration, the conductive plate disposed on the passive member is positioned in the width direction.

As described above, according to the contact device of the present invention, it is possible to provide an excellent effect that a high contact force can be exerted.

Hereinafter, a contact device according to an embodiment of the present invention will be described with reference to the accompanying drawings.

The contact device is configured to open and close a current path. The contact device of the present embodiment is configured to alternately switch between the open and closed states of the two current paths.

Note that, in the present embodiment, the following explanation will be given by exemplifying cases where the contact device is incorporated in changeover switch.

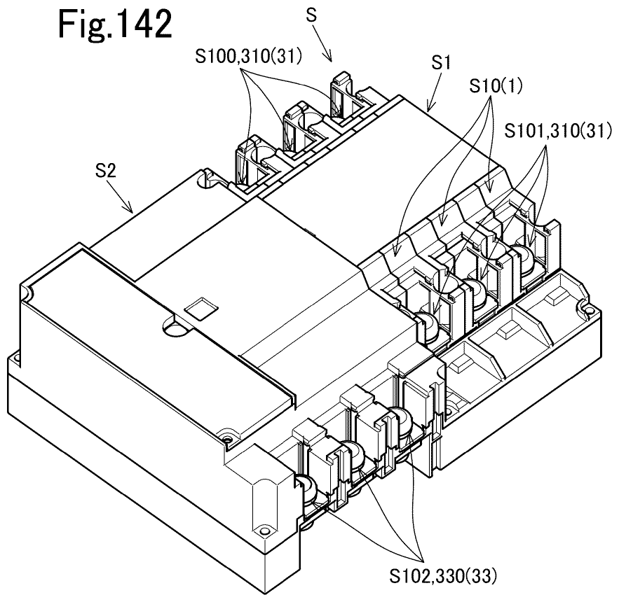

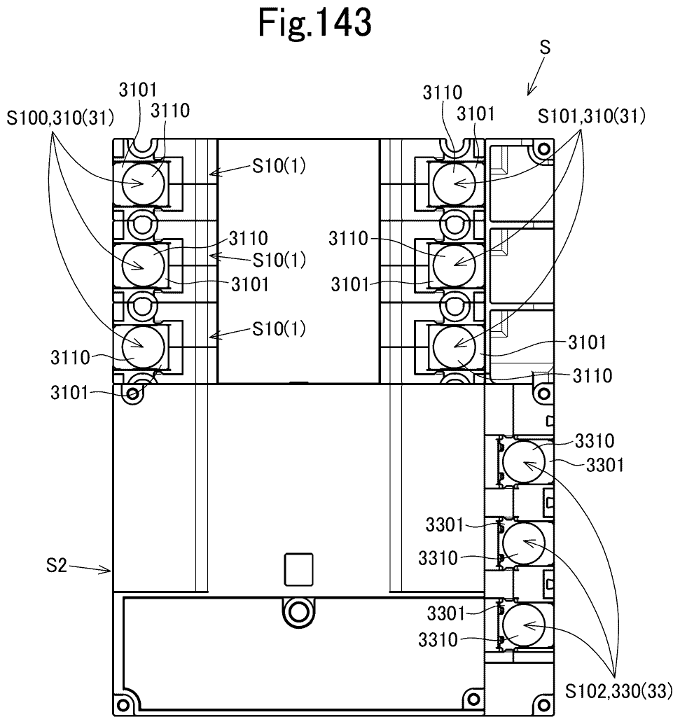

First, as shown in FIGS. 142 and 143, changeover switch 5 includes a switching main body part S1 having a switching unit S10 in which an opening/closing mechanism for opening/closing a current path is housed, and a switching control part S2 for controlling an opening/closing operation of the switching main body part (opening/closing mechanism).

The switching main body S1 of the present embodiment has three switching units S10, but each of the switching units S10 is constituted by the contact device 1.

Further, the switching unit S10 has three terminal part connected to various electric systems. In the present embodiment, each of the three terminal part is a first side terminal part S100 connected to the power system, a second side terminal part S101 connected to a power system different from the first side terminal part S100, and a load side terminal part S102 connected to a load system receiving power from the power system.

The electric power system is a commercial electric power system, an electric power system including a distributed power supply, or the like.

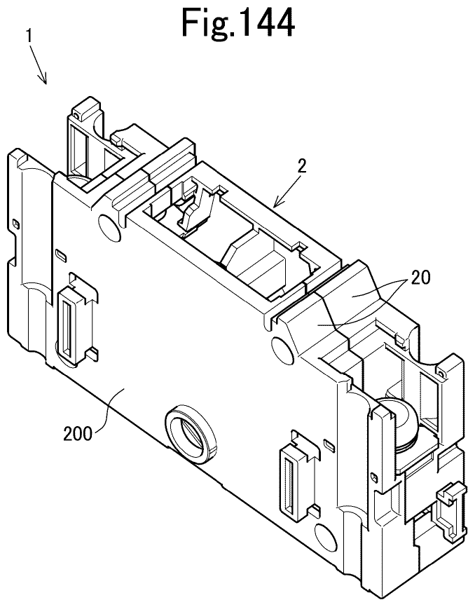

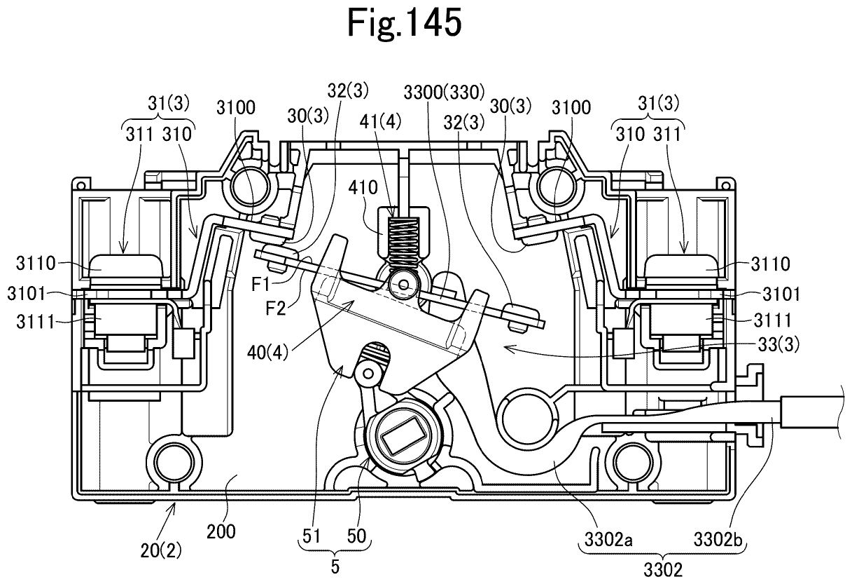

As shown in FIG. 144, the contact device 1 includes an exterior part 2, an opening/closing circuit part 3 configured to be openable/closable as shown in FIG. 145, an opening/closing mechanism part 4 for opening/closing the opening/closing circuit part 3, and an operation part 5 for operating the opening/closing mechanism part 4.

In the present embodiment, a case where the contact device 1 is a single-pole double throw switch will be described as an example.

The exterior part is configured by butting and fixing the pair of exterior forming parts 20 (see FIG. 143). In addition, the pair of exterior forming parts 20 constitute the side wall part 200 of the exterior part 2 with the wall parts that are disposed to face each other in a butting direction (hereinafter, referred to as a butting direction).

The opening/closing circuit part 3 includes a fixed contact 30 fixed at a fixed position inside the exterior part 2, a fixed-side external terminal part 31 for electrically connecting the fixed contact 30 and an external electric circuit, a movable contact 32 for contacting and separating the fixed contact 30 inside the exterior part 2, and a movable-side external terminal part 33 for electrically connecting the movable contact 32 and an external electric circuit.

As described above, the contact device 1 of the present embodiment is a single-pole double-throw switch, and thus includes a pair of fixed contacts 30 and a pair of movable contacts 32. In addition, a pair of fixed-side external terminal part 31 are provided in accordance with the numbers of fixed contacts 30.

Further, since the contact device 1 of the present embodiment is incorporated in changeover switch S, one fixed-side external terminal part 31 constitutes the first-side terminal part S100, the other fixed-side external terminal part 31 constitutes the second-side terminal part S101, and the movable-side external terminal part 33 constitutes the load-side terminal part S102 (see FIGS. 142 and 143).

The fixed-side external terminal part 31 has a fixed-side terminal main body part 310 having conductivity, and has a contact-side end part 3100 to which the fixed contact 30 is fixed, a fixed-side terminal main body part 310 having an outer end part 3101 to which a distribution material connected to an external electric circuit is connected, and an outer fixing structure 311 for fixing the electric circuit to the outer end part 3101 of the fixed-side terminal main body part 310.

The contact-side end part 3100 and the outer end part 3101 are fixed to the exterior part 2. Since the fixed-side terminal main body part 310 of the present embodiment is made of a plate material, part between the contact-side end part 3100, the outer end part 3101, and the contact-side end part 3100 and the outer end part 3101 is integrally formed.

In the fixed-side terminal main body part 310 of the present embodiment, the power distribution material is connected to the front surface side of the outer end part 3101, and the fixed contact 30 is exposed on the back surface side of the contact-side end part 3100.

The outer securing structure 311 of the present embodiment is configured to screw the power distribution material to the outer end 3101. More specifically, the outer fixing structure 311 has a terminal screw 3110 that is inserted from the front side of the outer end part 3101 with respect to the through hole formed in the outer end part 3101, and a screw receiving part 3111 that is disposed on the back side of the outer end part 3101 and is capable of screwing the terminal screw 3110.

The movable-side external terminal part 33 has a movable-side terminal main body part 330 having conductivity, and has a contact-side end part 3300 to which the movable contact 32 is fixed, a movable-side terminal main body part 330 having an outer end part 3301 to which a power distribution material connected to an external electric circuit is connected, and an outer fixing structure 331 (see FIG. 143) for fixing the electric circuit to the outer end part 3301 of the movable-side terminal main body part 330.

In the movable-side terminal main body part 330 of the present embodiment, the contact-side end part 3300 and the outer end part 3301 are formed separately.

The contact-side end part 3300 is formed of a conductive plate having a long plate shape and having conductivity. Hereinafter, the contact-side end part 3300 of the movable-side terminal main body part 330 is referred to as a conductive plate 3300. The conductive plate 3300 of the present embodiment has a substantially rectangular shape. The movable contact 32 is attached to both longitudinal end parts (one end part and the other end part), and the movable contact 32 is exposed on the front F1 of the conductive plate 3300.

The outer end part 3301 is formed of a conductive plate material.

Further, in the movable-side terminal main body part 330 of the present embodiment, the conductive plate 3300 and the outer end part 3301 formed separately are electrically connected by a connection line 3302. The connection line 3302 includes an inner connection line 3302a disposed inside the exterior part 2 and an outer connection line 3302b disposed outside the exterior part 2. The arrangement of the outer end part 3301 can be changed within a range in which the movement of the outer connecting line 3302b is allowed.

The outer securing structure 331 is configured to screw the power distribution material to the outer end 3301, as shown in FIG. 143. More specifically, the outer fixing structure 331 has a terminal screw 3310 that is inserted from the front side of the outer end part 3301 with respect to a through hole formed in the outer end part 3301, and a screw receiving part (not shown) that is disposed on the back side of the outer end part and is capable of screwing the terminal screw 3310.

As shown in FIG. 145, the opening/closing mechanism part 4 includes a passive member 40 that moves so that the movable contact 32 approaches the fixed contact 30, and a biasing means 41 that biases the conductive plate 3300 toward the passive member 40.

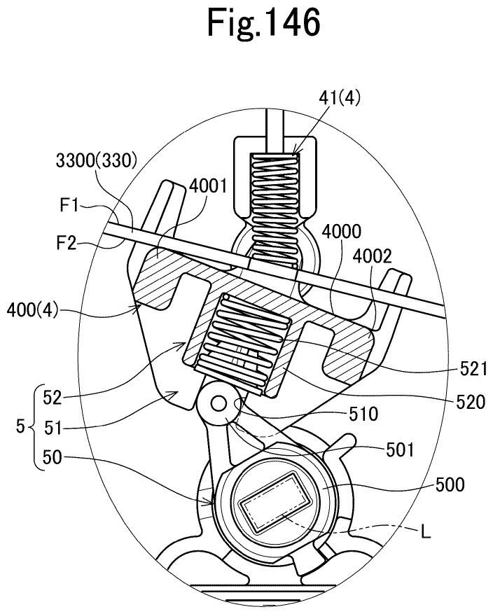

As illustrated in FIG. 146, the passive member 40 includes a support part 400 that supports the conductive plate 3300 from the back surface F2, and a holding structure 401 that holds the conductive plate in the exterior part 2 while allowing movement of the support part 400.

The support part 400 includes a placement surface 4000 on which the conductive plate 3300 is placed, one end side abutting part 4001 disposed in alignment with the position on the one end side of the conductive plate 3300, and the other end side abutting part 4002 disposed in alignment with the position on the other end side of the conductive plate 3300.

The mounting surface 4000 is formed in a rectangular shape in accordance with the shape of the conductive plate 3300.

The one-end-side abutment part 4001 and the other-end-side abutment part 4002 each constitute an end part in the longitudinal direction. In addition, the one-end-side contact part 4001 and the other-end-side contact part 4002 have a rounded shape. Note that one end part of the placement surface 4000 is included in the one-end-side contact part 4001, and the other end part of the placement surface 4000 is included in the other-end-side contact part 4002.

The length of the conductive plate 3300 in the longitudinal direction is larger than the length of the mounting surface 4000 in the longitudinal direction. Therefore, the conductive plate 3300 is configured such that both end parts in the longitudinal direction of the conductive plate 3300 itself extend outward from the placement surface 4000 in a state of being placed on the placement surface 4000.

Further, one end side abutting part 4001, in a state in which one of the movable contact 32 and one of the fixed contacts 30 is closed, is configured to abut on the back surface F2 on one end side of the conductive plate 3300, the other end side abutting part 4002, in a state in which the other movable contact 32 and the other fixed contact 30 are closed, the other end side of the conductive plate 3300 is configured to abut on the back surface F2 side.

Further, the passive member 40 of the present embodiment, in a state in which one of the movable contact 32 and one fixed contact 30 is closed, one end side contact part 4001 is in contact with the back surface F2 of one end side of the conductive plate 3300 and the other end side contact part 4002 can be separated from the back surface F2 of the other end side of the conductive plate 3300, further, in a state in which the other movable contact 32 and the other fixed contact 30 are closed, one end side contact part 4001 is separated from the back surface F2 of one end side of the conductive plate 3300 and the other end side contact part 4002 is configured to be in contact with the back surface F2 of the other end side of the conductive plate 3300.

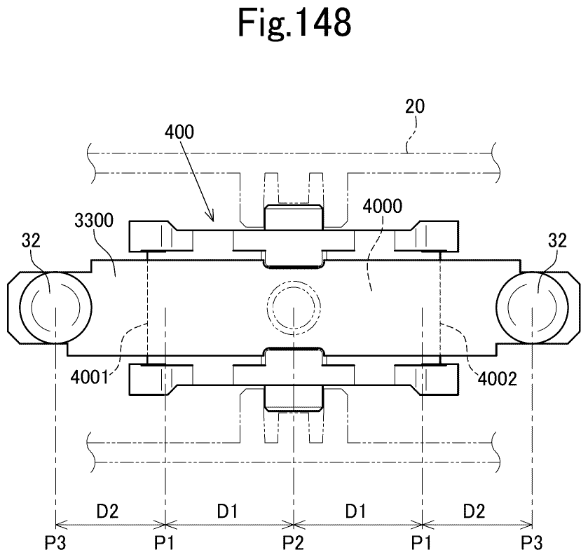

As shown in FIG. 148, when one of the movable contacts 32 and one of the fixed contacts 30 is brought into contact with each other, the support position at which the one end side abutting part 4001 contacts the conductive plate 3300 (one end side of the conductive plate 3300) is set so that the support position is in contact with the fulcrum P1, the biasing position biased by the biasing part 41 in the conductive plate 3300 becomes the force point P2, the movable contact 32 (more specifically, the position in contact with the fixed contact 30 of the movable contact 32) becomes the action point P3, and the distance (interval) D1 between the fulcrum P1 and the force point P2 is set to be larger than the distance (interval) D2 from the fulcrum P1 to the action point P3.

Also when the other movable contact 32 and the other fixed contact 30 are brought into contact with each other, the support position where the other end side abutting part 4002 contacts the conductive plate 3300 (the other end side of the conductive plate 3300) is in contact with the fulcrum P1, the biasing position biased by the biasing part 41 in the conductive plate 3300 is the force point P2, the movable contact 32 (more specifically, the position in contact with the fixed contact 30 of the movable contact 32) is the action point P3, and the distance D1 between the fulcrum P1 and the force point P2 is set to be larger than the distance (

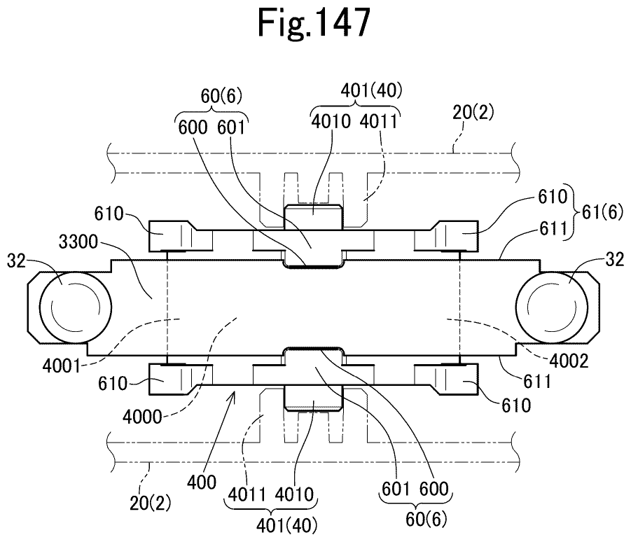

As shown in FIG. 147, the holding structure 401 includes a shaft part 4010 provided in the support part 400 and a bearing part 4011 provided inside the exterior part 2 and rotatably holding the shaft part.

The shaft part 4010 is a part serving as a rotation center of the passive member 40. If the shaft part 4010 is disposed in front of the mounting surface 4000 in the plane direction, it is easy to set a larger rotation range (swing range) of the support part 400, and if it is disposed behind the mounting surface 4000 in the plane direction, it is easy to suppress the rotation range (swing range) of the support part 400.

The shaft part 4010 is provided on one end side and the other end side of the passive member 40 in the butting direction, and the bearing part 4011 is provided on the inner surface of the one side wall part 200 and the inner surface of the other side wall part 200. The passive member 40 is sandwiched between the pair of side wall parts 200 (bearing parts 4011) together with the shaft part 4010 so as to be rotatable (swingable) about the shaft part 4010.

Here, the contact device 1 of the present embodiment includes a positioning structure 6 for positioning the conductive plate 3300 with respect to the passive member 40.

The positioning structure 6 includes a positioning structure (hereinafter, referred to as a first positioning structure) 60 for positioning the conductive plate 3300 in the longitudinal direction, and a positioning structure (hereinafter, referred to as a second positioning structure) 61 for positioning the conductive plate 3300 in the width direction orthogonal to the longitudinal direction and the plate surface direction.

The first positioning structure 60 includes a plate length engaging part 600 formed on the conductive plate 3300, and a receiving length engaging part 601 formed on the passive member 40 and engaged with the plate length engaging part 600. The long plate engaging part 600 and the receiving length engaging part 601 engage with each other in the longitudinal direction of the conductive plate 3300, so that the conductive plate 3300 is positioned in the longitudinal direction with respect to the passive member 40.

The second positioning structure 61 has a plate width engaging part 610 formed on the conductive plate 3300, and has a receiving width engaging part 611 that engages with the plate width engaging part 610 formed on the passive member 40. When the plate width engaging part 610 and the receiving width engaging part 611 engage in the width direction of the conductive plate 3300, the conductive plate 3300 is positioned in the width direction with respect to the passive member 40. Incidentally, the receiving width engaging part 611 of the present embodiment is erected at the four corners of the mounting surface 4000, and is configured to engage (abut) the long side part of the conductive plate 3300 in the width direction.

As shown in FIG. 145, the biasing means 41 is constituted by a compression spring disposed inside the exterior part 2. Further, the biasing means of the present embodiment is accommodated in the accommodation part 410 provided in the exterior part 2, and is accommodated in the accommodation part 410 formed so as to have a recessed part opening toward the conductive plate 3300.

The operation part 5 includes a driven rotating part 50 that rotates in response to an external force, an interlocking part 51 that is provided on the passive member 40 and that moves in conjunction with the movement of the driven rotating part 50, and an auxiliary biasing part 52 that assists the rotation operation of the driven rotating part 50.

As shown in FIG. 146, the driven rotation part 50 includes a rotation operation part 500 rotatably attached to the exterior part 2, and an arm part 501 extending outward from the rotation operation part 500.

The rotation operation part 500 is configured to be rotatable from the outside of the exterior part 2, and in the present embodiment, an operation lever L extending from the switching control part is inserted. The operating lever L of the present embodiment is automatically rotated by the switching control part S2. That is, the contact device 1 of the present embodiment is configured such that the opening and closing state of one of the fixed contact 30 and one of the movable contact 32 and the opening and closing state of the other of the fixed contact 30 and the other of the movable contact 32 are automatically switched, for example, the opening and closing state of one of the fixed contact 30 and one of the movable contact 32 and the other of the fixed contact 30 and the other of the movable contact 32 can be switched manually.

The interlocking part 51 is provided on the rear side (opposite side of the placing surface 4000) of the passive member 40. Further, the interlocking part 51 has a rotation engaging part 510 which is engaged with the arm part 501 so as to be relatively rotatable. The rotary engagement part 510 of the present embodiment is constituted by a recessed part, and the arm part 501 is formed in a shaft shape that engages in the recessed part.

The auxiliary biasing part 52 includes an auxiliary housing part 520 formed on the back side of the passive member 40 and forming a recess opening toward the arm part 501, and an auxiliary biasing part 521 that biases the arm part 501 in a state of being disposed in the auxiliary housing part 520. The auxiliary biasing part 521 is constituted by a compression spring.

The configuration of the contact device 1 according to the present embodiment is as described above. Next, the operation of the contact device 1 will be described.

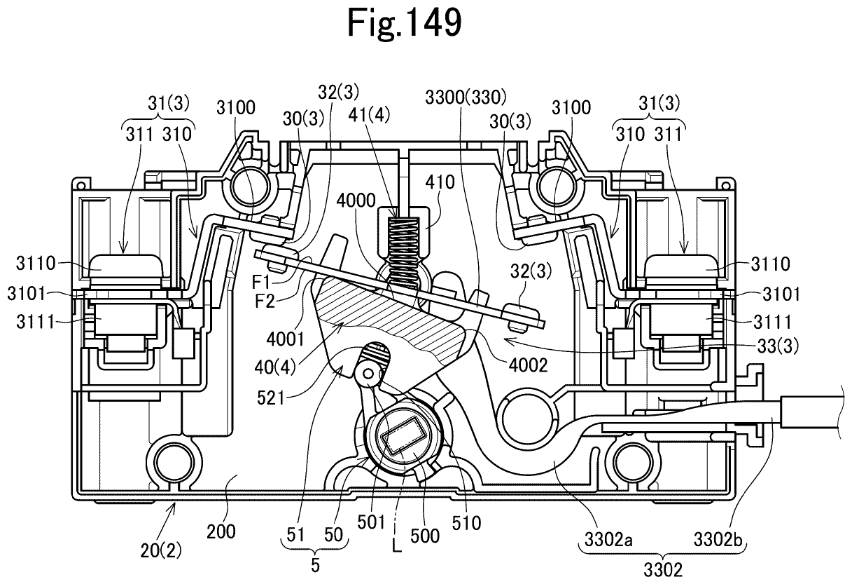

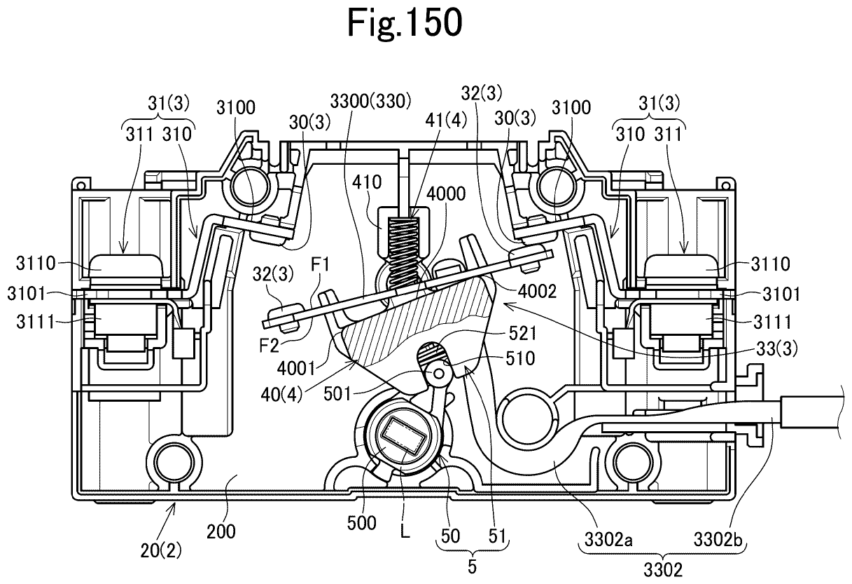

Contact device 1, as shown in FIG. 149, a first state in which the one fixed contact 30 and one movable contact 32 are closed and the other fixed contact 30 and the other movable contact 32 are opened, as shown in FIG. 150, one fixed contact 30 and one movable contact 32 are opened and the other fixed contact 30 and the other movable contact 32 are closed It is switchable to a second state.

When the state of the contact device 1 is switched from the first state to the second state, first, in the first state of FIG. 149, when the switching control part S2 starts rotating the operating lever L in the clockwise direction, the driven rotating part 50 (the rotating operation part 500 and the arm part 501) also starts rotating in the clockwise direction at the same time.

Since the arm part 501 is engaged with the rotation engagement part 510, the passive member 40 starts to rotate counterclockwise about the shaft part 4010. At this time, the auxiliary biasing part 521 is gradually compressed and contracted with rotation, and the elastic energy is accumulated.

Further, when the arm part 501 continues to rotate clockwise, the rotation center of the rotation operation part 500, the contact point between the arm part 501 and the auxiliary biasing part 521, and the rotation center of the passive member 40 are aligned on a straight line. When the contact point between the arm part 501 and the auxiliary biasing part 521 exceeds a position aligned with the rotation center of the rotation operation part 500 and the rotation center of the passive member 40, the elastic energy accumulated in the auxiliary biasing part 521 is released, and the arm part 501 continues to rotate until the elastic energy of the auxiliary biasing part 521 is received and switched to the second state.

When the state of the contact device 1 is switched from the second state to the first state, first, in the second state of FIG. 150, when the switching control part S2 starts rotating the operating lever L counterclockwise, the driven rotating part 50 (the rotating operation part 500 and the arm part 501) also starts rotating counterclockwise at the same time.

Since the arm part 501 is engaged with the rotation engagement part 510, the passive member 40 starts to rotate clockwise about the shaft part 4010. At this time, the auxiliary biasing part 521 is gradually pushed and contracted again with rotation, and the elastic energy is accumulated.

Further, when the arm part 501 continues to rotate counterclockwise, the rotation center of the rotation operation part 500, the contact point between the arm part 501 and the auxiliary biasing part 521, and the rotation center of the passive member 40 are aligned on a straight line. When the contact point between the arm part 501 and the auxiliary biasing part 521 exceeds a position aligned with the rotation center of the rotation operation part 500 and the rotation center of the passive member 40, the elastic energy accumulated in the auxiliary biasing part 521 is released, and the arm part 501 continues to rotate until the elastic energy of the auxiliary biasing part 521 is received and switched to the first state.

In the second state from the first state, when one of the fixed contact 30 and one of the movable contacts 32 is opened, until the other of the fixed contact 30 and the other of the movable contact 32 is closed, the one of the fixed contact 30 and the one of the movable contact 32 and the other of the fixed contact 30 and the other of the movable contact 32 are opened.

Also in the first state from the second state, when the other fixed contact 30 and the other movable contact 32 are opened, until the one fixed contact 30 and the one movable contact 32 are closed, the one fixed contact 30 and the one movable contact 32 and the other fixed contact 30 and the other movable contact 32 are also opened.

Also in the case of switching from the first state to the second state, also in the case of switching from the second state to the first state, one of the fixed contact 30 and one of the movable contact 32, the other of the fixed contact 30 and the other of the movable contact 32 is opened state, the entire back side of the central part in the longitudinal direction of the conductive plate abuts against the mounting surface 4000.

Further, in the contact device 1, when switching from the second state to the first state, when one of the fixed contact 30 and one of the movable contact 32 is closed, the entire back surface F2 of the central part of the conductive plate 3300 is brought into contact with the mounting surface 4000, the passive member 40 is further rotated, as shown in FIG. 149, one end side contact part 4001 is in contact with the back surface F2 of one end side of the conductive plate 3300, and the other end side contact part 4002 is in a state of being separated from the back surface F2 of the other end side of the conductive plate 3300.

Even when switching from the first state to the second state, when the other fixed contact 30 and the other movable contact 32 are closed, the entire back surface F2 of the central part of the conductive plate 3300 is brought into contact with the mounting surface 4000, but the passive member 40 is further rotated, as shown in FIG. 150, the other end side abutting part 4002 abuts on the back surface F2 of the other end side of the conductive plate 3300, and the one end side abutting part 4001 is separated from the back surface F2 of the other end side of the conductive plate 3300.

As described above, according to the contact device 1 of the present embodiment, in the case of switching from the first state to the 2 state, the distance D1 between the fulcrum P1 and the force point P2 is set to be larger than the distance D2 from the fulcrum P1 to the point of action P3, and also in the case of switching from the 2 state to the first state, Since the distance D1 between the fulcrum P1 and the force point P2 is set to be larger than the distance D2 from the fulcrum P3 to the point of action, the contact force of one movable contact 32 with respect to one fixed contact 30 (the force of pressing the other movable contact 32 with the other fixed contact 30) is also improved It is.

Although there are various causes of the phenomenon that the contact in the closed state is opened, the contact device 1 of the present embodiment focuses on the relationship between the contact force and the phenomenon that the contact in the closed state is opened, the support part 400 serving as a fulcrum P1 (one end-side abutting part 4001, the other end-side abutting part 4002), the biasing part 41 serving as a force point P2, by devising the positional relationship between the movable contact 32 serving as an action point, it is possible to exhibit an excellent effect that can exhibit a higher contact force than the conventional.

Further, since the support part 400 is configured to support the conductive plate 3300 at a position closer to one end than the biasing means 41 and a position closer to the other end than the biasing means 41, it is also possible to arrange the conductive plate 3300 in a stable state with respect to the passive member 40.

The support part 400 of the present embodiment has one end side contact part 4001 disposed at a position on one end side of the conductive plate 3300 and the other end side contact part 4002 disposed at a position on the other end side of the conductive plate 3300, and in a state in which one end side contact part 4001 abuts on the back surface F2 on one end side of the conductive plate 3300 and the other end side contact part 4002 is separated from the back surface F2 on one end side of the conductive plate 3300 and the other end side contact part 4002 is separated from the back surface on the other end side of the conductive plate 3300 When switching from the first state to the second state, the passive member 40 can be rotated until only the other end contact part 4002 comes into contact with the conductive plate 3300. The passive member 40 can be rotated until only the one-end abutment part 4001 comes into contact with the conductive plate 3300. As a result, in the contact device 1 of the present embodiment, the biasing force of the conductive plate by the biasing means is not dispersed, the force for pressing one of the movable contact 32 via the one end side contact part 4001 to one of the fixed contact 30, the other movable contact 32 via the other end side contact part 4002 is converted into a force for pressing the other fixed contact 30, so that the contact force is improved.

Further, in the contact device 1 of the present embodiment, in the state where the conductive plate 3300 is placed on the mounting surface 4000, by the plate length engaging part 600 and the receiving length engaging part 601 is engaged, the conductive plate 3300 is positioned in the longitudinal direction with respect to the passive member 40, also by the plate width engaging part 610 and the receiving width engaging part 611 is engaged, since the conductive plate 3300 is positioned in the width direction with respect to the passive member 40, the posture of the conductive plate 3300 on the mounting surface 4000 is stabilized.

It should be noted that the contact device of the present invention is not limited to the above-described embodiment, and various modifications can be made without departing from the gist of the present invention.

In the above embodiment, a case where the contact device 1 is a contact device for changeover switch S (a case where changeover switch S switching unit S10 is configured) has been exemplified, but the present invention is not limited to this configuration. For example, the contact device 1 may be used alone or may be incorporated in a device different from changeover switch S.

In the above embodiment, the contact device 1 is a single-pole double-throw switch as an example, but the present invention is not limited to this configuration. For example, the contact device may be a single pole, single throw switch. When the contact device 1 is a single-pole single throw switch, the opening/closing circuit part 3 may be configured to include one fixed contact 30, one fixed-side external terminal part 31, one movable contact 32, and one movable-side external terminal part 33.

In this manner, the contact device may open and close one current path, or may alternately open and close two current paths (i.e., switch the current path).

In the above-described embodiment, the entire fixed-side terminal main body 310 is made of a plate material, but the present invention is not limited to this configuration. For example, the fixed-side terminal main body part 310 may be configured such that the contact-side end part 3100 and the outer end part 3101 are formed of a plate material, and the contact-side end part 3100 and the outer end part 3101 are connected by a lead wire.

In the above embodiment, the outer securing arrangement 311 of the stationary outer terminal part 31 is configured to screw the electrical distribution material to the outer end 3101, but is not limited to this configuration. For example, the outer fixing structure 311 may be clamp-type or plug-in-type as long as the power distribution material can be fixed in contact with the outer end part 3101 (in a conductive state). The same applies to the outer fixing structure 330 of the movable-side external terminal part 33.

In the above-described embodiment, the outer fixing structure 330 of the movable-side external terminal part 33 is disposed at a position away from the exterior part 2, but is not limited to this configuration. For example, the outer fixing structure 330 of the movable-side external terminal part 33 may be disposed on the exterior part 2 in the same manner as the outer fixing structure 311 of the fixed-side external terminal part 31. Here, the connection line 3302 only needs to be constituted by the inner connection line 3302a.

In the above embodiment, the conductive plate 3300 is configured such that both end parts in the longitudinal direction extend outward from the mounting surface 4000, but the configuration is not limited to this configuration. For example, the conductive plate 3300 may be configured such that only one of the end parts in the longitudinal direction extends outward from the placement surface 4000.

In addition, when only one end part of both end parts in the longitudinal direction of the conductive plate 3300 is configured to extend outward from the placing surface 4000, at least one end side contact part 4001 of the one end side contact part 4001 and the other end side contact part 4002 may be configured to abut on the back surface F2 of the conductive plate 3300, and when only the other end part of the conductive plate 3300 is configured to extend outward from the placing surface 4000, at least the other end side contact part 4002 of the one end side contact part 4001 and the other end side contact part 4002 may be configured to abut on the back surface F2 of the conductive plate 3300.

In the above-described embodiment, the holding structure 401 has the shaft part 4010 provided in the support part 400 and the bearing part 4011 provided in the exterior part 2, but is not limited to this configuration. For example, in the holding structure 401, the shaft part 4010 may be provided inside the exterior part 2, and the bearing part 4011 may be provided in the support part 400.

That is, the holding structure 401 includes the shaft part 4010 and the bearing part 4011 that rotatably holds the shaft part 4010, and it is sufficient that one of the shaft part 4010 and the bearing part 4011 is provided in the support part 400, and the other of the shaft part 4010 and the bearing part 4011 is provided in the exterior part 2.

In the above-described embodiment, the conductive plate 3300 is positioned with respect to the passive member 40 in the longitudinal direction and the width direction by the two positioning structures 60 and 61, but the configuration is not limited thereto. For example, one positioning structure may position the conductive plate 3300 with respect to the passive member 40 in the longitudinal direction and the width direction.

In the above-described embodiment, the recessed part is formed in the rotation engagement part 510 of the arm part 501 and the rotation engagement part 510 which are configured to be relatively rotatable in a state of being engaged with each other, but the present invention is not limited to this configuration. For example, as long as the arm part 501 and the rotation engagement part 510 are configured to be relatively rotatable while keeping the engagement state, for example, a recess may be formed in the arm part 501, the auxiliary biasing part 521 may be disposed in the recess of the arm part 501, and the rotation engagement part 510 may be configured to be engaged in the recess of the arm part 501.

### REFERENCE SIGNS LIST

1: Changeover switch built-in board
2: First circuit part
3: Second circuit part
4: Load circuit part
5: Changeover switch
6: Relay circuit part
7: Housing
8: Cover structure

1-7. (canceled)

8. A changeover switch for changing over a power source for supplying power to a load system including a load between a 1st power supply system and a 2nd power supply system, the changeover switch comprising:
a 1st side terminal to which power from the 1st power supply system is input:
a 2nd side terminal to which power from the 2nd power supply system is input; and
a load side terminal for outputting to a load system power from the 1st power supply system that is input to the 1st side terminal, or power from the 2nd power supply system that is input to the 2nd side terminal, wherein
areas in which the 1st side terminal, the 2nd side terminal, and the load side terminal are respectively disposed are set at different locations from each other in a front view.

9. The changeover switch according to claim 8, further comprising a changeover body that can change over the electrical connection state of the 1st side terminal and the 2nd side terminal with the load side terminal, and have the load side terminal disposed at a tip of a terminal conductor that extends from the changeover body.

10. The changeover switch according to claim 8, wherein the 1st side terminal and the 2nd side terminal are disposed to be aligned with each other in a right-left direction orthogonal to a front-back direction, and the load side terminal is disposed to be aligned with the 1st side terminal or the 2nd side terminal in a vertical direction orthogonal to the front-back direction and the right-left direction.

11. The changeover switch according to claim 8, wherein the 1st side terminal and the 2nd side terminal are disposed to be aligned with each other in the vertical direction orthogonal to the front-back direction, and the load side terminal is disposed on the right side of the 1st side terminal and the 2nd side terminal in the right-left direction orthogonal to the front-back direction and the vertical direction.

12. The changeover switch according to claim 10, further comprising a changeover body that can change over the electrical connection state of the 1st side terminal and the 2nd side terminal with the load side terminal, and the 1st side terminal and the 2nd side terminal are disposed to be oriented in the mutually opposite sides in the right-left direction.

13. The changeover switch according to claim 8, further comprising a changeover body that can change over the electrical connection state of the 1st side terminal and the 2nd side terminal with the load side terminal, and a changeover control part that controls the changeover of the electrical connection state of the 1st side terminal and the 2nd side terminal with the load side terminal by the changeover body, wherein the 1st side terminal and the 2nd side terminal are disposed in the changeover body, and the load side terminal is disposed at a location adjacent to the changeover control part.
